(19) United States
(12) Patent Application Publication
(10) Pub. No.: US 2006/0093955 A1
(43) Pub. Date: May 4, 2006

(54) Image forming method, and image forming apparatus and process cartridge using the image forming method

(76) Inventors: Kohichi Ohshima, Mishima-shi (JP); Yasuo Suzuki, Fuji-shi (JP); Tetsuro Suzuki, Fuji-shi (JP); Michitaka Sasaki, Chiba-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/261,751

(22) Filed: Oct. 31, 2005

(30) Foreign Application Priority Data
Nov. 1, 2004 (JP) 2004-318342

(51) Int. Cl. G03G 21/10

(52) U.S. Cl. 430/125; 399/159

(57) ABSTRACT

An image forming method including forming a toner image on an image bearing member; transferring the toner image onto a receiving material; and then cleaning the surface of the image bearing member with a cleaning member while applying a voltage to the cleaning member such that the cleaning member electrostatically attracts toner particles remaining on the image bearing member, wherein the image bearing member has, as an outermost layer, a crosslinked charge transport layer comprising a crosslinked resin including at least one unit obtained from at least one radical polymerizable polyfunctional monomer having three or more radical polymerizable functional groups and no charge transport structure, and a unit obtained from a radical polymerizable functional monomer having one or more radical polymerizable functional groups and a charge transport structure. An image forming apparatus and a process cartridge using the image forming method are also provided.

### BACKGROUND OF THE INVENTION

1. Field of the Invention

The present invention relates to an image forming method, and more particularly to an electrophotographic image forming method. In addition, the present invention also relates to an image forming apparatus and a process cartridge using the image forming method.

2. Discussion of the Background

Electrophotography is widely used for image forming apparatuses such as copiers and laser printers. Electrophotographic image forming methods typically include the following processes:
(1) charging an electrophotographic photoreceptor (herein after referred to as a photoreceptor) serving as an image bearing member (charging process);
(2) irradiating the charged photoreceptor with imagewise light to form an electrostatic latent image on the surface of the photoreceptor (light irradiating process);
(3) developing the electrostatic latent image with a developer including a toner to form a toner image on the photoreceptor (developing process);
(4) transferring the toner image onto a receiving material optionally via an intermediate transfer medium (transferring process);
(5) fixing the toner image to the receiving material (fixing process); and
(6) cleaning the surface of the photoreceptor after the transferring process (cleaning process).

The electrophotographic image forming methods have an advantage in that the photoreceptor is repeatedly used and therefore a plate making operation is not needed. Therefore, electrophotographic image forming apparatuses have been widely used for clerical work. Recently, low-cost and small-sized laser printers have been developed and used as output devices of personal computers. In addition, recently a need exists for a color laser printer which can easily and stably produce high definition full color images.

In general, organic photoreceptors using an organic photoconductive material as a photosensitive material have been used for electrophotographic image forming apparatuses. Specific examples of the organic photoreceptors include single-layered organic photoreceptors using a photoconductive polymer such as polyvinyl carbazole (PVK) or a charge transfer complex such as polyvinyl carbazole-2,4,7-trinitrofluorenone (PVK-TNF); and functionally separated photoreceptors in which a charge transport layer including a charge transport material such as triphenylamine compounds is overlaid on a charge generation layer including a photoconductive material such as azo pigments and phthalocyanine pigments.

Among these photoreceptors, the functionally-separated photoreceptors are mainly used now because of having the following advantages:
(1) having wide design flexibility;
(2) having low cost;
(3) having good disposability (i.e., capable of being easily disposed of because of having great safety); and
(4) materials having high sensitivity to the laser light used for electrophotographic image forming apparatuses can be used therefor.

However, the organic photoreceptors have relatively low mechanical and chemical durability compared to inorganic photoreceptors. For example, when a photoreceptor has, as an outermost layer, a charge transport layer in which a charge transport material having a low molecular weight is dispersed in a polymer compound, such a photoreceptor has too low mechanical strength to be repeatedly used for the image forming processes mentioned above. In particular, such an outermost layer is seriously abraded in the following cases:
(1) the photoreceptor is used for a developing device using a two-component developer while rubbed with the two-component developer;
(2) the photoreceptor is contacted with various receiving materials;
(3) the photoreceptor is rubbed with a cleaning blade in a cleaning process; and
(4) the photoreceptor is contacted with a contact charger in a charging process.

In general, a photoreceptor is typically charged by a charging method utilizing corona charging. Therefore, charging products such as ozone and NOx are continuously produced in image forming apparatuses. Since these charging products are chemically active, the products are easily accumulated on the surface of the photoreceptor or reacted with the surface. In addition, a part of the charging products invades into the photosensitive layer, and thereby the electrostatic properties of the photoreceptor are deteriorated, resulting in deterioration of image qualities. In particular, when the charging products or the reaction products of the charging products and the materials constituting the photosensitive layer absorb the moisture in the air under high humidity conditions, the surface resistivity of the photosensitive layer seriously decreases, and thereby abnormal images such as tailed images and blurred images are produced. Such abnormal images are fatal defects for high definition full color images.

Various investigations have been made to improve the mechanical durability of organic photoreceptors. Among the stresses applied to a photoreceptor in an image forming apparatus, the stress applied by a cleaning blade in a cleaning process is the maximum. Therefore, a technique in that a brush is used as a cleaning member to reduce abrasion loss while sacrificing the parts cost is proposed. In addition, published unexamined Japanese patent applications Nos. (hereinafter referred to as JP-As) 06-342236, 08-202226 and 09-81001 have disclosed techniques in that the friction coefficient of surface of a photoreceptor is controlled so as to fall in a proper range to reduce the shearing strength of the blade used for cleaning the surface of the photoreceptor. Further, a technique in that a toner including a lubricant is used to supply the lubricant to the surface of a photoreceptor and a technique in that a lubricant is applied on the surface of a photoreceptor in a cleaning process using an applicator have been proposed. Furthermore, a technique in that a lubricant is included in the outermost layer of a photoreceptor is proposed.

The chemical durability of a photoreceptor is typically deteriorated by corona charging performed in a charging process and a transferring process. Recently, contact charging methods in which a charging member charges a photoreceptor while being contacted with the surface of the photoreceptor have been used for the charging process and the transferring process. For example, JP-As 63-149668 and 07-281503 have disclosed charging methods in which a voltage is applied to a charging member such as brushes, rollers and blades, which has a proper conductivity and elasticity, while contacting the charging member with the surface of a photoreceptor to charge the photoreceptor. Since the voltage applied to a charging member in such contact charging methods is relatively low compared to that in non-contact charging methods, the amount of generated ozone and NOx is relatively small. Therefore, the contact charging methods have an advantage in that degree of deterioration of the photoreceptor used is lower than that in a case of using a non-contact charging method.

Further, recently short-range charging methods which are an intermediate method between contact charging methods and non-contact charging methods and in which a charging member applies a DC voltage or a DC voltage overlapped with an AC voltage to a photoreceptor while a small gap is formed therebetween have been used.

However, ozone and NOx are also generated by these charging methods although the amounts of such materials can be reduced. Namely, even when these methods are used, it is hard for a photoreceptor to be stably used for a long period of time.

In a tandem type high speed color printer in which a full color image is formed by forming four color images on respective photoreceptors, transferring the four color images onto an intermediate transfer medium one by one, and then transferring the four color images to a receiving material at the same time, a problem in that the resultant full color image has poor color balance tends to occur because the abrasion losses of the four photoreceptors are different and therefore the photosensitivities of the photoreceptors are different from each other. In addition, even when only one color image is blurred, the image quality of the resultant full color image seriously deteriorates. Further, when a photoreceptor is repeatedly used for a long period of time at a high speed, the abrasion loss of the photoreceptor seriously increases, and therefore the photoreceptor has to be frequently replaced with new one. In this case, the image forming apparatus loses the above-mentioned advantage of the electrophotographic image forming apparatuses.

In attempting to solve the abrasion problem, techniques in that a protective layer is formed on the surface of a photoreceptor have been proposed. In addition, techniques in that a filler is included in a protective layer and/or a photosensitive layer have been proposed. For example, JP-A 07-84394 has disclosed techniques in that a fluorine-containing resin is included (or dispersed) in a protective layer and a photosensitive layer while controlling the surface energy of the layer to improve the mechanical and chemical durability of the photoreceptor.

On the other hand, it is found that a spherical toner having a small particle diameter is useful for producing high quality images. Such a toner is typically prepared by a polymerization method. Toners prepared by a polymerization method have a relatively sharp particle diameter distribution compared to that of toners prepared by a pulverization method. In addition, polymerization toners have an advantage in that a wax can be easily included in toner particles and thereby the fluidity of the toner can be enhanced. Further, it is easy for polymerization methods to control the shape of toner particles, i.e., to prepare a spherical toner.

However, such spherical toners prepared by a polymerization method have several drawbacks. Among the drawbacks, the most serious drawback is that toner particles remaining on the surface of a photoreceptor even after a cleaning process cannot be perfectly removed therefrom, resulting in occurrence of a cleaning problem for the photoreceptor. The reason therefor is as follows. The toner particles sandwiched by a cleaning blade and a photoreceptor achieve a state near the closest packing state, and therefore a second toner particle layer slips on a first toner particle layer which is contacted with the surface of the photoreceptor while having a high adhesion against the photoreceptor. Therefore, the first toner particle layer remains without being removed by the cleaning blade. In addition, the tip of a cleaning blade is not smoothly contacted with the surface of a photoreceptor when images are formed at a high speed, thereby causing a problem in that the tip of the cleaning blade is turned around and the following toner particles cannot be removed by the deformed portion of the cleaning blade particularly when the toner particles have a small particle diameter.

In attempting to solve the problem, JP-A 05-265360 discloses a technique in that toner particles remaining on the surface of a photoreceptor are removed with a cleaning blade made of an electroconductive material while an AC voltage and a DC voltage having the same polarity as that of charge of the toner used are applied to the blade. In addition, JP-A 07-210053 discloses a technique in that residual toner particles are removed with a cleaning blade which is made of an electroconductive material and which is grounded. Further, a technique in that a DC voltage having a polarity opposite to that of charge of the toner used is applied to a cleaning blade and a technique in that a DC voltage having the same polarity as that of charge of the toner used is applied to a cleaning blade have been proposed.

However, in these cleaning methods, residual toner particles are scraped off by a cleaning blade and thereby a wax included in a surface portion of the toner particles is exuded therefrom due to the pressure of the cleaning blade if the toner includes a polyester resin having a low melt viscosity and a sharp melting property. The thus exuded wax is pressed by the cleaning blade to the surface of the photoreceptor, resulting formation of a wax film on the surface of the photoreceptor. This wax film deteriorates the image qualities. Namely, when the friction coefficient of the photoreceptor is decreased due to formation of the wax film, the adhesion of toner particles to the photoreceptor decreases, and thereby the toner particles constituting a toner image tend to be abnormally transferred from the photoreceptor to a receiving material, resulting in formation of a scattered toner image. This is because the toner particles are scattered due to occurrence of discharging of the toner particles located before the nip between the receiving material and the photoreceptor.

When a film including foreign materials such as waxes and other materials is formed on a surface of a photoreceptor, the qualities of images produced by the photoreceptor deteriorate to greater or lesser degrees. In addition, when a photoreceptor is repeatedly charged, the surface of the photoreceptor is deteriorated. In attempting to solve this problem, JP-A 2004-117419 discloses a technique in that polishing means is provided to polish the surface of a photoreceptor. However, it is necessary to change the polishing conditions depending on the hardness of the photoreceptor to uniformly polish the surface of the photoreceptor.

In addition, a technique in that a reinforced layer including a particulate alumina is formed as an outermost layer of a photoreceptor is disclosed. However, such a technique produces some side effects.

Because of these reasons, a need exists for an image forming method by which high quality images can be stably produced for a long period time even when a photoreceptor is repeatedly used and a spherical toner having a small particle diameter is used.

### SUMMARY OF THE INVENTION

In the image forming method of the present invention, a photoreceptor having a crosslinked charge transport layer as an outermost layer is used. The crosslinked charge transport layer is prepared by crosslinking a radical polymerizable polyfunctional monomer having three or more radical polymerizable functional groups and having no charge transport structure and a radical polymerizable functional monomer having one or more radical polymerizable functional groups and a charge transport structure. This photoreceptor has good abrasion resistance and good scratch resistance, but the surface of the photoreceptor is very slightly abraded when image forming operations are repeatedly performed thereon. Therefore, charging products generated in charging processes are not accumulated on the surface of the photoreceptor because the charging products present on the surface of the photoreceptor are removed as the surface is slightly abraded (i.e., the surface is always renewed).

In addition, a cleaning device configured to attract toner particles utilizing an electrostatic force is used for the image forming method instead of a cleaning blade or a combination of a cleaning blade and an assistant cleaning member configured to attract toner particles utilizing an electrostatic force is used, an excessive stress is not applied to the photoreceptor. Further, a polishing member configured to actively polish the surface of the photoreceptor to an extent such that image qualities are not deteriorated is used. Therefore, high quality images can be stably produced for a long period time.

It is preferable that a voltage is applied between a cleaning member of the cleaning device and the photoreceptor such that the cleaning member electrostatically attracts residual toner particles present on the surface of the photoreceptor. By using this cleaning method, residual toner particles can be well removed even when the toner is a spherical toner having a small particle diameter. Therefore, occurrence of the problem in that the image qualities are deteriorated due to residual toner particles can be prevented.

The toner used for the image forming method of the present invention preferably has a volume average particle diameter (Dv) of from 3 to 9 μm, a ratio (Dv/Dn) of the volume average particle diameter (Dv) to the number average particle diameter (Dn) of from 1.01 to 1.25, and an average circularity of not less than 0.950 and less than 1.0. By using such a toner, high definition images can be produced. In addition, by using a urea-modified polyester resin as a binder resin of the toner having such a sharp particle diameter distribution as mentioned above, the toner has a good combination of fluidity, low temperature fixability and hot offset resistance, and can produce color images having a good combination of transparency and glossiness.

Specifically, an image forming method of the present invention includes:

forming a toner image on a surface of an image bearing member;

transferring the toner image onto a receiving material; and

then cleaning the surface of the image bearing member with a cleaning member while applying a voltage to the cleaning member such that an electric field is formed between the image bearing member and the cleaning member and the cleaning member attracts toner particles remaining on the surface of the image bearing member,

wherein the image bearing member has, as an outermost layer, a crosslinked charge transport layer including a crosslinked resin including at least one unit obtained from at least one radical polymerizable polyfunctional monomer having three or more radical polymerizable functional groups and no charge transport structure and a unit obtained from a radical polymerizable functional monomer having one or more radical polymerizable functional group and a charge transport structure.

In this case, a plurality of radical polymerizable polyfunctional monomers can be used for preparing the crosslinked resin. In addition, the crosslinked resin can further include one or more units obtained from a radical polymerizable monofunctional monomer and/or a radical polymerizable difunctional monomer, which have no charge transport structure. The radical polymerizable monomer having a charge transport structure is preferably a monofunctional monomer.

The crosslinked charge transport layer preferably has a thickness of from 1 to 20 μm.

The radical polymerizable polyfunctional monomer or monomers having no charge transport structure preferably have an acryloyloxy group and/or a methacryloyloxy group. In addition, the radical polymerizable monomer having a charge transport structure preferably has an acryloyloxy group and/or a methacryloyloxy group.

The radical polymerizable polyfunctional monomer having no charge transport structure preferably has the following formula (A): 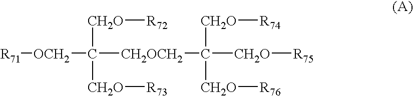
wherein each of R₇₁, R₇₂, R₇₃, R₇₄, R₇₅ and R₇₆ represents a hydrogen atom or a group having the following formula (B): 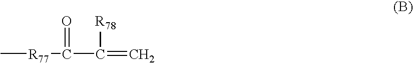
wherein R₇₇ represents a single bond, an alkylene group, an alkeleneether group or an alkyleneoxycarbonyl group, and R₇₈ represents a hydrogen atom or a methyl group.

It is preferable that five groups of the six groups R₇₁, R₇₂, R₇₃, R₇₄, R₇₅ and R₇₆ have formula (B) and the other of the six groups is a hydrogen atom, or all of the six groups have formula (B).

As another aspect of the present invention, an image forming apparatus is provided which includes:

an image bearing member configured to bear an electrostatic latent image on a surface thereof,

a developing device configured to develop the electrostatic latent image with a developer including a toner to form a tone image on the surface of the image bearing member;

a transferring device configured to transfer the toner image onto a receiving material; and

a cleaning device configured to clean the surface of the image bearing member with a cleaning member while applying a voltage to the cleaning member such that an electric field is formed between the image bearing member and the cleaning member and the cleaning member attracts toner particles remaining on the surface of the image bearing member,

wherein the image bearing member has, as an outermost layer, a crosslinked charge transport layer including a crosslinked resin including a unit obtained from a radical polymerizable polyfunctional monomer having three or more radical polymerizable functional groups and no charge transport structure and a radical polymerizable functional monomer having one or more radical polymerizable functional groups and a charge transport structure.

The cleaning device preferably includes a toner polarity controlling member which is located on the upstream side from the cleaning member relative to the rotation direction of the image bearing member. The cleaning member preferably includes an elastic roller. Alternatively, the cleaning member may be a brush roller, wherein a DC voltage with a polarity opposite to that of the toner, an AC voltage or a DC voltage overlapped with an AC voltage is applied to the brush roller. The cleaning member can include two brush rollers, which are arranged along the image bearing member and to which voltages (such as a DC voltage with a polarity opposite to that of the toner, an AC voltage or a DC voltage overlapped with an AC voltage) with different polarities are applied. Alternatively, the cleaning member may include a cleaning blade and at least two assistant cleaning members which are located on an upstream side from the cleaning blade relative to the rotation direction of the image bearing member. The assistant cleaning members are, for example, rotatable brush rollers having a cleaning element configured to clean the brush roller. The assistant cleaning members preferably have the same electric resistivity.

Alternatively, the assistant cleaning members may be a combination of a rotatable brush roller and a fixed brush roller or a combination of a brush roller and an elastic sheet. The at least two assistant cleaning members may have different electric resistivity. In this case, the resistivity of the assistant cleaning member located on the uppermost stream side is lower than those of the others of the at least two assistant cleaning members. It is preferable that DC voltages with different polarities are applied to the at least two assistant cleaning members. More preferably, a DC voltage overlapped with an AC voltage is applied to the assistant cleaning member located on the uppermost stream side, and a DC voltage is applied to each of the others of the at least two assistant cleaning members. The amount of particles of the toner reaching the cleaning blade is preferably not greater than 0.05 mg/cm². The cleaning blade is preferably a polishing blade.

The toner preferably has a volume average particle diameter (Dv) of from 3 to 9 μm, a ratio (Dv/Dn) of the volume average particle diameter (Dv) to the number average particle diameter (Dn) of from 1.01 to 1.25, and an average circularity of not less than 0.950 and less than 1.00.

It is preferable that the toner includes a modified polyester resin as a binder resin, and a wax which is dispersed in the modified polyester resin. The modified polyester resin is preferably a urea-modified polyester resin.

As yet another aspect of the present invention, a process cartridge is provided which includes:

an image bearing member configured to bear an electrostatic latent image on a surface thereof; and

a cleaning device configured to clean the surface of the image bearing member with a cleaning member while applying a voltage to the cleaning member such that an electric field is formed between the image bearing member and the cleaning member and the cleaning member attracts toner particles remaining on the surface of the image bearing member,

wherein the image bearing member is the image bearing member mentioned above.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a schematic view illustrating a cleaning device for use in the image forming apparatus or the process cartridge of the present invention;

FIG. 2 is a schematic view illustrating an embodiment of the image forming apparatus of the present invention which uses the cleaning device illustrated in FIG. 1;

FIG. 3 is a graph illustrating the residual toner removing efficiency of the cleaning device illustrated in FIG. 2;

FIG. 4 is a schematic view illustrating an instrument for use in measuring the static friction coefficient of a photoreceptor;

FIG. 5 is a schematic view illustrating a polarity controlling device which applies a charge having a predetermined polarity to an image bearing member and toner particles;

FIGS. 6 and 7 are schematic views illustrating other cleaning devices for use in the image forming apparatus or the process cartridge of the present invention;

FIGS. 8-10 are schematic views for explaining how to remove residual toner particles using a cleaning brush;

FIG. 11 is a schematic view illustrating hairs of a conventional brush for use in a cleaning device;

FIG. 12 is a schematic view illustrating hairs of a brush for use in the image forming apparatus of the present invention;

FIGS. 13-15 are schematic views illustrating other brushes for use in the image forming apparatus of the present invention;

FIG. 16 is a schematic view illustrating another cleaning device for use in the image forming apparatus of the present invention;

FIG. 17 is a schematic view illustrating another embodiment of the image forming apparatus of the present invention which uses the cleaning device illustrated in FIG. 16;

FIG. 18 is a schematic view illustrating another cleaning device for use in the image forming apparatus of the present invention;

FIG. 19 is a schematic view illustrating another embodiment of the image forming apparatus of the present-invention which uses the cleaning device illustrated in FIG. 18;

FIG. 20 is a schematic view illustrating a cleaning device for use in the image forming apparatus of the present invention;

FIGS. 21A and 21B are schematic views illustrating background cleaning devices;

FIGS. 22-24 are schematic views illustrating other cleaning devices for use in the image forming apparatus of the present invention;

FIGS. 25 and 26 are schematic views illustrating other embodiments of the image forming apparatus of the present invention, each of which uses a roller-type cleaning member.

FIG. 27 is a graph illustrating the charge distribution of a toner after a developing process and a transferring process;

FIG. 28 is a graph illustrating the charge distribution of a toner when environmental conditions are changed;

FIGS. 29 and 30 are graphs illustrating the charge distribution of a toner under a high temperature/high humidity condition and a low temperature/low humidity condition, respectively;

FIG. 31 is a graph illustrating the charge distribution of toner particles remaining on a photoreceptor when the toner particles pass through a conventional assistant cleaning member to which a positive DC voltage is applied; and

FIG. 32 is a graph illustrating the charge distribution of toner particles remaining on a photoreceptor when the toner particles pass through a conventional assistant cleaning member to which a positive DC voltage overlapped with an AC voltage is applied.

### DETAILED DESCRIPTION OF THE INVENTION

The present inventors have sought an image forming method by which high quality images can be produced for a long period of time using a small spherical toner which includes a polyester resin having good low temperature fixability and a wax dispersed in the polyester resin. As a result, it is found that by decreasing the stress applied to the toner used as much as possible while applying a considerable stress to the photoreceptor used, good cleaning performance can be provided. Specifically, it is preferable to perform cleaning utilizing an electrostatic force while using a photoreceptor having a crosslinked charge transport layer (hereinafter referred to as a CCTL) as an outermost layer, which has a good mechanical flexibility and a high mechanical strength. More specifically, since in this image forming method a small spherical toner including a urea-modified polyester resin is used as a binder resin, occurrence of the wax filming problem can be prevented. Even when the wax filming problem is caused, the wax film can be easily removed from the surface of the photoreceptor by a polishing blade.

In the cleaning device for use in the image forming method of the present invention, a voltage is applied to a cleaning member to form an electric field between the cleaning member and the photoreceptor so that the toner particles remaining on the photoreceptor can be attracted by the cleaning member. The photoreceptor for use in the image forming method of the present invention has a CCTL as an outermost layer, which is prepared by polymerizing and crosslinking a first radical polymerizable polyfunctional monomer having no charge transport structure and a second polymerizable functional monomer having a charge transport structure. By using the cleaning device and photoreceptor, the above-mentioned object of the present invention can be attained. Radical polymerizable polyfunctional monomers having three or more functional groups are preferably used as the first radical polymerizable monomer, and more preferably plural radical polymerizable polyfunctional monomers having three or more functional groups are used. Further, a radical polymerizable mono- or di-functional monomers can be preferably used in combination of one or more radical polymerizable polyfunctional monomers having three or more functional groups.

As the second radical polymerizable monomer, radical polymerizable monomers having one to three functional groups can be preferably used, and radical polymerizable monofunctional monomers can be more preferably used.

The reason therefor is not yet determined but is considered to be as follows. For example, when a combination of a radical polymerizable trifunctional monomer having no charge transport structure and a radical polymerizable monofunctional monomer having no charge transport structure is used as the first radical polymerizable monomer, the following effects can be produced. When a CCTL coating liquid including such a combination of monomers is coated on a charge transport layer (CTL), almost all the solvents included in the coating liquid are evaporated and thereby the monomers which have higher boiling points than the solvents remains in the coated layer. Since the monomers, are present, molecules of other components included in the CCTL coating layer can freely move therein, i.e., the molecules can maintain microscopic fluidity. In addition, the monofunctional monomer contributes to make a field of the crosslinking reaction, resulting in increase of the crosslinking density.

It is known that a solvent having no radical reactivity remaining in a coating liquid contributes to make a field of the crosslinking reaction. However, it is difficult to control the amount of solvents remaining in a coating liquid when UV light is irradiated for the crosslinking reaction. In addition, solvents which have no reactivity are obstacles in a crosslinking reaction.

Thus, it is preferable to use such a combination of a trifunctional monomer and a monofunctional monomer, which have no charge transport structure. The same is true for a combination of a trifunctional monomer and a hexafunctional monomer. In this case, the trifunctional monomer serves as a reactive diluent. Specifically, it is preferable to use a combination of a radical polymerizable monomer having (n) functional groups and a radical polymerizable monomer having (n′) functional groups, wherein (n′−n) is not less than 2. By using such a combination of radical monomers, the crosslinking density can be increased, i.e., a CCTL having good mechanical strength can be formed. Further, it is preferable that in such a combination of monomers, one of the monomers is a radical polymerizable polyfunctional monomer having six or more functional groups. Such an effect cannot be produced by merely combining two monomers. The effect can be produced even when the thickness of the CCTL is not less than 5 μm.

At first, the photoreceptor for use in the image forming apparatus and process cartridge of the present invention will be explained.

The photoreceptor for use in the image forming apparatus and process cartridge of the present invention includes a photosensitive layer including a crosslinked charge transport layer which serves as an outermost layer of the photoreceptor.

The photoreceptor includes a substrate. Suitable materials for use as the substrate include materials having a volume resistivity not greater than 10¹⁰ Ω·cm. Specific examples of such materials include plastic cylinders, plastic films or paper sheets, on the surface of which a metal such as aluminum, nickel, chromium, nichrome, copper, gold, silver, platinum and the like, or a metal oxide such as tin oxides, indium oxides and the like, is formed by deposition or sputtering. In addition, a plate of a metal such as aluminum, aluminum alloys, nickel and stainless steel can be used. A metal cylinder can also be used as the substrate 1, which is prepared by tubing a metal such as aluminum, aluminum alloys, nickel and stainless steel by a method such as impact ironing or direct ironing, and then treating the surface of the tube by cutting, super finishing, polishing and the like treatments. Further, endless belts of a metal such as nickel, stainless steel and the like, which are disclosed in published unexamined Japanese patent application No. 52-36016, can also be used as the substrate.

Furthermore, substrates, which are prepared by coating a coating liquid including a binder resin and an electroconductive powder on the supports mentioned above, can also be used as the substrate. Specific examples of such an electroconductive powder include carbon black, acetylene black, powders of metals such as aluminum, nickel, iron, nichrome, copper, zinc, silver and the like, and metal oxides such as electroconductive tin oxides, ITO (indium tin oxide) and the like. Specific examples of the binder resin include known thermoplastic resins, thermosetting resins and photo-crosslinking resins, such as polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylates, phenoxy resins, polycarbonates, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins, alkyd resins and the like resins.

Such an electroconductive layer can be formed by coating a coating liquid in which an electroconductive powder and a binder resin are dispersed or dissolved in a proper solvent such as tetrahydrofuran, dichloromethane, methyl ethyl ketone, toluene and the like solvent, and then drying the coated liquid.

In addition, substrates, in which an electroconductive resin film is formed on a surface of a cylindrical substrate using a heat-shrinkable resin tube which is made of a combination of a resin such as polyvinyl chloride, polypropylene, polyesters, polyvinylidene chloride, polyethylene, chlorinated rubber and fluorine-containing resins (such as TEFLON (trademark)), with an electroconductive material, can also be used as the substrate.

The photosensitive layer includes at least a charge generation layer (hereinafter referred to as a CGL) having a charge generation function, a charge transport layer (hereinafter referred to as a CTL) having a charge transport function and a crosslinked charge transport layer (hereinafter referred to as a CCTL), which are overlaid on a substrate in this order.

The CGL of the photoreceptor includes a charge generation material (hereinafter referred to as a CGM) as a main component, and optionally includes a binder resin and other components. For the CGL, known CGMs such as inorganic CGMs and organic CGMs can be used. Specific examples of the inorganic CGMs include crystalline selenium, amorphous selenium, selenium-tellurium, selenium-tellurium-halogen, selenium-arsenic compound, amorphous silicon, etc. In addition, amorphous silicon in which a dangling bond is terminated with a hydrogen atom or a halogen atom or in which a boron atom, a phosphorous atom is doped can be preferably used.

Specific examples of the organic CGMs include phthalocyanine pigments such as metal phthalocyanine and metal-free phthalocyanine; azulenium salt type pigments; squaric acid methyne pigments; azo pigments having a carbazole skeleton; azo pigments having a triphenyl amine skeleton; azo pigments having a diphenyl amine skeleton; azo pigments having a dibenzothiophene skeleton; azo pigments having a fluorenone skeleton; azo pigments having an oxadiazole skeleton; azo pigments having a bisstilbene skeleton; azo pigments having a distyryloxadiazole skeleton; azo pigments having a distyrylcarbazole skeleton; perylene pigments; anthraquinone pigments, polycyclic quinone pigments, quinone imine pigments,. diphenylmethane pigments, triphenylmethane pigments, benzoquinone pigments, naphthoquinone pigments, cyanine pigments, azomethine pigments, indigoide pigments, benzimidazole pigments, and the like organic pigments. These CGMs are used alone or in combination.

Among these CGMs, oxytitanium phthalocyanine compounds having the following formula (1) are preferably used.

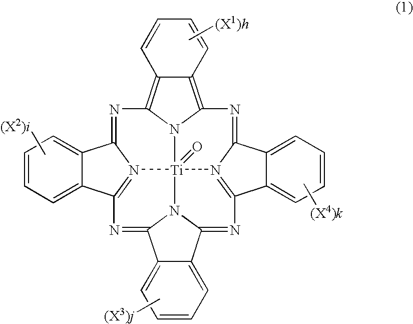

In formula (1), X¹, X², X³ and X⁴ independently represent a chlorine atom or a bromine atom; and each of h, i, j and k is 0 or an integer of from 1 to 4.

Among the oxytitanium phthalocyanine compounds, oxytitanium phthalocyanine compounds having an X-ray diffraction spectrum such that strong peaks are observed at least at Bragg (2θ) angles of 9.0°, 14.2°, 23.9° and 27.1° (±0.2°) or oxytitanium phthalocyanine compounds having an X-ray diffraction spectrum such that strong peaks are observed at least at Bragg (2θ) angles of 9.6° and 27.3° (±0.2°) are preferably used because of having high photosensitivity.

Suitable binder resins, which are optionally included in the CGL, include polyamide, polyurethane, epoxy resins, polyketone, polycarbonate, polyarylate, silicone resins, acrylic resins, polyvinyl butyral, polyvinyl formal, polyvinyl ketone, polystyrene, poly-N-vinylcarbazole, polyacrylamide, and the like resins. These resins can be used alone or in combination.

Specifically, polymers described in published unexamined Japanese patent applications Nos. 01-009964, 04-011627, 04-175337, 05-232727, 05-310904, 06-234836, 06-234841, 06-239049, 06-236050, 06-236051, 06-295077, 07-056374 and 08-176293 can be used.

In addition, charge transport polymers having a charge transport function such as polycarbonates, polyesters, polyurethanes, polyethers, polysiloxanes, and acrylic resins, which have an arylamine skeleton, a benzidine skeleton, a hydrazone skeleton, a carbazole skeleton, a stilbene skeleton, and/or a pyrazoline skeleton, and polymers having a polysilane skeleton can also be used alone or in combination as the binder resin. Specific examples of the polysilylene polymers are described in published unexamined Japanese patent applications Nos. 63-285552, 05-19497, 05-70595 and 10-73944.

The CGL can include a low molecular weight CTM. Low molecular weight CTMs are broadly classified into electron transport materials and positive hole transport materials.

Specific examples of the electron transport materials include electron accepting materials such as chloranil, bromanil, tetracyanoethylene, tetracyanoquinodimethane, 2,4,7-trinitro-9-fluorenone, 2,4,5,7-tetranitro-9-fluorenone, 2,4,5,7-tetranitro-xanthone, 2,4,8-trinitrothioxanthone, 2,6,8-trinitro-4H-indeno[1,2-b]thiophene-4-one, 1,3,7-trinitrobenzothiophene-5,5-dioxide, diphenoxy derivatives, etc. These election transport materials can be used alone or in combination.

Specific examples of the positive hole transport materials include electron donating materials such as oxazole derivatives, oxadiazole derivatives, imidazole derivatives, monoarylamine derivatives, diarylamine derivatives, triphenylamine derivatives, stilbene derivatives, α-phenylstilbene derivatives, benzidine derivatives, diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives, bisstilbene derivatives, enamine derivatives, etc. These positive hole transport materials can be used alone or in combination.

Suitable methods for forming the CGL include vacuum thin film forming methods and casting methods.

Specific examples of such vacuum thin film forming methods include vacuum evaporation methods, glow discharge decomposition methods, ion plating methods, sputtering methods, reaction sputtering methods, CVD (chemical vapor deposition) methods, and the like methods. A layer of the above-mentioned inorganic and organic materials can be formed by one of these methods.

The casting methods useful for forming the CGL include, for example, the following steps;
(1) preparing a coating liquid by mixing one or more inorganic or organic charge generation materials mentioned above with a solvent such as tetrahydrofuran, dioxane, dioxolan, toluene, dichloromethane, monochlorobenzene, dichloroethane, cyclohexanone, cyclopentanone, anisole, xylene, methyl ethyl ketone, acetone, ethyl acetate, butyl acetate, etc.;
(2) coating on a substrate the coating liquid, which is diluted if necessary, by a dip coating method, a spray coating method, a bead coating method, a ring coating method or the like method, wherein the coating liquid optionally includes a leveling agent such as dimethylsilicone oils, and methyl phenyl silicone oils; and
(3) drying the coated liquid to form a CGL.

The thickness of the CGL is preferably from 0.01 to 5 μm, and more preferably from 0.05 to 2 μm.

Then the CTL will be explained.

The CTL of the photoreceptor has a charge transport function. The CTL is typically prepared by coating a coating liquid, which is prepared by dissolving or dispersing a CTM and a binder resin in a solvent, on the CGL and then drying the coated liquid. Suitable CTMs for use in the CTL include electron transporting materials and positive hole transporting materials mentioned above for use in the CGL. Charge transport polymers can be preferably used for the CTL because the resultant CTL is hardly dissolved by a coating liquid for the CCTL to be formed on the CTL.

Specific examples of the binder resin for use in the CTL include thermoplastic resins, thermosetting resins and photo-crosslinking resins such as polystyrene resins, styrene-acrylonitrile copolymers, styrene-butadiene copolymers, styrene-maleic anhydride copolymers, polyester resins, polyvinyl chloride resins, vinyl chloride-vinyl acetate copolymers, polyvinyl acetate resins, polyvinylidene chloride resins, polyarylate resins, phenoxy resins, polycarbonate resins, cellulose acetate resins, ethyl cellulose resins, polyvinyl butyral resins, polyvinyl formal resins, polyvinyl toluene resins, poly-N-vinylcarbazole resins, acrylic resins, silicone resins, epoxy resins, melamine resins, urethane resins, phenolic resins, alkyd resins and the like resins.

The added amount of a CTM in the CTL is preferably from 20 to 300 parts by weight, and more preferably from 40 to 150 parts by weight, per 100 parts by weight of the binder resin included in the CTL.

Charge transport polymers can be used alone or in combination with a binder resin.

Suitable solvents for use in the CTL coating liquid include the solvents mentioned above for use in the CGL coating liquid. Among these solvents, solvents which can well dissolve the binder resin and CTM to be included in the CTL. The solvents can be used alone or in combination.

When the CTL coating liquid is coated, one of the coating methods mentioned above for use in preparing the CGL can be used.

The CTL can optionally include one or more additives such as plasticizers and leveling agents.

Suitable plasticizers for use in the CTL include known plasticizers such as dibutyl phthalate, and dioctyl phthalate, which have been used as plasticizers for popular resins. The added amount of a plasticizer in the CTL is preferably from 0 to 30 parts by weight per 100 parts by weight of the binder resin included in the CTL.

Suitable leveling agents for use in the CTL include silicone oils such as dimethylsilicone oils and methylphenylsilicone oils; and polymers and oligomers having a perfluoroalkyl group in a side chain thereof. The added amount of a leveling agent in the CTL is preferably from 0 to 1 part by weight per 100 parts by weight of the binder resin included in the CTL.

The thickness of the CTL is not particularly limited, and is preferably from 5 to 40 μm, and more preferably from 10 to 30 μm.

Then the CCTL will be explained.

The CCTL is formed on the CTL by coating a coating liquid (followed by optional drying), and heating or light-irradiating the coated layer to crosslink the layer.

The CCTL is a crosslinked layer having a charge transport function and is prepared using a coating liquid which is prepared by dissolving or dispersing in a proper solvent at least one first radical polymerizable monomer which has three or more functional groups (hereinafter sometimes referred to as tri- or more-functional monomers) and which has no charge transport structure and a second radical polymerizable monomer which has one or more functional groups and which has a charge transport structure, followed by drying and crosslinking.

Suitable tri- or more-functional monomers include monomers which have three or, more radical polymerizable groups and which do not have a charge transport structure (such as positive hole transport structure (e.g., triarylamine, hydrazone, pyrazoline and carbazole structures); and electron transport structure (e.g., condensed polycyclic quinine structure, diphenoquinone structure, and electron accepting aromatic ring groups having a cyano group or a nitro group)). As the radical polymerizable groups, any radical polymerizable groups having a carbon-carbon double bond can be used. Suitable radical polymerizable groups include 1-substituted ethylene groups having the below-mentioned formula (2) and 1,1 -substituted ethylene groups having the below-mentioned formula (3).
CH₂═CH—X¹— (2)
wherein X¹ represents an arylene group (such as a phenylene group and a naphthylene group), which optionally has a substituent, a substituted or unsubstituted alkenylene group, a group —CO—, a group —COO—, a group —CON(R¹⁰) (R¹⁰ represents a hydrogen atom, an alkyl group (e.g., a methyl group, and an ethyl group), an aralkyl group (e.g., a benzyl group, a naphthylmethyl group and a phenetyl group), or an aryl group (e.g., a phenyl group and a naphthyl group)) or a group S—.

Specific examples of the groups having formula (2) include a vinyl group, a stylyl group, 2-methyl-1.3-butadienyl group, a vinylcarbonyl group, acryloyloxy group, acryloylamide, vinyl thio ether, etc.
CH₂═C(Y)—(X²)n- (3)
wherein Y represents a substituted or unsubstituted alkyl group, a substituted or unsubstituted aralkyl group, a substituted or unsubstituted aryl group (such as phenyl and naphthyl groups), a halogen atom, a cyano group, a nitro group, an alkoxyl group (such as methoxy and ethoxy groups), or a group —COOR¹¹ (wherein R¹¹ represents a hydrogen atom, a substituted or unsubstituted alkyl group (such as methyl and ethyl groups), a substituted or unsubstituted aralkyl group (such as benzyl and phenethyl groups), a substituted or unsubstituted aryl group (such as phenyl and naphthyl groups) or a group —CONR¹²R¹³ (wherein each of R¹² and R¹³ represents a hydrogen atom, a substituted or unsubstituted alkyl group (such as methyl and ethyl groups), a substituted or unsubstituted aralkyl group (such as benzyl, naphthylmethyl and phenethyl groups), a substituted or unsubstituted aryl group (such as phenyl and naphthyl groups))); X² represents a group selected from the groups mentioned above for use in X¹ and an alkylene group, wherein at least one of Y and X2 is an oxycarbonyl group, a cyano group, an alkenylene group or an aromatic group; and n is 0 or 1.

Specific examples of the groups having formula (3) include an α-chloroacryloyloxy group, a methacryloyloxy group, an α-cyanoethylene group, an α-cyanoacryloyloxy group, an α-cyanophenylene group, a methacryloylamino group, etc.

Specific examples of the substituents for use in the groups X and Y include halogen atoms, a nitro group, a cyano group, alkyl groups (such as methyl and ethyl groups), alkoxy groups (such as methoxy and ethoxy groups), aryloxy groups (such as a phenoxy group), aryl groups (such as phenyl and naphthyl groups), aralkyl groups (such as benzyl and phenethyl groups), etc.

Among these radical polymerizable tri- or more-functional groups, acryloyloxy, groups and methacryloyloxy groups are preferably used. Compounds having three or more acryloyloxy groups can be prepared by subjecting (meth)acrylic acid (salts), (meth)acrylhalides and (meth)acrylates, which have three or more hydroxyl groups, to an ester reaction or an ester exchange reaction. The three or more radical polymerizable groups included in the radical polymerizable monomers may be the same as or different from the others.

As for the radical polymerizable tri- or more-functional monomer having no charge transport structure, any known compounds can be used. It is preferable to use two or more of radical polymerizable tri- or more-functional monomers.

Among the radical polymerizable tri- or more-functional monomers, at least one of monomers which include an acryloyloxy group or a methacryloyloxy group and which have the following formula (A) is preferably used as the radical polymerizable tri- or more-fumctional monomer. 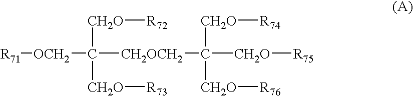
wherein each of R₇₁, R₇₂, R₇₃, R₇₄, R₇₅ and R₇₆ represents a hydrogen atom or a group having the following formula (B): 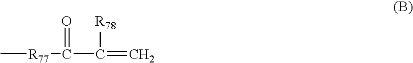
wherein R₇₇ represents a single bond, an alkylene group, an alkeleneether group or an alkyleneoxycarbonyl group, and R₇₈ represents a hydrogen atom or a methyl group.

Suitable compounds for use as the radical polymerizable tri- or more-functional monomer having formula (A) include compounds having three acryloyloxy groups and three hydrogen atoms, compounds having four acryloyloxy groups and two hydrogen atoms, compounds having five acryloyloxy groups and one hydrogen atoms, compounds having six acryloyloxy groups, compounds having three methacryloyloxy groups and three hydrogen atoms, compounds having four methacryloyloxy groups and two hydrogen atoms, compounds having five methacryloyloxy groups and one hydrogen atoms, and compounds having six methacryloyloxy groups. In addition, the following compounds can also be used. However, the radical polymerizable tri- or more-functional monomer is not limited thereto.

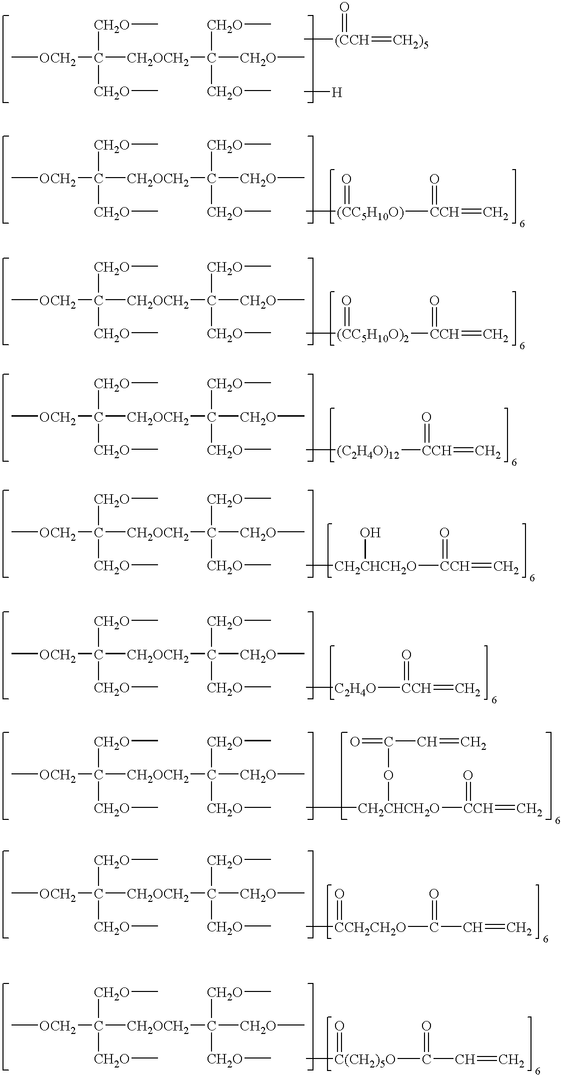

These compounds are preferably used in combination.

These monomers are typically prepared by an esterification method of a polyhydric alcohol because the method is superior in yield, manufacturing costs, and productivity. When two or more of these monomers are used and one of the monomers is a monomer having six functional groups, it is preferable to use a combination (mixture) of the monomer having six functional groups and a monomer having not greater than five functional monomers and one or more hydrogen atoms in view of yield. In view of yield, the content of the monomer in the mixture is preferably from 20 to 99% by weight, more preferably from 30 to 97% by weight, and even more preferably from 40 to 95% by weight. Similarly, when a monomer having five functional monomer is used, the content of the monomer in the mixture is preferably from 20 to 99% by weight, more preferably from 30 to 97% by weight, and even more preferably from 40 to 95% by weight. Similarly, when a monomer having four functional monomer is used, the content of the monomer in the mixture is preferably from 0.01 to 30% by weight, more preferably from 0. 1 to 20% by weight, and even more preferably from 3 to 5% by weight. Similarly, when a monomer having three functional monomer is used, the content of the monomer in the mixture is preferably from 0.01 to 30% by weight, more preferably from 0.1 to 20% by weight, and even more preferably from 3 to 5% by weight.

More specifically, the following combinations are preferably used.
(1) Monomer having six acryloyloxy groups (from 70 to 30% by weight and preferably from 60 to 40% by weight)—monomer having five acryloyloxy groups and one hydrogen atom (from 30 to 70% by weight and preferably from 40 to 60% by weight).
(2) Monomer having six acryloyloxy groups (from 65 to 30% by weight and preferably from 55 to 40% by weight)—monomer having five acryloyloxy groups and one hydrogen atom (from 30 to 65% by weight and preferably from 40 to 55% by weight)—monomer having from 1 to 4 acryloyloxy groups and from 5 to 2 hydrogen atoms (from 0.01 to 5% by weight and preferably from 1 to 3% by weight).
(3) Monomer having six methacryloyloxy groups (from 70 to 30% by weight and preferably from 60 to 40% by weight) monomer having five methacryloyloxy groups and one hydrogen atom (from 30 to 70% by weight and preferably from 40 to 60% by weight).
(4) Monomer having six methacryloyloxy groups (from 65 to 30% by weight and preferably from 55 to 40% by weight)—monomer having five methacryloyloxy groups and one hydrogen atom (from 30 to 65% by weight and preferably from 40 to 55% by weight)—monomer having from 1 to 4 methacryloyloxy groups and from 5 to 2 hydrogen atoms (from 0.01 to 5% by weight and preferably from 1 to 3% by weight).

The content of one or more of radical polymerizable monomers having formula (A) and no charge transport structure in the CCTL is from 3 to 95% by weight, preferably from 5 to 80% by weight and more preferably from 10 to 70% by weight. When the content is not less than 3% by weight, the resultant CCTL has high three dimensional crosslinking density and a abrasion resistance much better than in a case where conventional thermoplastic resins are used as the binder resin. When the content is not greater than 95% by weight, the resultant CCTL has good electric properties because a considerable amount of monomers having a charge transport structure are included therein.

In order to reduce the viscosity of the coating liquid, to relax the stress of the CCTL, and to reduce the surface energy and friction coefficient of the CCTL, known radical polymerizable mono- to tetra-functional monomers and oligomers can be used in combination therewith. By using such monomers, the resultant CCTL has smooth surface and little strain, resulting in improvement of cleanability of the photoreceptor and prevention of occurrence of cracks in the CCTL. Particularly, combinations of a radical polymerizable monomer having three or four functional groups and a radical polymerizable monomer having six functional groups are preferably used. The content of such monomers and oligomers in the CCTL is from 1 to 80% by weight, preferably from 5 to 60% by weight and more preferably from I 0 to 40% by weight. In addition, the viscosity of such radical monomers is preferably not higher than 1000 mPa·s, and more preferably not higher than 800 mPa·s.

Specific examples of such radical polymerizable monomers having one to four functional groups include the following monomers.

Specific examples of the radical polymerizable monomers include trimethylolpropane triacrylate (TMPTA), trimethylolpropane trimethacylate, alkylene-modified trimethylolpropane triacrylate, ethyleneoxy-modified trimethylolpropane triacrylate, propyleneoxy-modified trimethylolpropane triacrylate, caprolactone-modified trimethylolpropane triacrylate, epichlorohydrin-modified trimethylolpropane triacrylate, alkylene-modified trimethylolpropane trimethacrylate, pentaerythritol triacrylate, pentaerythritol tetraacrylate (PETTA), glycerol triacrylate, epichlorohydrin-modified glycerol triacrylate, ethyleneoxy-modified glycerol triacrylate, propyleneoxy-modified glycerol triacrylate, tris(acryloxyethyl)isocyanurate, alkyl-modified dipentaerythritol triacrylate, dimethylolpropane tetraacrylate (DTMPTA), pentaerhythritol ethoxytriacrylate, ethyleneoxy-modified triacrylate phosphate, 2,2,5,5-tetrahydroxymethylcyclopentanone tetraacrylate, 2-ethylhexyl acrylate, 2-hyderoxyethyl acrylate, 2-hyderoxypropyl acrylate, tetrahydrofurfryl acrylate, 2-ethylhexylcarbitol acrylate, 3-methoxybutyl acrylate, benzyl acrylate, cyclohexyl acrylate, isoamyl acrylate, isobutyl acrylate, methoxytriethyleneglycol acrylate, phenoxytetraethyleneglycol acrylate, cetyl acrylate, isostearyl acrylate, stearyl acrylate, styrene monomer, 1,3-butanediol diacrylate, 1,4-butanediol diacrylate, 1,4-butanediol dimethacrylate, 1,6-hexanediol diacrylate, 1,6-hexanediol dimethacrylate, diethyleneglycol diacrylate, neopentylglycol diacrylate, ethyleneoxy-modified bisphenol A diacryalte, ethyleneoxy-modified bisphenol F diacryalte, etc.

Among these compounds, trimethylolpropane triacrylate (TMPTA), alkylene-modified trimethylolpropane triacrylate, ethyleneoxy-modified tiimethylolpropane triacrylate, propyleneoxy-modified trimethylolpropane triacrylate, and epichlorohydrin-modified trimethylolpropane triacrylate are preferably used.

Functional monomers other than the above-mentioned radical polymerizable mono- to tetra-functional monomers can also be used. Specific examples thereof include fluorine-containing monomers such as octafluoropentyl acrylate, 2-perfluorooctylethyl acrylate, 2-perfluorooctylethyl methacrylate, and 2-perfluoroisononylethyl acrylate; and vinyl monomers, acrylates and methacrylates having a polysiloxane group such as siloxane units having a repeat number of from 20 to 70 which are described in JP-B 05-60503 and 06-45770 (e.g., acryloylpolydimethylsiloxaneethyl, methacryloylpolydimethylsiloxaneethyl, acryloylpolydimethylsiloxanepropyl, acryloylpolydimethylsiloxanebutyl, and diacryloylpolydimethylsiloxanediethyl).

In order to form a dense crosslinked network in the crosslinked charge transport layer, the ratio (Mw/F) of the molecular weight (Mw) of the tri- or more-functional monomer to the number of functional groups (F) included in a molecule of the monomer is preferably not greater than 500. When the number is too large, the resultant CCTL becomes soft and thereby the abrasion resistance of the layer is slightly deteriorated. In this case, it is not preferable to use only one monomer which is modified with a group such as ethylene oxide, propylene oxide and caprolactone and which has a long chain group.

Radical polymerizable mono- or more-functional monomers having a charge transport structure can be used for the CCTL. Among these monomers, radical polymerizable monofunctional monomers having a charge transport structure are preferably used. Suitable radical polymerizable monofunctional monomers having a charge transport structure for use in preparing the CCTL include compounds having one radical polymerizable functional group and a charge transport structure such as positive hole transport groups (e.g., triarylamine, hydrazone, pyrazoline and carbazole groups) and electron transport groups (e.g., electron accepting aromatic groups such as condensed polycyclic quinine, diphenoquinone, cyano and nitro groups). As the functional group of the radical polymerizable monofunctional monomers, the functional groups mentioned above can be exemplified. Among the functional groups, acryloyloxy and methacryloyloxy groups are preferably used. In addition, triarylamine groups are preferably used as the charge transport group. Among the triarylamine groups, compounds having the following formula (4) or (5) are preferably used because of having good electric properties (i.e., because the resultant photoreceptor has high photosensitivity and low residual potential)

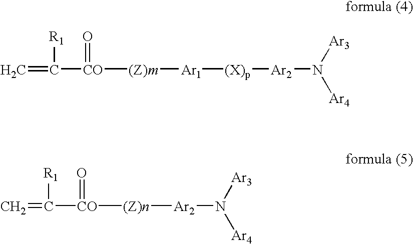

In formulae (4) and (5), R¹ represents a hydrogen atom, a halogen atom, a substituted or unsubstituted alkyl group, a substituted or unsubstituted aralkyl group, a substituted or unsubstituted aryl group, a cyano group, a nitro group, an alkoxy group, a group —COOR⁷ (wherein R⁷ represents a hydrogen atom, a substituted or unsubstituted alkyl group, a substituted or unsubstituted aralkyl group and a substituted or unsubstituted aryl group), a halogenated carbonyl group or a group —CONR⁸R⁹ (wherein each of R⁸ and R⁹ represents a hydrogen atom, a substituted or unsubstituted alkyl group, a substituted or unsubstituted aralkyl group and a substituted or unsubstituted aryl group); each of Ar¹ and Ar² represents a substituted or unsubstituted arylene group; each of Ar₃ and Ar₄ represents a substituted or unsubstituted arylene group; X represents a substituted or unsubstituted alkylene group, a substituted or unsubstituted cycloalkylene group, a substituted or unsubstituted alkylene ether group, an oxygen atom, a sulfur atom or a vinylene group; Z represents a substituted or unsubstituted alkylene group, a substituted or unsubstituted divalent alkylene ether group, or a substituted or unsubstituted divalent alkyleneoxy carbonyl group; each of m and n is 0 or an integer of from 1 to 3; and p is 0 or 1.

In formulae (4) and (5), specific examples of the alkyl, aryl, aralkyl, and alkoxy groups for use in R₁ include the following.

Alkyl Group

Methyl, ethyl, propyl and butyl groups.

Aryl Group

Phenyl and naphthyl groups, etc.

Aralkyl Group

Benzyl, phenethyl and naphthylmethyl groups.

Alkoxy Group

Methoxy, ethoxy and propoxy groups.

These groups may be substituted with a halogen atom, a nitro group, a cyano group, an alkyl group (such as methyl and ethyl groups), an alkoxy group (such as methoxy and ethoxy groups), an aryloxy group (such as a phenoxy group), an aryl group (such as phenyl and naphthyl groups), an aralkyl group (such as benzyl and phenethyl groups), etc.

Among these substituents, a hydrogen atom and a methyl group are preferable.

Suitable substituted or unsubstituted aryl group for use as Ar³ and Ar⁴ include condensed polycyclic hydrocarbon groups, non-condensed cyclic hydrocarbon groups, and heterocyclic groups.

Specific examples of the condensed polycyclic hydrocarbon groups include compounds in which 18 or less carbon atoms constitute one or more rings, such as pentanyl, indecenyl, naphthyl, azulenyl, heptalenyl, biphenilenyl, as-indacenyl, s-indacenyl, fluorenyl, acenaphthylenyl, preiadenyl, acenaphthenyl, phenarenyl, phenanthoryl, anthoryl, fluorantenyl, acephenanthorylenyl, aceanthorylenyl, triphenylenyl, pyrenyl, chrysenyl, and naphthasenyl groups.

Specific examples of the non-condensed cyclic hydrocarbon groups include monovalent groups of benzene, diphenyl ether, polyethylene diphenyl ether, diphenyl thioether, and diphenyl sulfone; monovalent groups of non-condensed polycyclic hydrocarbon groups such as biphenyl, polyphenyl, diphenyl alkans, diphenylalkenes, diphenyl alkyne, triphenyl methane, distyryl benzene, 1,1-diphenylcycloalkanes, polyphenyl alkans, polyphenyl alkenes; and ring aggregation hydrocarbons such as 9,9-diphenyl fluorenone.

Specific examples of the heterocyclic groups include monovalent groups of carbazole, dibenzofuran, dibenzothiophene, oxadiazole, and thiadiazole.

The aryl groups for use as Ar3 and Ar4 may be substituted with the following groups.
(1) Halogen atoms, and cyano and nitro groups.
(2) Linear or branched alkyl groups which preferably have from 1 to 12 carbon atoms, more preferably from 1 to 8 carbon atoms and even more preferably from 1 to 4 carbon atoms. These alkyl groups can be further substituted with another group such as a fluorine atom, a hydroxyl group, a cyano group, an alkoxy group having 1 to 4 carbon atoms, and a phenyl group which may be further substituted with a halogen atom, an alkyl group having 1 to 4 carbon atoms, or an alkoxy group having 1 to 4 carbon atoms. Specific examples of the alkyl groups include methyl, ethyl, n-propyl, iso-propyl, n-butyl, sec-butyl, t-butyl, trifluoromethyl, 2-hydroxyethyl, 2-ethoxyethyl, 2-cyanoethyl, 2-methoxyethyl, benzyl, 4-chlorobenzyl, 4-methylbenzyl and 4-phenylbenzyl groups.
(3) Alkoxy groups (i.e., —OR₂). R₂ represents one of the alkyl groups defined above in paragraph (2). Specific examples of the alkoxy groups include methoxy, ethoxy, n-propoxy, iso-propoxy, t-butoxy, n-butoxy, s-butoxy, iso-butoxy, 2-hydroxyethoxy, benzyloxy and trifluoromethoxy groups.
(4) Aryloxy groups. Specific examples of the aryl group of the acryloxy groups include phenyl and naphthyl groups. The aryloxy groups may be substituted with an alkoxy group having from 1 to 4 carbon atoms, an alkyl group having from 1 to 4 carbon atoms, or a halogen atom. Specific examples of the groups include phenoky, 1-naphthyloxy, 2-naphthyloxy, 4-methoxyphenoxy, and 4-methylphenoxy groups.
(5) Alkylmercapto or arylmercapto group. Specific examples of the groups include methylthio, ethylthio, phenylthio, and p-methylphenylthio groups
(6) Groups having the following formula (6).

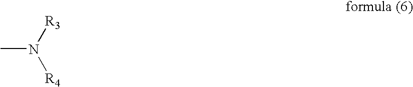

In formula (6), each of R₃ and R₄ represents a hydrogen atom, one of the alkyl groups defined in paragraph (2) or an aryl group (such as phenyl, biphenyl, and naphthyl groups). These groups may be substituted with another group such as an alkoxy group having from 1 to 4 carbon atoms, an alkyl group having from 1 to 4 carbon atoms, and a halogen atom. In addition, R3 and R4 optionally share bond connectivity to form a ring.

Specific examples of the groups having formula (6) include amino, diethylamino, N-methyl-N-phenylamino, N,N-diphenylamino, N,N-di(tolyl)amino, dibenzylamino, piperidino, morpholino, and pyrrolidino groups.
(7) Alkylenedioxy or alkylenedithio groups such as methylenedioxy and methylenedithio groups.
(8) Substituted or unsubstituted styryl groups, substituted or unsubstituted β-phenylstyryl groups, diphenylaminophenyl groups, and ditolylaminophenyl groups.

As the arylene groups for use in Ar₁ and Ar₂, divalent groups delivered from the aryl groups mentioned above for use in Ar₃ and Ar₄ can be used.

Group X is a substituted or unsubstituted alkylene group, a substituted or unsubstituted cycloalkylene group, a substituted or unsubstituted alkylene ether, an oxygen atom, a sulfur atom, and a vinylene group.

Suitable groups for use as the substituted or unsubstituted alkylene group include linear or branched alkylene groups which preferably have from 1 to 12 carbon atoms, more preferably from 1 to 8 carbon atoms and even more preferably from 1 to 4 carbon atoms. These alkylene groups can be further substituted with another group such as a fluorine atom, a hydroxyl group, a cyano group, an alkoxy group having 1 to 4 carbon atoms, and a phenyl group which may be further substituted with a halogen atom, an alkyl group having 1 to 4 carbon atoms, or an alkoxy group having 1 to 4 carbon atoms. Specific examples of the alkylene groups include methylene, ethylene, n-propylene, iso-propylene, n-butylene, sec-butylene, t-butylene, trifluoromethylene, 2-hydroxyethylene, 2-ethoxyethylene, 2-cyanoethylene, 2-methoxyethylene, benzylidene, phenylethylene, 4-chlorophenylethylene, 4-methylphenylethylene and 4-biphenylethylene groups.

Suitable groups for use in the substituted. or unsubstituted cycloalkylene groups include cyclic alkylene groups having from 5 to 7 carbon atoms, which may be substituted with a fluorine atom or another group such as a hydroxyl group, alkyl groups having from 1 to 4 carbon atoms, and alkoxy groups having 1 to 4 carbon atoms. Specific examples of the substituted or unsubstituted cycloalkylene groups include cyclohexylidene, cyclohexylene, and 3,3-dimethylcyclohexylidene groups.

Specific examples of the substituted or unsubstituted alkylene ether groups include ethyleneoxy, propyleneoxy, ethylene glycol, propylene glycol, diethylene glycol, tetraethylene glycol, and tripropylene glycol groups. The alkylene group of the alkylene ether groups may be substituted with another group such as hydroxyl, methyl and ethyl groups.

As the vinylene group, groups having one of the following formulae can be preferably used.

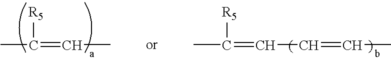

In the above-mentioned formulae, R5 represents a hydrogen atom, one of the alkyl groups mentioned above for use in paragraph (2), or one of the aryl groups mentioned above for use in Ar₃ and Ar_{4,} wherein a is 1 or 2, and b is 1, 2 or 3.

In formulae (4) and (5), Z represents a substituted or unsubstituted alkylene group, a substituted or unsubstituted divalent alkylene ether group, a divalent alkyleneoxycarbonyl group. Specific examples of the substituted or unsubstituted alkylene group include the alkylene groups mentioned above for use as group X. Specific examples of the substituted or unsubstituted alkylene ether group include the divalent alkylene ether groups mentioned above for use as group X. Specific examples of the divalent alkyleneoxycarbonyl group include divalent groups modified by caprolactone.

More preferably, monomers having the following formula (7) are used as the radical polymerizable monofunctional monomer having a charge transport structure.

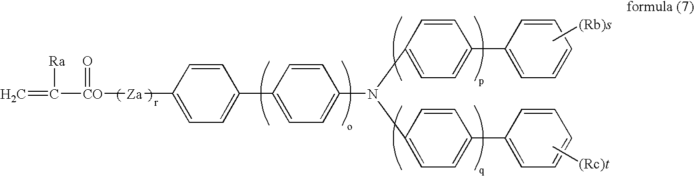

In formula (7), each of o, p and q is 0 or 1; Ra represents a hydrogen atom, or a methyl group; each of Rb and Rc represents an alkyl group having from 1 to 6 carbon atoms, wherein each of Rb and Rc can include plural groups which are the same as or different from each other; each of s and t is 0, 1, 2 or 3; r is 0 or 1; Za represents a methylene group, an ethylene group or a group having one of the following formulae.

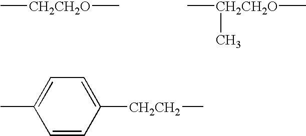

In formula (7), each of Rb and Rc is preferably a methyl group or an ethyl group.

The radical polymerizable monofunctional monomers having formula (4) or (5) (preferably formula (7)), have the following property. Namely, a monofunctional monomer is polymerized while the double bond of a molecule is connected with double bonds of other molecules. Therefore, the monomer is incorporated inside a polymer chain (i.e., the monomer is not located at the end of the resultant polymer). Namely, the monomer is incorporated in a main chain or a side chain of the crosslinked polymer chain which is formed by the monomer and a radical polymerizable tri- or more-functional monomer. The side chain of the unit obtained from the monofunctional monomer is present between two main polymer chains which are connected by crosslinking chains. In this regard, the crosslinking chains are classified into intermolecular crosslinking chains and intramolecular crosslinking chains.

In any of these case, a triarylamine group which is a pendant of the main chain of the unit obtained from the monofunctional monomer is bulky and is connected with the main chain with a carbonyl group therebetween while not being fixed (i.e., while being fairly free in a three-dimensional space). Therefore, the crosslinked polymer has little strain. In addition, when the CCTL is formed as an outermost layer, occurrence of a problem in that the charge transport passage is disconnected can be prevented.

Specific examples of the radical polymerizable monofunctional monomers include the following compounds Nos. 1-160, but are not limited thereto.

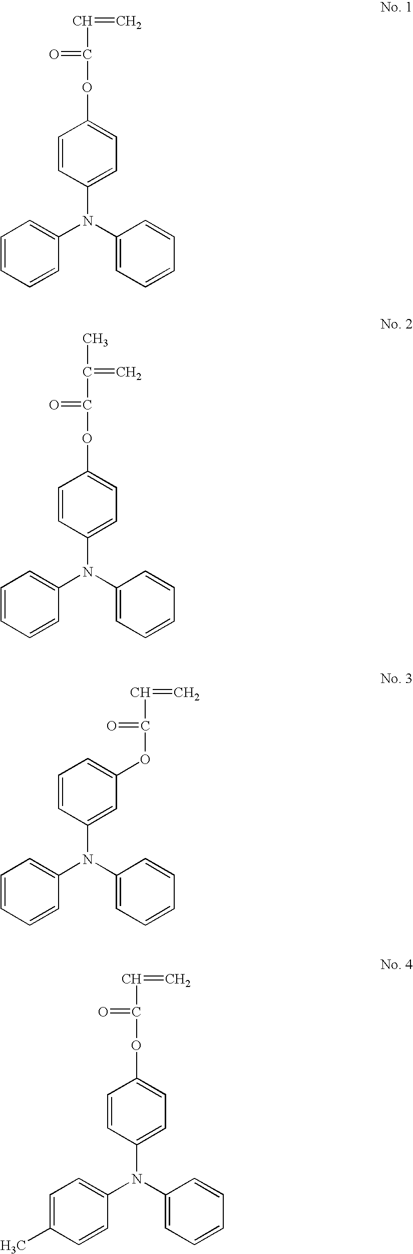

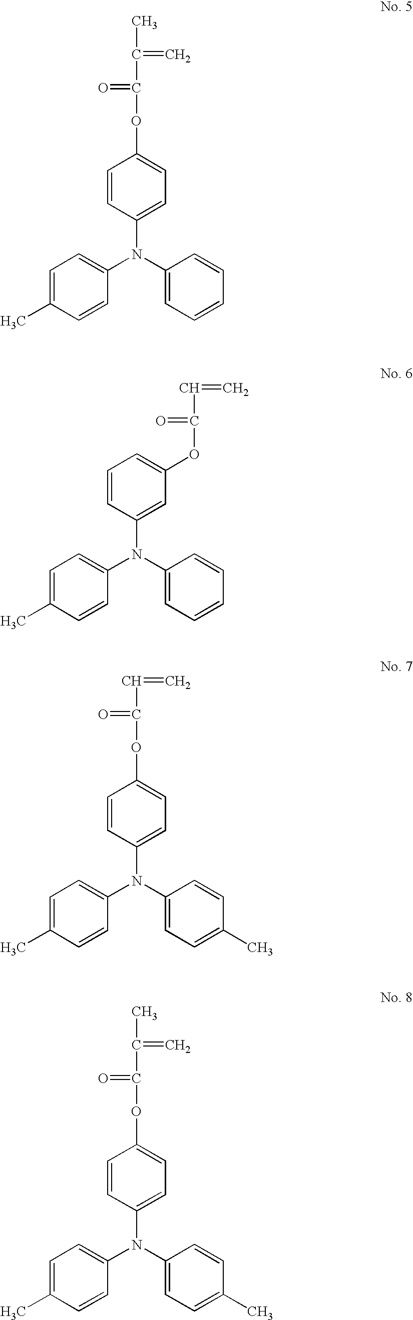

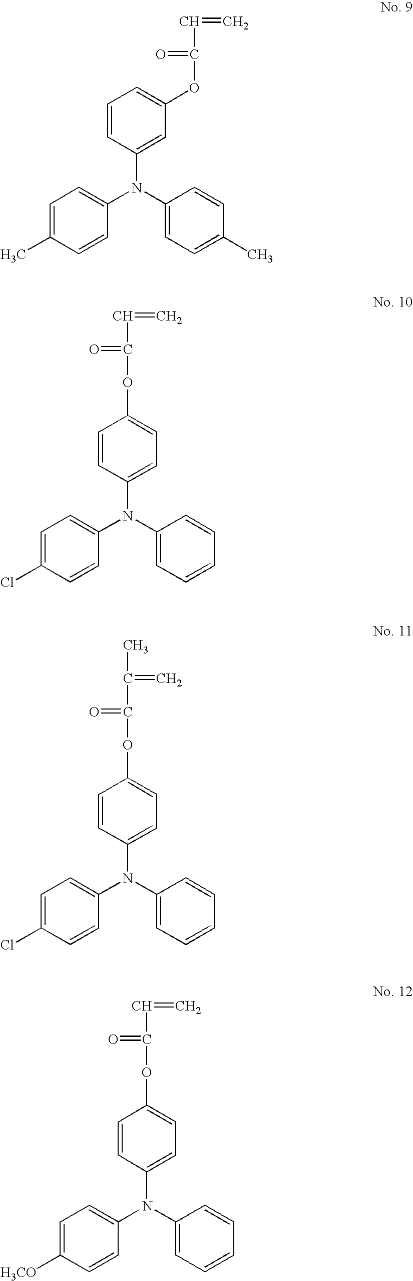

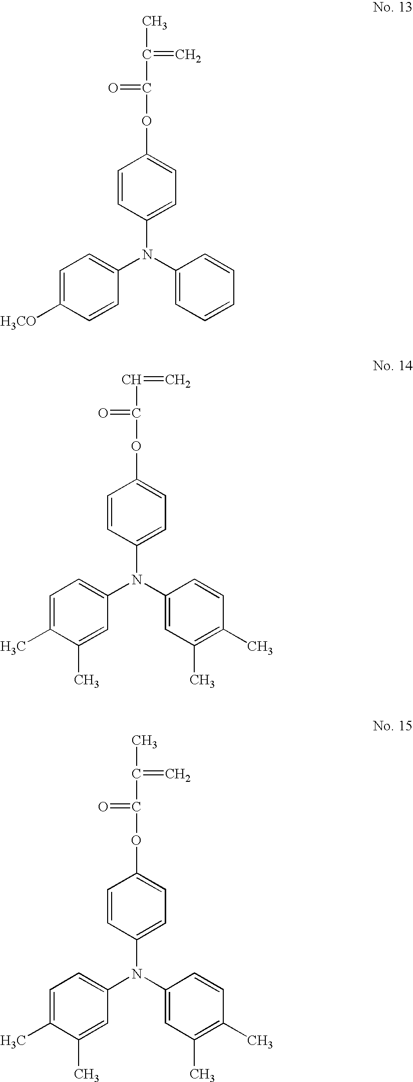

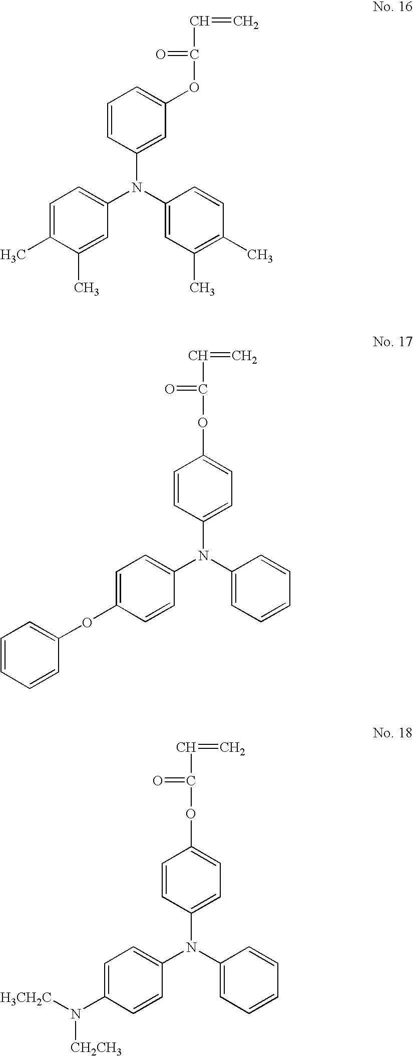

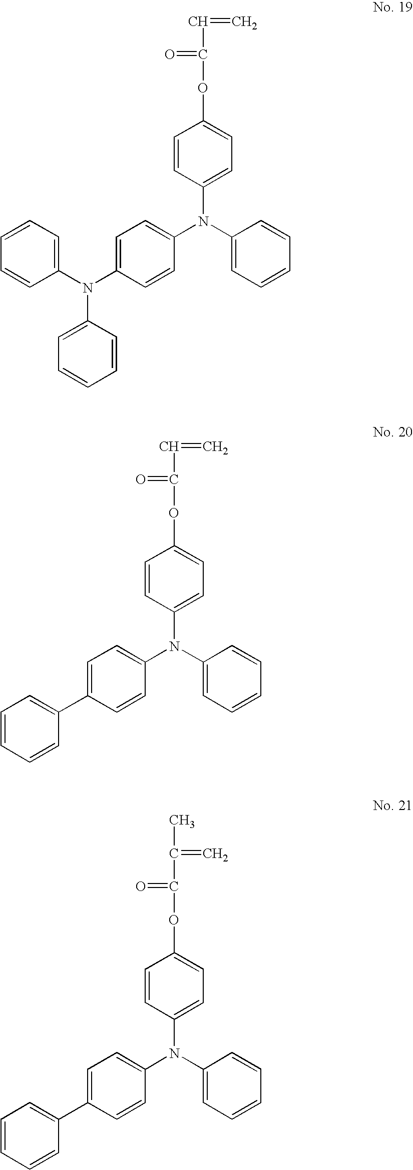

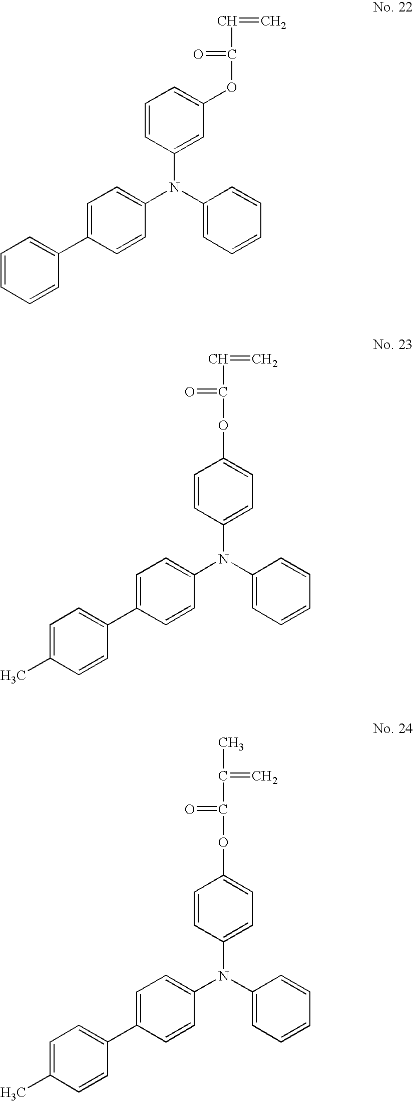

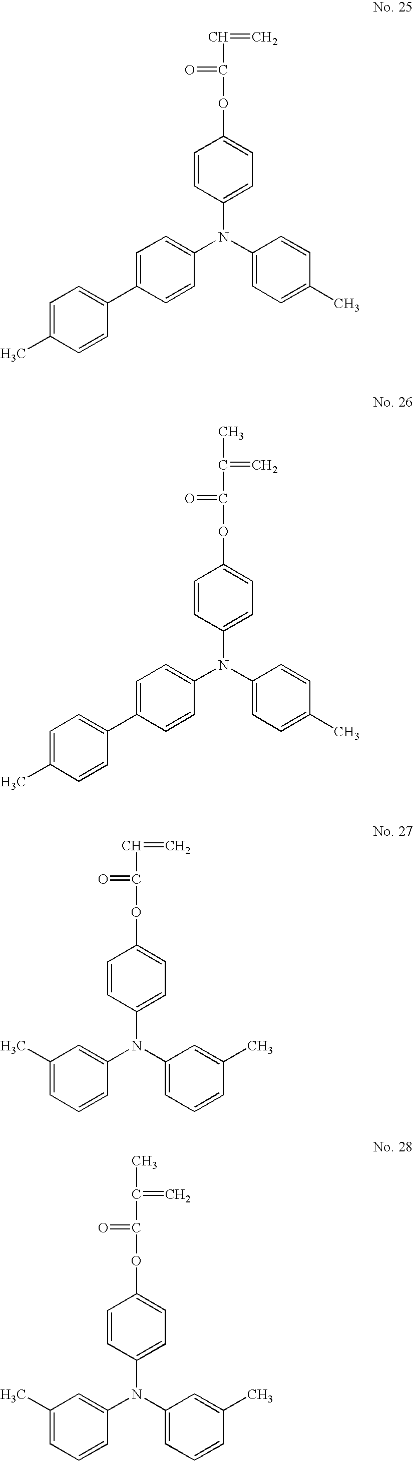

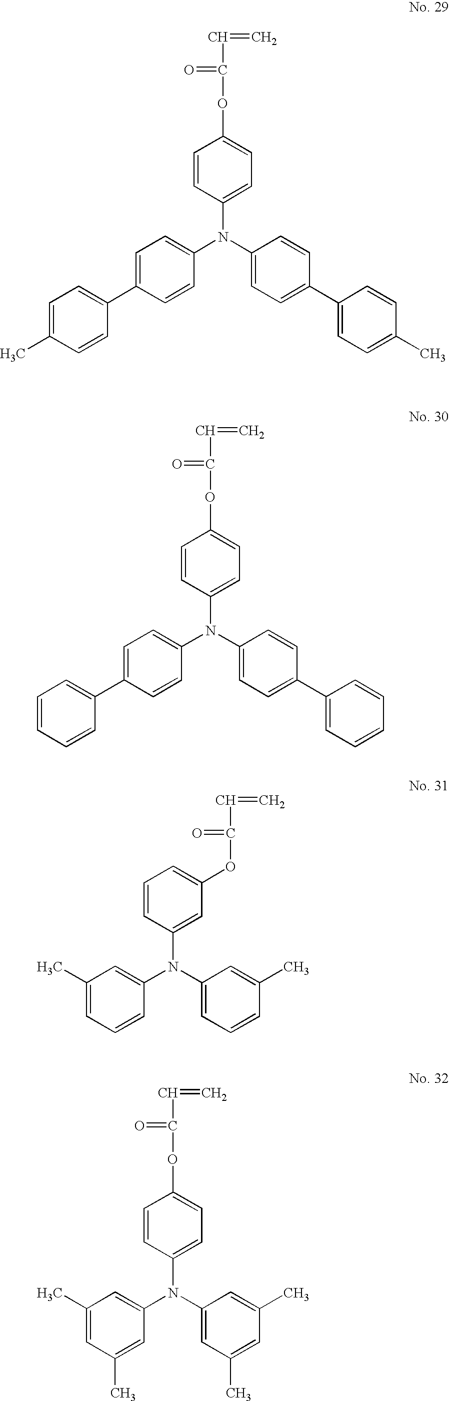

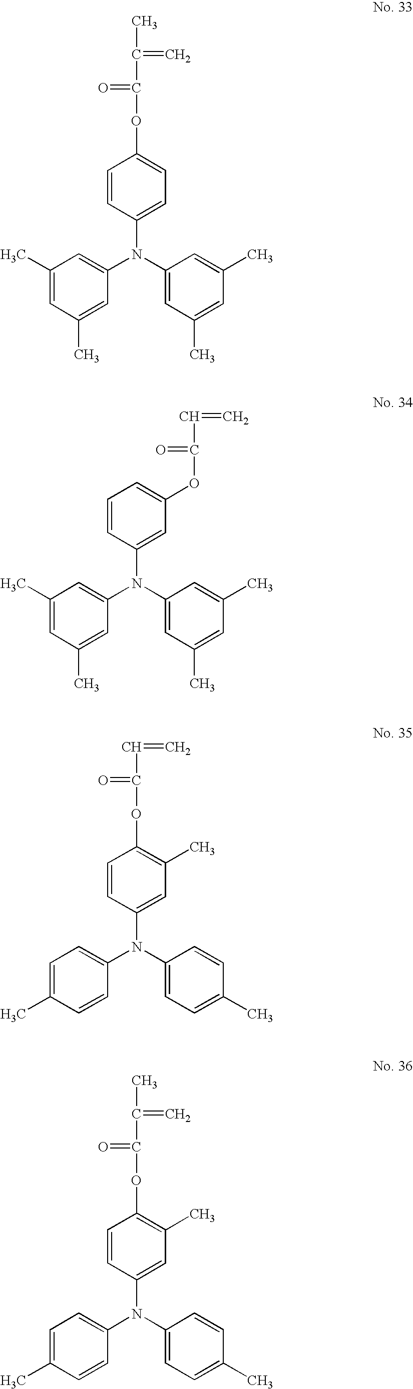

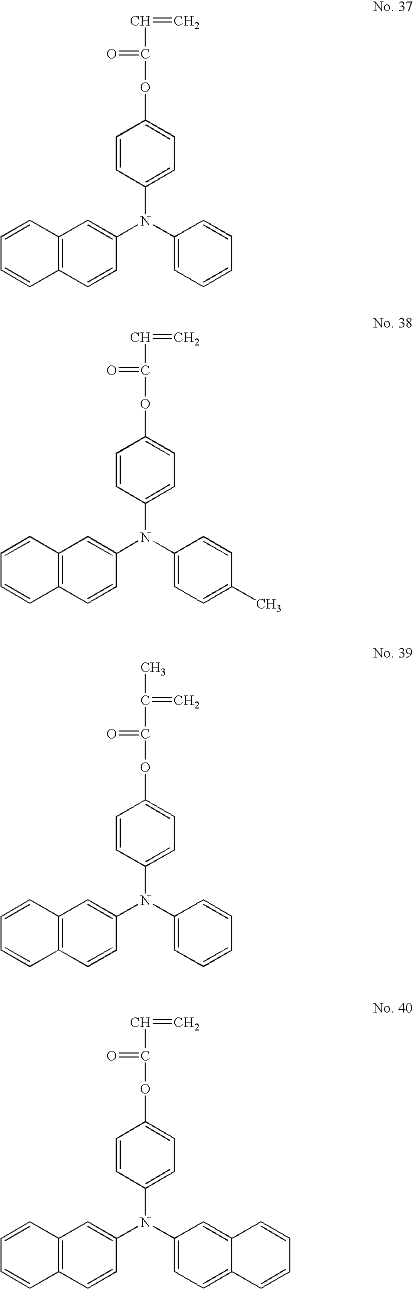

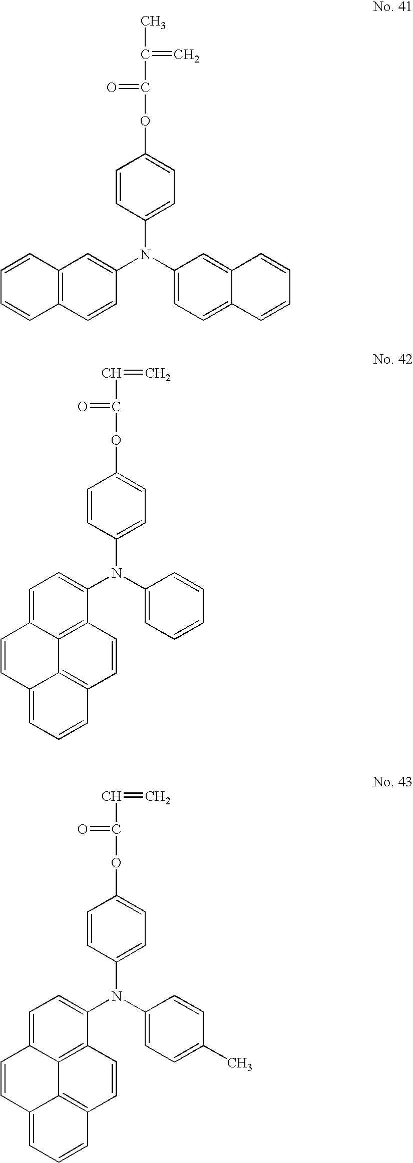

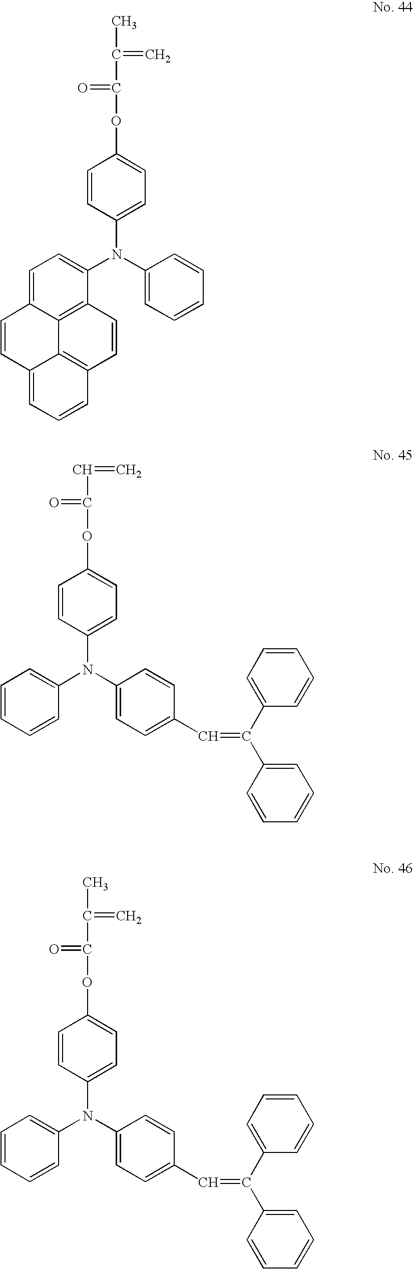

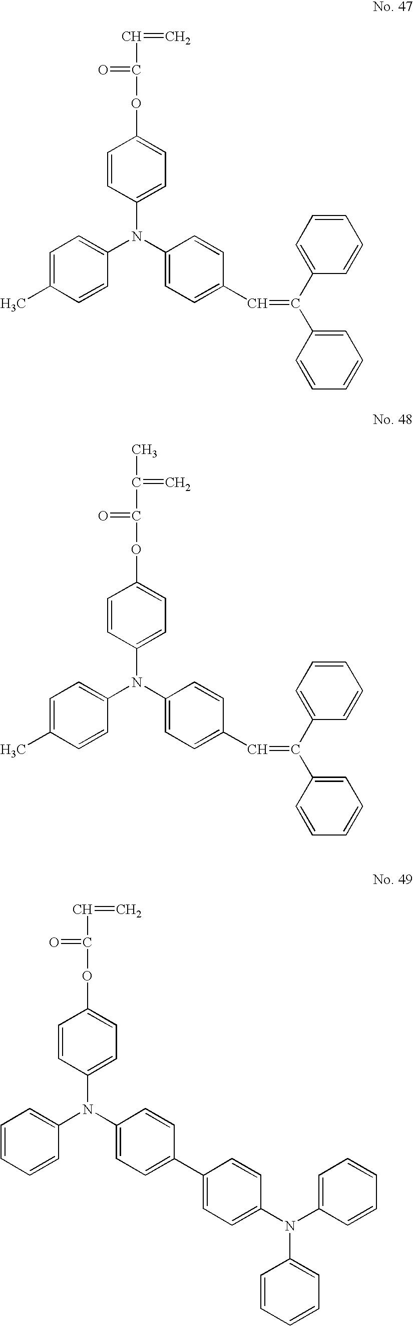

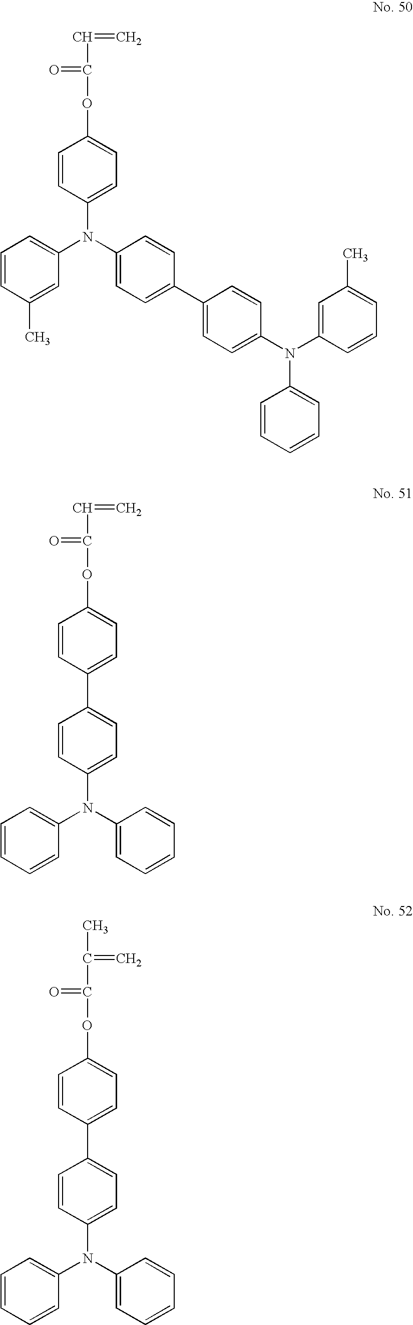

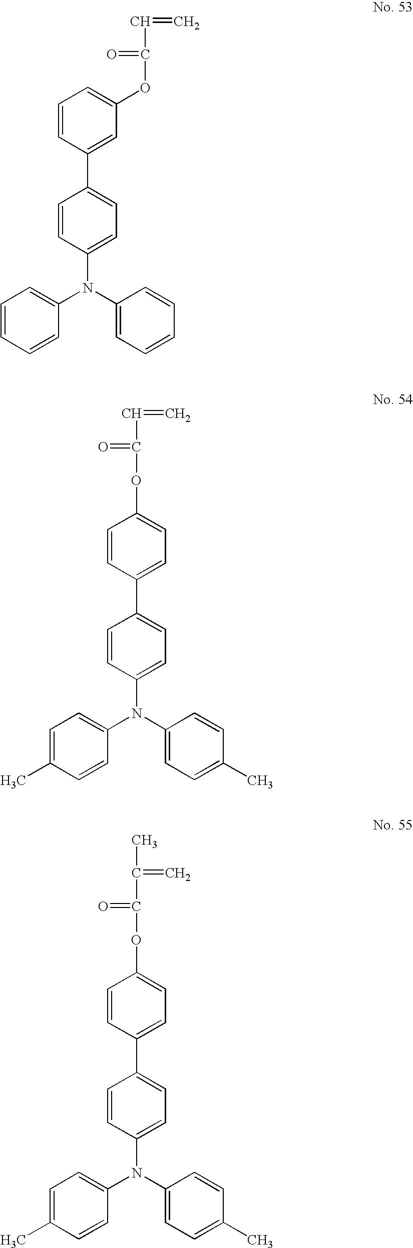

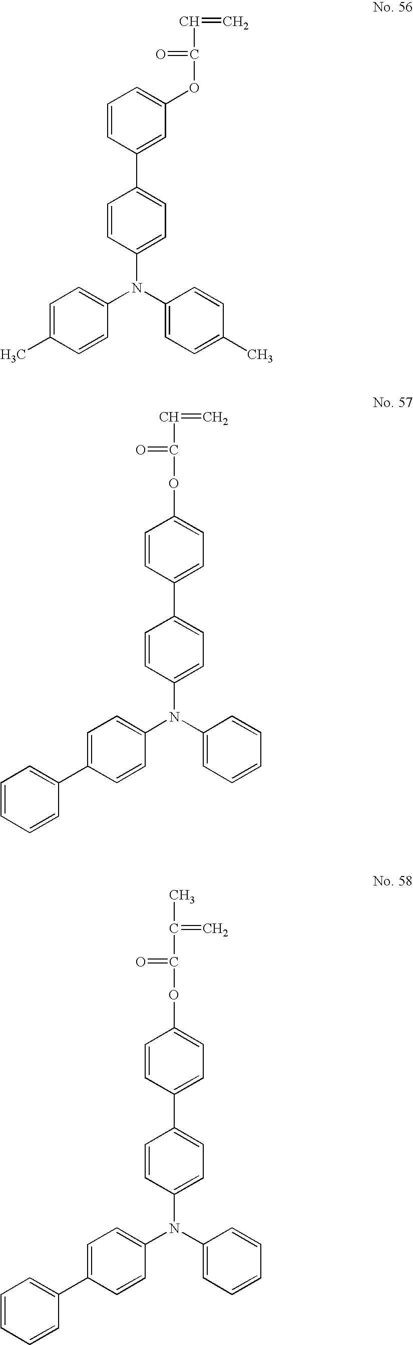

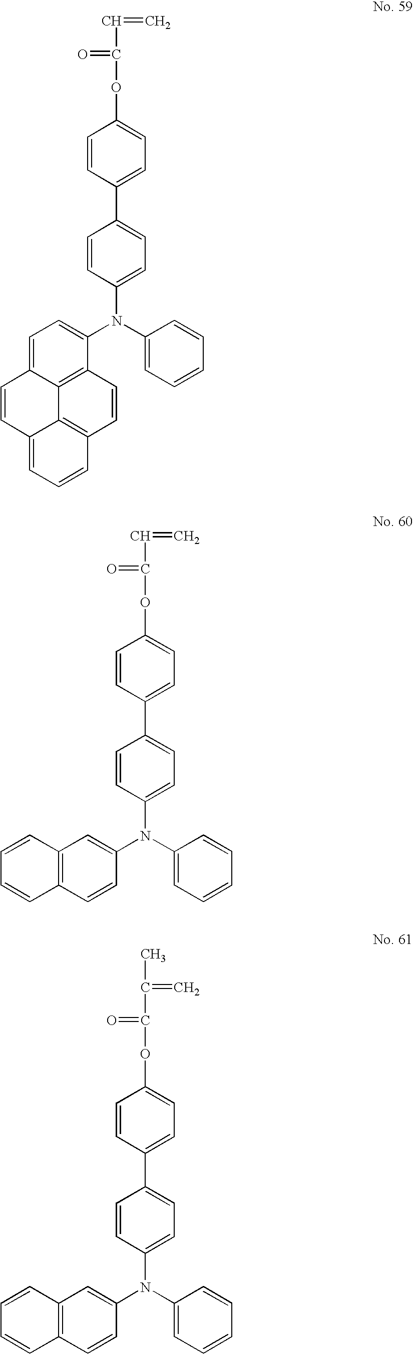

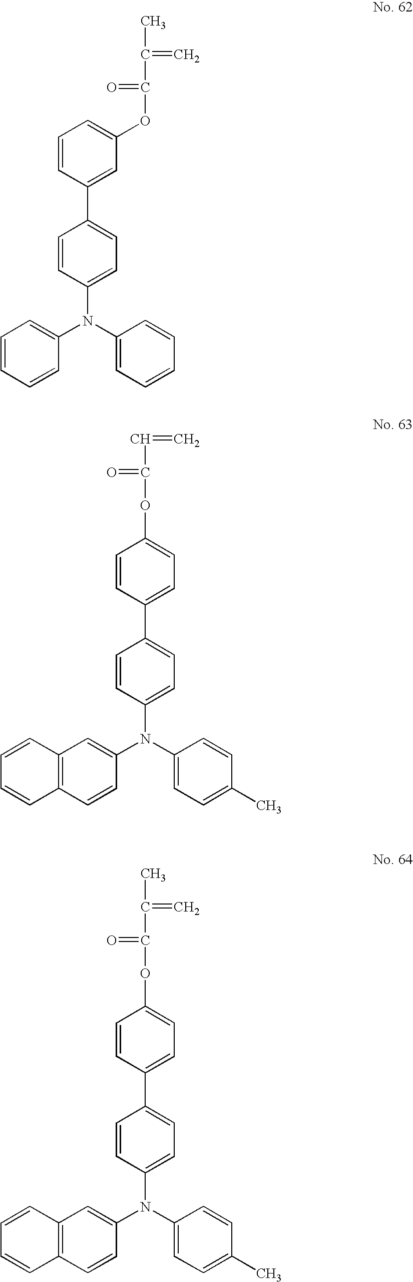

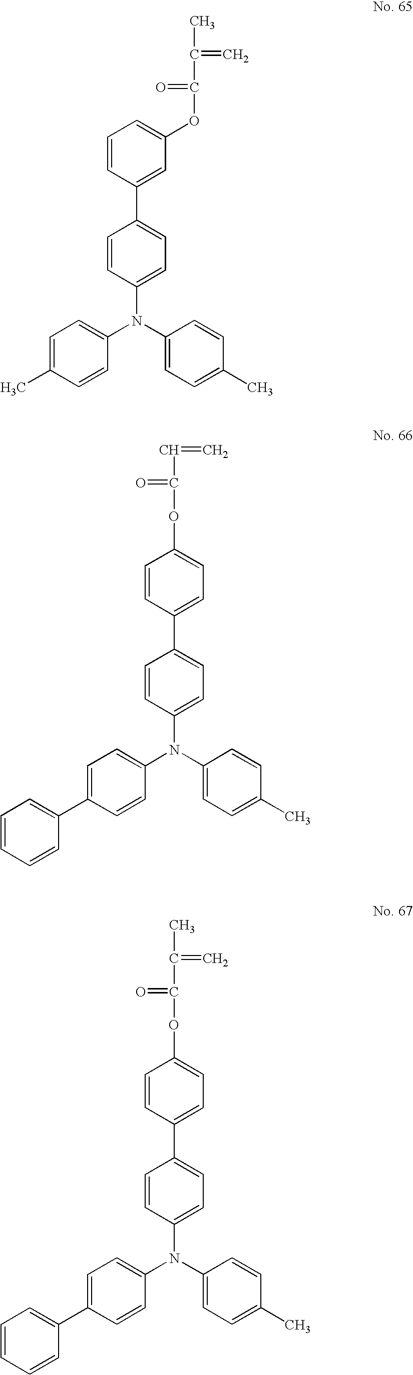

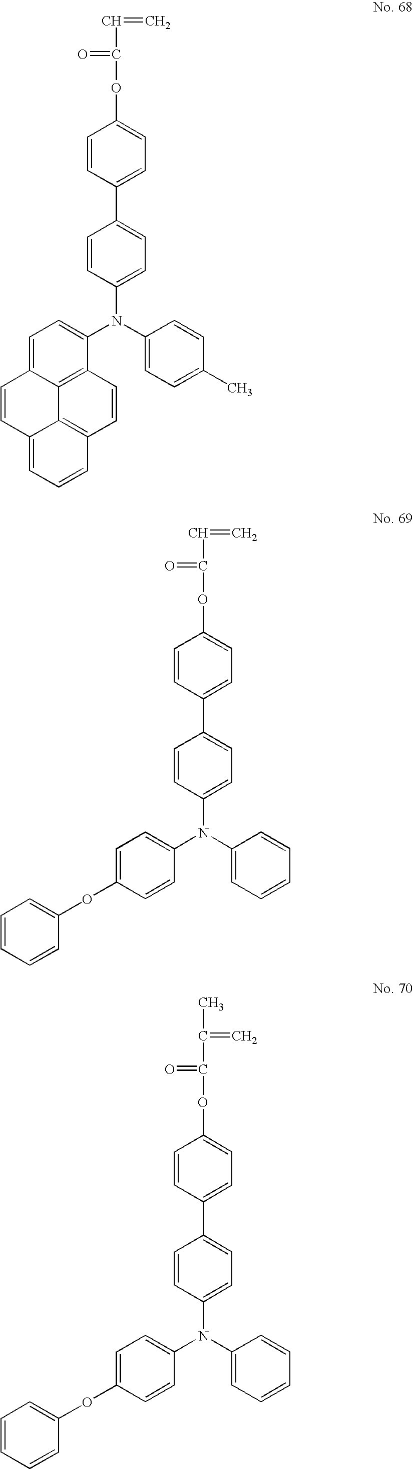

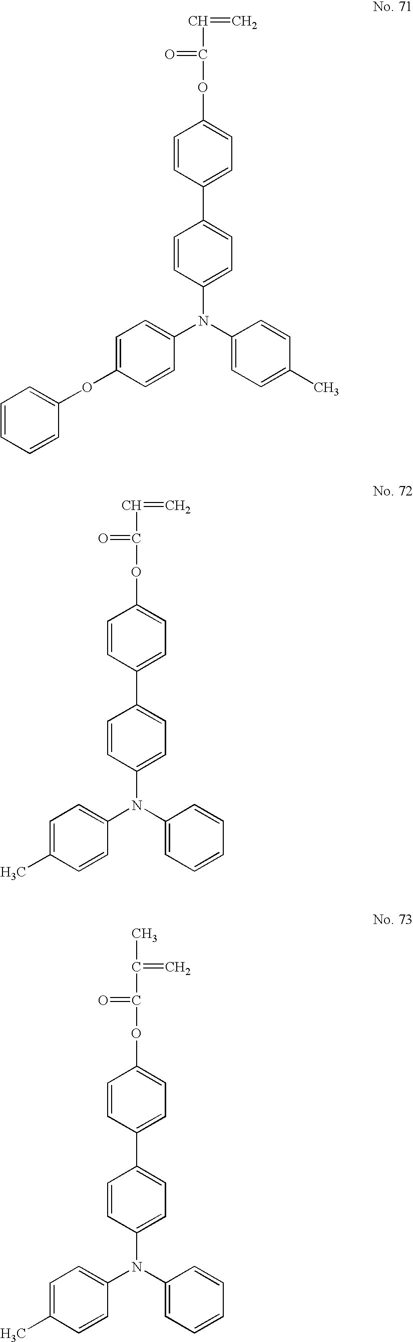

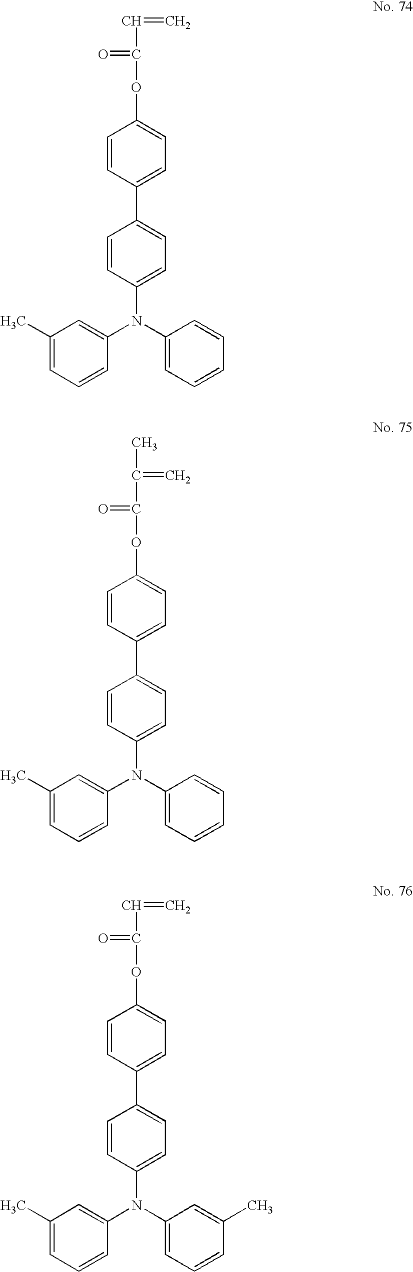

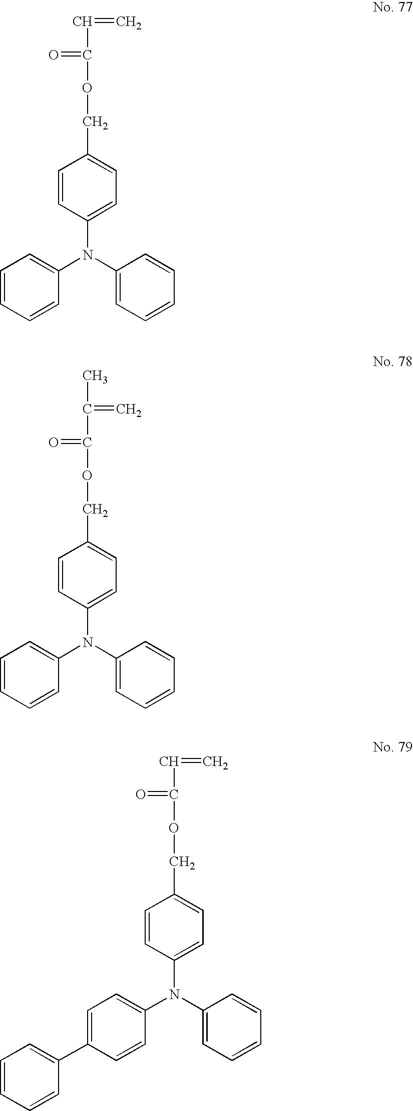

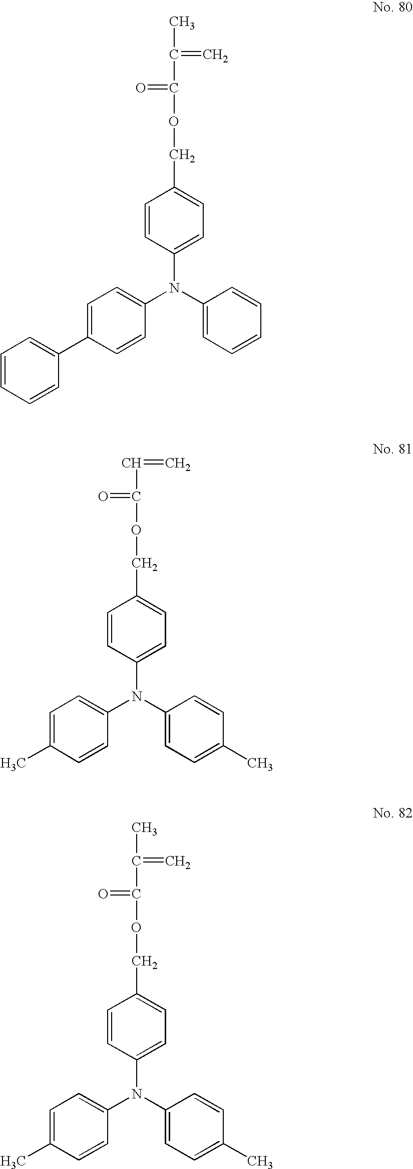

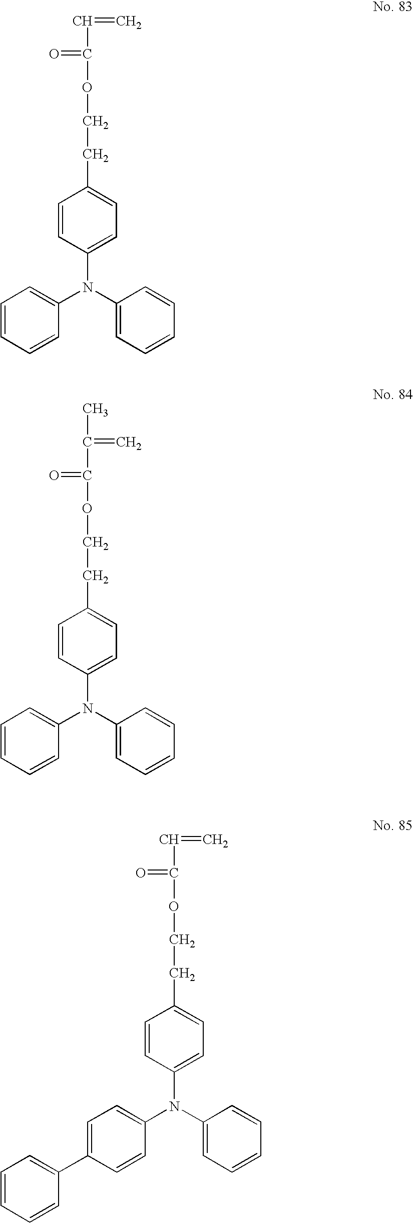

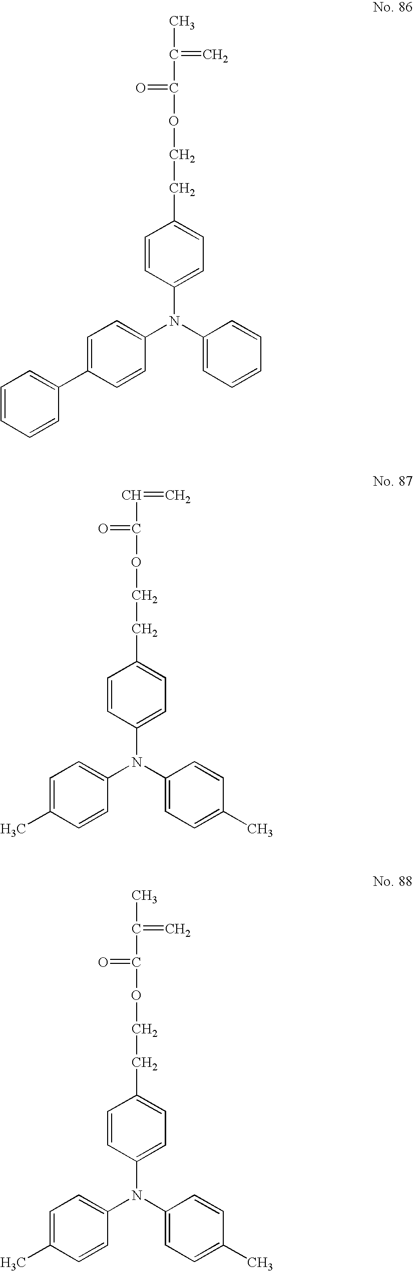

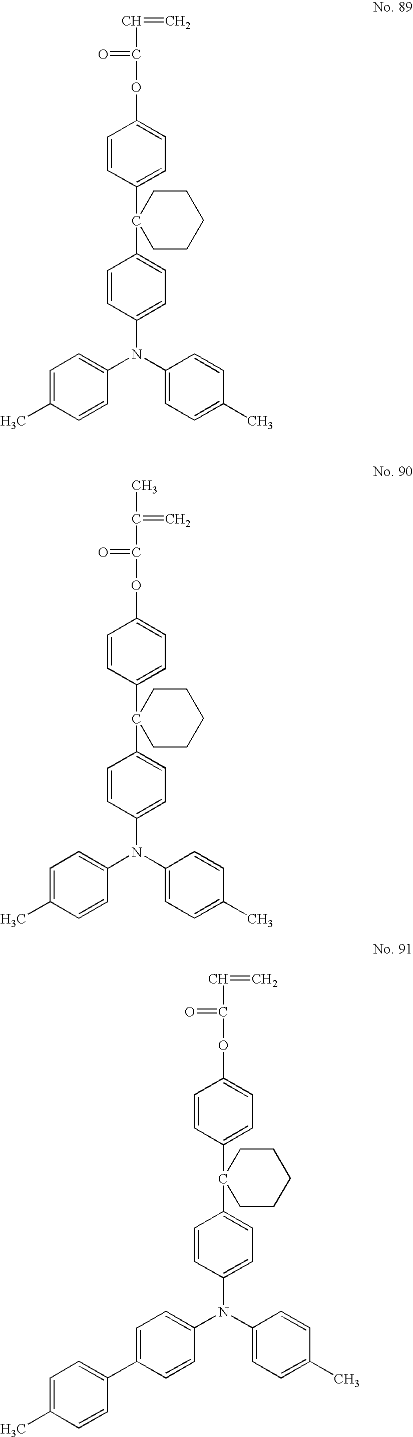

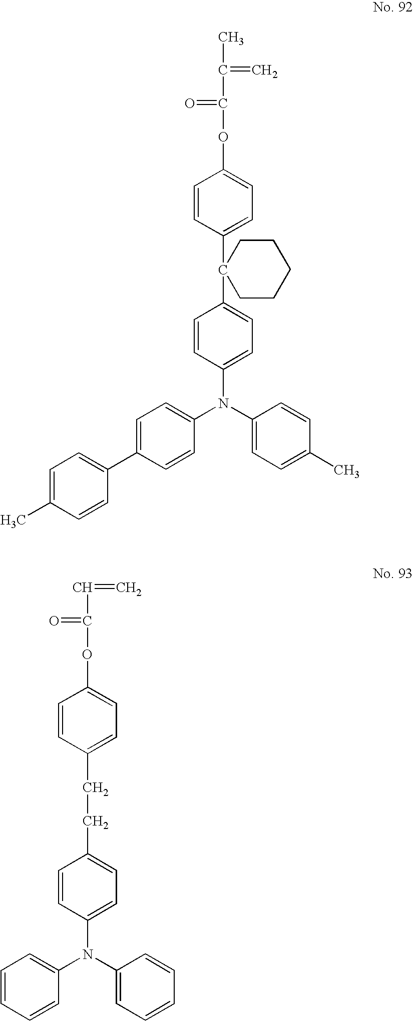

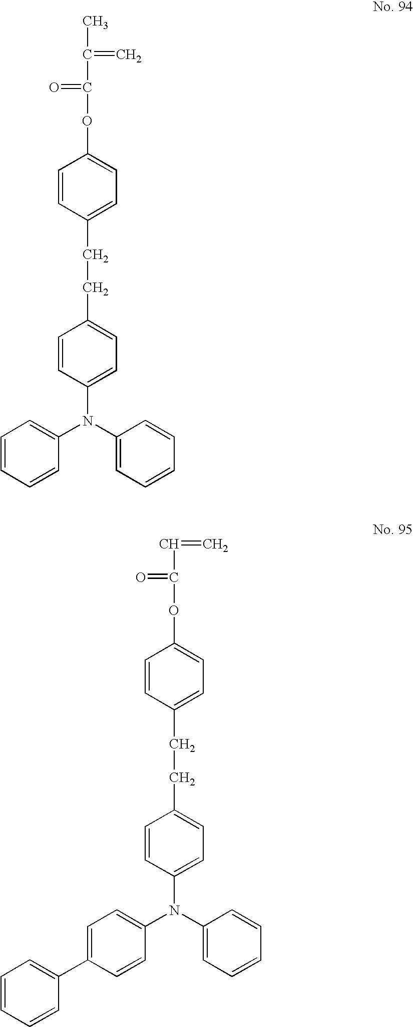

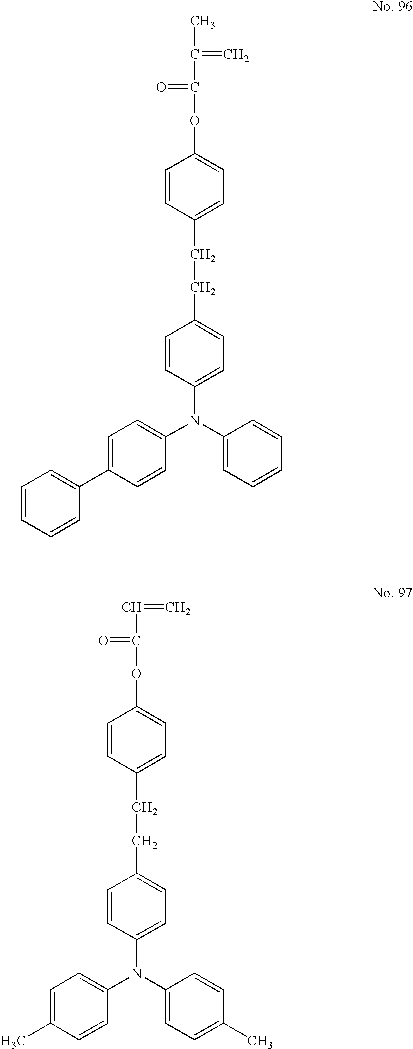

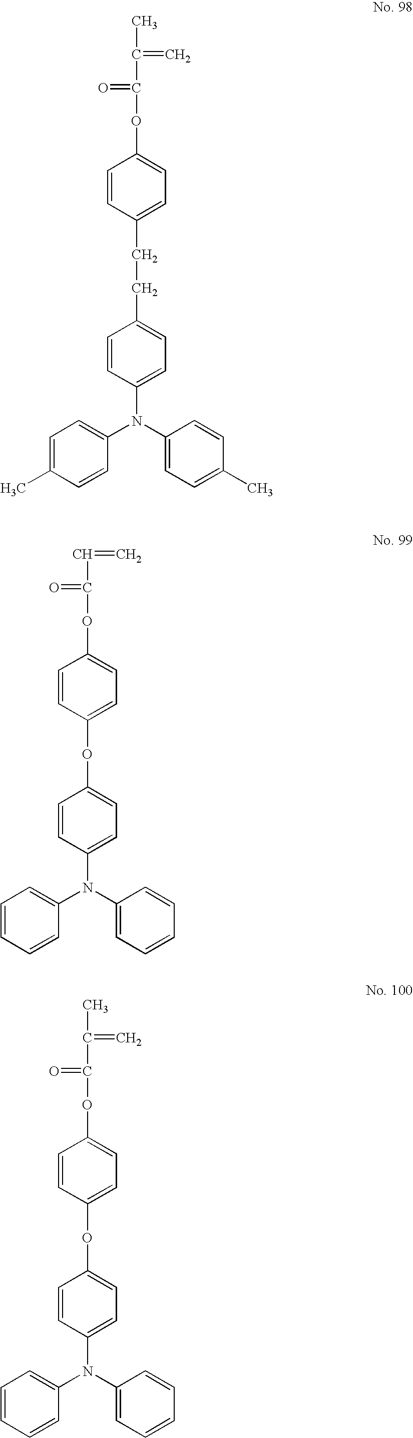

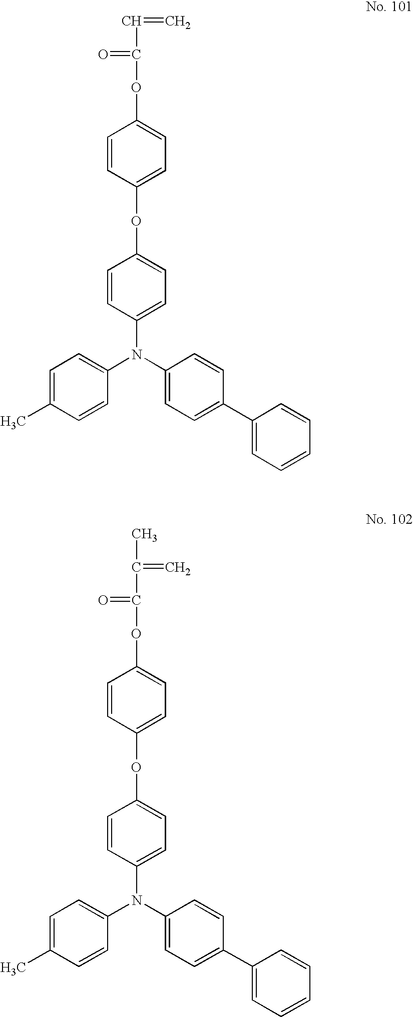

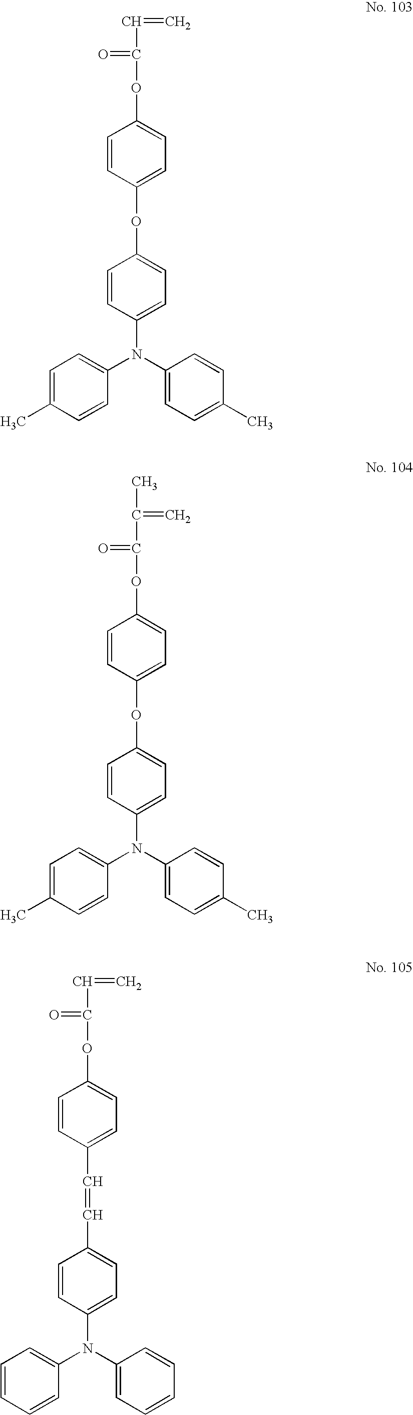

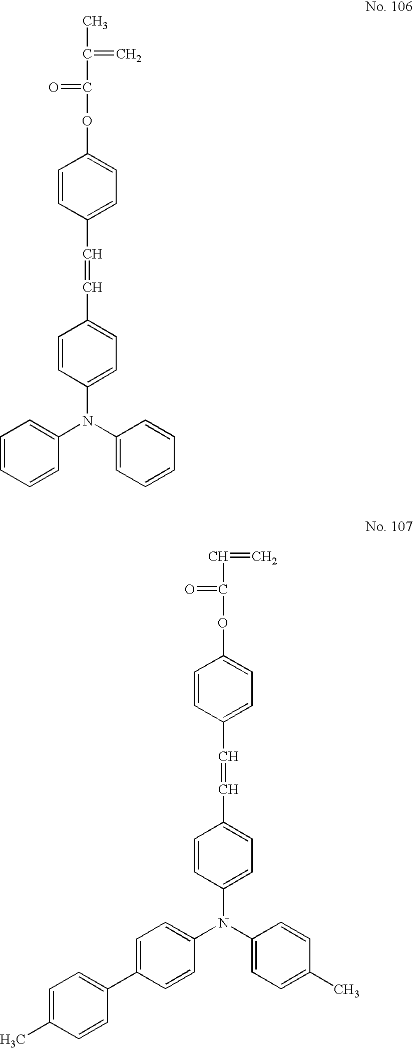

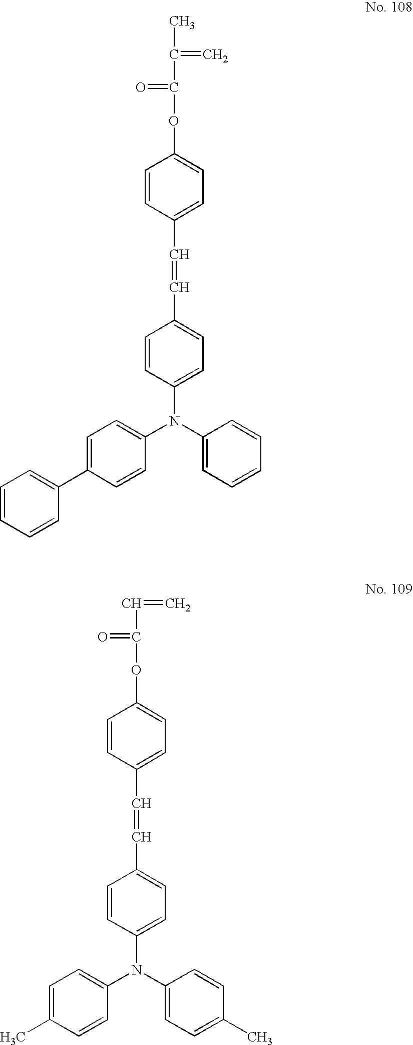

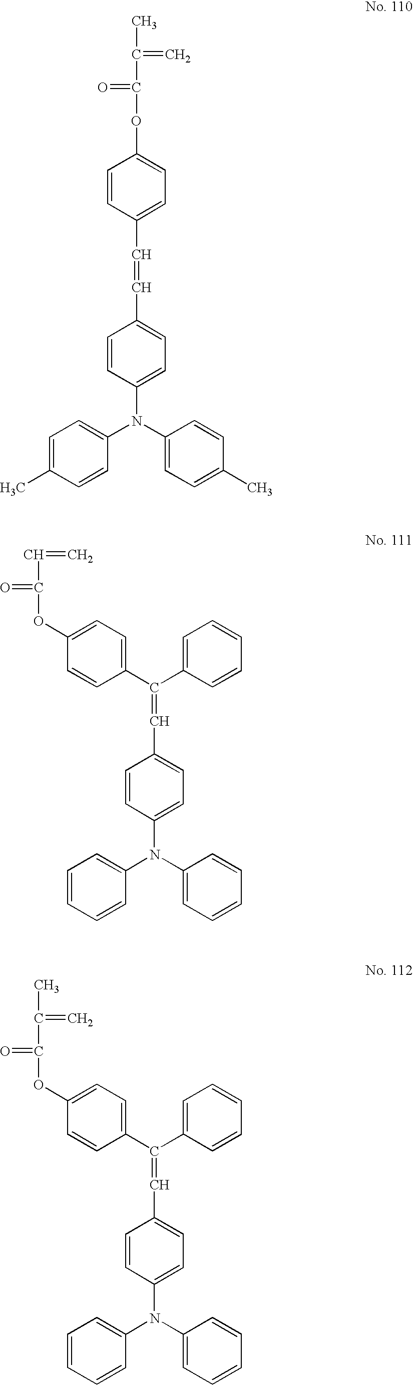

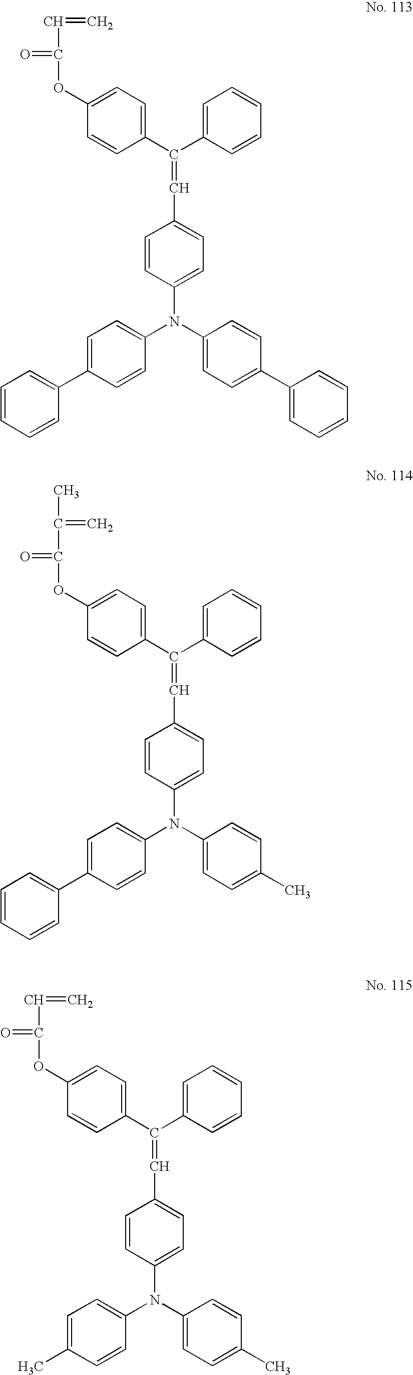

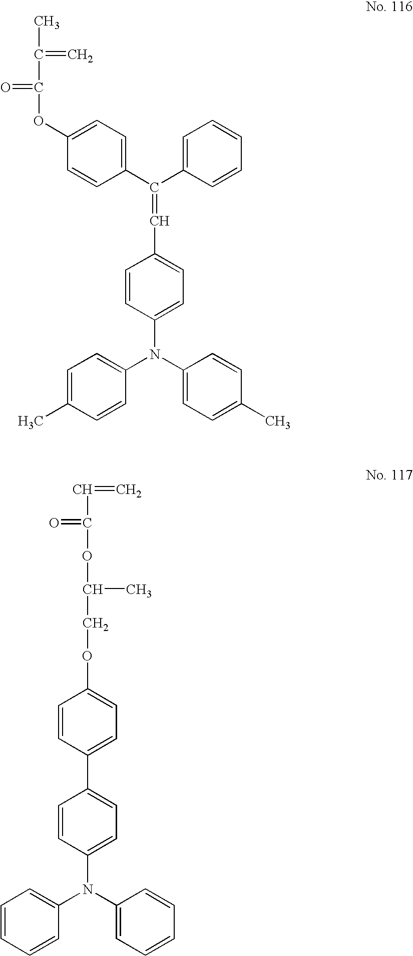

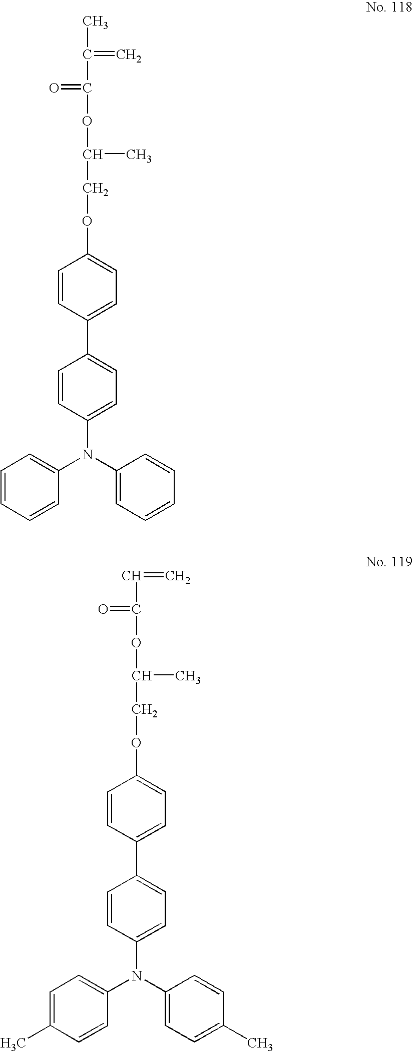

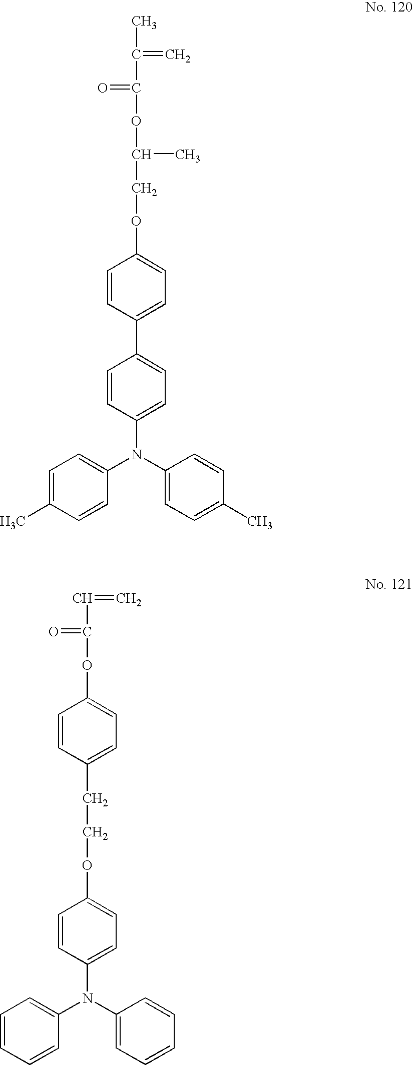

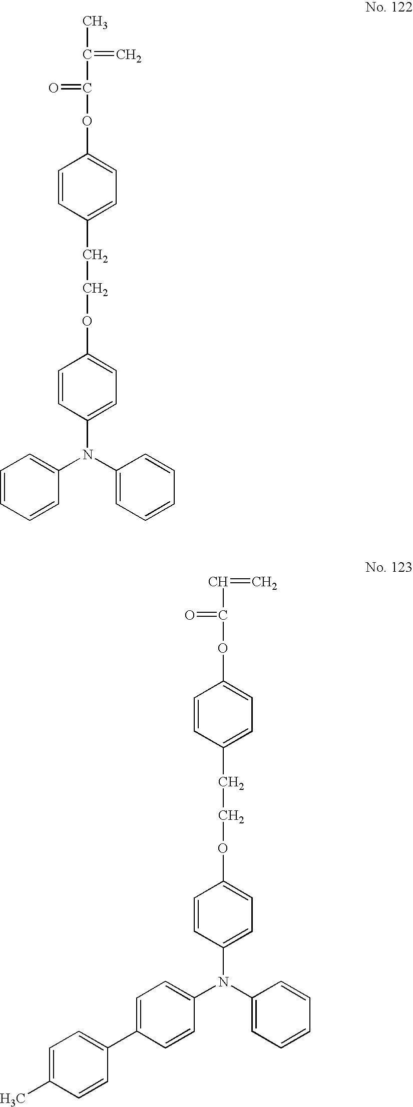

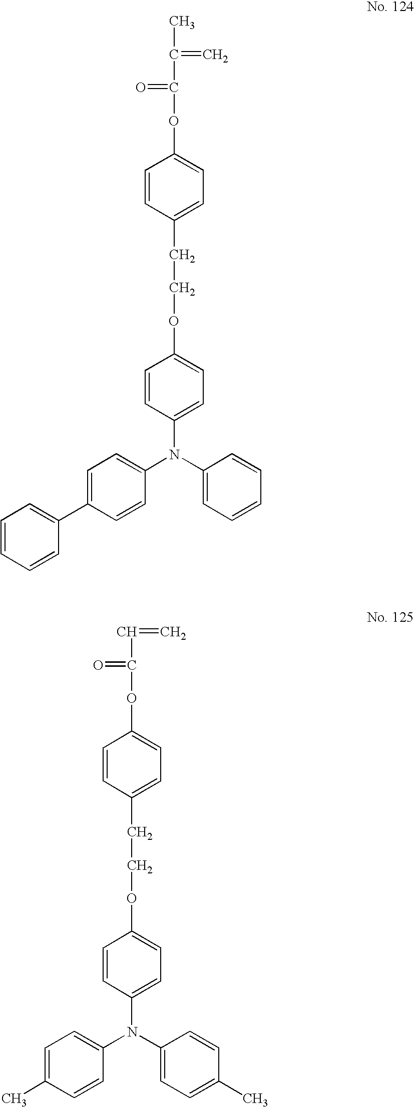

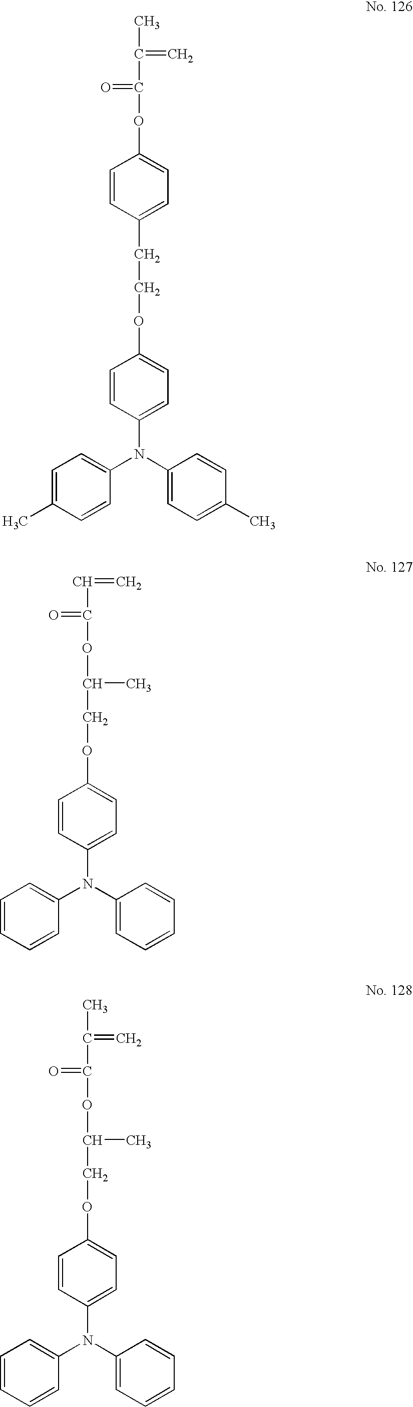

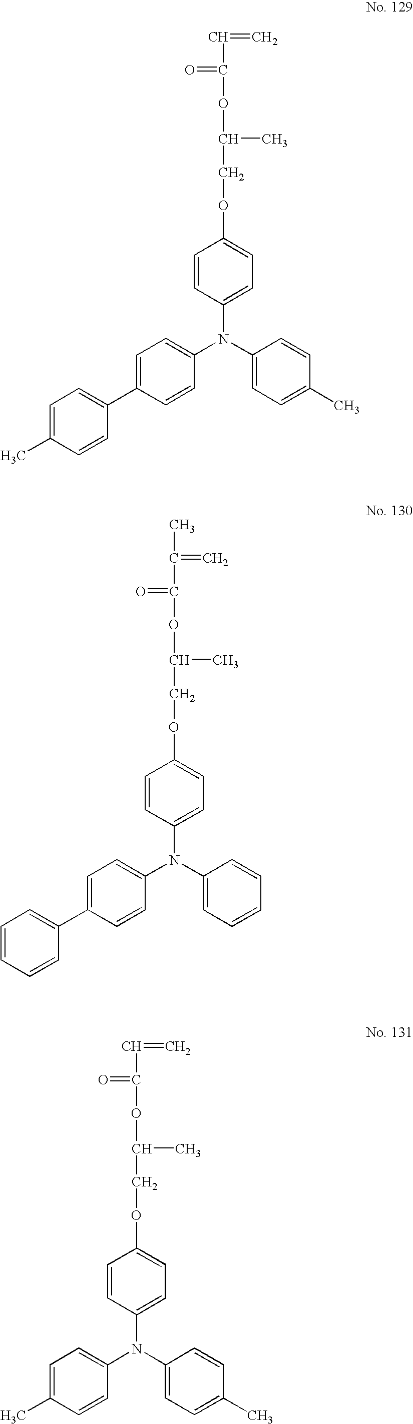

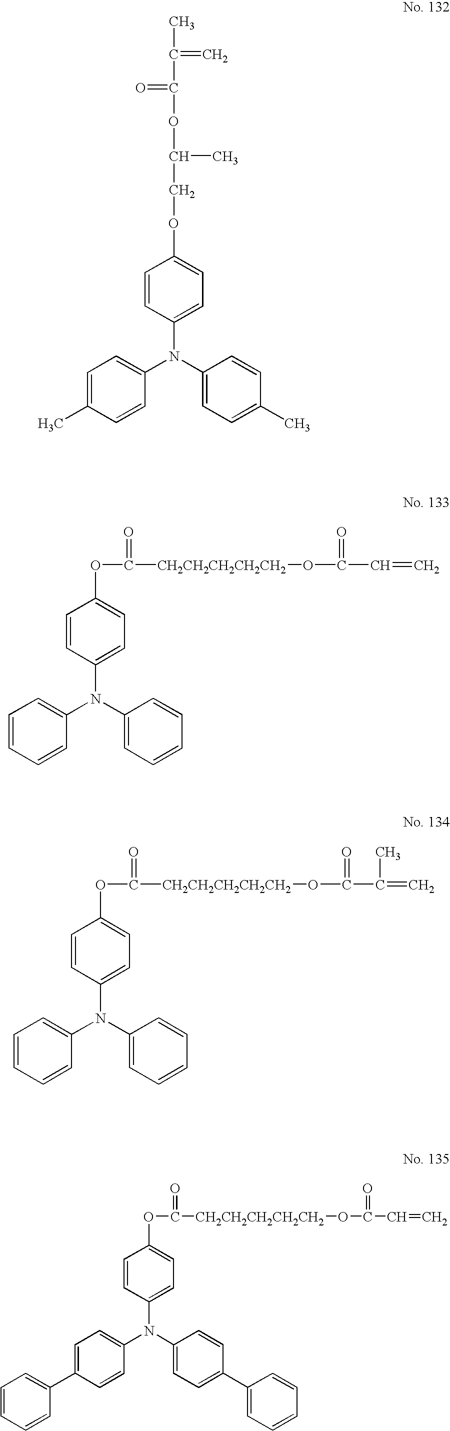

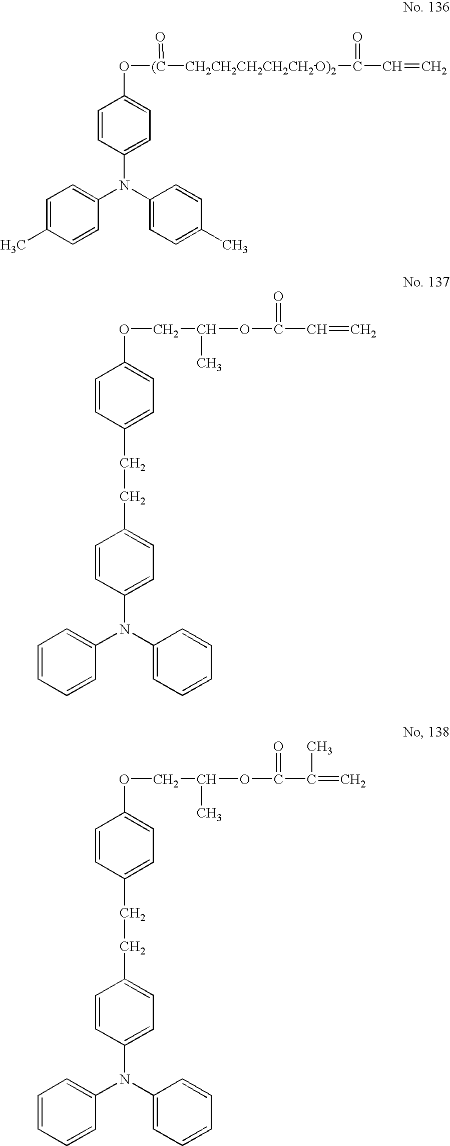

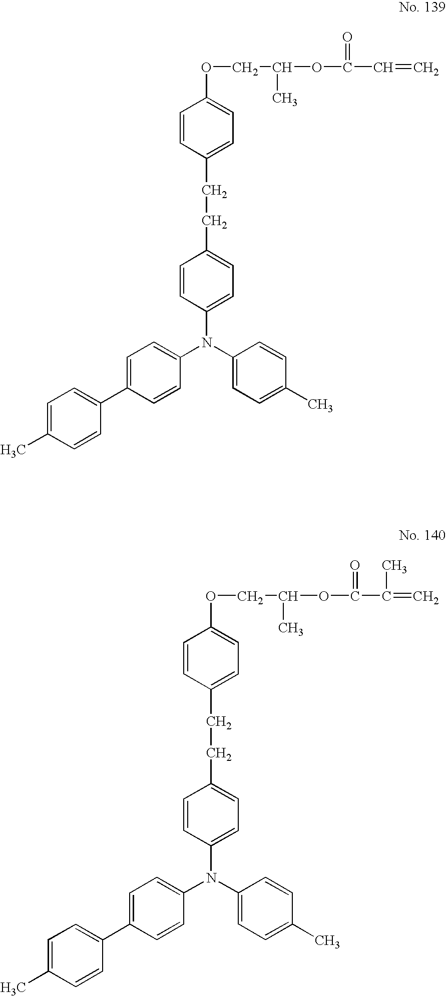

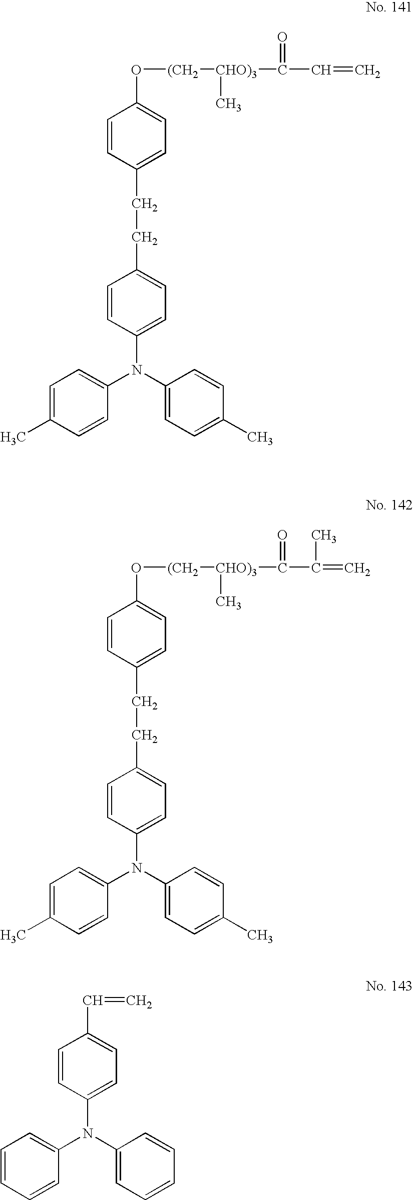

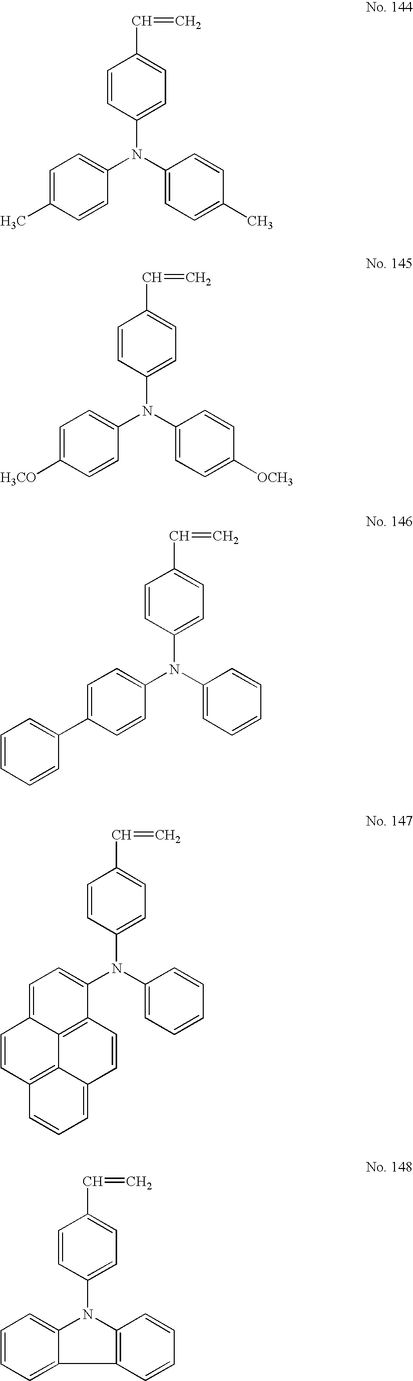

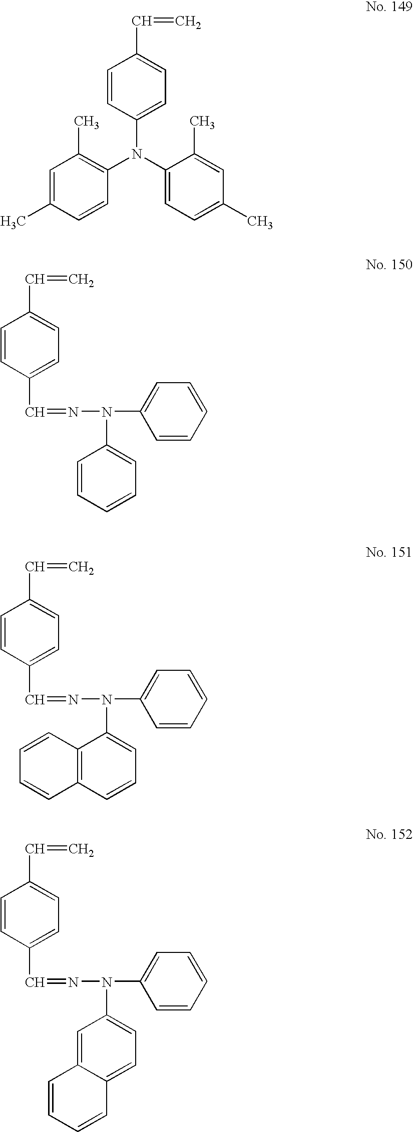

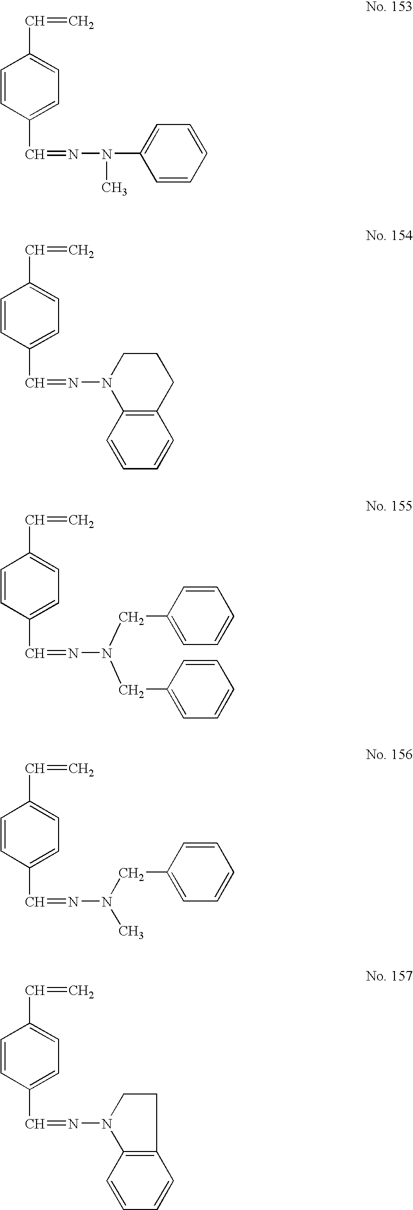

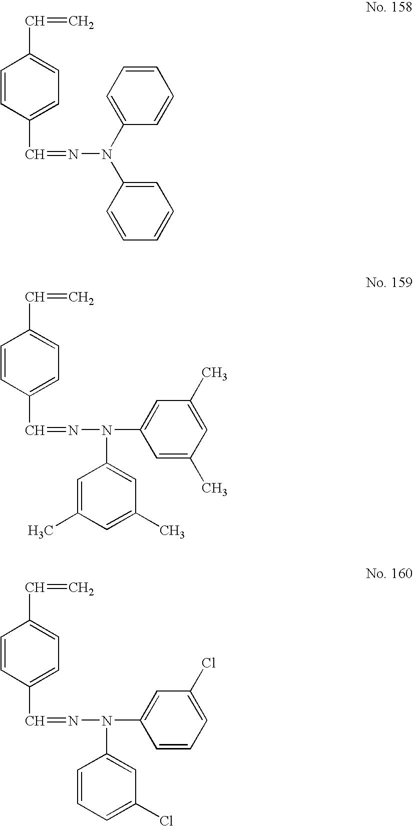

In addition, radical polymerizable monomers having two or more functional groups and a charge transport structure can also preferably used. Such difunctional monomers are inferior to monofunctional monomers because:
(1) the monomers have less steric flexibility;
(2) the resultant CCTL cannot have a structure such that the triarylamine structures are arranged side by side with a proper space therebetween; and
(3) the resultant CCTL has a strain.

Therefore, a charge transport passage cannot be fully formed. However, when such a di- or more-functional monomer are used in combination of one or more tri- or more-functional monomers having no charge transport structure, a unit obtained from the di- or more-functional monomer is incorporated in the resultant CCTL and thereby a good combination of electric properties and mechanical properties can be imparted to the CCTL. In this case, it is preferable to use plural tri- or more-functional monomers having no charge transport structure.

In order to improve the crosslinking speed, for example, a radical polymerizable monomer having 5 or 6 functional groups and having no charge transport structure can be preferably used. In this case, it is preferable to use a radical polymerizable monomer having 1 to 4 (preferably from 3 to 4) functional groups and having no charge transport structure in combination therewith. By using such a combination of a high-functional monomer and a low-functional monomer, the above-mentioned drawbacks can be considerably remedied.

Specific examples of the radical polymerizable monomers having two or more functional groups and a charge transport structure include the following, but are not limited thereto.

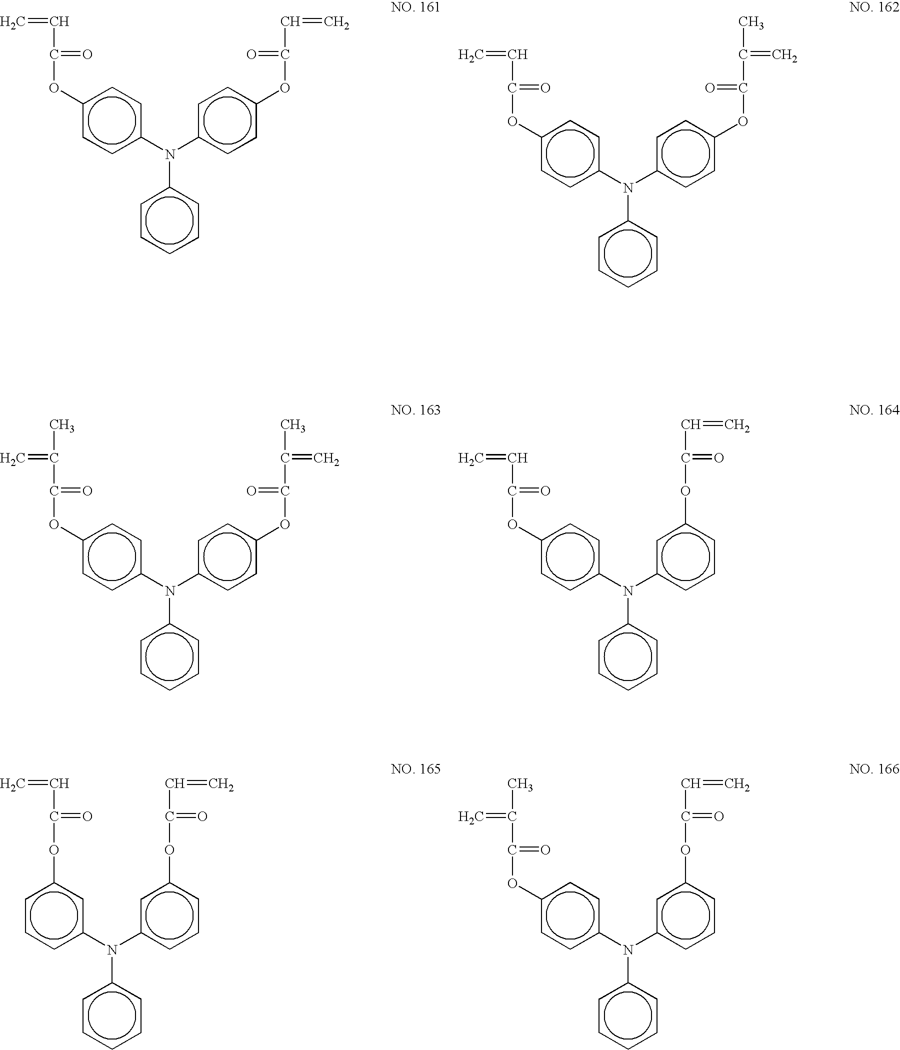

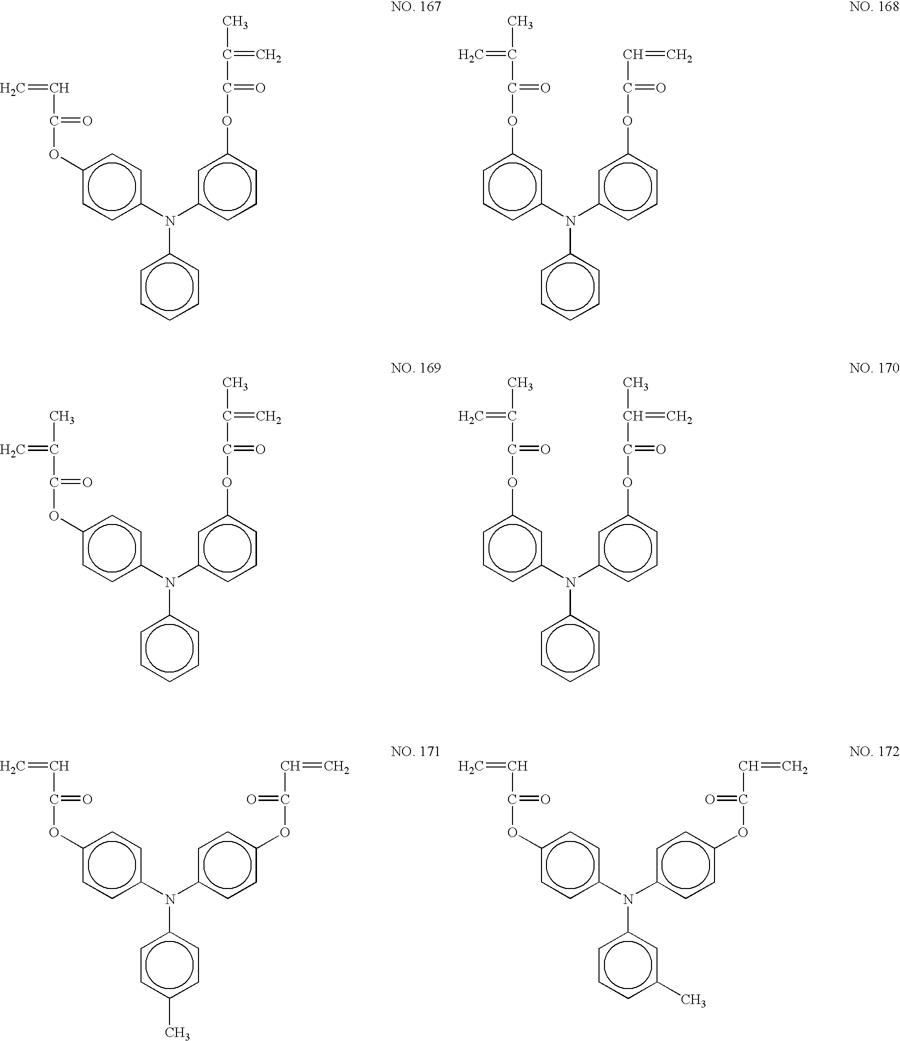

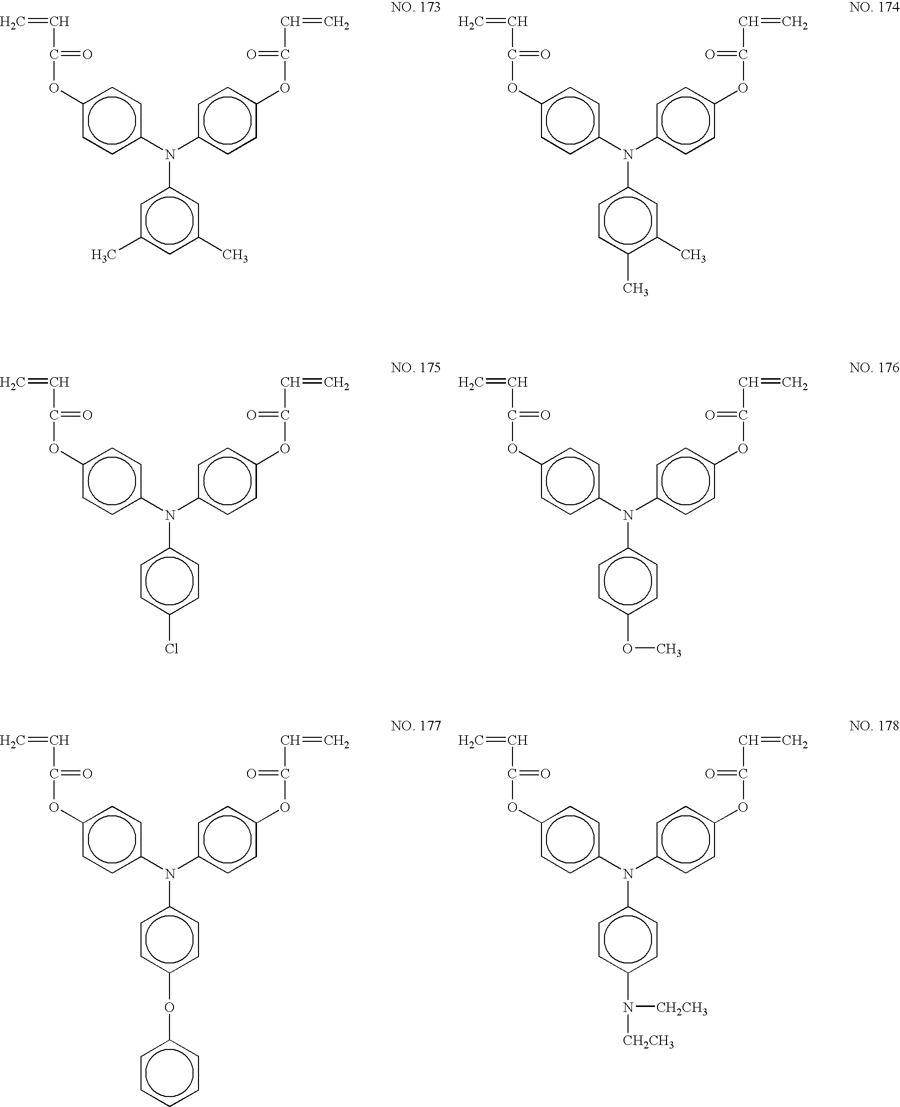

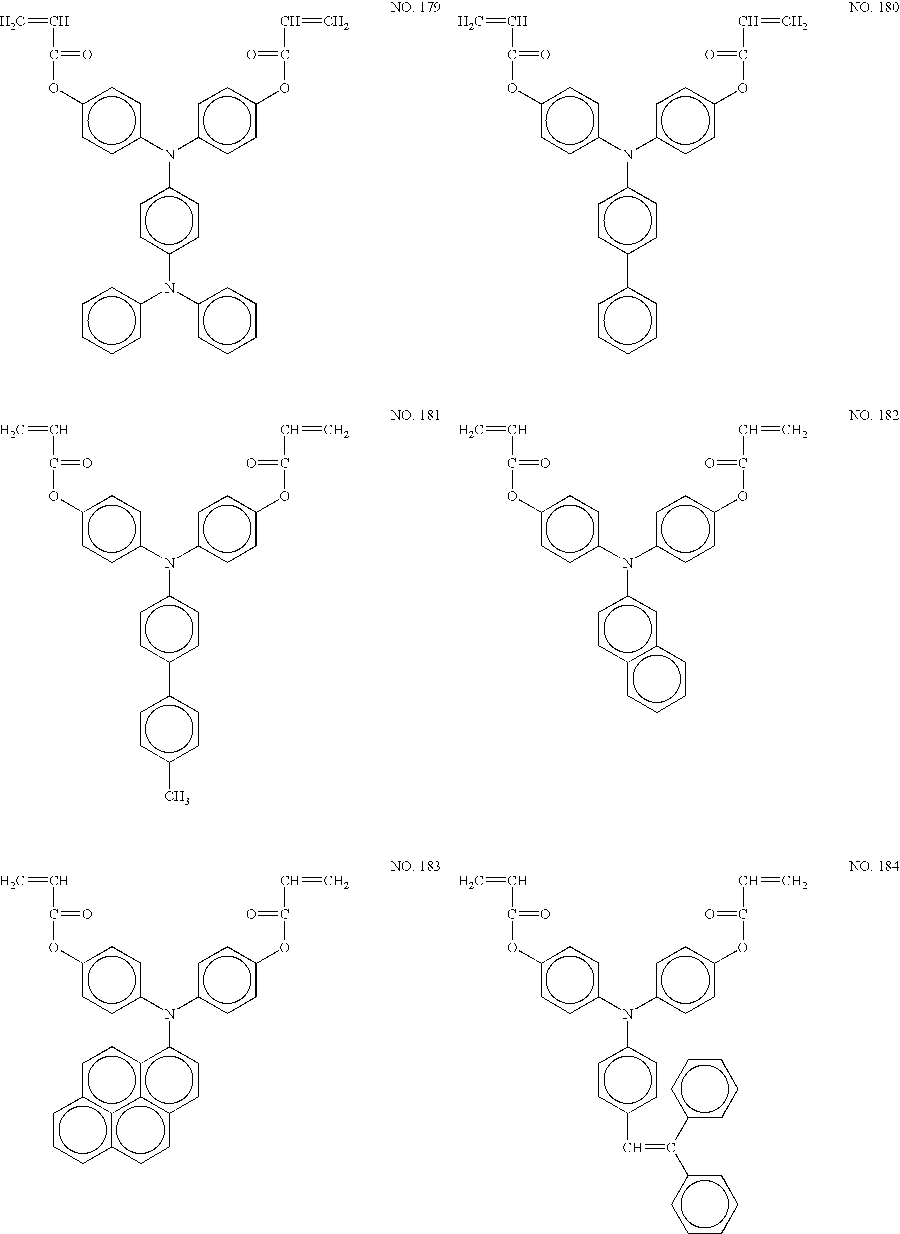

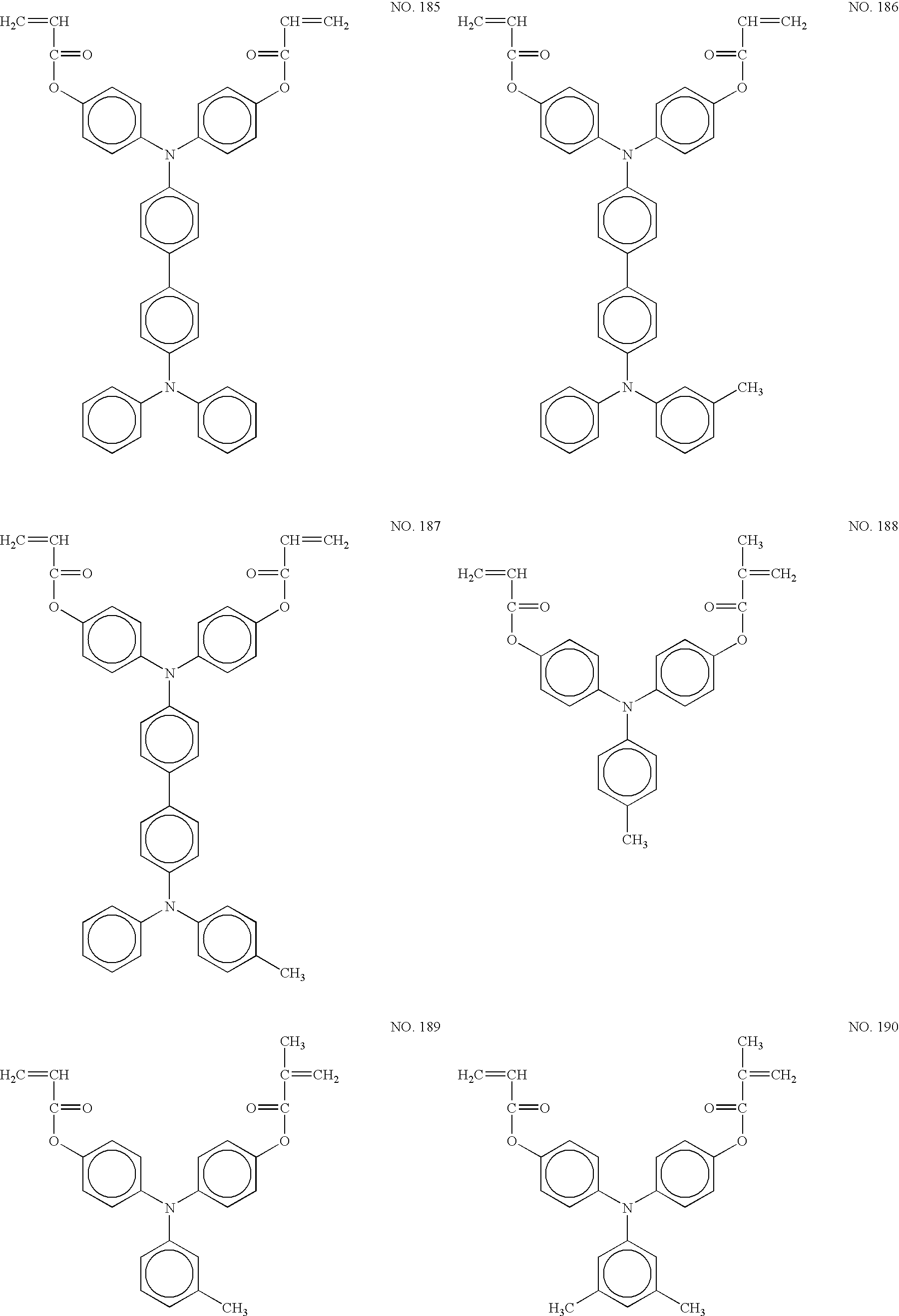

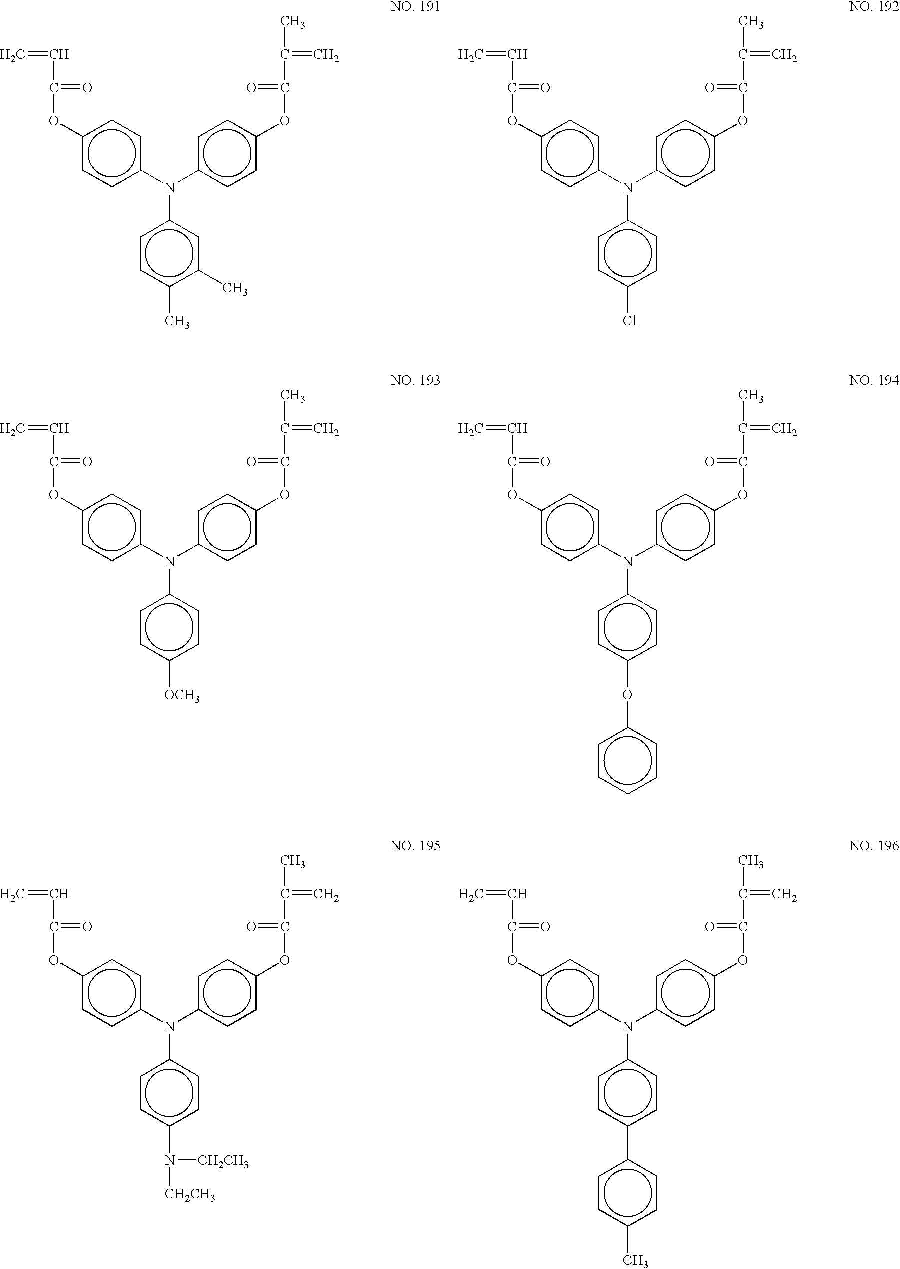

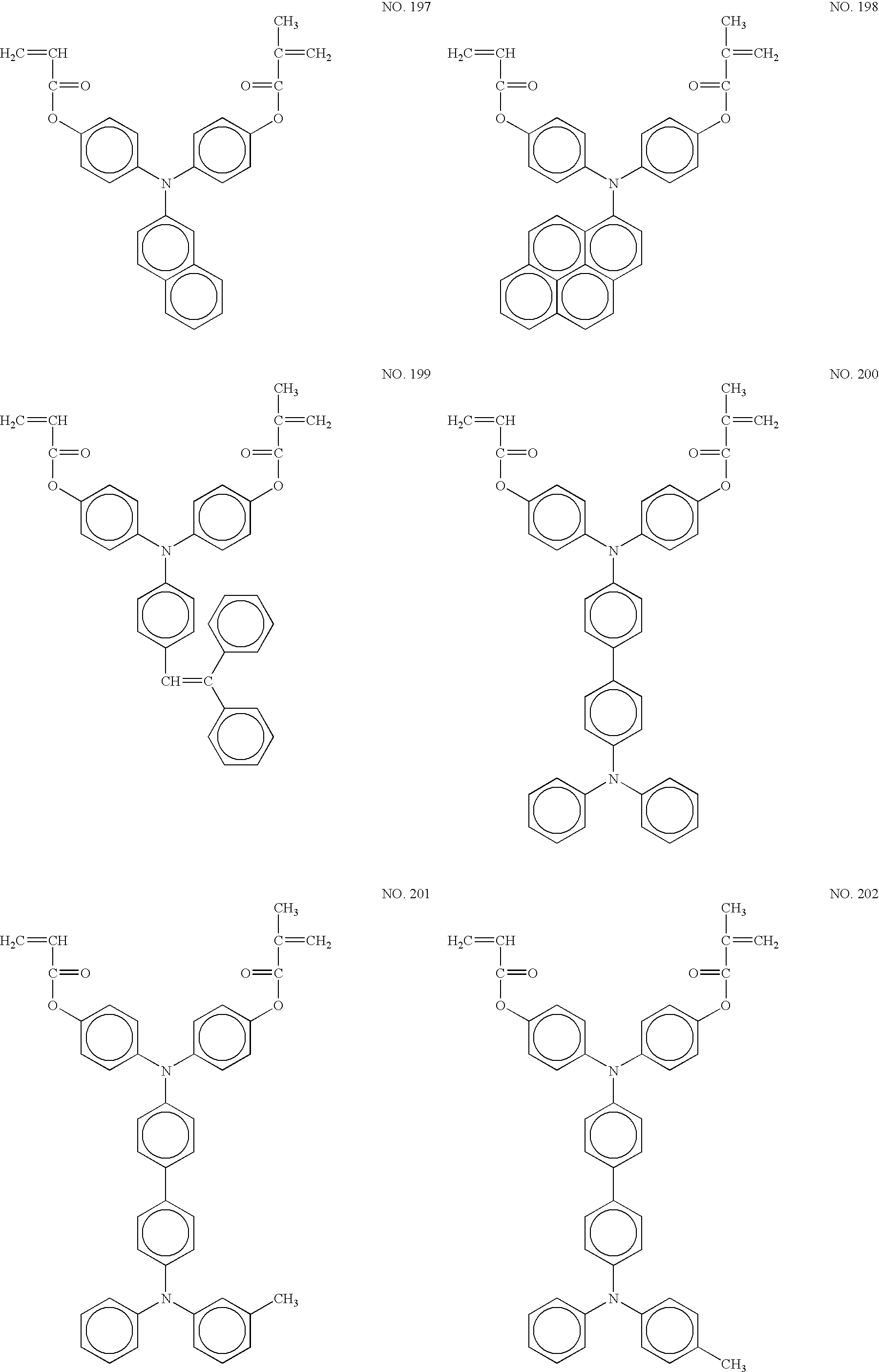

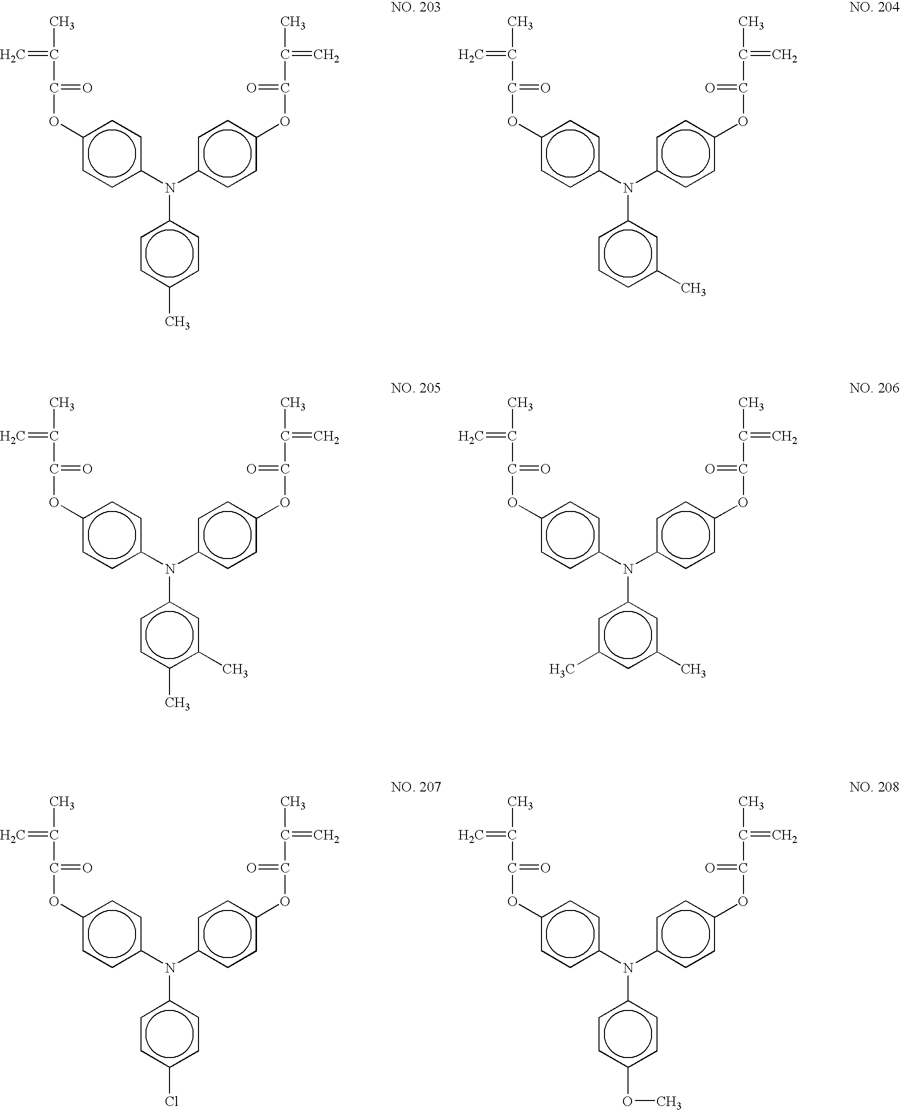

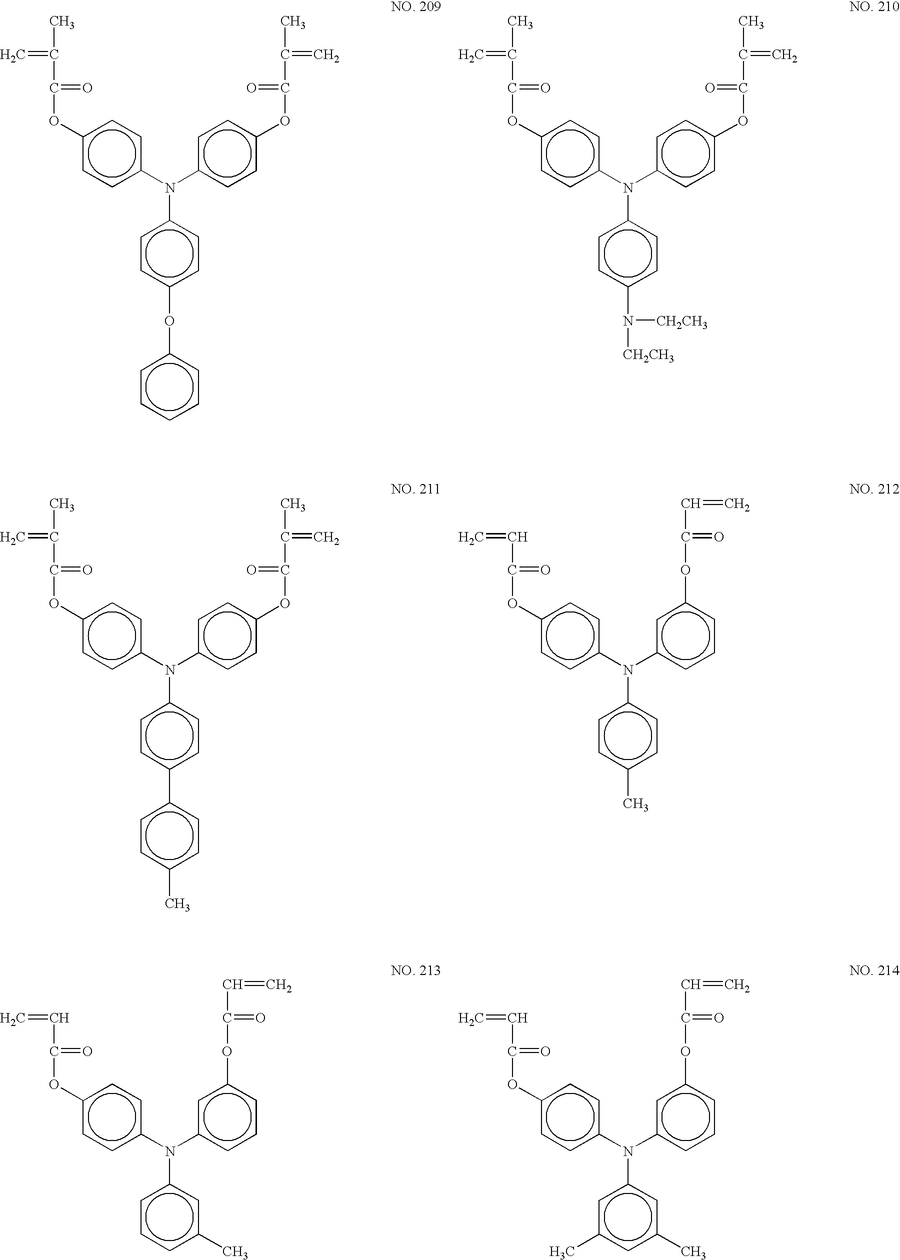

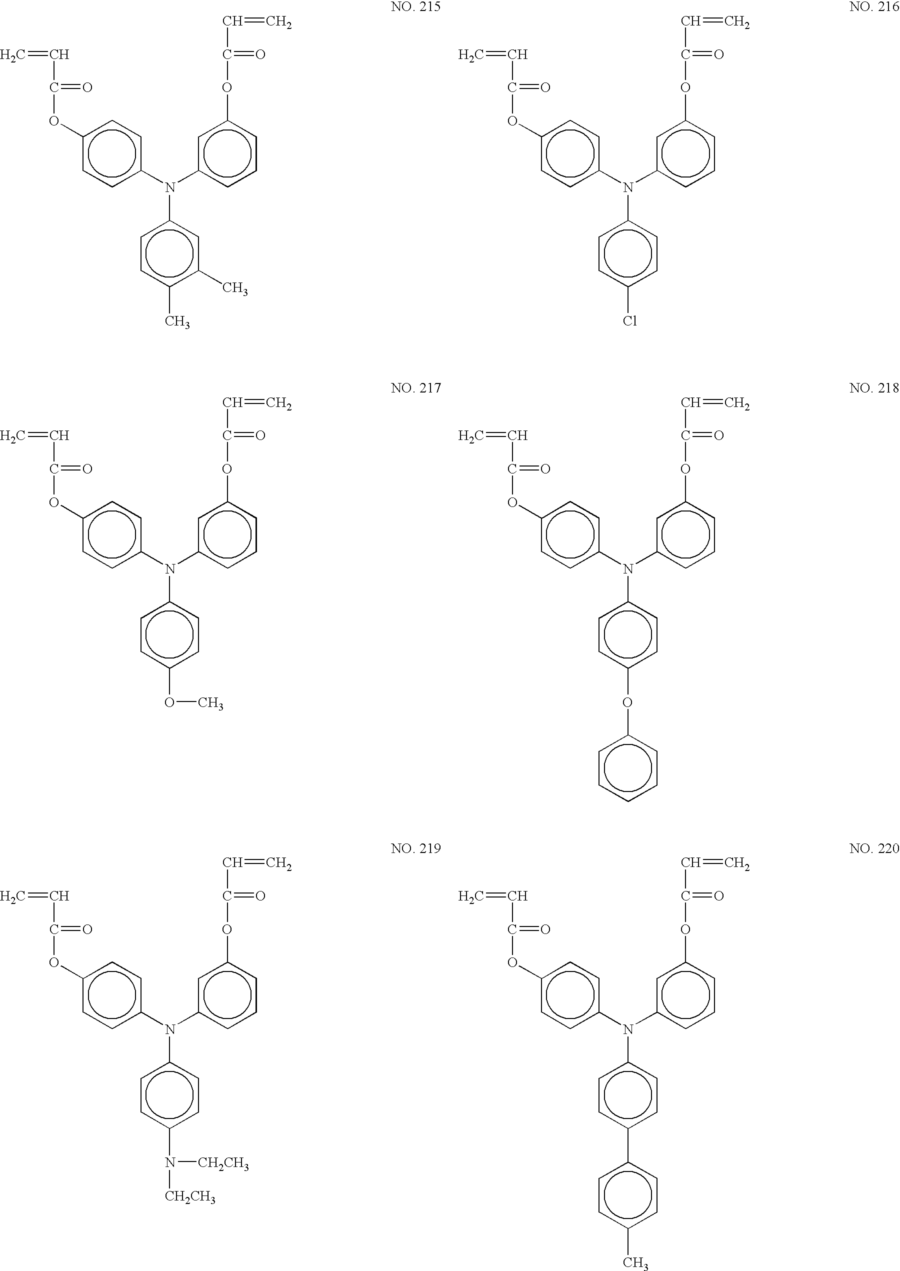

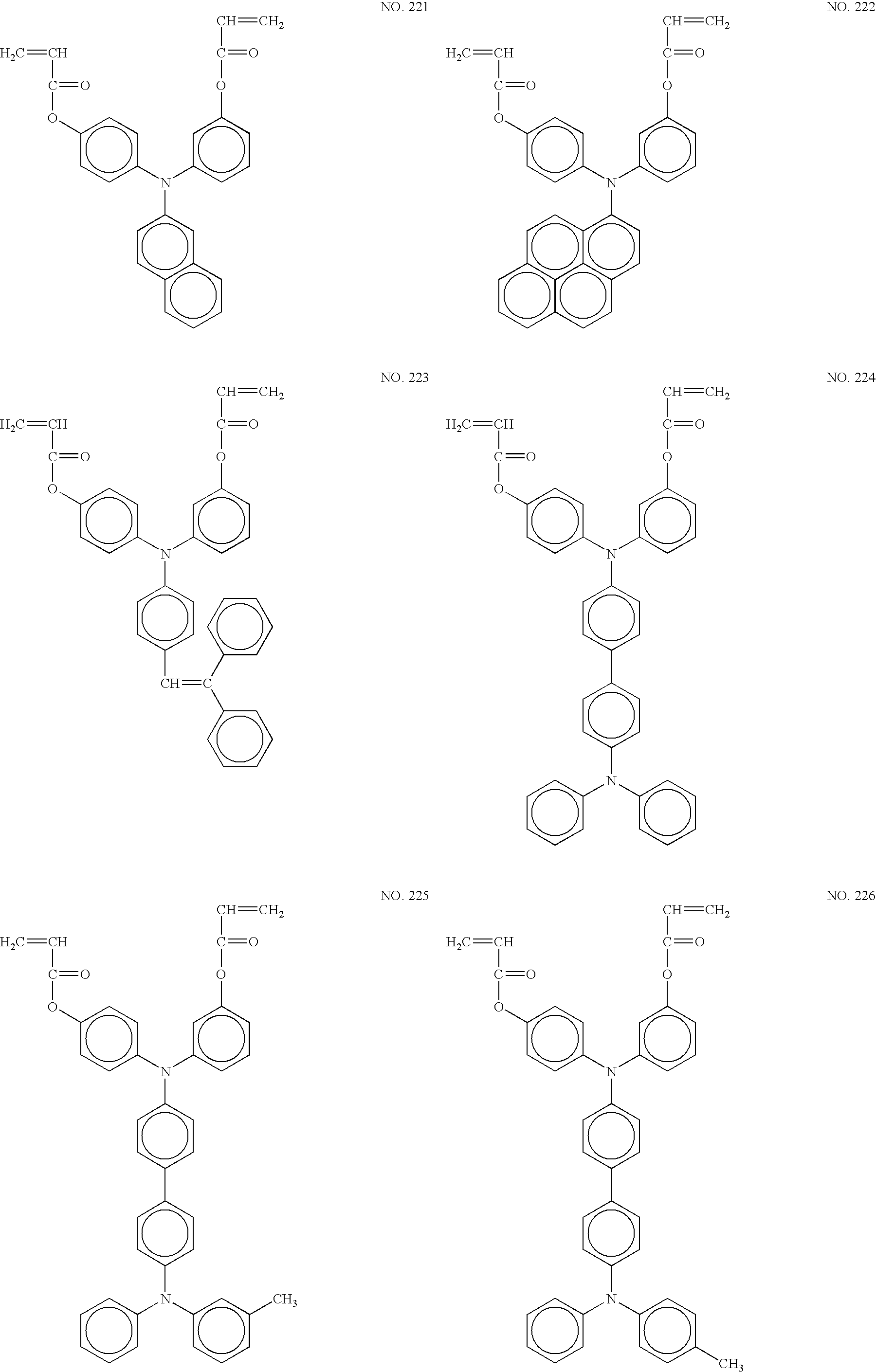

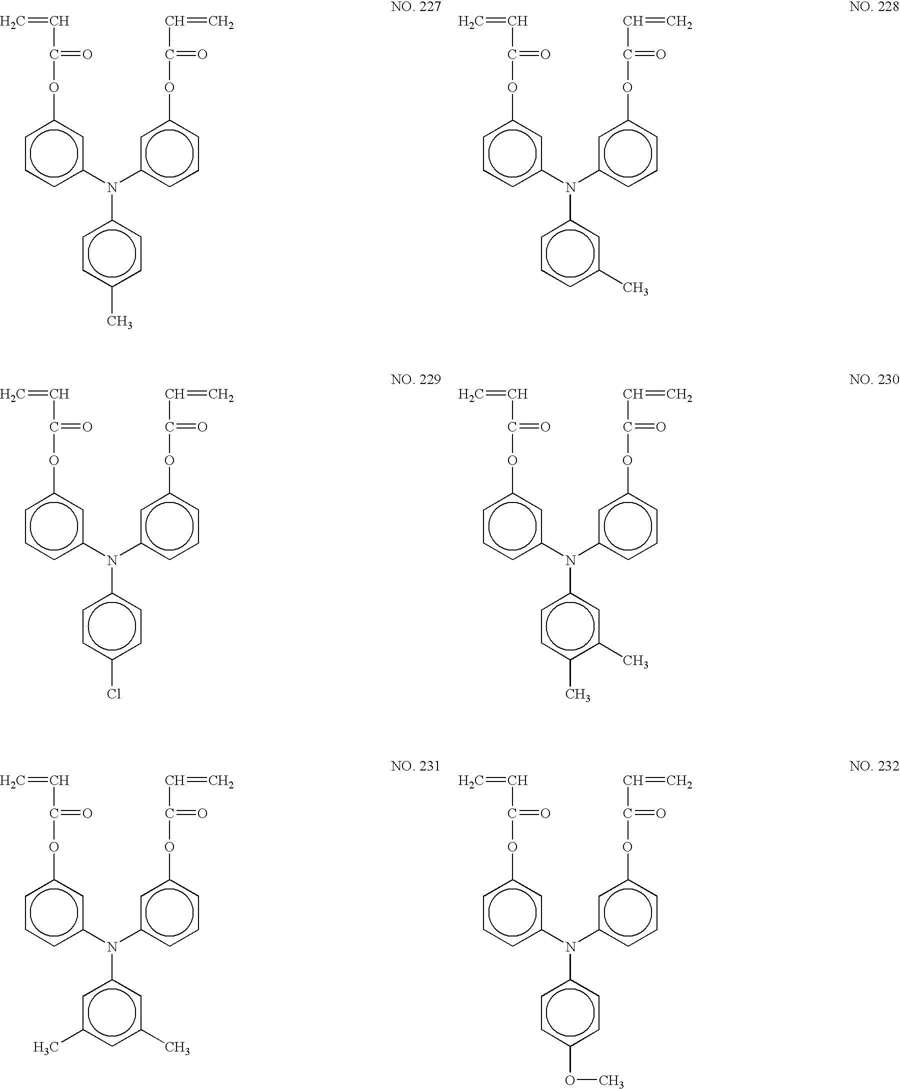

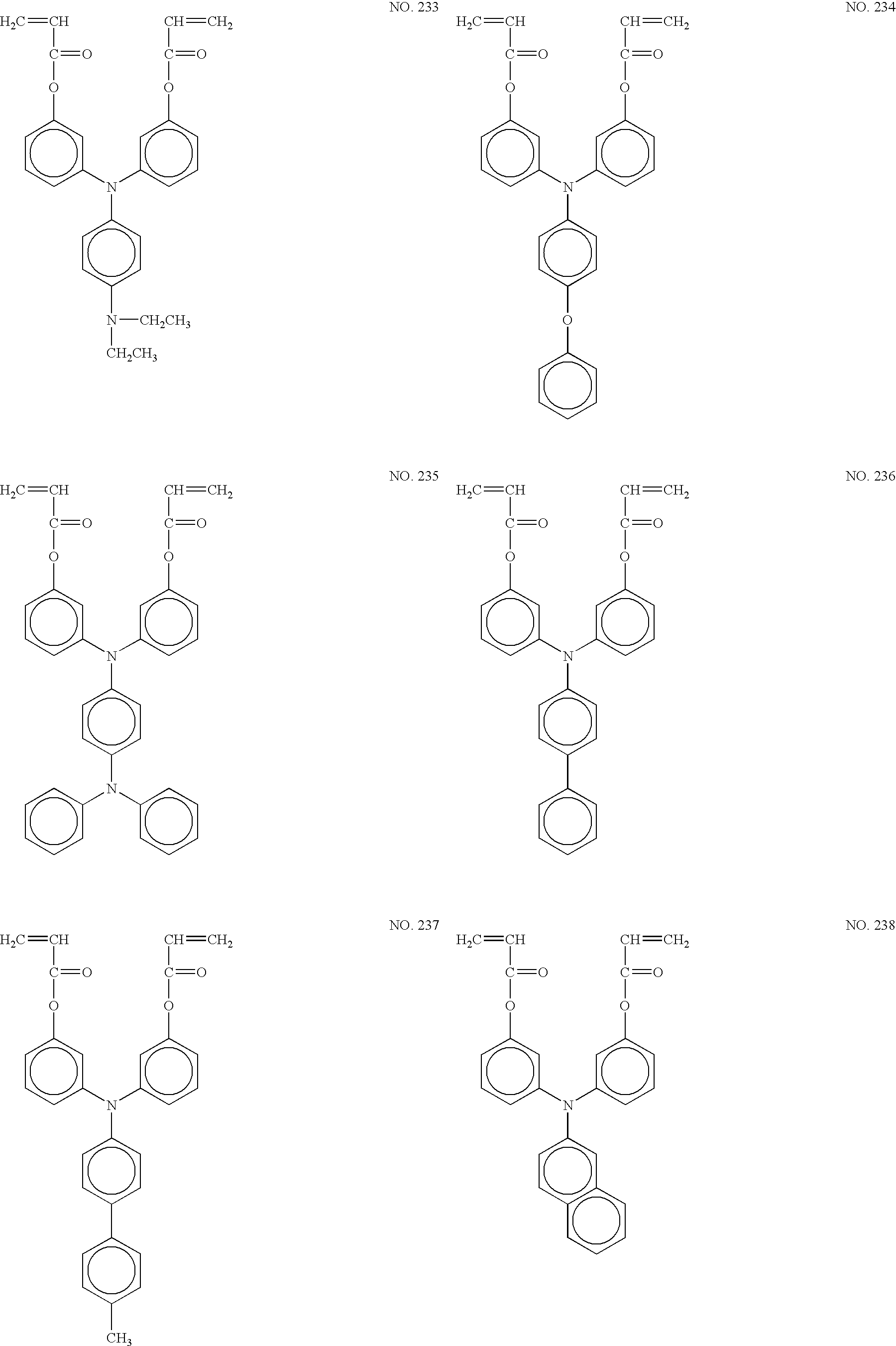

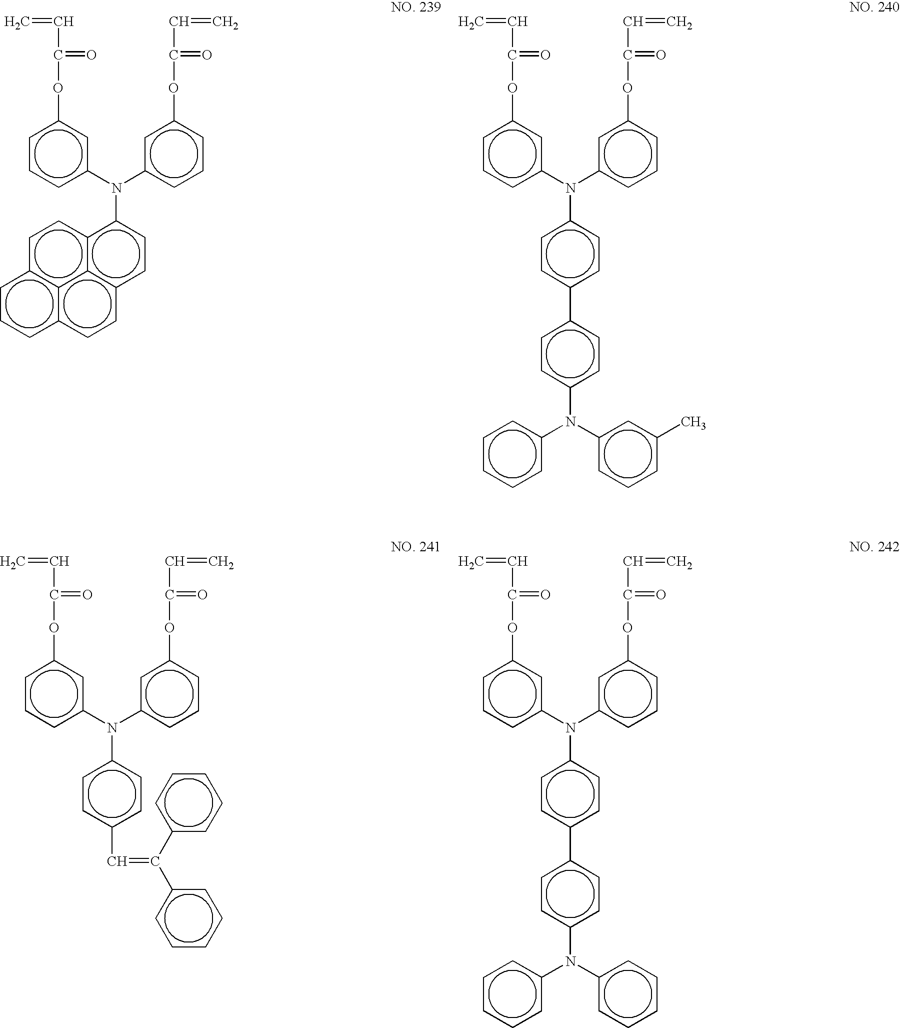

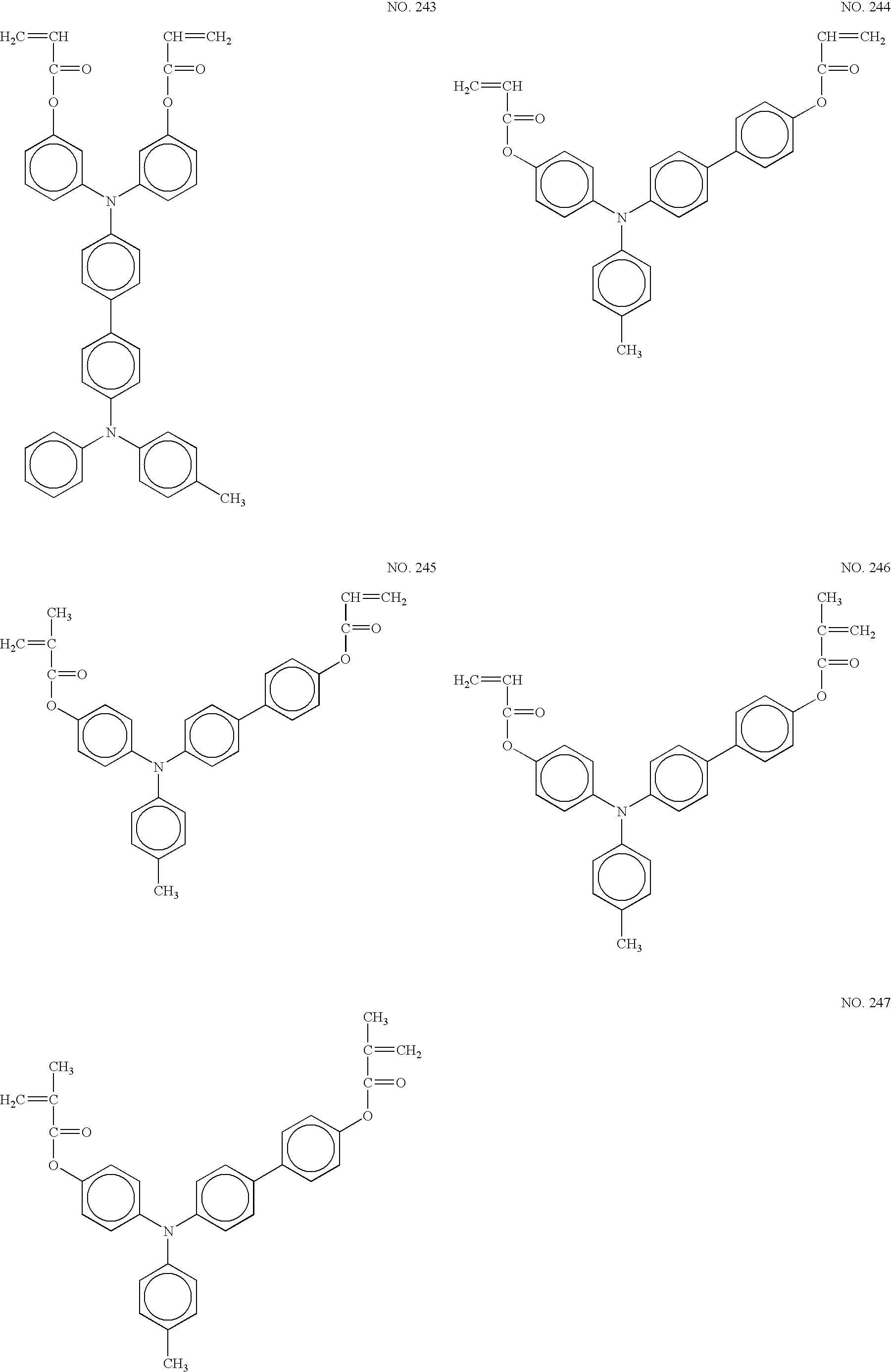

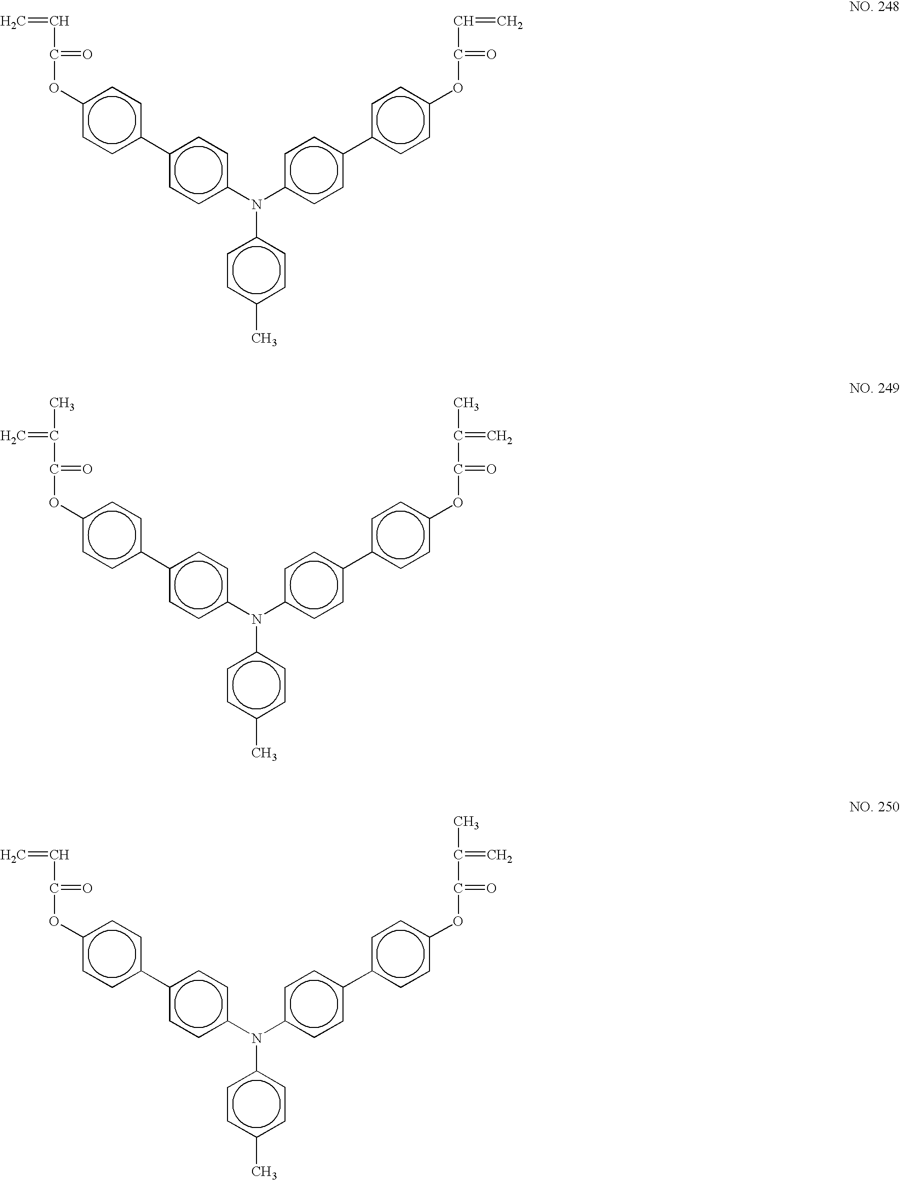

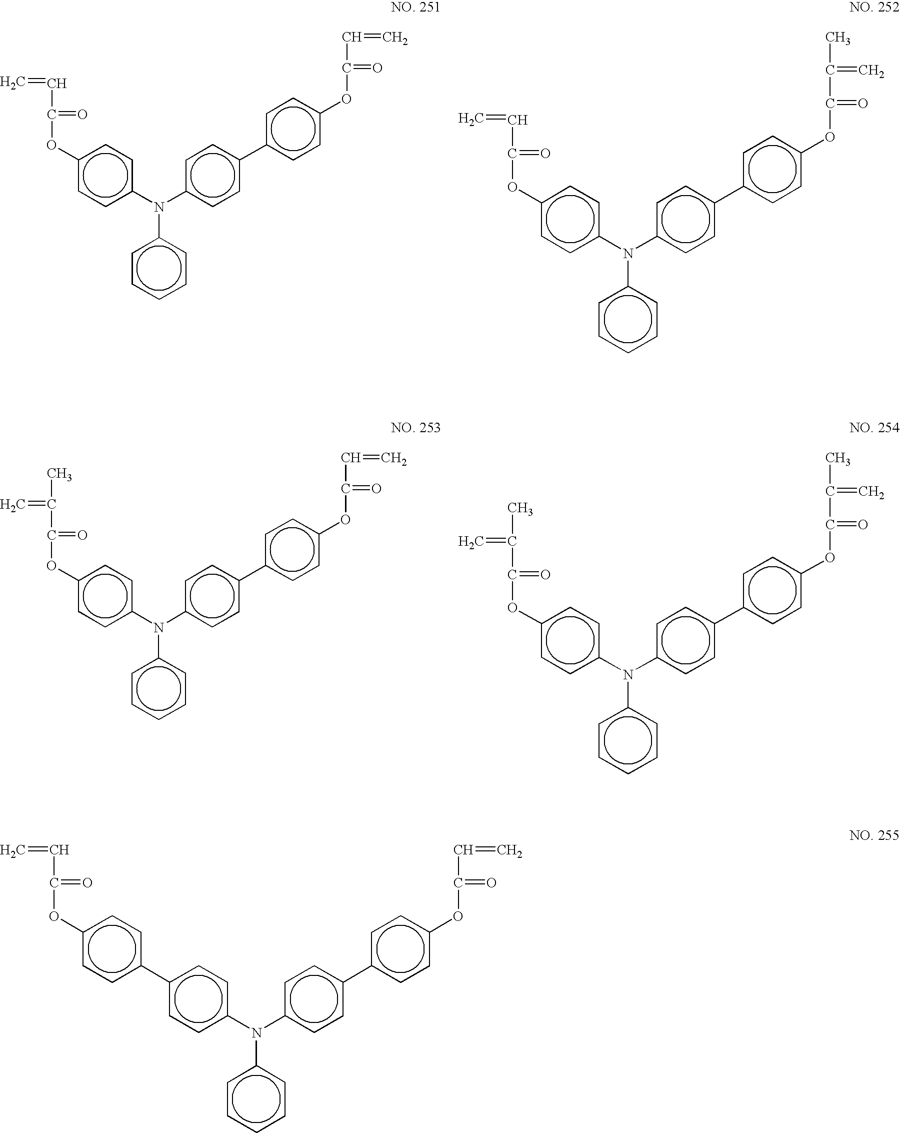

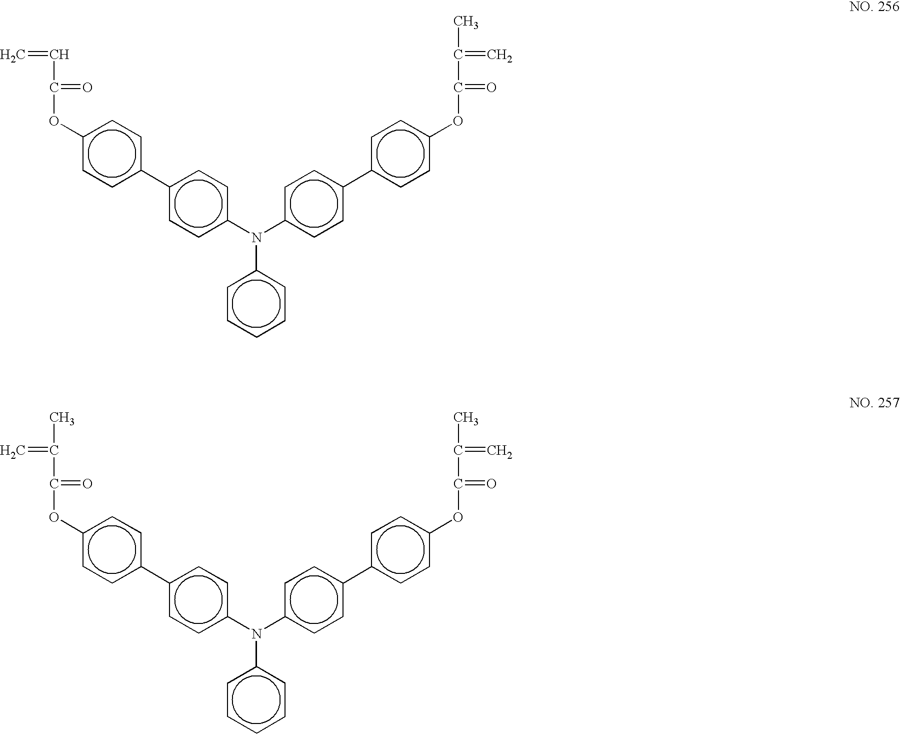

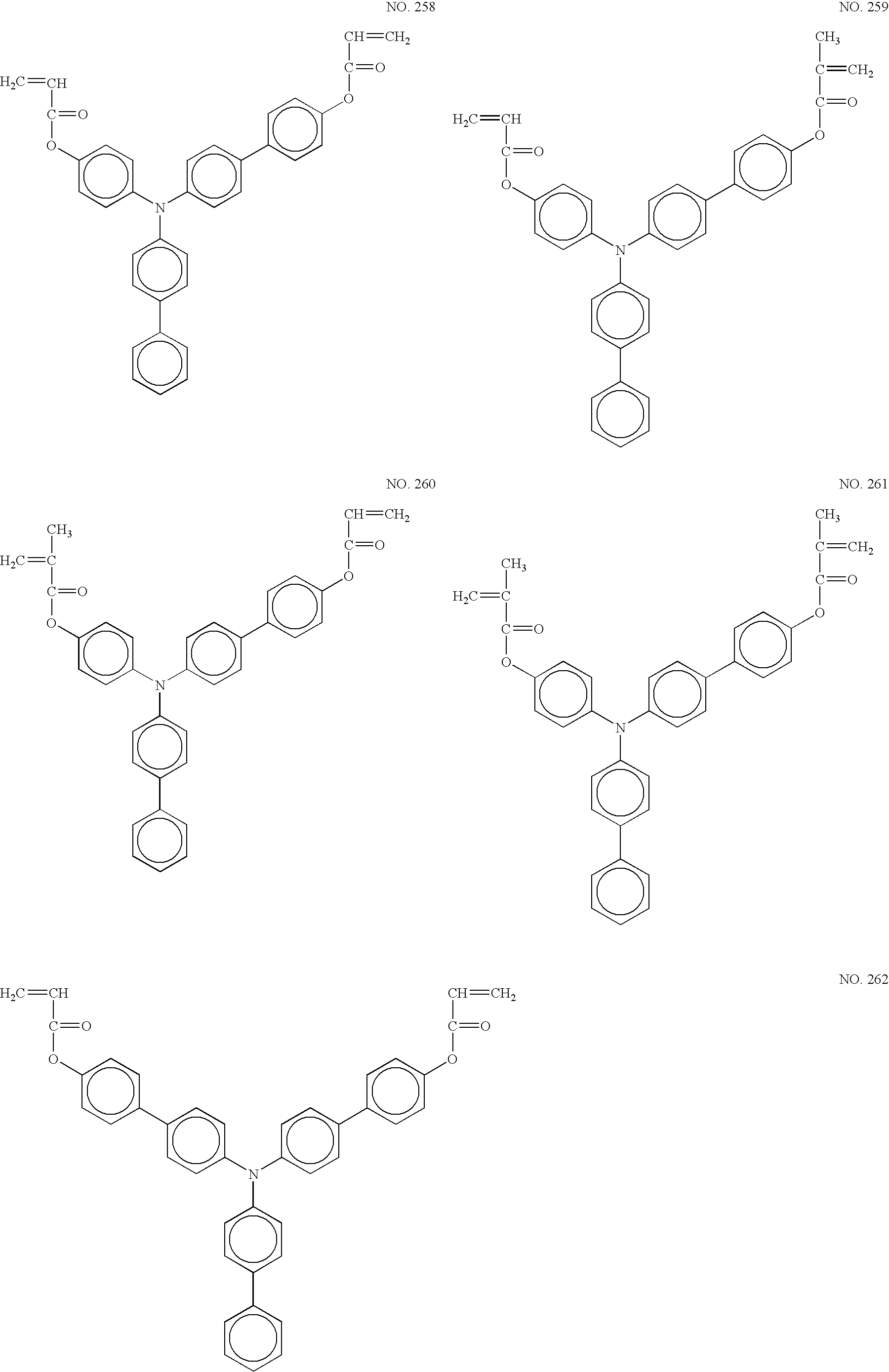

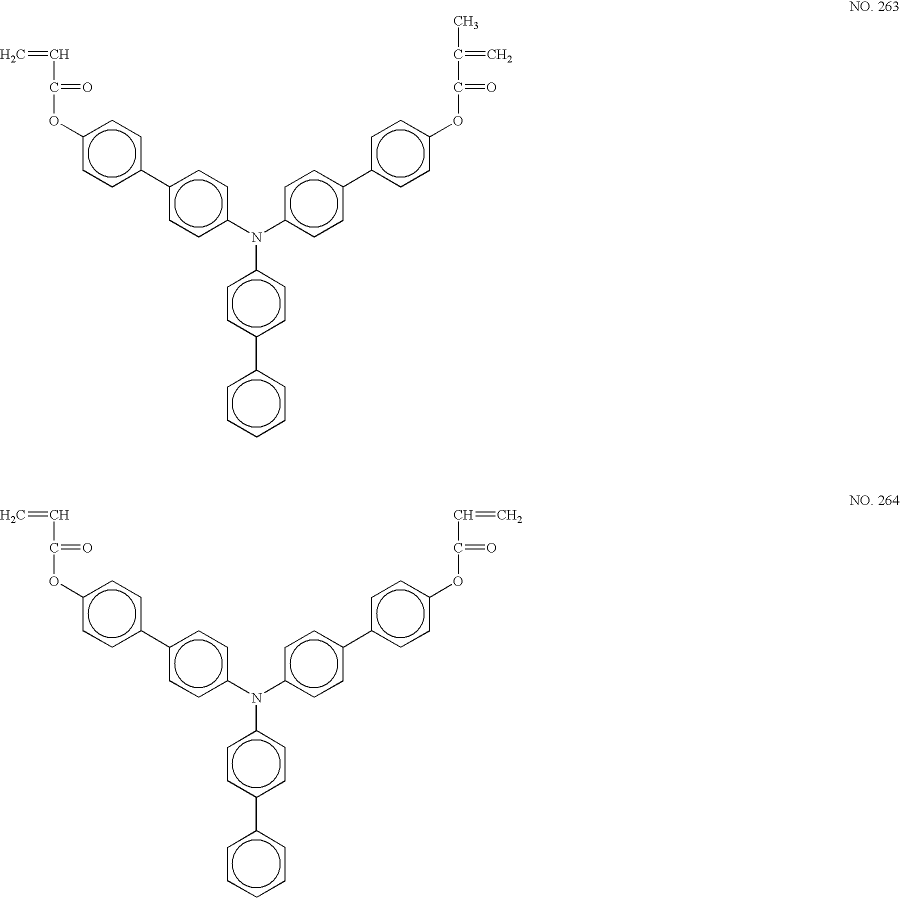

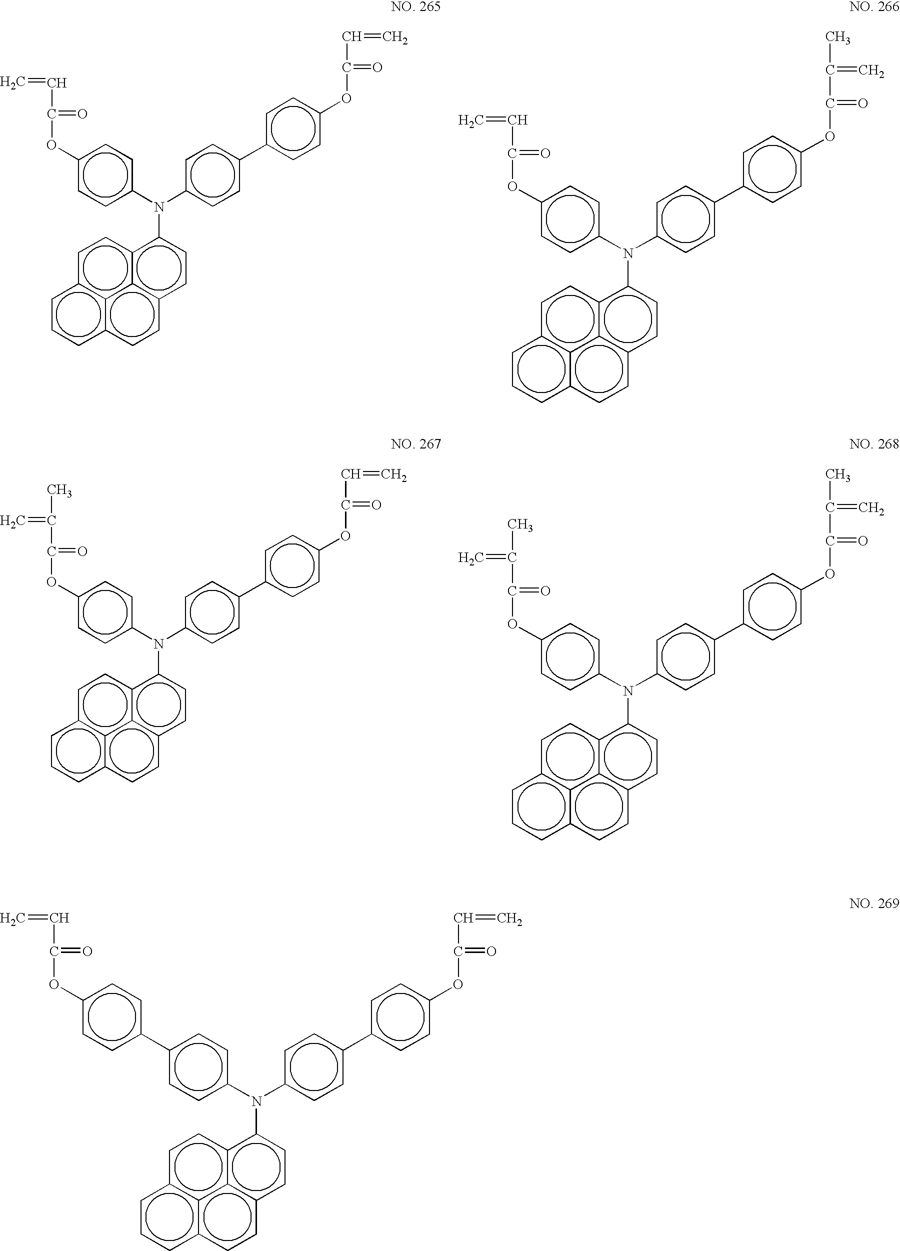

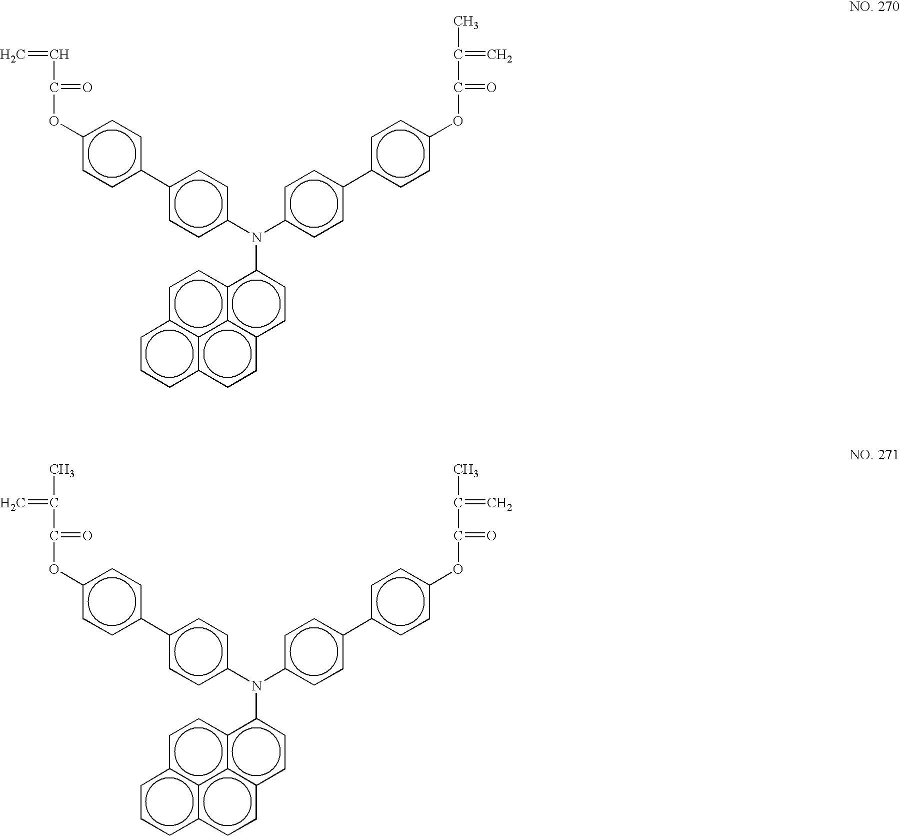

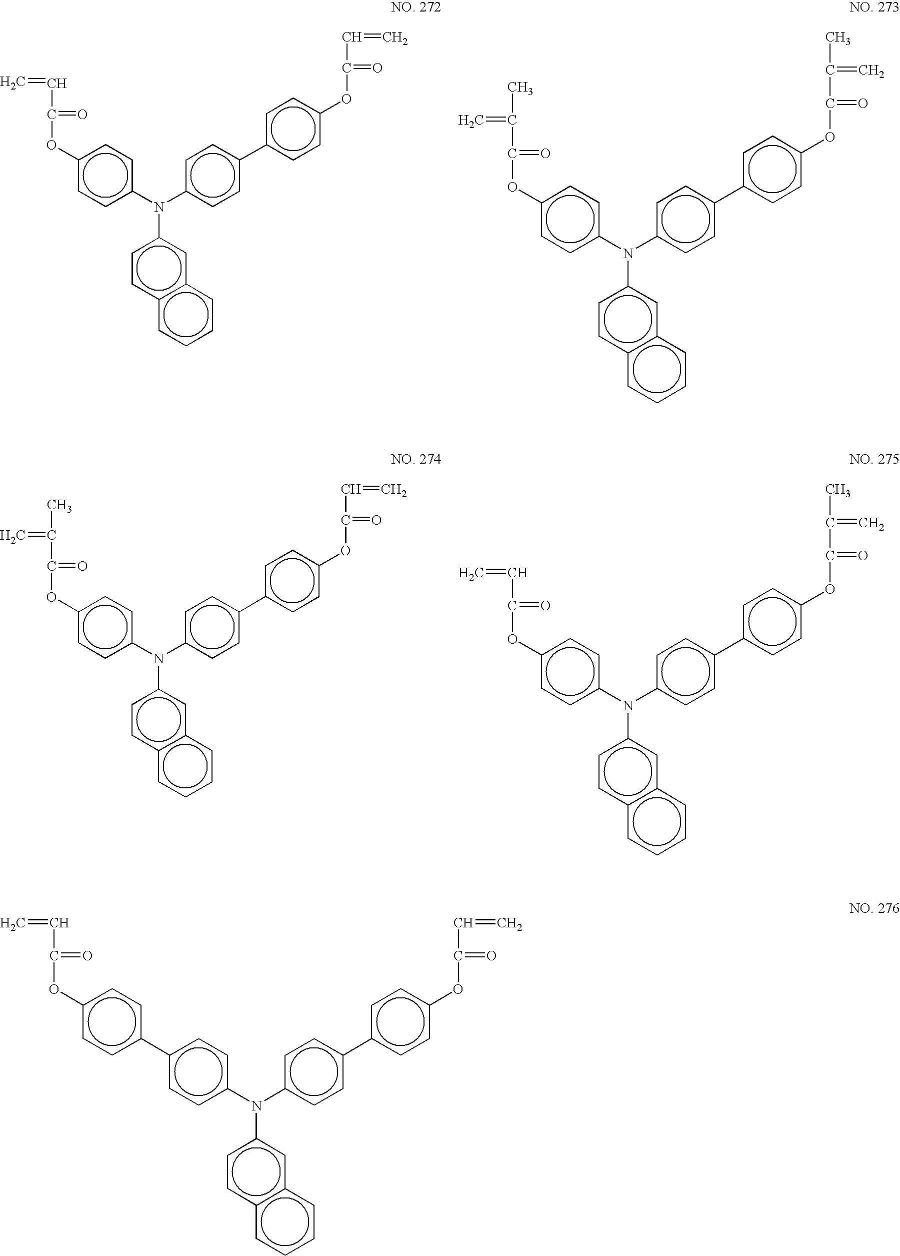

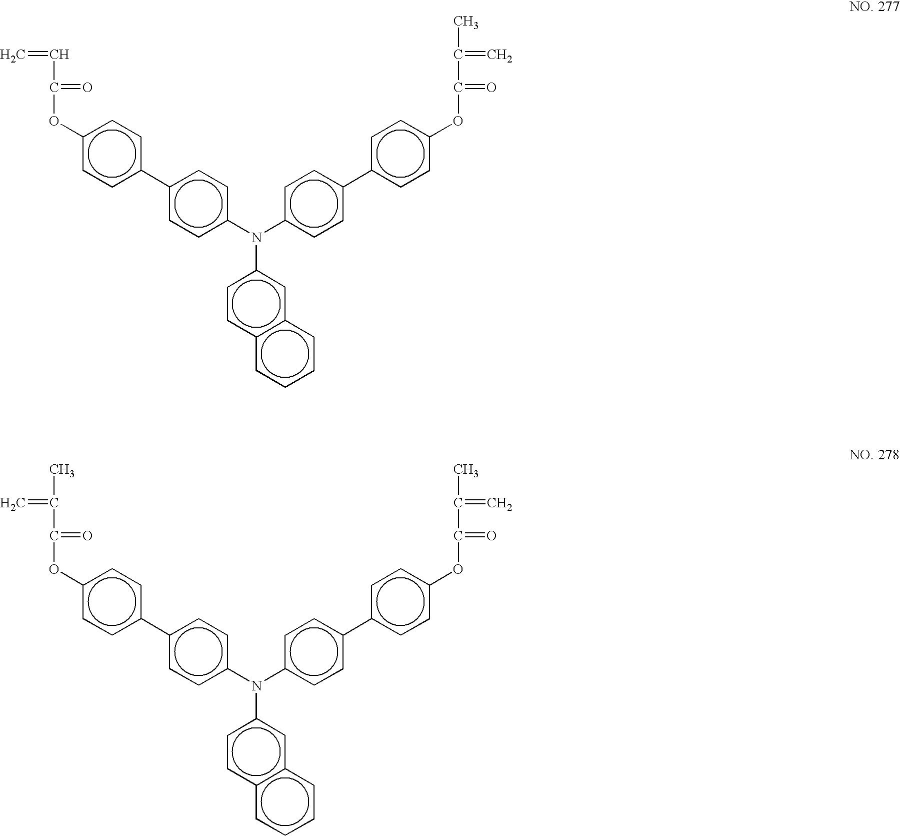

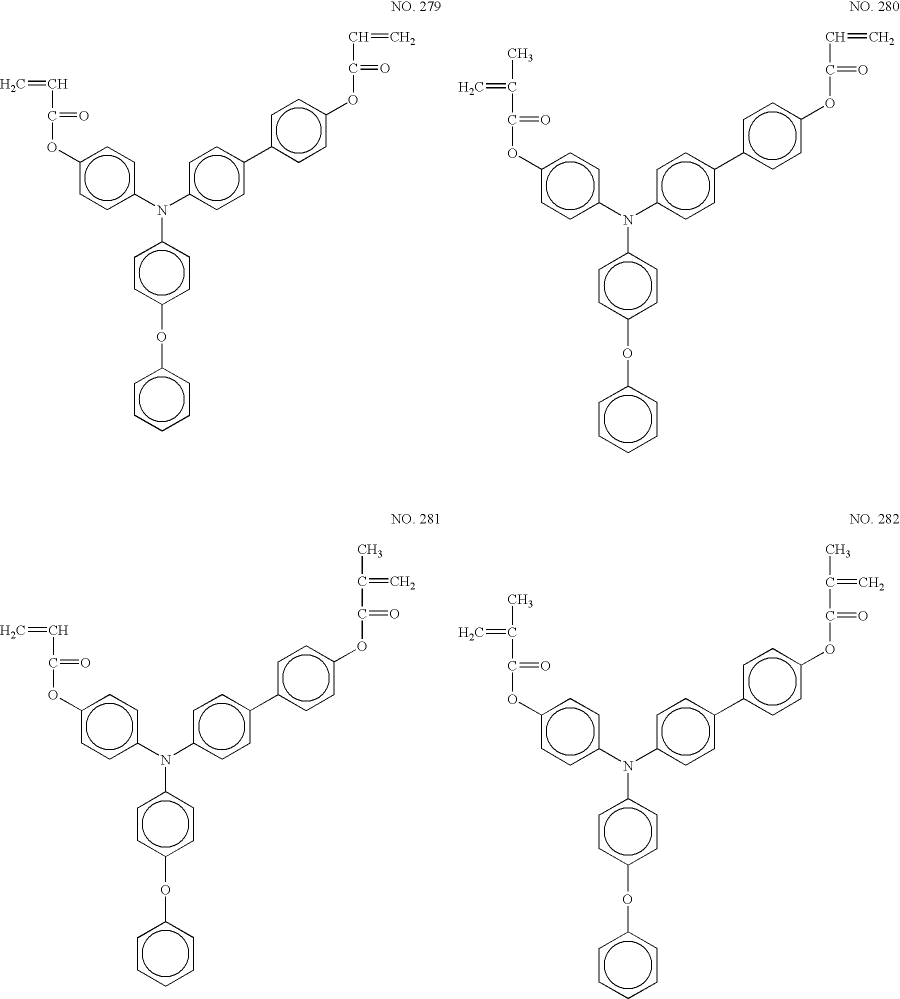

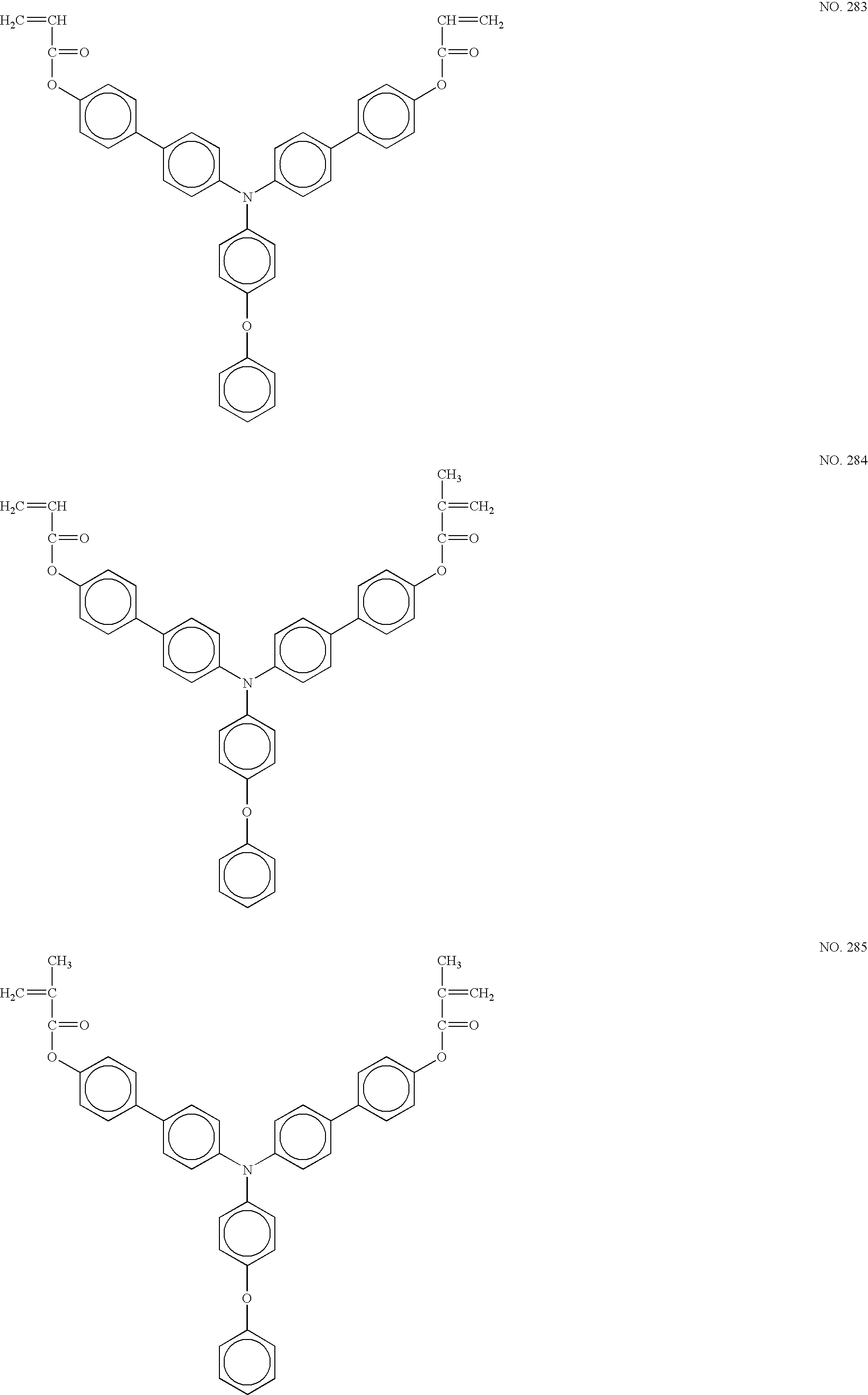

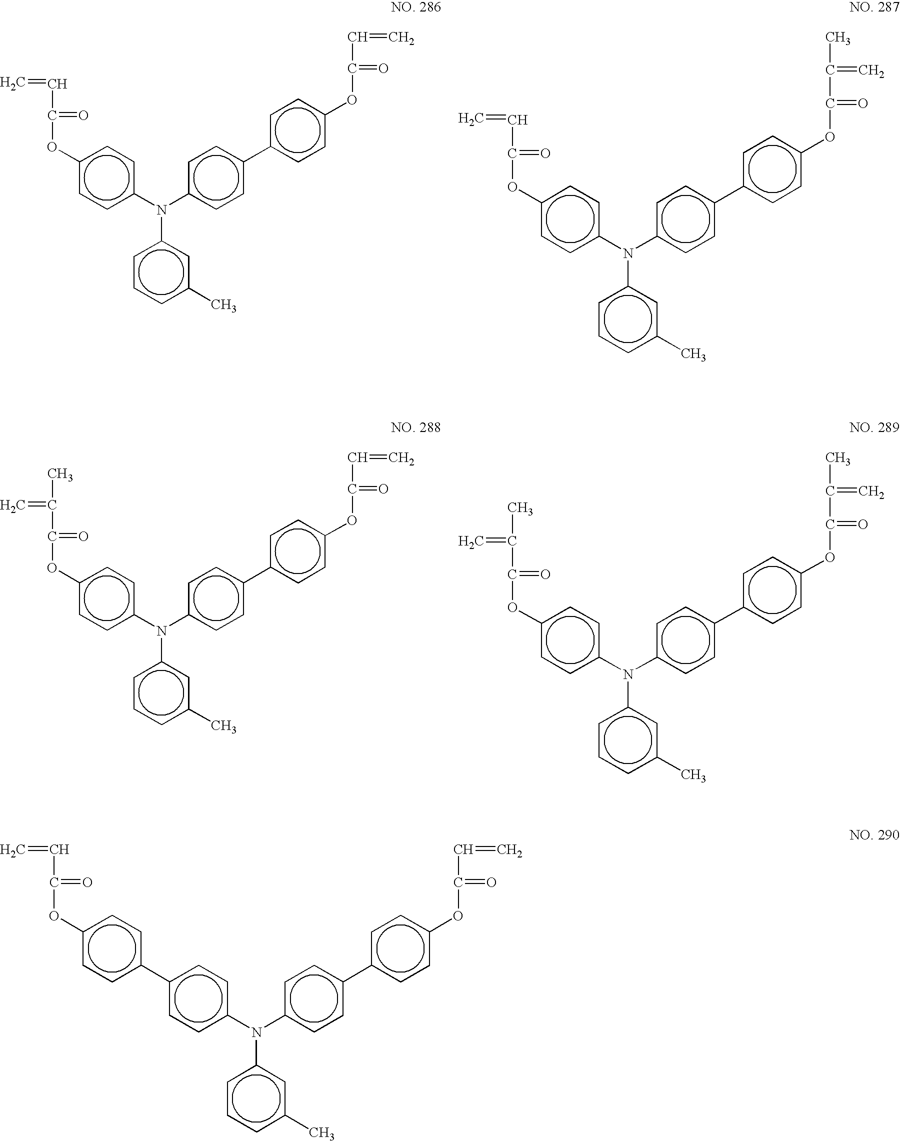

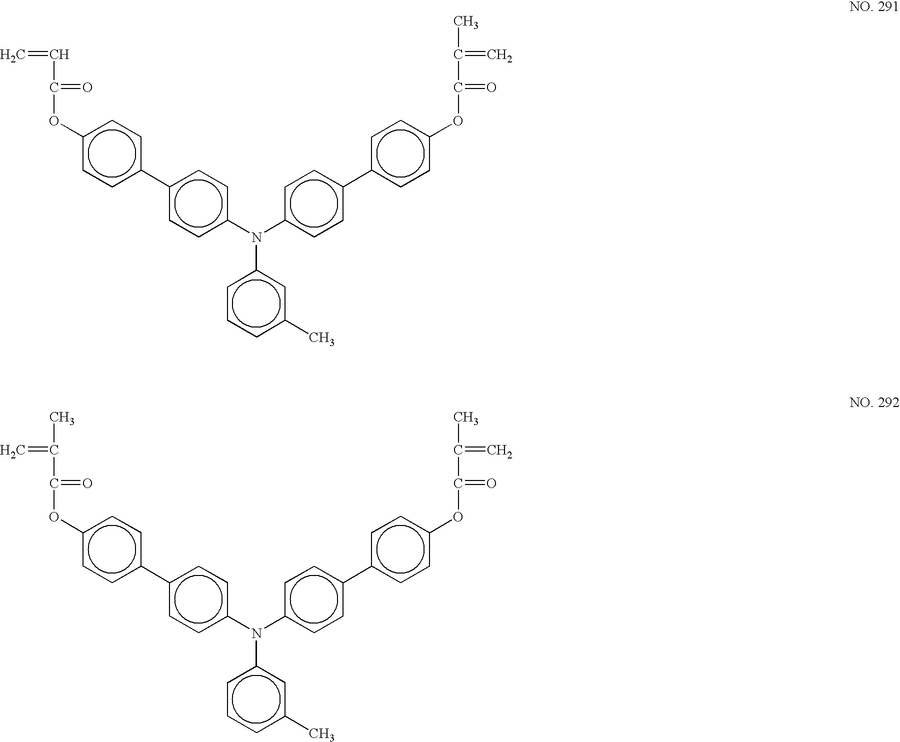

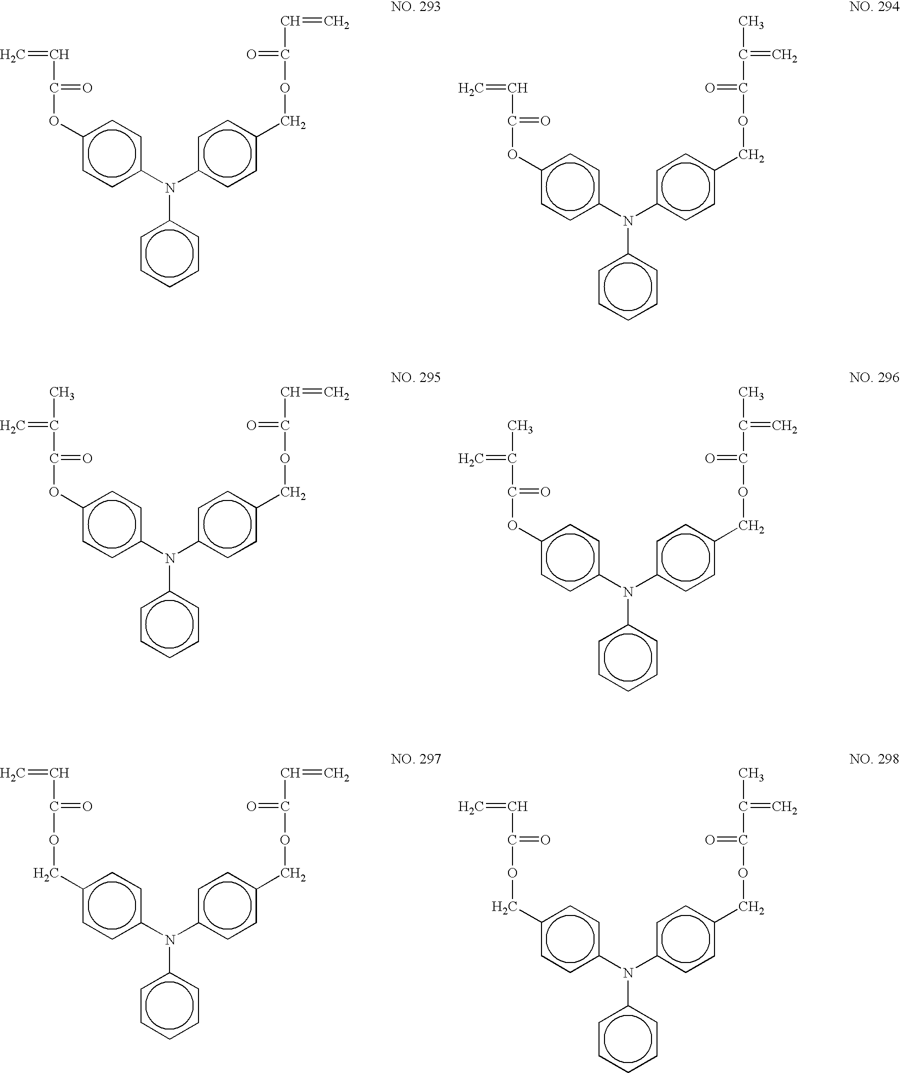

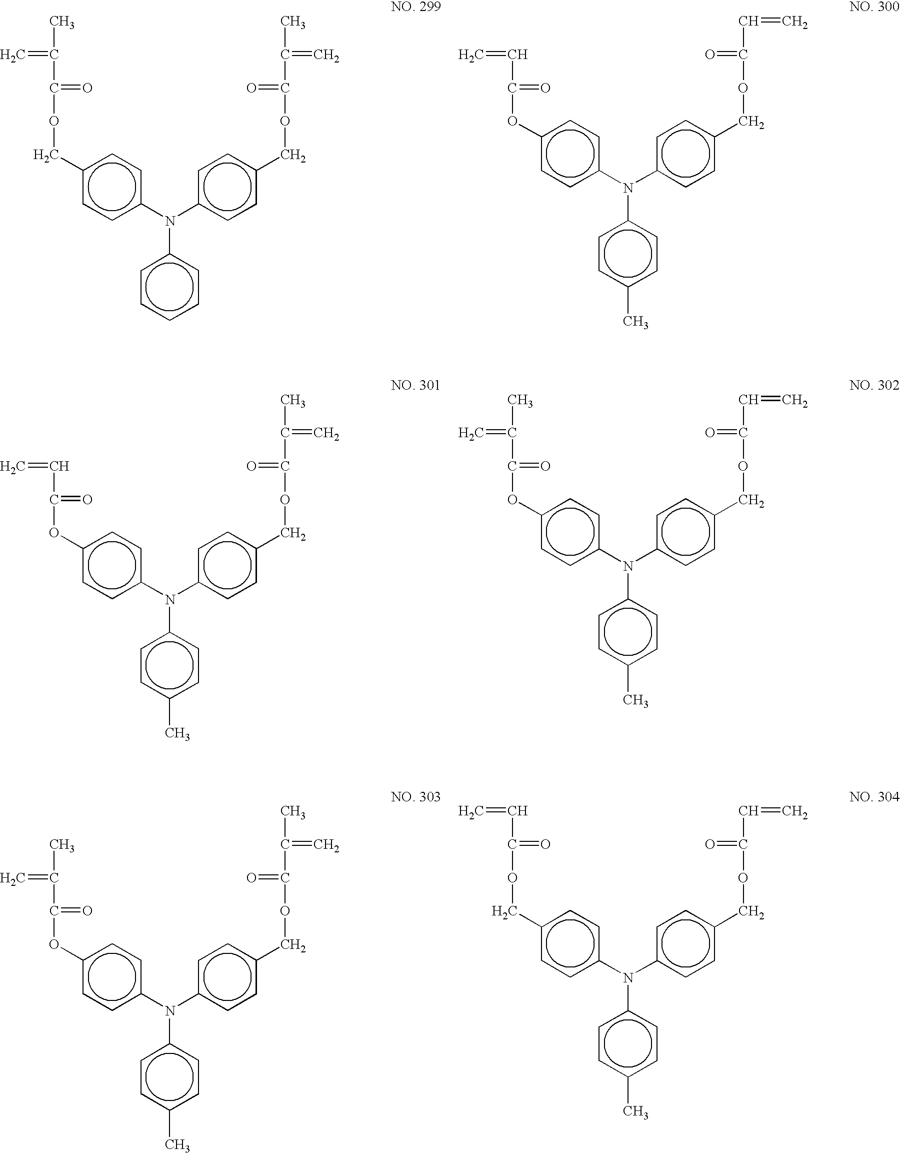

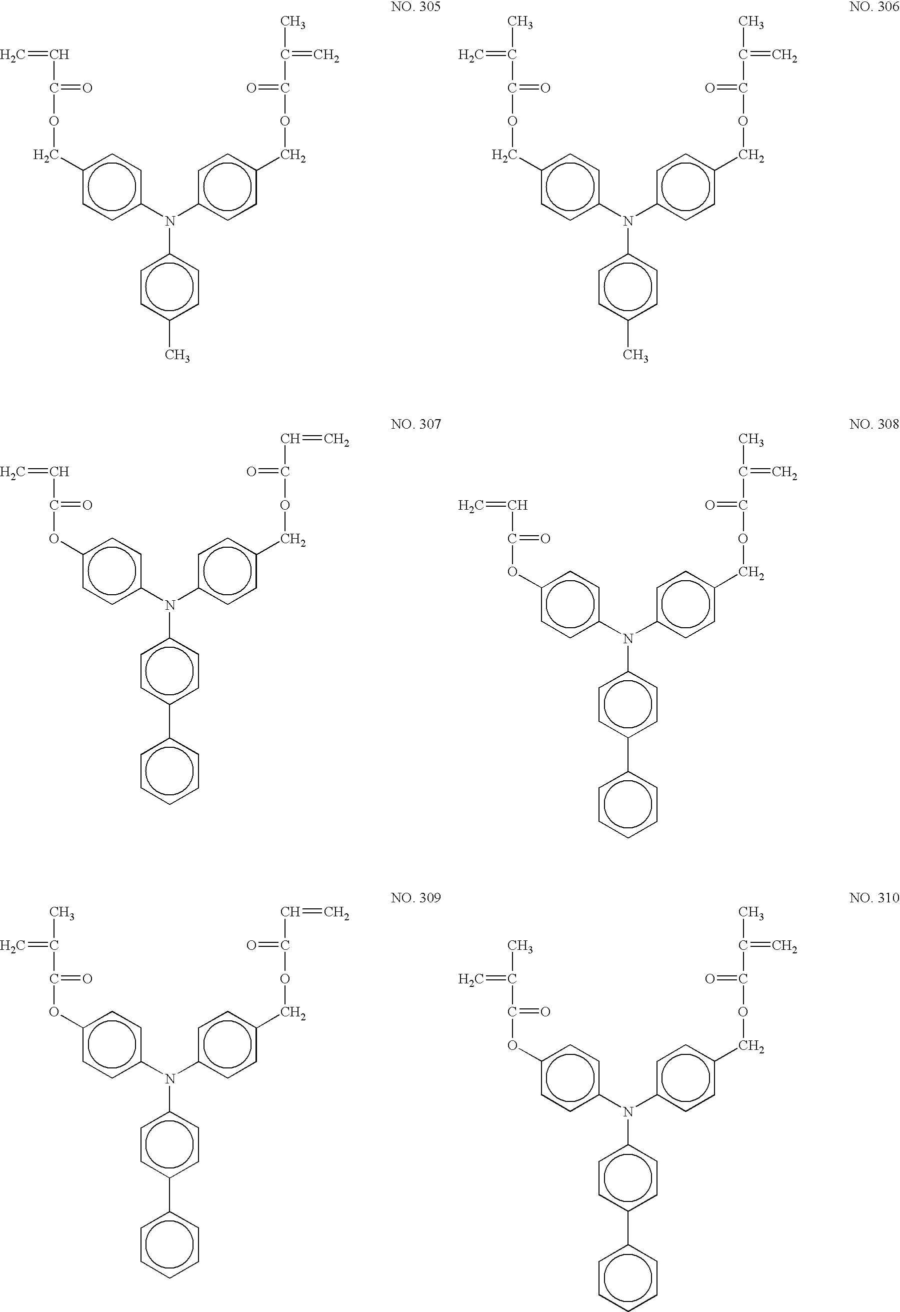

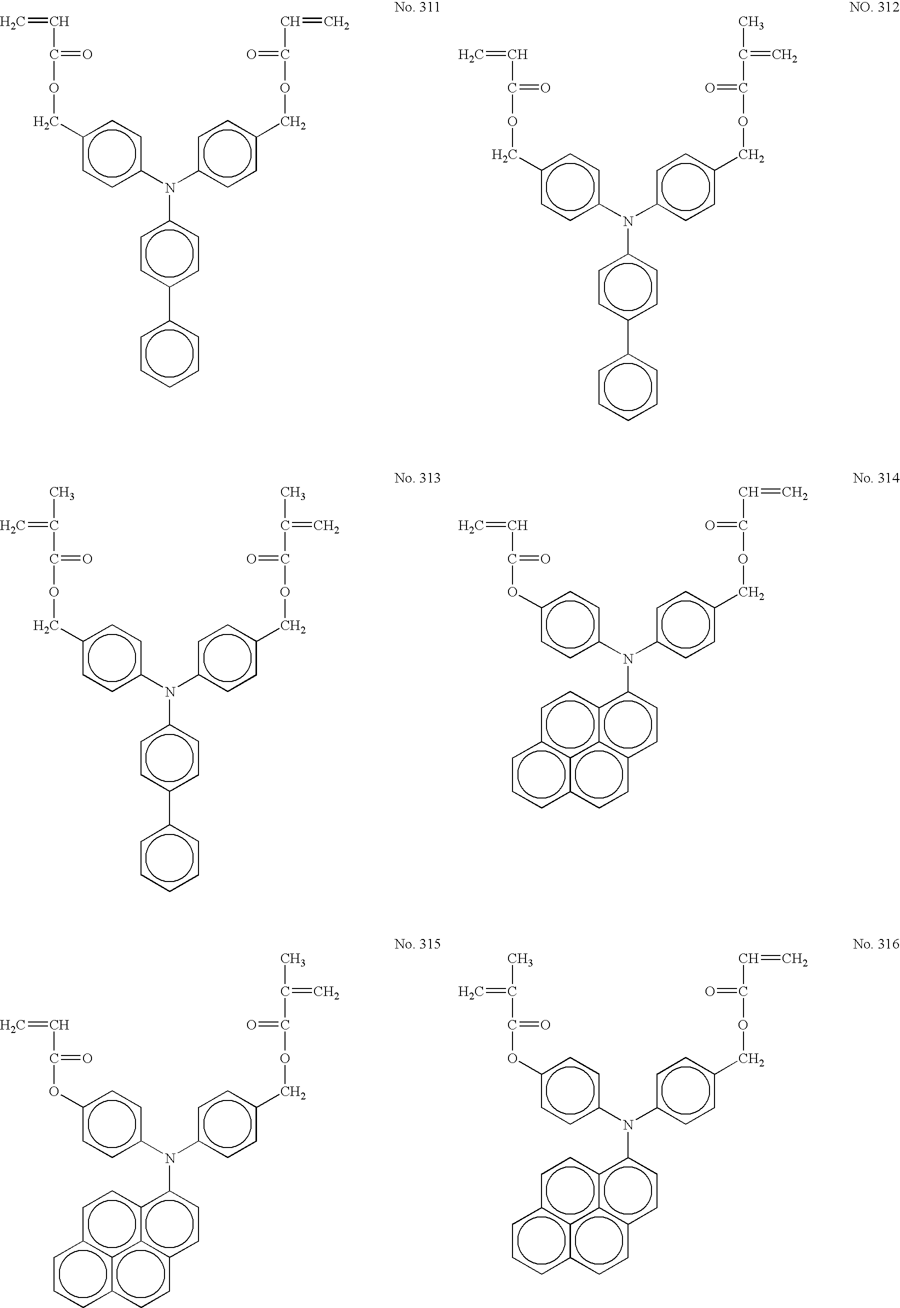

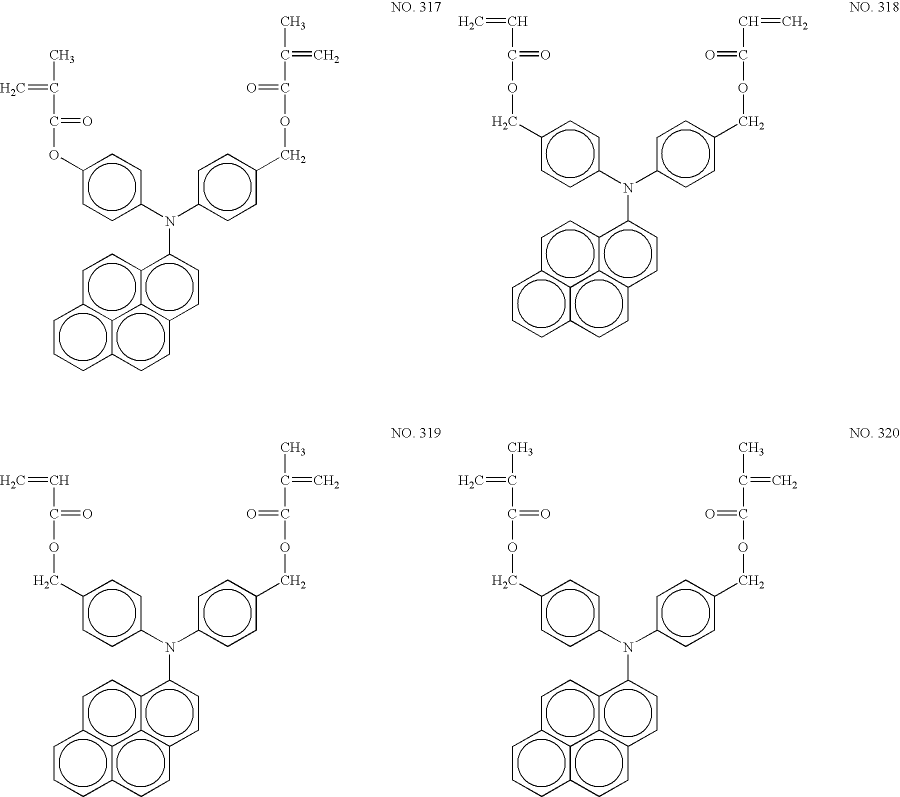

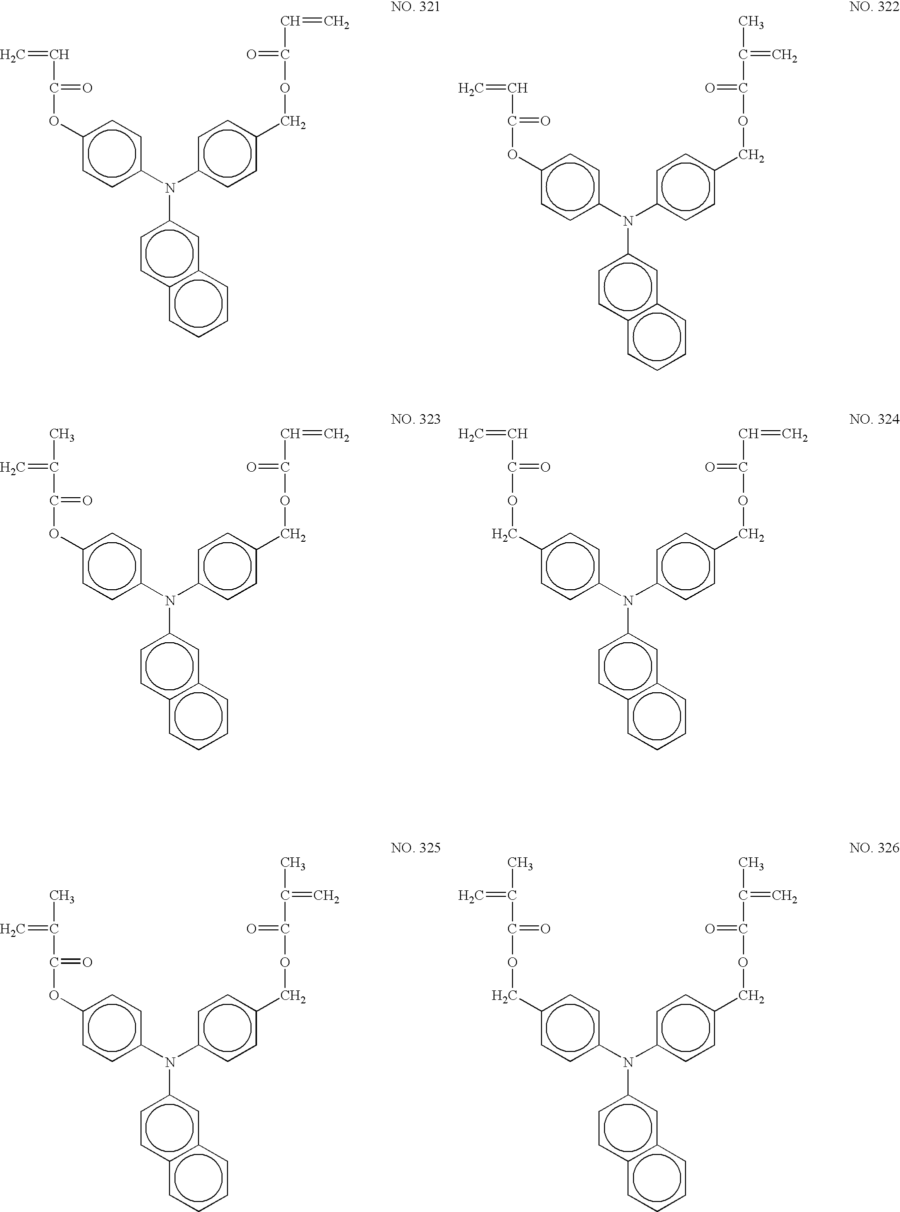

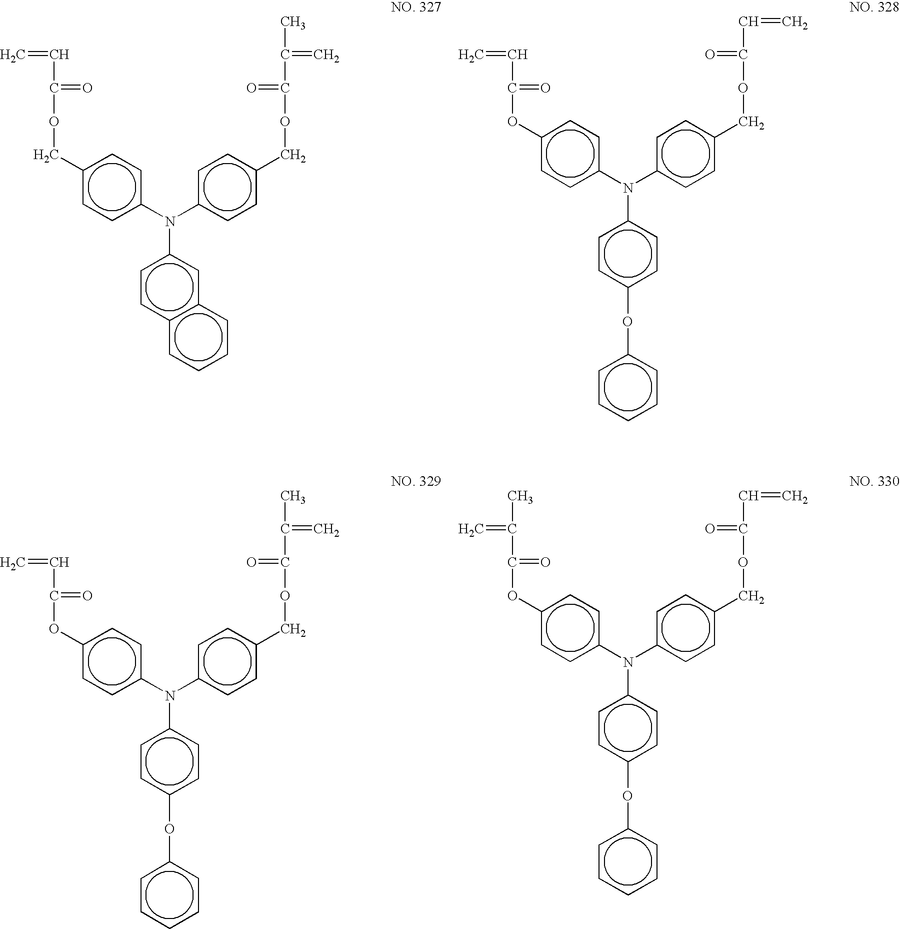

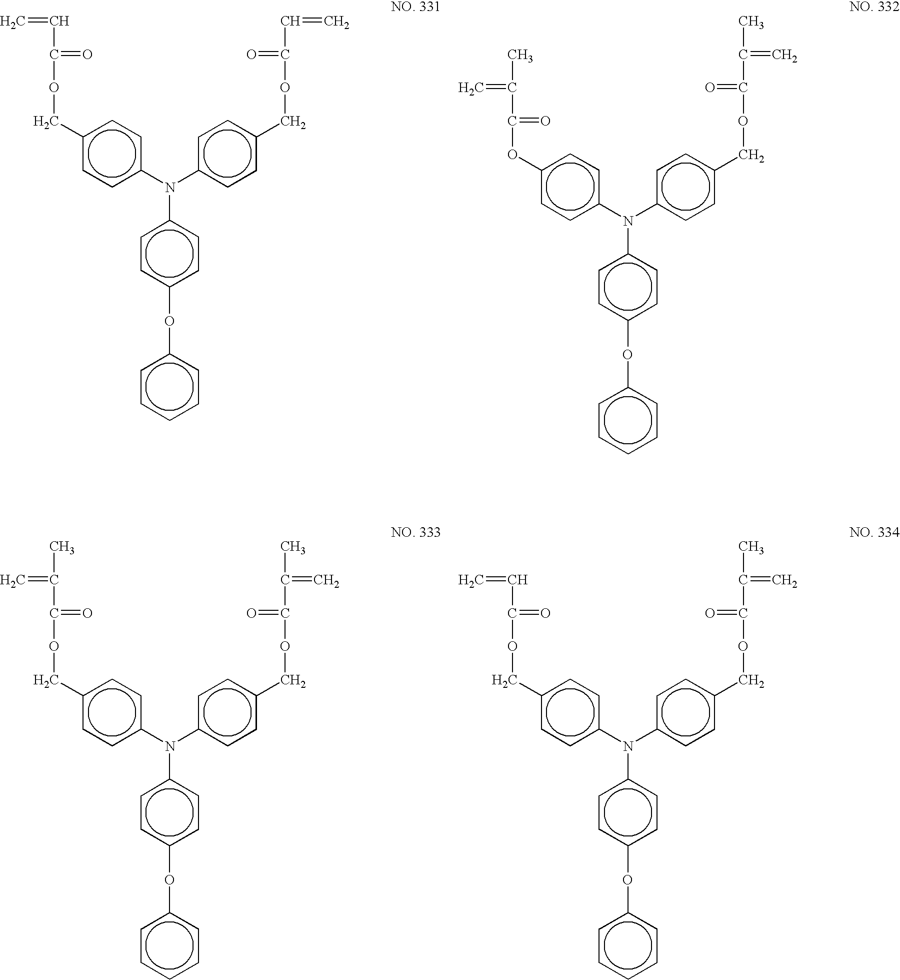

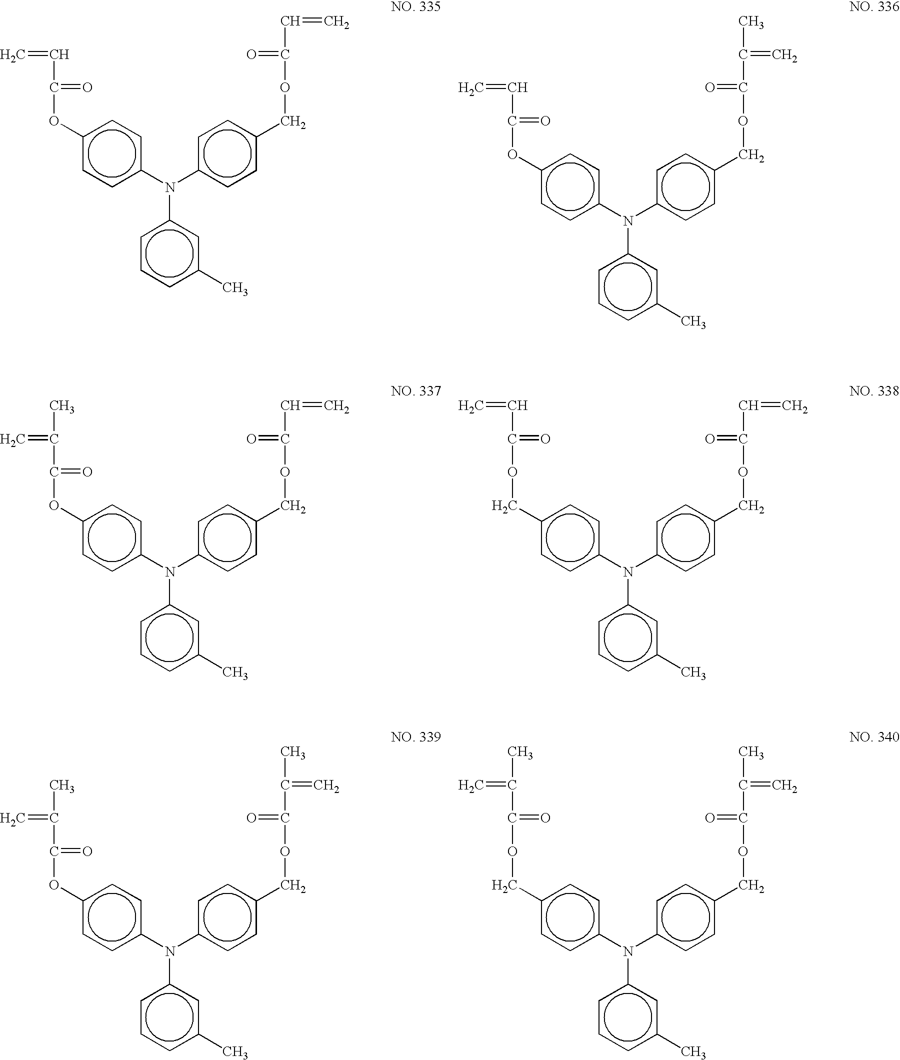

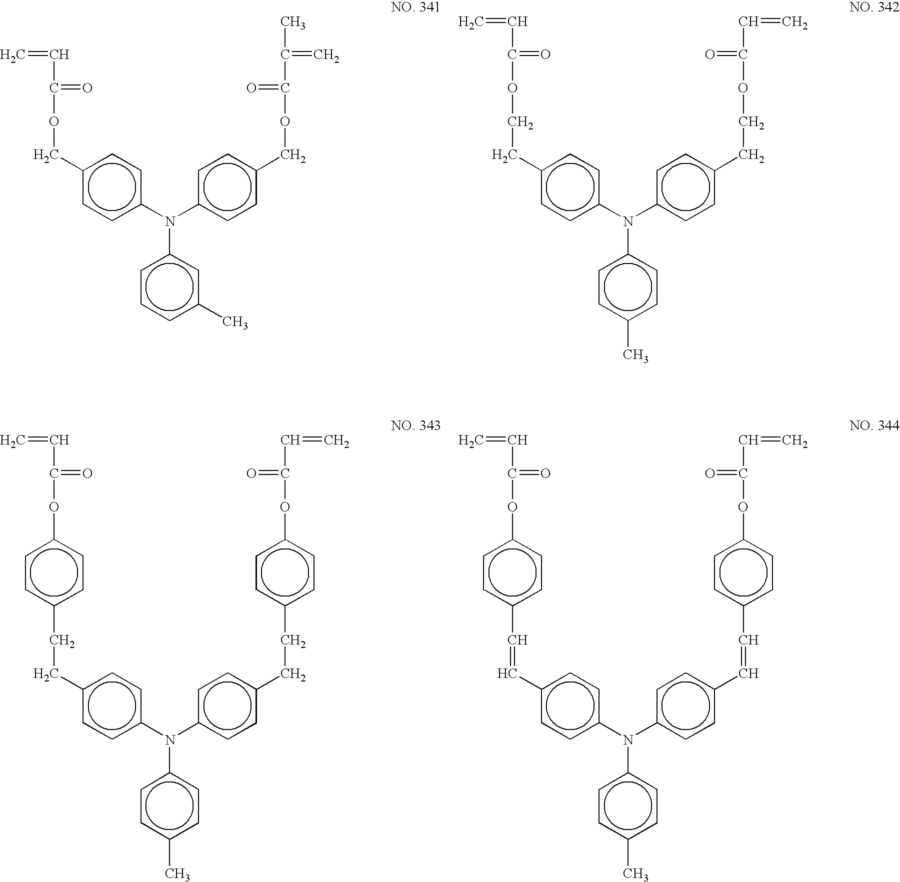

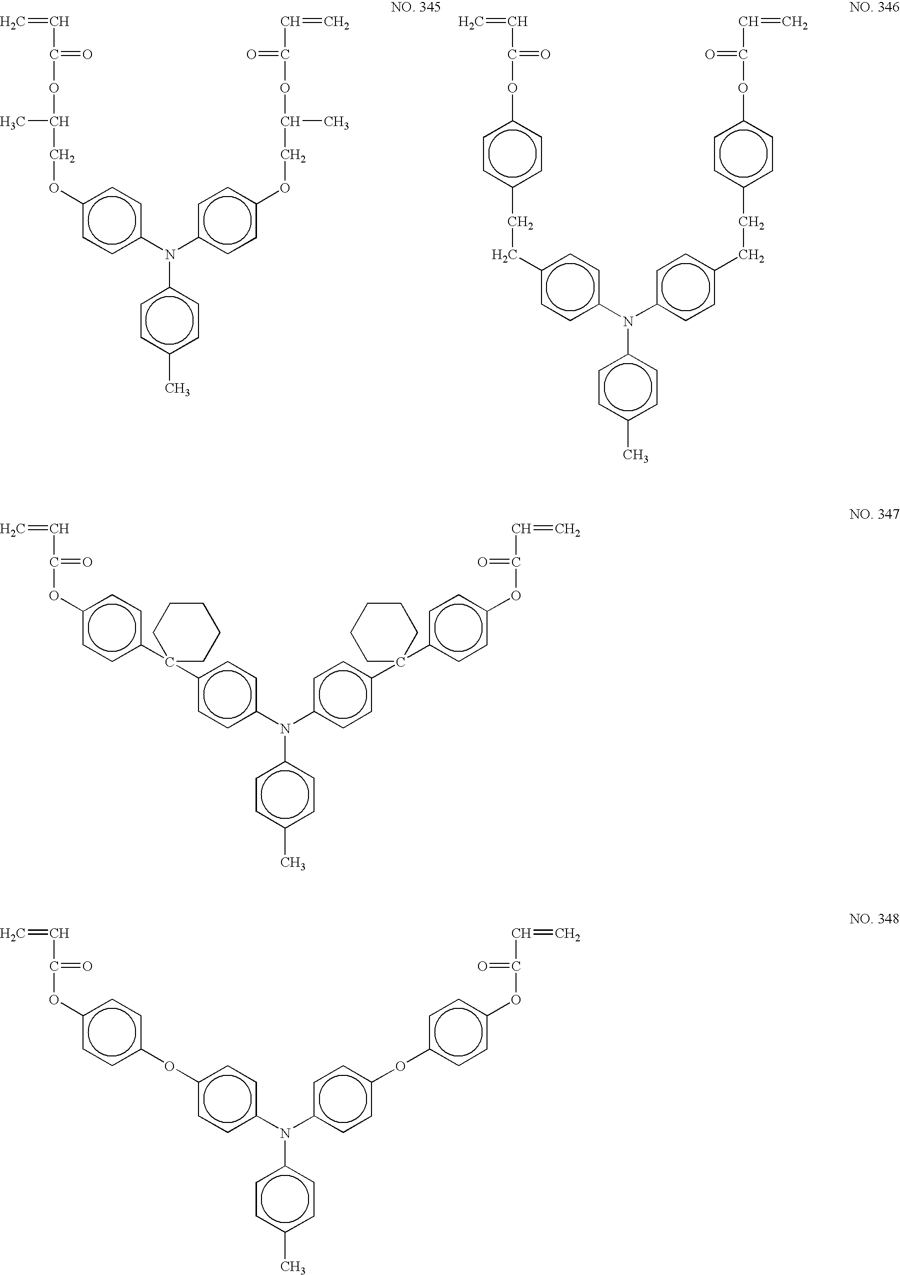

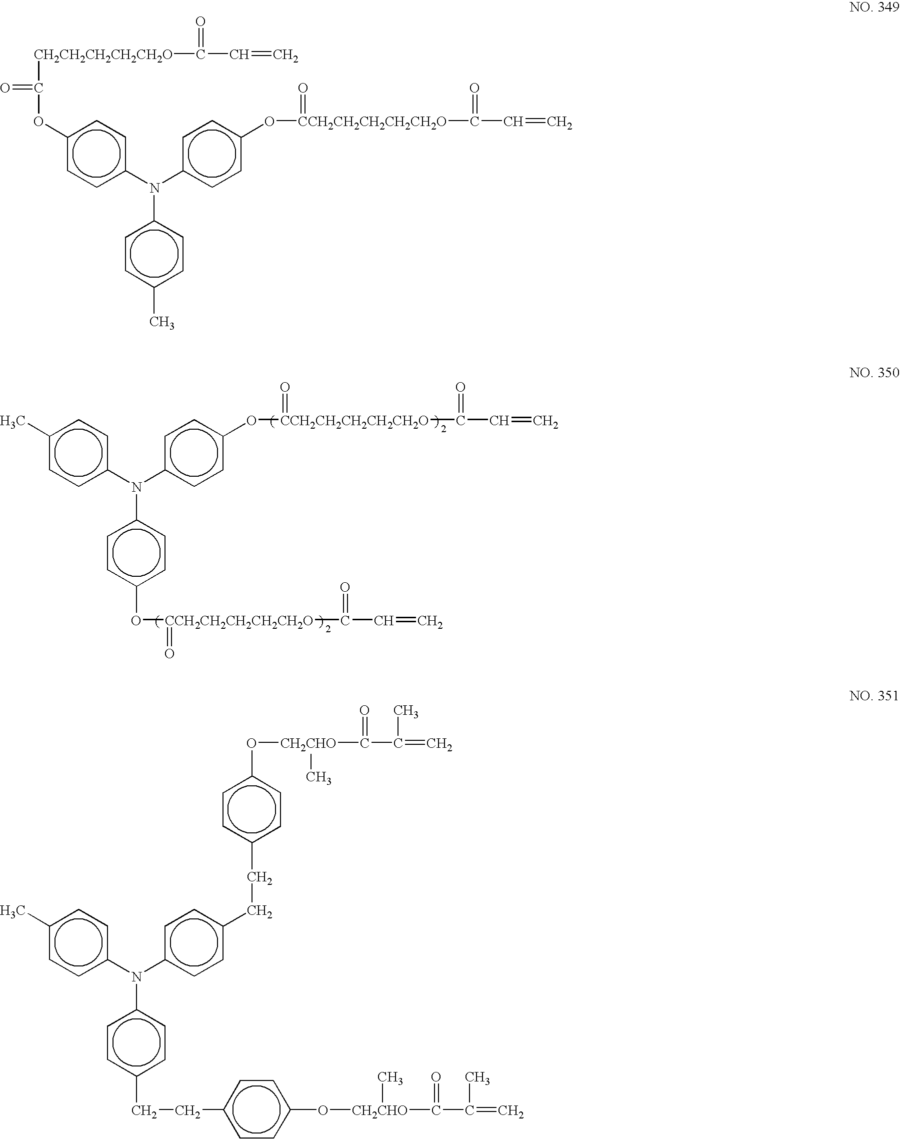

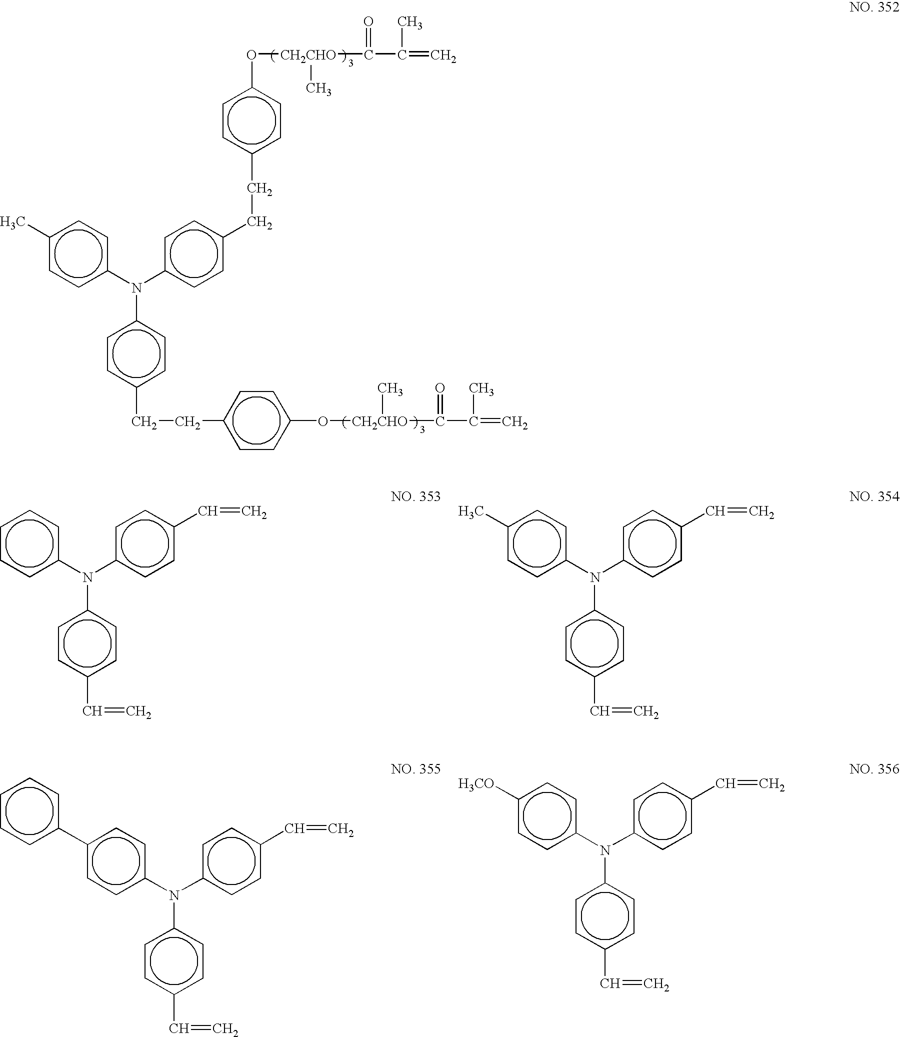

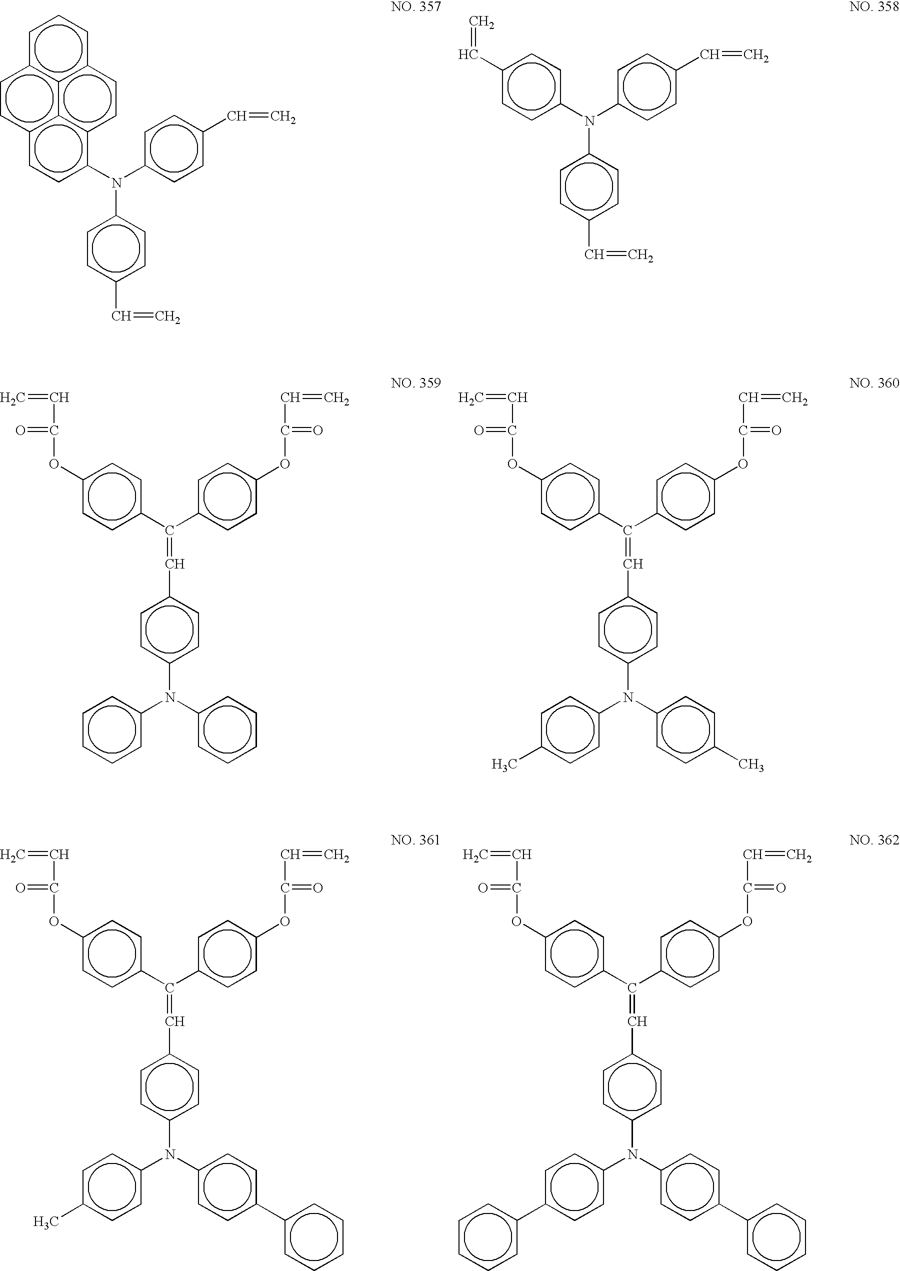

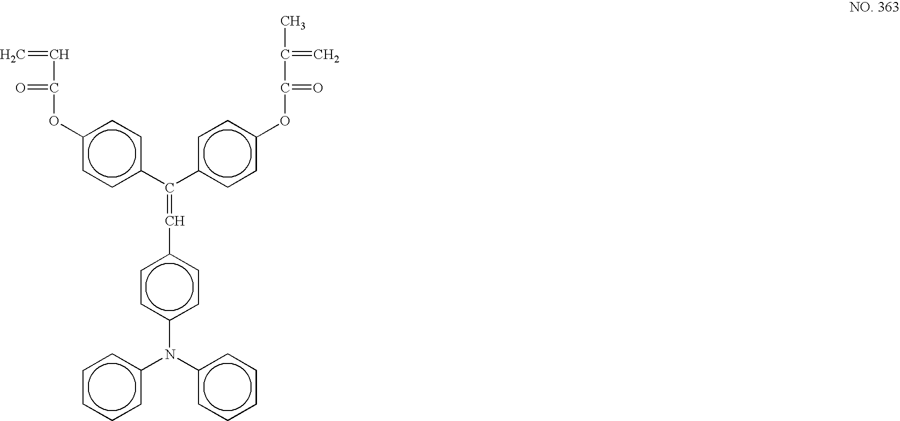

Specific examples of the radical polymerizable monomers having three functional groups and a charge transport structure include the following, but are not limited thereto.

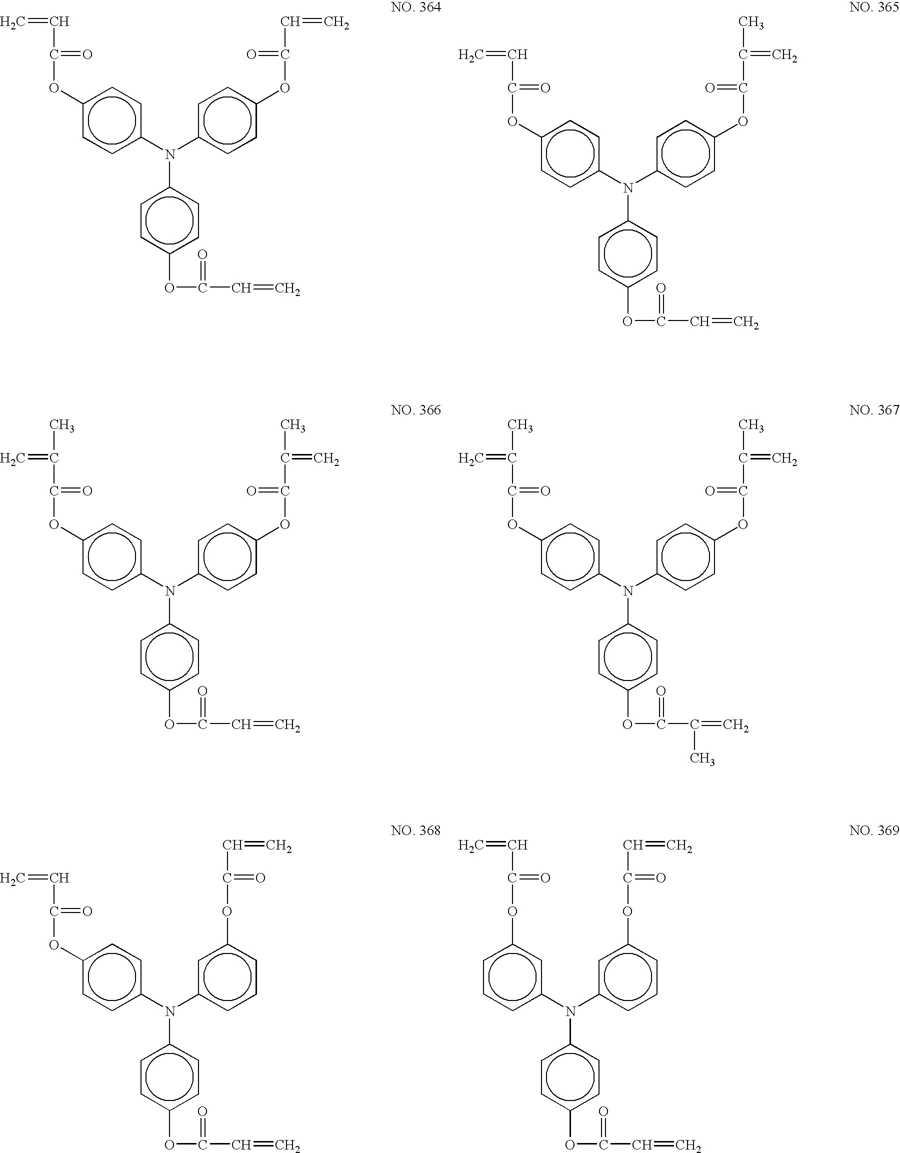

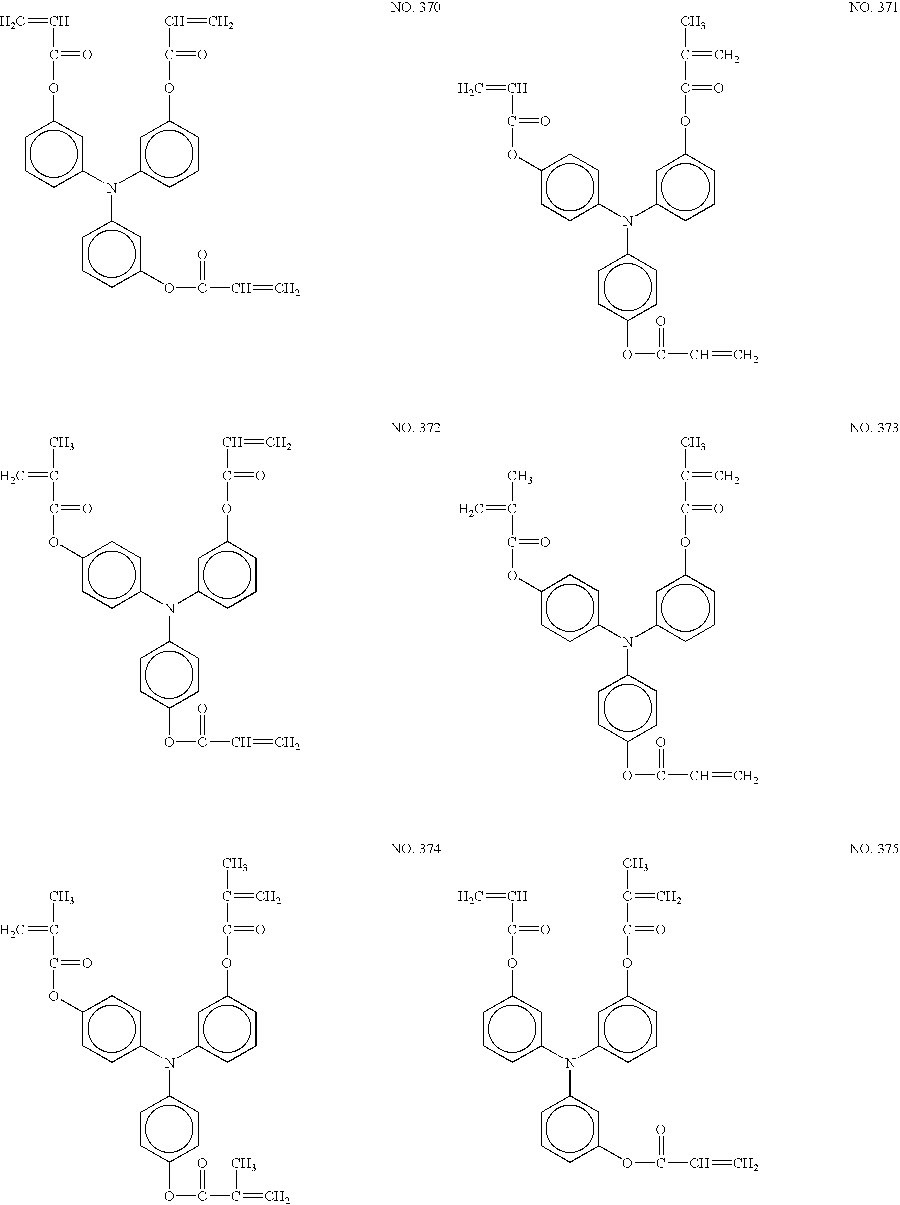

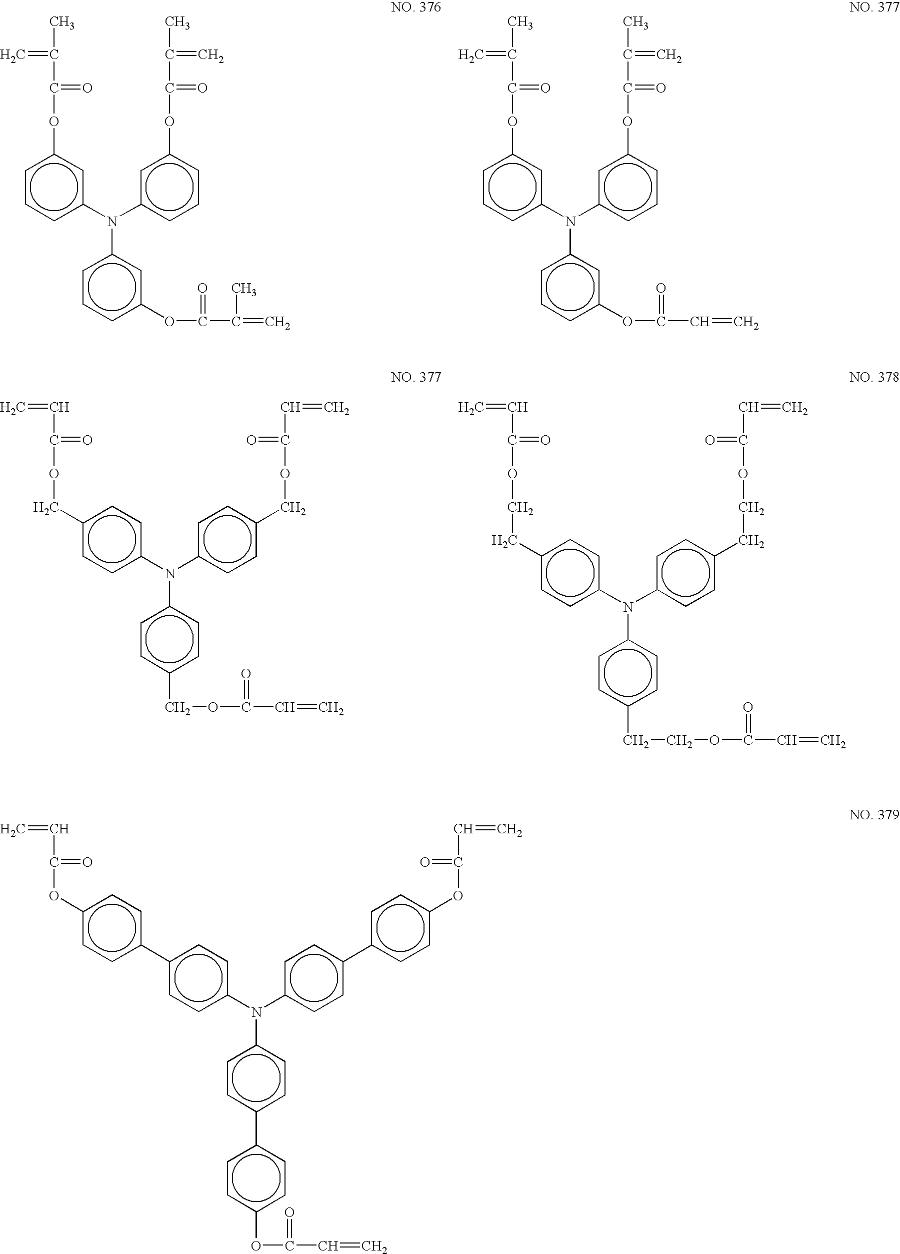

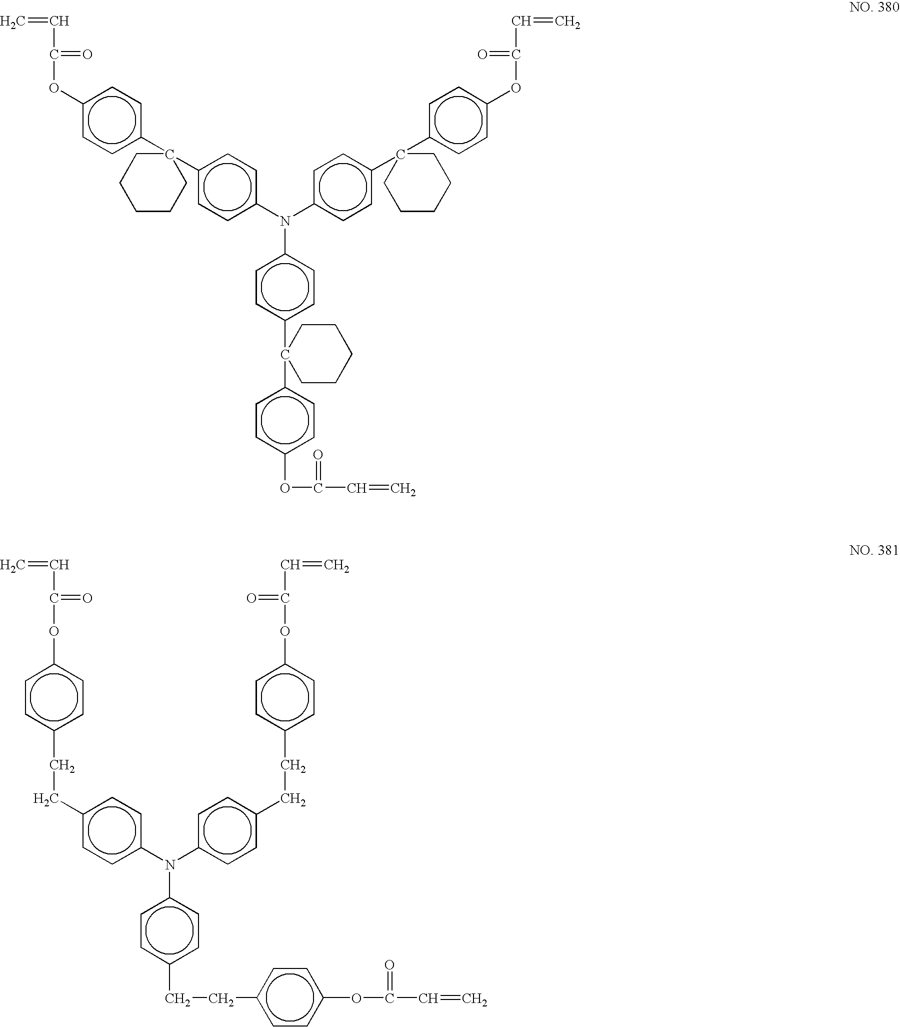

The radical polymerizable mono- or more-functional monomers having a charge transport structure are used for imparting a charge transport property to the resultant polymer. The added amount of the radical polymerizable mono- or more-functional monomers is preferably from 20 to 80% by weight, and more preferably from 30 to 70% by weight, based on the total weight of the CCTL. When the added amount is too small, a good charge transport property cannot be imparted to the resultant polymer, and thereby the electric properties (such as photosensitivity and residual potential) of the resultant photoreceptor is deteriorated. In contrast, when the added amount is too large, the crosslinking density of the resultant CCTL decreases, and thereby the abrasion resistance of the resultant photoreceptor deteriorates. From this point of view, the added amount of the mono- or more-functional monomers is from 30 to 70% by weight.

In addition, in order to efficiently crosslink the CCTL, a polymerization initiator can be added to the CCTL coating liquid. Suitable polymerization initiators include heat polymerization initiators and photo polymerization initiators. The polymerization initiators can be used alone or in combination.

Specific examples of the heat polymerization initiators include peroxide initiators such as 2,5-dimethylhexane-2,5-dihydroperoxide, dicumyl peroxide, benzoyl peroxide, t-butylcumyl peroxide, 2,5-dimethyl-2,5-di(peroxybenzoyl)hexyne-3, di-t-butylperoxide, t-butylhydroperoxide, cumenehydroperoxide, lauroyl peroxide, and 2,2-bis(4,4-di-t-butylperoxycyclohexy)propane; and azo type initiators such as azobisisobutyronitrile, azobiscyclohexanecarbonitrile, azobisbutyric acid methyl ester, hydrochloric acid salt of azobisisobutylamidine, and 4,4′-azobis-cyanovaleric acid.

Specific examples of the photopolymerization initiators include acetophenone or ketal type photopolymerization initiators such as diethoxyacetophenone, 2,2-dimethoxy-1,2-diphenylethane-1-one, 1 -hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1,2-hydroxy-2-methyl-1-phenylpropane-1-one, 2-methyl-2-morpholino(4-methylthiophenyl)propane-1-one, and 1-phenyl-1,2-propanedione-2-(o-ethoxycarbonyl)oxime; benzoin ether type photopolymerization initiators such as benzoin, benzoin methyl ether, benzoin ethyl ether, benzoin isobutyl ether, and benzoin isopropyl ether; benzophenone type photopolymerization initiators such as benzophenone, 4-hydroxybenzophenone, o-benzoylbenzoic acid methyl ester, 2-benzoyl naphthalene, 4-benzoyl biphenyl, 4-benzoyl phenyl ether, acryalted benzophenone, and 1,4-benzoyl benzene; thioxanthone type photopolymerization initiators such as 2-isopropylthioxanthone, 2-chlorothioxanthone, 2,4-dimethylthioxanthone, 2,4-diethylthioxanthone, and 2,4-dichlorothioxanthone; and other photopolymerization initiators such as ethylanthraquinone, 2,4,6-trimethylbenzoyldiphenylphosphineoxide, 2,4,6-trimethylbenzoylphenylethoxyphosphineoxide, bis(2,4,6-trimethylbenzoyl)phenylphosphineoxide, bis(2,4-dimethoxybenzoyl)-2,4,4-trimethylpentylphosphineoxide, methylphenylglyoxyester, 9,10-phenanthrene, acridine compounds, triazine compounds, imidazole compounds, etc.

Photopolymerization accelerators can be used alone or in combination with the above-mentioned photopolymerization initiators. Specific examples of the photopolymerization accelerators include triethanolamine, methyldiethanolamine, ethyl 4-dimethylaminobenzoate, isoamyl 4-dimethylaminobenzoate, 2-dimethylaminoethyl benzoate, 4,4′-dimethylaminobenzophenone, etc.

The added amount of the polymerization initiators is preferably from 0.5 to 40 parts by weight, and more preferably from 1 to 20 parts by weight, per 100 parts by weight of the total weight of the radical polymerizable monomers used.

In order to relax the stress of the CCTL and to improve the adhesion of the CCTL to the CTL, the CCTL coating liquid may include additives such as plasticizers, leveling agent, and low molecular weight charge transport materials having no radical polymerizability.

Specific examples of the plasticizers include known plasticizers for use in general resins, such as dibutyl phthalate, and dioctyl phthalate. The added amount of the plasticizers in the CCTL coating liquid is preferably not greater than 20% by weight, and more preferably not greater than 10% by weight, based on the total solid components included in the coating liquid.

Specific examples of the leveling agents include silicone oils (such as dimethylsilicone oils,and methylphenylsilicone oils), and polymers and oligomers having a perfluoroalkyl group in their side chains. The added amount of the leveling agents is preferably not greater than 3% by weight based on the total solid components included in the coating liquid.

The CCTL is typically prepared by coating a coating liquid, which includes a radical polymerizable tri- or more-functional monomer having no charge transport structure and a radical polymerizable mono- or more-functional monomer having a charge transport structure, on the CTL and then crosslinking the coated layer. When the monomers are liquid, it may be possible to dissolve other components in the monomers, resulting in preparation of the CCTL coating liquid. The coating liquid can optionally include a solvent to well dissolve the other components and/or to reduce the viscosity of the coating liquid.

Specific examples of the solvents include alcohols such as methanol, ethanol, propanol, and butanol; ketones such as acetone, methyl ethyl ketone, methyl isobutyl ketone, and cyclohexanone; esters such as ethyl acetate, and butyl acetate; ethers such as tetrahydrofuran, dioxane, and propyl ether; halogenated solvents such as dichloromethane, dichloroethane, trichloroethane, and chlorobenzene; aromatic solvents such as benzene, toluene, and xylene; cellosolves such as methyl cellosolve, ethyl cellosolve and cellosolve acetate; etc. These solvents can be used alone or in combination.

The added amount of the solvents is determined depending on the solubility of the solid components, the coating method used, and the target thickness of the CCTL. Coating methods such as dip coating methods, spray coating methods, bead coating methods, and ring coating methods can be used for forming the CCTL.

After coating a CCTL coating liquid, energy such as heat energy, photo energy and radiation energy is applied to the coated layer from the coated layer side or from the opposite side to crosslink the layer. Specific examples of the method for applying energy are as follows:
(1) applying heated gas (such as air and nitrogen gas) thereto;
(2) contacting a heated material (such as steam and heating media) thereto; and
(3) irradiating the coated layer with light or electromagnetic waves.

The temperature at which the coated CCTL is heated is preferably from 100 to 170° C. When the temperature is too low, the crosslinking speed is too slow, and thereby a problem in that the coated layer is not sufficiently crosslinked is caused. When the temperature is too high, the crosslinking reaction is unevenly performed, and thereby a problem in that the resultant CCTL has a large strain or includes non-reacted functional groups is caused. In order to uniformly perform the crosslinking reaction, a method in which at first the coated layer is heated at a relatively low temperature (preferably, not higher than about 100° C.), followed by heating at a relatively high temperature (preferably, not lower than about 100° C.) is preferably used.

Specific examples of the light source for use in photo-crosslinking the coated layer include ultraviolet light emitting devices such as high pressure mercury lamps and metal halide lamps. In addition, visible light emitting lamps can also be used if the radical polymerizable monomers and the photopolymerization initiators used have absorption in a visible region. The illuminance intensity is preferably from 50 to 1000 mW/cm². When the illuminance intensity is too low, it takes a long time until the coated layer is crosslinked. In contrast, when the illuminance intensity is too high, a problem in that the crosslinking reaction is unevenly performed, resulting in formation of wrinkles in the resultant CCTL, or the layer includes non-reacted reaction groups therein is caused. In addition, a problem in that due to rapid crosslinking, the resultant CCTL causes cracks or peeling occurs.

Specific examples of the radiation energy applying methods include methods using electron beams.

Among these methods, the methods using heat or light are preferably used because the reaction speed is high and the energy applying devices are simple.

The thickness of the CCTL is preferably from 1 to 20 μm and more preferably from 2 to 10 μm.

When the CCTL is too thick, a problem in that the resultant layer causes cracks or peeling occurs. When the thickness is not greater than 10 μm, the margin for avoiding cracks and peeling can be further increased, and therefore the crosslinking density can be increased. Further, the abrasion resistance of the CCTL can be improved because various materials can be used therefor and crosslinking conditions can be widely changed.

In general, radical polymerization reaction is obstructed by oxygen included in the air, namely, crosslinking is not well performed in the surface portion (with a thickness of about 1 μm in the thickness direction) of the coated layer due to oxygen in the air, resulting in formation of unevenly-crosslinked layer. Therefore, if the CCTL is too thin (i.e., the thickness of the CCTL is less than about 1 μm), the layer has poor abrasion resistance or uneven abrasion occurs in the layer. Further, when the CCTL coating liquid is coated directly on a CTL, the components included in the CTL tends to be dissolved by the coating liquid, resulting in migration of the components of the CTL into the CCTL. If the CCTL is too thin, the components of the CTL are migrated into the entire CCTL layer, resulting in occurrence of a problem in that crosslinking cannot be well performed or the crosslinking density is low.

In general, when the thickness of the CCTL is not less than 1 μm, the layer has good abrasion resistance and scratch resistance. However, when a photoreceptor having a CCTL with a thickness of about 1 μm is repeatedly used for a long period of time, a problem in that the CCTL is worn and the exposed CTL is also abraded, resulting in variation of photosensitivity and formation of uneven half tone images tends to occur. Therefore, the thickness of the CCTL is preferably not less than 2 μm in order that the photoreceptor has a further long life and can produce high quality images.

The CCTL coating liquid can include additives such as binder resins having no radical polymerizable group, antioxidants and plasticizers as well as a radical polymerizable tri- or more-functional monomer having no charge transport structure and a polymerizable monofunctional monomer having a charge transport structure.

When the added amount of these additives is too large, the crosslinking density of the CCTL decreases and the CCTL causes a phase separation problem in that the crosslinked polymer is separated from the additives, and thereby the resultant CCTL becomes soluble in an organic solvent. Therefore, the added amount of the additives is preferably not greater than 20% by weight based on the total weight of the solid components included in the CCTL coating liquid. In addition, in order not to decrease the crosslinking density, the total amount of the mono- or di-functional monomers, reactive oligomers and reactive polymers in the CCTL coating liquid is preferably not greater than 20% by weight based on the weight of the radical polymerizable tri- or more-functional monomers used. In particular, when the added amount of the di-functional monomers is too large, units having a bulky structure are incorporated in the CCTL while the units are connected with plural chains of the CCTL, thereby generating strain in the CCTL, resulting in formation of aggregates of micro crosslinked materials in the CCTL. Such a CCTL is soluble in an organic solvent. The added amount of a radical polymerizable di- or more-functional monomer having a charge transport structure is determined depending on the species of the monomer used, but is generally not greater than 10% by weight based on the weight of the radical polymerizable monofunctional monomer having a charge transport structure included in the CCTL.

In the photoreceptor having the structure mentioned above, the CCTL, which is the outermost layer, is preferably insoluble in organic solvents. In this case, the CCTL has good combination of abrasion resistance and scratch resistance.

In order to prepare a CCTL having good resistance to organic solvents, the key points are as follows.
(1) optimizing the formula of the CCTL coating liquid, i.e., to optimize the content of each of the components included in the liquid;
(2) choosing a proper solvent for diluting the CCTL coating liquid, while properly controlling the solid content of the coating liquid;
(3) using a proper method for coating the CCTL coating liquid;
(4) crosslinking the coated layer under proper crosslinking conditions; and
(5) forming a CTL which is hardly insoluble in the solvent included in the CCTL coating liquid.

Such an insoluble CCTL is not necessarily formed using only one of the methods mentioned above, and it is preferable to combine two or more of the methods.

When an organic solvent having a low evaporating speed is used for the CCTL coating liquid, problems which occur are that the solvent remaining in the coated layer adversely affects crosslinking of the CCTL and a large amount of the components included in the CTL are migrated into the CCTL, resulting in formation of a CCTL with a low crosslinking density or an unevenly crosslinked CCTL, and thereby the CCTL layer becomes soluble in organic solvents. From this point of view, it is preferable to use solvents such as tetrahydrofuran, mixture solvents of tetrahydrofuran and one or more of methanol, ethyl acetate, methyl ethyl ketone, and ethyl cellosolve. It is preferable that one or more proper solvents are selected in consideration of the coating method used.

When the solid content of the CCTL coating liquid is too low, similar problems occur. The upper limit of the solid content changes depending on the target thickness of the CCTL and the target viscosity of the CCTL coating liquid, which is determined depending on the coating method used. However, the solid content of the CCTL coating liquid is generally from 10 to 50% by weight.

Suitable coating methods for use in preparing the CCTL include methods such that the weight of the solvent included in the coated layer is as low as possible, and the time during which the solvent in the coated layer contacts the CTL on which the coating liquid is coated is as short as possible. Specific examples of such coating methods include spray coating methods and ring coating methods in which the weight of the coated layer is controlled so as to be light. In addition, in order to control the amount of the components of the CTL migrating into the CCTL so as to be as small as possible, it is preferable to use a charge transport polymer for the CTL and/or to form an intermediate layer, which has good resistance to the solvent used for the CCTL coating liquid, between the CTL and the CCTL.

When the heat energy or irradiation energy is low in the crosslinking process, the coated layer is not completely crosslinked. In this case, the resultant layer becomes soluble in organic solvents. In contrast, when the energy is too high, uneven crosslinking tends to be performed, resulting in increase of non-crosslinked portions or portions at which radicals are terminated, or formation of aggregates of micro crosslinked materials. In this case, the resultant CCTL has such a drawback as to be soluble in organic solvents.

In order to prepare a CCTL insoluble in organic solvents, the crosslinking conditions are preferably as follows:

Heat Crosslinking Conditions

Temperature: 100 to 170° C.

Heating time: 10 minutes to 3 hours

UV Light Crosslinking Conditions

Illuminance intensity: 50 to 1000 mW/cm²

Irradiation time: 5 seconds to 5 minutes

Temperature rise: 50° C. or less

By performing crosslinking under such conditions, occurrence of an uneven crosslinking problem can be prevented.

In order to prepare a CCTL layer insoluble in organic solvents in a case where an acrylate monomer having three acryloyloxy group and a triarylamine compound having one acryloyloxy group are used for the CCTL coating liquid, the weight ratio (A/T) of the acrylate monomer (A) to the triarylamine compound (T) is preferably 7/3 to 3/7. The added amount of one or more of the polymerization initiators mentioned above is preferably from 3 to 20% by weight based on the total weight of the acrylate monomer (A) and the triarylamine compound (T). In addition, a proper solvent is preferably added to the coating liquid. Provided that the CTL, on which the CCTL coating liquid is to be coated, is formed of a triarylamine compound (serving as a CTM) and a polycarbonate resin (serving as a binder resin), and the CCTL layer is coated by a spray coating method, the solvent of the CCTL coating liquid is preferably selected from tetrahydrofuran, 2-butanone, and ethyl acetate. The added amount of the solvent in the coating liquid is preferably from 300 to 1000 parts by weight per 100 parts by weight of total of the acrylate monomers (A) used.

After the CCTL coating liquid is prepared, the coating liquid is coated by a spray coating method on a peripheral surface of a drum, which includes, for example, an aluminum cylinder and an undercoat layer, a CGL and a CTL which are formed on the aluminum cylinder one by one. Then the coated layer is naturally dried, followed by drying for a short period of time (from 1 to 10 minutes) at a relatively low temperature (from 25 to 80° C.). Then the dried layer is heated or exposed to UV light to be crosslinked.

When crosslinking is performed using UV light, the illuminance intensity of UV light is preferably from 50 mW/cm² to 1000 mW/cm². Provided that plural UV lamps emitting UV light of 200 mW/cm² are used, it is preferable that the coated layer is uniformly exposed to the UV light, for about 30 seconds. In this case, the temperature of the drum is controlled so as not to exceed 50° C. When heat crosslinking is performed, the temperature is preferably from 100 to 170° C., and an oven with an air blower is preferably used as the heating device. When the heating temperature is 150° C., the heating time is preferably from 20 minutes to 3 hours.

It is preferable that after the crosslinking operation, the thus prepared photoreceptor is heated for a time of from 10 minutes to 30 minutes at a temperature of from 100 to 150° C. to remove the solvent remaining in the CCTL. Thus, a photoreceptor (i.e., an image bearing member) for use in the image forming apparatus of the present invention is prepared.

The photoreceptor can include an intermediate layer and/or an undercoat layer.

Intermediate Layer

In the photoreceptor for use in the present invention, an intermediate layer may be formed between the CTL and the CCTL to prevent the components in the CTL from migrating into the CCTL and/or to improve the adhesion of the CCTL to the CTL. The intermediate layer includes a resin as a main component which is insoluble or is hardly soluble in the solvent used for the CCTL coating liquid. Specific examples of the resin for use in the intermediate layer include polyamides, alcohol soluble nylons, water-soluble polyvinyl butyral, polyvinyl butyral, polyvinyl alcohol, and the like. The intermediate layer can be formed by one of the known coating methods mentioned above for use in preparing the CCTL. The thickness of the intermediate layer is preferably from 0.05 to 2 μm.

Undercoat Layer

The photoreceptor for use in the present invention may include an undercoat layer between the substrate and the photosensitive layer. The undercoat layer includes a resin as a main component. Since a photosensitive layer is typically formed on the undercoat layer by coating a liquid including an organic solvent, the resin included in the undercoat layer preferably has good resistance to general organic solvents.

Specific examples of such resins include water-soluble resins such as polyvinyl alcohol resins, casein and polyacrylic acid sodium salts; alcohol soluble resins such as nylon copolymers and methoxymethylated nylon resins; and thermosetting resins capable of forming a three-dimensional network such as polyurethane resins, melamine resins, alkyd-melamine resins, epoxy resins and the like.

The undercoat layer may include a fine powder of metal oxides such as titanium oxide, silica, alumina, zirconium oxide, tin oxide and indium oxide to prevent occurrence of moire in the recorded images and to decrease residual potential of the photoreceptor.

The undercoat layer can be formed by coating a coating liquid using a proper solvent and a proper coating method mentioned above for use in preparing the photosensitive layer.

The undercoat layer may be formed using a silane coupling agent, titanium coupling agent or a chromium coupling agent.

In addition, a layer of aluminum oxide which is formed by an anodic oxidation method and a layer of an organic compound such as polyparaxylylene or an inorganic compound such as SiO, SnO2, TiO2, indium tin oxide (ITO) or CeO2 which is formed by a vacuum evaporation method is also preferably used as the undercoat layer.

The thickness of the undercoat layer is preferably 0 to 5 μm.

In order to impart high stability to withstand environmental conditions to the resultant photoreceptor (particularly, to prevent deterioration of photosensitivity and increase of residual potential under high temperature and high humidity conditions), an antioxidant can be included in the above-mentioned layers (i.e., the CCTL, CTL, CGL, intermediate layer and undercoat layer).

Suitable antioxidants for use in the layers include phenolic compounds, paraphenylenediamine compounds, hydroquinone compounds, sulfur containing organic compounds, phosphorous containing organic compounds, etc. These antioxidants can be used alone or in combination. Specific examples thereof are as follows.

Phenolic Compounds

2,6-di-t-butyl-p-cresol, butylated hydroxyanisole, 2,6-di-t-butyl-4-ethylphenol, n-octadecyl-3-(4′-hydroxy-3′,5′-di-t-butylphenol), 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butyric acid]glycol ester, tocophenol compounds, and the like.

Paraphenylenediamine Compounds

N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, N,N′-dimethyl-N,N′-di-t-butyl-p-phenylenediamine, and the like.

Hydroquinone Compounds

2,5-di-t-octylhydroquinone, 2,6-didodecylhydroquinone, 2-dodecylhydroquinone, 2-dodecyl-5-chlorohydroquinone, 2-t-octyl-5-methylhydroquinone, 2-(2-octadecenyl)-5-methylhydroquinone and the like.

Sulfur Containing Organic Compounds

dilauryl-3,3′-thiodipropionate, distearyl-3,3′-thiodipropionate, ditetradecyl-3,3′-thiodipropionate, and the like.

Phosphorus Containing Organic Compounds

triphenylphosphine, tri(nonylphenyl)phosphine, tri(dinonylphenyl)phosphine, tricresylphosphine, tri(2,4-dibutylphenoxy)phosphine and the like.

These compounds are commercialized as antioxidants for rubbers, plastics, oil and fats.

The added amount of an antioxidant in a layer is not particularly limited, and is preferably from 0.01 to 10% by weight based on the weight of the layer to which the antioxidant is added.

The toner for use in the image forming apparatus of the present invention will be now explained.

The toner includes toner particles and an external additive which is present on the surface of the toner particles. The toner has a volume average particle diameter of from 3 to 9 μm. In addition, the ratio (Dv/Dn) of the volume average particle diameter (Dv) to the number average particle diameter (Dn) is preferably from 1.01 to 1.25. In this case, the toner has good cleanability.

In general, using a toner having a particle diameter as small as possible is advantageous to produce high definition and high quality images. However, such a toner is inferior in transferability and cleanability. When the toner has a volume average particle diameter smaller than the above-mentioned range, the toner tends to cause a problem in that the developer is fixedly adhered to a carrier after long term agitation, resulting in deterioration of the charging ability of the carrier when the toner is used for a two component developer. When such a small toner is used as a one component developer, problems in that the toner forms a film on a developing roller, and the toner is fixedly adhered to members such as a blade configured to form a thin toner layer tend to be caused.

In contrast, when the volume average particle diameter of the toner is larger than the above-mentioned range, it is difficult to produce high resolution and high quality images and in addition a problem in that the particle diameter distribution of the toner in a developer largely changes when the toner is used while replenishing the toner to the developer, resulting in variation of image qualities tends to occur.

When the ratio (Dv/Dn) is greater than 1.40, the toner has a broad charge quantity distribution and the resultant images have poor resolution. Therefore, it is not preferable.

The average particle diameter and particle diameter distribution of a toner can be measured using an instrument COULTER COUNTER MODEL TAII (trademark) from Beckman Coulter Inc., which is connected with a personal computer equipped with an interface (from Nikkaki Bios Co., Ltd.) by which the number-basis particle diameter. distribution and weight-basis particle diameter distribution can be output. In addition, an aperture (i.e., a small hole) having a diameter of 100 Am is used. The measuring method is as follows.
(1) at first a 1% solution of NaCl is prepared using a first class NaCl to prepare an electrolyte (ISOTON II from Coulter Beckmann can also be used as an electrolyte); a sample (toner) is dispersed in an electrolyte solution including a surfactant to prepare a dispersion of the sample;
(2) 0.1 to 5 ml of a dispersant such as alkylbenzenesulfonate is added to 100 to 150 ml of the electrolyte prepared above;
(3) 2 to 20 mg of a sample is added thereto and the mixture is dispersed using an ultrasonic dispersing machine;
(3) the dispersion is set in the measuring instrument to measure the particle diameter distribution of the sample using the 100 μm; and
(4) the volume average particle diameter (Dv) and the weight average particle diameter (D4) are determined based on the particle diameters distribution (on volume basis) of the particles of the sample in a range of from 2 to 40 μm.

The toner preferably has an average circularity of not less than 0.950 and less than 1.0.

The circularity of a toner particle can be determined by dividing the circumference of a projected image of an optically detected toner particle by the circumference of a circle having the same area as that of the projected image. Specifically, measurements of the circularity are performed using a flow-type particle image analyzer (FPIA-1000 manufactured by Sysmex Corp). Specifically, at first 100 to 150 ml of water from which solid impurities have been removed is fed to a predetermined container. Then 0.1 to 0.5 ml of a surfactant serving as a dispersant is added thereto. In addition, 0.1 g to 9.5 g of a sample (i.e., toner) to be measured is added thereto. The mixture is dispersed using an ultrasonic dispersing machine for about 1 to 3 minutes to prepare a suspension including particles of 3,000 to 10,000 per 1 micro-liter of the suspension. Thus the average circularity and circularity distribution of the toner in the suspension are determined by the analyzer mentioned above.

The toner particles include a binder resin. Suitable resins for use as the binder resin include polystyrene resins, polyester resins, and epoxy resins. Among these resins, polyester resins are preferably used. In particular, modified polyester resins such as urea-modified polyester resins and urethane-modified polyester resins are preferably used. Specific examples of the urea-modified polyester resins include reaction products of a polyester prepolymer having an isocyanate group with an amine. Polyester prepolymers having an isocyanate group are prepared by reacting a polycondensation product of a polyol and a polycarboxylic acid, which has a group having an active hydrogen atom, with a polyisocyanate compound. Specific examples of the group having an active hydrogen atome include hydroxyl groups (such as alcoholic hydroxyl groups and phenolic hydroxyl groups), amino groups, carboxyl groups and mercapto groups. Among these groups, alcoholic hydroxyl groups are preferable.

The toner also includes a colorant. Known dyes and pigments, which can be used for preparing yellow, magenta, cyan and black color toners, can be used as the colorant. Specific examples of such dyes and pigments include carbon black, lamp black, ultramarine blue, Aniline Blue, Phthalocyanine Blue, Phthalocyanine Green, HANSA YELLOW G, Rhodamine 6G Lake, chalco-oil blue, chrome yellow, Quinoline Yellow, Benzidine Yellow, Rose Bengale, triarylmethane dyes, etc. These dyes and pigments can be used alone or in combination.

The toner preferably includes a charge controlling agent. Suitable materials for use as the charge controlling agent include metal salts of salicylic acid and its derivatives. A transparent or white charge controlling agent is preferably used alone or in combination with another charge controlling agent for color toners. Specific examples of such transparent or white charge controlling agents include organic boron compounds, fluorine-containing ammonium salts, calixarene compounds, etc., but are not limited thereto.

The toner preferably includes an external additive. The external additive preferably has a specific surface area of from 20 m² to 50 m². When the specific surface area is too small, there is a case where some particles of the external additive are present alone without adhering to the toner particles, and thereby the fluidity of the toner is not improved. In contrast, when the specific surface area is too large, the fluidity of the toner is excessively improved, and thereby a cleaning problem in that toner particles remaining on the image bearing member are not well removed occurs.

The toner preferably includes an external additive in an amount of from 0.3 to 2.0 parts by weight based on 100 parts by weight of the toner particles. When the added amount of the external additive is too small, a problem in that a black streak image (in a case of black toner) is formed due to defective cleaning occurs. In contrast, when the added amount is too large, many particles of the external additive are present alone without adhering to the toner particles, and thereby the charge properties of the toner are deteriorated.

Specific examples of the external additive include inorganic particulate materials such as metal powders, silica, titanium oxide, and aluminum oxide; organic particulate resins, etc. Among these materials, silica and titanium oxide are preferably used, and more preferably silica is used. Silicas prepared by a wet process or a dry process can be used as the external additive. Among these silicas, so-called “fumed silica” which is prepared by a dry method in which a vaporized halogene-containing silicon compound is oxidized-is preferably used because of being able to impart good fluidity to the resultant toner.

Specifically, the fumed silica is prepared, for example, by subjecting silicon tetrachloride in a gas state to a heat decomposition oxidation reaction in the presence of hydrogen and oxygen gases. The reaction formula is as follows.
SiCl₄+2H₂+O₂→SiO₂+4HCl

In this manufacturing process, by using another metal halide, such as aluminum chloride and titanium chloride, in combination of silicone halides, particles of a complex metal oxide including silica and another metal oxide can be provided. Such a complex metal oxide can also be used as the external additive. In addition, the surface of a particulate silica can be coated with a silane compound to hydrophobized the particulate silica.

Specifically, the hydroxyl group bonded with a particulate silica is reacted with a silane compound to substitute the hydroxyl group with a siloxyl group. In this regard, hydrophobicity of the treated silica is defined by the following equation:
Hydrophobicity (%)={Nhb/(Nhb−Nha)}×100
wherein Nhb represents the number of hydroxyl groups of the silica before the treatment, and Nha represents the number of hydroxyl groups of the silica after the treatment.

The hydrophobizing treatment is typically performed by reacting a particulate silica with a silane compound such as dialkyldihalogenated silane, trialkylhalogenated silane, hexaalkyldisilazane and alkyltrihalogenated silane at a high temperature.

The hydrophobicity of a treated silica is determined as follows.
(1) 50 ml of water is fed in a beaker of 200 ml, and 0.2 g of a sample (i.e., a treated silica) is added thereto;
(2) the mixture is agitated with a stirrer (the silica is floating on the surface of water);
(3) methanol is gradually added into the mixture using a burette, the tip of which is dipped in the mixture; and
(4) methanol is added until all the floating silica particles are perfectly sunk in the liquid.

The hydrophobicity of the sample is determined by the following equation:
Hydrophobicity (%)=Vm/(50+Vm)×100
wherein Vm represents the total volume (in units of milliliter) of methanol added.

In this case, methanol serves as a surfactant. As methanol is added to the mixture, the floating silica particles become to be dispersed in the liquid. Therefore, the greater the volume of methanol added, the greater hydrophobicity the sample has.

In addition, by adding a lubricant to the toner particles as an external additive, the resultant toner has good cleanability (i.e., toner particles remaining on an image bearing member can be well removed). This is because the lubricant decreases the adhesion of the toner to the image bearing member.

Suitable lubricants for use as the external additive include fatty acid metal salts, vinylidene fluoride, etc., but is not limited thereto.

Further, in order to improve the fluidity of the toner, particles such as alumina can be added to the toner particles as an external additive.

Then the photoreceptor for use in the image forming apparatus will be further explained referring to examples.

Synthesis of Monofunctional Compound Having Charge Transport Structure

Radical polymerizable monofunctional monomers for use in the CCTL can be prepared, for example, by the method described in Japanese Patent No. 3,164,426, which is as follows.

(1) Synthesis of Triarylamine Compound Substituted with Hydroxyl Group (i.e., a Compound Having the Below-Mentioned Formula (9)) At first, 113.85 g (0.3 mol) of a triarylamine compound which is substituted with a methoxy group and which has the below-mentioned formula (8), 138 g (0.92 mol) of sodium iodide, and 240 ml of sulforane were mixed and heated at 60° C. under a nitrogen gas flow. Then, 99 g (0.91 mol) of trimethylchlorosilane was dropped thereto over 1 hour. The mixture was agitated for 4.5 hours at about 60° C. to complete the reaction. Then 1.5 liters of toluene was added to the reaction product, followed by cooling to room temperature. Further, the toluene solution of the reaction product was further washed using water, followed by washing using an aqueous solution of sodium carbonate. The washing treatment was repeated several times. Then toluene was removed from the toluene solution of the reaction product, and the reaction product was subjected to column chromatography (absorbent: silica gel, solvent: toluene/ethyl acetate=20/1) to be refined. The thus prepared pale yellow oily material was mixed with cyclohexane to precipitate a crystal. Thus, 88.1 g of a white crystal having the below-mentioned formula (9) and a melting point of from 64.0 to 66.0° C. was prepared. In this reaction, the yield was 80.4%.

Then the crystal was subjected to an elementary analysis. The results (i.e., the amounts of the elements (C, H and N) in the crystal) are shown in Table 1.

TABLE 1

| | C | H | N |
|---|---|---|---|
| Actual measurement | 85.06 | 6.41 | 3.73 |
| value | | | |
| Calculated value | 85.44 | 6.34 | 3.83 |

formula (8)

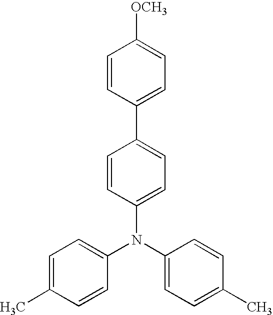

formula (9)

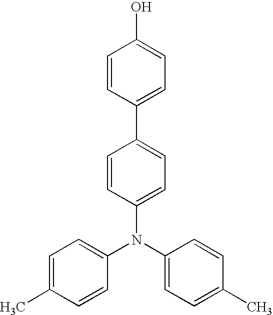

(2) Acrylate Compound Substituted with Triarylamine Group Having the Above-Mentioned Formula 54

At first, 82.9 g (0.227 mol) of the compound having formula (9) was dissolved in 400 ml of tetrahydrofuran. Then an aqueous solution of sodium hydroxide including 12.4 g of sodium hydroxide and 100 ml of water was dropped into the above-prepared solution under nitrogen gas flow. After the mixture was cooled to 5° C., 25.2 g (0.272 mol) of acrylic acid chloride was added thereto over 40 minutes. The mixture was agitated for 3 hours at 5° C. to complete the reaction. The reaction product was then added into water, and then subjected to extraction using toluene. The extraction liquid was subjected to washing using a sodium hydrogen carbonate aqueous solution, followed by washing using water. This washing treatment was performed several times.

After toluene was removed from the toluene solution of the reaction product, the reaction product was subjected to column chromatography (absorbent: silica gel, solvent: toluene) to be refined. The thus prepared colorless oily material was mixed with n-hexane to precipitate a crystal. Thus, 80.73 g of a white crystal which is the compound No. 54 mentioned above and a melting point of from 117.5 to 119.0° C. was prepared. In this reaction, the yield was 84.8%.

Then the crystal was subjected to an elementary analysis. The results (i.e., the amounts of the elements (C, H and N) in the crystal) are shown in Table 2.

TABLE 2

| | C | H | N |
|---|---|---|---|
| Actual measurement | 83.13 | 6.01 | 3.16 |
| value | | | |
| Calculated value | 83.02 | 6.00 | 3.33 |

Synthesis of Difunctional Compound Having a Charge Transport Structure

A radical polymerizable difunctional monomer having a charge transport structure, dihydroxymethyltriphenylamine, can be prepared, for example, by the following method.

At first, 49 g of a compound having the below-mentioned formula (10) and 184 g of phosphorous oxychloride were fed into a flask equipped with a thermometer, a condenser, an agitator and a dropping funnel and the mixture was heated to prepare a solution. Then 117 g of dimethylformamide was dropped into the solution using the dropping funnel. Then the mixture was heated for about 15 hours at a temperature of from 85 to 95° C. while agitated. After the reaction liquid was gradually added into a large amount of hot water, the mixture was gradually cooled while agitated. After the precipitated crystal was filtered, followed by drying, impurities in the crystal was absorbed by silica gel and then the crystal was refined using acetonitrile. Thus, 30 g of a compound having the below-mentioned formula (11) was prepared.

Thirty (30) grams of the thus prepared compound (11) and 100 ml of ethanol were mixed in a flask while agitated. Then 1.9 g of sodium boron hydride was gradually added to the mixture. Then the mixture was agitated for about 2 hours while the temperature of the mixture was controlled to be from 40 to 60° C. Then the reaction liquid was gradually added into 300 ml of water and the mixture was agitated to precipitate a crystal. After the mixture was filtered, the precipitate was washed and dried. Thus, 30 g of a compound having the following formula (12) was prepared.

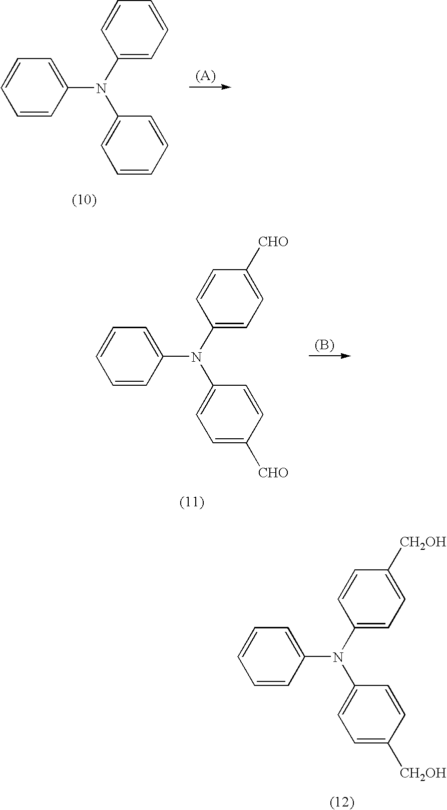

### PHOTORECEPTOR PREPARATION EXAMPLE 1

Formation of Undercoat Layer

At first, an aluminum pipe having a diameter of 30 mm and a length of 350 mm which had been subjected to a cutting treatment to prevent occurrence of a moire image was dipped into a 5% methanol solution of a polyamide resin (CM8000 from Toray Industries, Inc.), followed by drying, to form an undercoat layer having a thickness of 0.3 μm on the peripheral surface of the pipe.

Formation of CGL

The following components were mixed and dispersed for 20 hours using a sand mill including glass beads having a diameter of 1 mm.

| | |
|---|---|
| Oxytitanium phthalocyanine | 10 parts |
| (having an X-ray diffraction spectrum having | |
| strong peaks at Bragg (2θ) angles of | |
| 9.0°, 14.2°, 23.9° and 27.1° (±0.2°) | |
| Polyvinyl butyral | 10 parts |
| (S-LEC BM2 (trademark) from Sekisui Chemical Co., Ltd.) | |
| Cyclohexanone | 60 parts |

The dispersion was then mixed with 100 parts of methyl ethyl ketone. Thus, a CGL coating liquid was prepared.

The above-prepared CGL coating liquid was coated on the surface of the undercoat layer formed on the aluminum pipe was coated by a dip coating method, and then dried. Thus, a CGL having a thickness of 0. 12 μm was prepared.

Formation of CTL

The following components were mixed to prepare a CTL coating liquid.

| | |
|---|---|
| CTM having the following formula (13) | 10 parts |
| 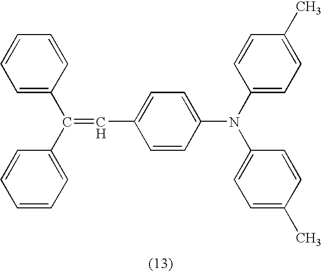 | |
| Z-form polycarbonate resin (weight average molecular | 12 parts |
| weight (Mw) of 28000) | |
| Monochlorobenzene | 60 parts |

The thus prepared CTL coating liquid was coated on the surface of the CGL, followed by drying. Thus, a CTL having a thickness of 20 μm was prepared.

Formation of CCTL

The following components were mixed to prepare a CCTL coating liquid.

| | |
|---|---|
| Radical polymerizable hexafunctional monomer (a) having the following formula | 5 parts |
| 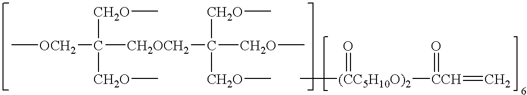 | |
| (i.e., caprolactone-modified dipentaerythritol hexaacrylate, KAYARAD DPCA-120 from | |
| Nippon Kayaku Co., Ltd., which has no charge transport structure and has a viscosity of | |
| 1700 mPa · s/25° C., an average molecular weight of 1947, and a ratio (Mw/F) of the | |
| molecular weight (Mw) to the number of functional groups (F) of 324) | |
| Radical polymerizable trifunctional monomer (b) having the following formula | 5 parts |
| 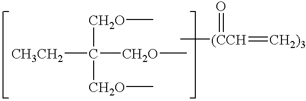 | |
| (i.e., trimethylolpropane triacrylate, KAYARAD TMPTA from Nippon Kayaku Co., | |
| Ltd., which has no charge transport structure and has a viscosity of 105 mPa · s/25° C., | |
| an average molecular weight of 296, and a ratio (Mw/F) of the molecular weight (Mw) | |
| to the number of functional groups (F) of 99) | |
| Compound No. 54 mentioned above (serving as a radical polymerizable monofunctional | 10 parts |
| monomer having a charge transport structure) | |
| 1-hydroxycyclohexyl phenyl ketone (photopolymerization initiator, IRGACURE 184 | 1 part |
| from Chiba Specialty Chemicals) | |
| Tetrahydrofuran | 100 parts |

The thus prepared CCTL coating liquid was coated on the CTL by a spray coating method, followed by natural drying for 20 minutes. Then the coated layer was exposed to light emitted by a metal halide lamp under the following conditions:

Distance between the lamp and coated layer: 120 mm

Illuminance intensity: 500 mW/cm²

Illumination time: 60 sec

The layer was then heated for 20 minutes at 130° C. Thus, a CCTL having a thickness of 5.0 μm was prepared.

Thus, a photoreceptor (1) was prepared.

### PHOTORECEPTOR PREPARATION EXAMPLES 2-6

The procedure for preparation of the photoreceptor (1) was repeated except that the thickness of the CCTL was changed from 5.0 μm to 1.0 μm, 3.0 μm, 8 μm, 10 μm and 20 μm. Thus, photoreceptors (2) to (6) were prepared.

### PHOTORECEPTOR PREPARATION EXAMPLE 7

The procedure for preparation of the photoreceptor (1) was repeated except that the radical polymerizable hexafunctional monomer (a) was replaced with the following radical polymerizable polyfunctional monomer (c).

Radical polymerizable polyfunctional monomer (c) 5 parts

(Urethane acrylate, U-15HA, Shin Nakamura Chemical Industry Co., Ltd., which has 15 functional groups and which has a viscosity of 45,000 mPa·s/40° C., an average molecular weight of 2,300,;and a ratio (Mw/F) of the molecular weight (Mw) to the number of functional groups (F) of 153)

Thus, a photoreceptor (7) was prepared.

### PHOTORECEPTOR PREPARATION EXAMPLE 8

The procedure for preparation of the photoreceptor (7) was repeated except that the radical polymerizable trifunctional monomer (b) was replaced with the following radical polymerizable polyfunctional monomer (d).

Radical polymerizable polyfunctional monomer (d) 5 parts

(ethoxylated pentaerythritol tetraacrylate, KAYARAD SR-494 from Nippon Kayaku Co., Ltd., which has 4 functional groups and which has a viscosity of 150 mPa·s/25° C.)

Thus, a photoreceptor (8) was prepared.

### PHOTORECEPTOR PREPARATION EXAMPLE 9

The procedure for preparation of the photoreceptor (1) was repeated except that the radical polymerizable monomer having a charge transport structure (the compound No. 54) was replaced with a compound having the following formula (I):

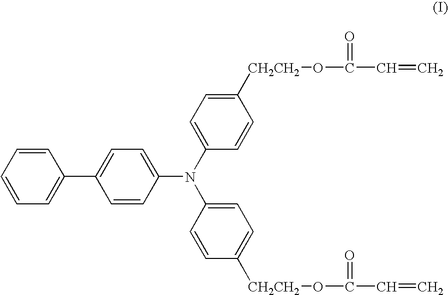

Thus, a photoreceptor (9) was prepared.

### PHOTORECEPTOR PREPARATION EXAMPLE 10

The procedure for preparation of the photoreceptor (9) was repeated except that the radical polymerizable polyfunctional monomers (a) and (b) were replaced with the radical polymerizable polyfunctional monomer (c) and the following radical polymerizable polyfunctional monomer (e), respectively.

Radical polymerizable polyfunctional monomer (e) 5 parts

(ethyleneoxy-modified pentaerythritol tetraacrylate, KAYARAD RP-1040 from Nippon Kayaku Co., Ltd., which has 4 functional groups and which has a viscosity of 150 mPa·s/25° C., a molecular weight of 528, and a ratio (Mw/F) of the molecular weight (Mw) to the number of functional groups (F) of 132)

Thus, a photoreceptor (10) was prepared.

### PHOTORECEPTOR PREPARATION EXAMPLE 11

The procedure for preparation of the photoreceptor (1) was repeated except that the compound No. 54 was replaced with the compound No. 377 and the radical polymerizable hexafunctional monomer (a) was replaced with the following radical polymerizable polyfunctional monomer (f).

Radical polymerizable polyfunctional monomer (f) 5 parts

(caprolactone-modified pentaerythritol hexaacrylate, KAYARAD DPCA-60 from Nippon Kayaku Co., Ltd., which has 6 functional groups and which has a viscosity of 900 mPa·s/25° C., a molecular weight of 1263, and a ratio (Mw/F) of the molecular weight (Mw) to the number of functional groups (F) of 211)

Thus, a photoreceptor (11) was prepared.

### PHOTORECEPTOR PREPARATION EXAMPLE 12

The procedure for preparation of the photoreceptor (11) was repeated except that the radical polymerizable polyfunctional monomers (f) and (b) were replaced with the radical polymerizable polyfunctional monomers (c) and (e), respectively.

Thus, a photoreceptor (12) was prepared.

### PHOTORECEPTOR PREPARATION EXAMPLE 13

The procedure for preparation of the photoreceptor (1) was repeated except that the radical polymerizable polyfunctional monomers (a) and (b) were replaced with 10 parts of the radical polymerizable polyfunctional monomer (b) (i.e., TMPTA).

Thus, a photoreceptor (13) was prepared.

### PHOTORECEPTOR PREPARATION EXAMPLE 14

The procedure for preparation of the photoreceptor (9) was repeated except that the radical polymerizable polyfunctional monomers (a) and (b) were replaced with 10 parts of a radical polymerizable polyfunctional monomer (g) which is pentaerythritol hexaacrylate, KAYARADA DPHA from Nippon Kayaku Co., Ltd., which has 6 functional groups and which has a viscosity of 6000 mPa·s/25° C., a molecular weight of 552, and a ratio (Mw/F) of the molecular weight (Mw) to the number of functional groups (F) of 100).

Thus, a photoreceptor (14) was prepared.

### PHOTORECEPTOR PREPARATION EXAMPLE 15

The procedure for preparation of the photoreceptor (12) was repeated except that the radical polymerizable polyfunctional monomers (c) and (e) were replaced with 10 parts of the radical polymerizable polyfunctional monomer (c) (i.e., U-1 5FHA).

Thus, a photoreceptor (15) was prepared.

### PHOTORECEPTOR PREPARATION EXAMPLE 16

The procedure for preparation of the photoreceptor (1) was repeated except that the radical polymerizable polyfunctional monomers (a) and (b) were replaced with radical polymerizable polyfunctional monomer (c) and the following radical polymerizable polyfunctional monomer (h).

Radical polymerizable polyfunctional monomer (h) 5 parts

(1,6-hexanediol diacrylate, KS-HDDA from Nippon Kayaku Co., Ltd., which has 2 functional groups and which has a viscosity of 7 mPa·s/25° C., a molecular weight of 226, and a ratio (Mw/F) of the molecular weight (Mw) to the number of functional groups (F) of 226)

Thus, a photoreceptor (16) was prepared.

### PHOTORECEPTOR PREPARATION EXAMPLE 17

The procedure for preparation of the photoreceptor (9) was repeated except that the radical polymerizable polyfunctional monomer (b) was replaced with the following radical polymerizable monofunctional monomer (j).

Radical polymerizable monofunctional monomer (j) 5 parts

(2-(2-ethoxyethoxy)ethylacrylate, SR-256 from Nippon Kayaku Co., Ltd., which has a viscosity of 6 mPa·s/25° C., a molecular weight of 188, and a ratio (Mw/F) of the molecular weight (Mw) to the number of functional groups (F) of 188)

Thus, a photoreceptor (17) was prepared.

### PHOTORECEPTOR PREPARATION EXAMPLE 18

The procedure for preparation of the photoreceptor (11) was repeated except that the radical polymerizable polyfunctional monomers (f) and (b) were replaced with the radical polymerizable polyfunctional monomer (h) and the radical polymerizable monofunctional monomer (j), respectively.

Thus, a photoreceptor (18) was prepared.

### PHOTORECEPTOR PREPARATION EXAMPLE 19

The procedure for preparation of the photoreceptor (1) was repeated except that the CCTL was not formed.

The following components were mixed.

| | | |
|---|---|---|
| Trimethoxymethyl silane | 180 | g |
| 1-butanol | 280 | ml |
| 1% aqueous solution of acetic acid | 106 | ml |

The mixture was agitated at 60° C. for 2 hours.

Then 370 ml of 1-butanol was added thereto and the mixture was agitated for 48 hours. Further, 67.5 g of dihydroxymethyltriphenylamine (i.e., a difunctional compound having a charge transport structure), 1.7 g of an antioxidant (SANOL LS2626 from Sankyo Co. Ltd.) and 4.5 g of dibutyltin acetate were added thereto. Thus, a resin layer coating liquid was prepared. The coating liquid was coated on the CTL prepared above, and then the coated layer was heated for 1 hour at 120° C. to be crosslinked. Thus, a resin layer having a thickness of 1.5 μm was formed on the CTL and a photoreceptor (19) was prepared.

### PHOTORECEPTOR PREPARATION EXAMPLE 20

The procedure for preparation of the photoreceptor (1) was repeated except that the CCTL layer was not formed. Thus, a photoreceptor (20) was prepared.

Then the toner for use in the image forming apparatus will be further explained referring to examples.

Preparation of Toner A

The following components were mixed using a blender.

| | |
|---|---|
| Polyester resin | 100 parts |
| (serving as a binder resin, having a ½ flow | |
| starting temperature of 126° C.) | |
| Zinc salt of salicylic acid derivative | 3 parts |
| (serving as a charge controlling agent) | |
| Carbon black | 2 parts |
| (REGAL 400R from Cabot Corp.) | |

The mixture was melted and kneaded with a two roll mill heated at a temperature of from 100 to 110° C.

After being naturally cooled, the kneaded mixture was crushed with a cutter mill, followed by pulverization using a jet air pulverizer and classification using an air classifier. Thus, a toner A was prepared. After the toner particles were dipped in hot water at 80° C., the physical properties of the toner particles were measured. The results are as follows.

Average circularity: 0.940

Volume average particle diameter (Dv): 6.4 μm

Number average particle diameter (Dp): 4.7 μm

Dv/Dp ratio: 1.35

Preparation of Toner B

The procedure for preparation of the toner A was repeated except that the classification conditions were changed and the amount of fine toner particles is decreased. Thus, a toner B was prepared. After the toner particles were dipped in hot water at 80° C., the physical properties of the toner particles were measured. The results are as follows.

Average circularity: 0.968

Volume average particle diameter (Dv): 5.4 μm

Number average particle diameter (Dp): 4.5 μm

Dv/Dp ratio: 1.20

Preparation of Toners b1-b9

The procedure for preparation of the toner B except that that the classification conditions and the hot water heating conditions (heating temperature and time) were changed while the volume average particle diameter (Dv) was controlled so as to be 6.0 μm.

Thus, toners b1-b9 having a average circularity of from 0.94 to 0.98 and a ratio (Dv/Dp) of from 1.05 to 1.35 were prepared.

Preparation of Toner C

The following components were fed in a beaker.

| | |
|---|---|
| Solution of styrene - acrylic copolymer | 240 parts |
| (solvent: ethylacetate/methyl ethyl ketone) | |
| Pentaerythritol tetrabehenate | 20 parts |
| (melting point of 81° C., melt viscosity of 25 cps) | |
| Copper phthalocyanine blue pigment | 4 parts |

The mixture was agitated at 60° C. using a TK HOMOMIXER from Tokushu Kika Kogyo Co., Ltd. which was rotated at a revolution of 12000 rpm. Thus, a dispersion (A) was prepared.

On the other hand, the following components were fed in a beaker.

| | |
|---|---|
| Ion-exchange water | 706 parts |
| 10% suspension of hydroxyapatite | 294 parts |
| (SUPERTITE 10 (trademark) from Nippon | |
| Chemical Industrial Co., Ltd.) | |
| Sodium dodecylbenzenesulfonate | 0.2 parts |

Thus, a dispersion (B) was prepared. After being heated to 60° C., the dispersion (B) was agitated with a mixer, TK HOMOMIXER (trademark), which was rotated at a revolution of 12000 rpm. Then the dispersion (A) prepared above was added thereto, and the mixture was agitated for 10 minutes. After being fed in a flask equipped with a stirrer and a thermometer, the mixture was heated to 98° C. to remove the solvent therefrom. Then the dispersion was subjected to filtering, washing, drying and classification treatments. Thus a toner C was prepared. The physical properties of the toner C were as follows.

Average circularity: 0.988

Volume average particle diameter (Dv): 3.3 μm

Number average particle diameter (Dp): 3.1 μm

Dv/Dp ratio: 1.05

Preparation of Toner D

The procedure for preparation of the toner C was repeated except that the agitation conditions under which the mixture of the dispersions (A) and (B) was agitated were changed to 9000 rpm (rotation speed) and 20 minutes (agitation time). Thus, a toner D was prepared. The physical properties of the toner D were as follows.

Average circularity: 0.980

Volume average particle diameter (Dv): 8.8 μm

Number average particle diameter (Dp): 8.0 μm

Dv/Dp ratio: 1.10

Preparation of Developers A, B, C and b1-b9

One hundred parts of each of the toners A, B, C and b1-b9 was mixed with 1.5 parts of a hydrophobized silica having a specific surface area of 40 m²/g and a bulk density of 190 g/l) using a mixer HENSCHEL MIXER (trademark). Then 5 parts by weight of each toner was mixed with 95 parts by weight of a spherical carrier which had been coated with a silicone resin and which has an average particle diameter of 50 μm. Thus, developers A, B, C and b1-b9 were prepared.

Preparation of Developer D

One hundred parts of the toner D was mixed with 1.5 parts of a hydrophobized silica having a specific surface area of 40 m²/g and a bulk density of 190 g/l) and 0.2 parts of zinc stearate using a mixer HENSCEL MIXER (trademark). Then 5 parts by weight of the toner was mixed with 95 parts by weight of a spherical carrier which had been coated with a silicone resin and which has an average particle diameter of 50 μm. Thus, a developer D was prepared.

Then a method for manufacturing a toner using a urea-modified polyester resin as a binder resin will be explained.

Preparation of Toner (1)

Preparation of Toner Particles

Preparation of Aqueous Phase Liquid

The following components were fed in a reaction vessel equipped with a stirrer and a thermometer.

| | |
|---|---|
| Water | 683 parts |
| Sodium salt of sulfate of ethylene oxide adduct of | 11 parts |
| methacrylic acid | |
| (ELEMINOL RS-30 (trademark) from Sanyo | |
| Chemical Industries Ltd.) | |
| Styrene | 138 parts |
| Methacrylic acid | 138 parts |
| Ammonium persulfate | 1 part |

The mixture was agitated for 15 minutes while the stirrer was rotated at a revolution of 400 rpm. As a result, a milky emulsion was prepared.

Then the emulsion was heated for 5 hours at 75° C. to react the monomers.

Further, 30 parts of a 1% aqueous solution of ammonium persulfate was added thereto, and the mixture was aged for 5 hours at 75° C. Thus, an aqueous dispersion of a vinyl resin (i.e., a copolymer of styrene/methacrylic acid/butyl acrylate/sodium salt of sulfate of ethylene oxide adduct of methacrylic acid, hereinafter referred to as particulate resin dispersion (1)) was prepared.

The volume average particle diameter of the particles in the particulate resin dispersion (1), which was measured with an instrument LA-920 from Horiba Ltd., was 0.14 μm. In addition, part of the particulate resin dispersion (1) was dried to prepare a solid of the vinyl resin. It was confirmed that the vinyl resin has a glass transition temperature of 52° C.

In a reaction vessel equipped with a stirrer, 990 parts of water, 80 parts of the particulate resin dispersion (1) prepared above, 40 parts of an aqueous solution of a sodium salt of dodecyldiphenyletherdisulfonic acid (ELEMINOL MON-7 (trademark) from Sanyo Chemical Industries Ltd., solid content of 48.5%), and 90 parts of ethyl acetate were mixed while agitated. As a result, a milky liquid (hereinafter referred to as an aqueous phase liquid (1)) was prepared.

Preparation of Low Molecular Weight Polyester Resin

The following components were fed in a reaction vessel equipped with a condenser, a stirrer and a nitrogen feed pipe to perform a polycondensation reaction for 8 hours at 230° C. under normal pressure.

| | |
|---|---|
| Ethylene oxide (2 mole) adduct of | 220 parts |
| bisphenol A | |
| Propylene oxide (3 mole) adduct of | 561 parts |
| bisphenol A | |
| Terephthalic acid | 218 parts |
| Adipic acid | 48 parts |
| Dibutyltin oxide | 2 parts |

Then the reaction was further continued for 5 hours under a reduced pressure of from 10 to 15 mmHg.

Further, 45 parts of trimellitic anhydride was fed to the container to be reacted with the reaction product for 2 hours at 180° C. Thus, an unmodified polyester resin (1) was prepared. The unmodified polyester resin (1) has a number average molecular weight (Mn) of 2500, a weight average molecular weight (Mw) of 6700, a glass transition temperature (Tg) of 43° C. and an acid value of 25 mgKOH/g.

Preparation of Prepolymer (i.e., Polymer Reactive with Active Hydrogen Atom Containing Compound)

The following components were fed in a reaction vessel equipped with a condenser, a stirrer and a nitrogen feed pipe.

| | |
|---|---|
| Ethylene oxide (2 mole) adduct of | 682 parts |
| bisphenol A | |
| Propylene oxide (2 mole) adduct of | 81 parts |
| bisphenol A | |
| Terephthalic acid | 283 parts |
| Trimellitic anhydride | 22 parts |
| Dibutyl tin oxide | 2 parts |

The mixture was reacted for 8 hours at 230° C. under normal pressure.

Then the reaction was further continued for 5 hours under a reduced pressure of from 10 to 15 mmHg. Thus, an intermediate polyester resin (1) was prepared. The intermediate polyester (1) had a number average molecular weight (Mn) of 2,100, a weight average molecular weight (Mw) of 9,500, a glass transition temperature (Tg) of 55° C., an acid value of 0.5 mgKOH/g and a hydroxyl value of 51 mgKOH/g.

In a reaction vessel equipped with a condenser, a stirrer and a nitrogen feed pipe, 410 parts of the intermediate polyester resin (1), 89 parts of isophorone diisocyanate and 500 parts of ethyl acetate were mixed and the mixture was heated at 100° C. for 5 hours to perform the reaction. Thus, a polyester prepolymer (1) having an isocyanate group was prepared. The content of free isocyanate included in the polyester prepolymer 1 was 1.53% by weight.

Synthesis of Ketimine Compound

In a reaction vessel equipped with a stirrer and a thermometer, 170 parts of isophorone diamine and 75 parts of methyl ethyl ketone were mixed and reacted for 5 hours at 50° C. to prepare a ketimine compound. The ketimine compound has an amine value of 418 mgKOH/g.

Preparation of Master Batch

The following components were mixed with a mixer HENSCHEL MIXER (trademark).

| | |
|---|---|
| Carbon black | 40 parts |
| (REGAL 400R (trademark) from Cabot Corp.) | |
| Polyester resin | 60 parts |
| (RS-801 from Sanyo Chemical Industries Ltd., acid | |
| value of 10 mgKOH/g, weight average molecular | |
| weight (Mw) of 20,000 and glass transition | |
| temperature (Tg) of 64° C.) | |
| Water | 30 parts |

Thus, a mixture in which aggregated pigment penetrated with water was prepared.

The mixture was kneaded for 45 minutes at 130° C. using a two roll mill. After being cooled by rolling, the kneaded mixture was pulverized with a pulverizer (manufactured by Hosokawa Micron Co., Ltd.) so as to have a size of 1 mm. Thus, a master batch (1) was prepared.

Preparation of Oil Phase Liquid

In a reaction vessel equipped with a stirrer and a thermometer, 378 parts-of the unmodified polyester resin (1), 110 parts of carnauba wax, 22 parts of a charge controlling agent (salicylic acid metal complex E-84 from Orient Chemical Co., Ltd.), and 947 parts of ethyl acetate were mixed and the mixture was heated to 80° C. while agitated. After being heated at 80° C. for 5 hours, the mixture was cooled to 30° C. over 1 hour. Then 500 parts of the master batch (1) and 500 parts of ethyl acetate were added to the vessel, and the mixture was agitated for 1 hour to prepare a raw material dispersion (1).

Then 1324 parts of the raw material dispersion 1 were subjected to a dispersion treatment using a bead mill (ULTRAVISCOMILL (trademark) from Aimex Co., Ltd.). The dispersing conditions were as follows.

Liquid feeding speed: 1 kg/hour

Peripheral speed of disc: 6 m/sec

Dispersion media: zirconia beads with a diameter of 0.5 mm

Filling factor of beads: 80% by volume

Repeat number of dispersing operation: 3 times (3 passes)

Then 1324 parts of a 65% ethyl acetate solution of the unmodified polyester resin (1) prepared above was added thereto. The mixture was subjected to the dispersion treatment using the bead mill. The dispersion conditions are the same as those mentioned above except that the dispersion operation was performed once (i.e., one pass).

The thus prepared colorant/wax dispersion (1) had a solid content of 50% when it was determined by heating the liquid at 130° C. for 30 minutes.

Emulsification and Solvent Removal

Then the following components were mixed in a vessel.

| | | |
|---|---|---|
| Colorant/wax dispersion (1) prepared above | 648 | parts |
| Prepolymer (1) prepared above | 154 | parts |
| Ketimine compound (1) prepared above | 6.6 | parts |

The components were mixed for 1 minute using a mixer TK HOMOMIXER (trademark) from Tokushu Kika Kogyo K.K. at a revolution of 5,000 rpm. Thus, an oil phase liquid (1) (i.e., a toner composition liquid) was prepared.

In a container, 1,200 parts of the aqueous phase liquid (1) and the oil phase liquid (1) prepared above were mixed for 20 minutes using a mixer TK HOMOMIXER (trademark) at a revolution of 13,000 rpm. Thus, an emulsion (1) was prepared.

The emulsion (1) was fed into a container equipped with a stirrer and a thermometer, and the emulsion was heated for 8 hours at 30° C. to remove the organic solvent (ethyl acetate) from the emulsion. Then the emulsion was aged for 4 minutes at 45° C. Thus, a dispersion (1) was prepared. The particles dispersed in the dispersion 1 have a volume average particle diameter of 5.95 μm and a number average particle diameter of 5.45 μm, which was measured with an instrument MULTISIZER II (trademark) from Macbeth Coulter Inc.

Washing and Drying

One hundred (100) parts of the dispersion (1) was filtered under a reduced pressure.

The thus obtained wet cake was mixed with 100 parts of ion-exchange water and the mixture was agitated for 10 minutes with a TK HOMOMIXER at a revolution of 12,000 rpm, followed by filtering. Thus, a wet cake (a) was prepared.

The thus prepared wet cake (a) was mixed with 100 parts of a 10% sodium hydroxide. The mixture was agitated for 30 minutes with a mixer TK HOMOMIER (trademark) at a revolution of 12000 rpm while a ultrasonic wave was applied thereto. Then the mixture was filtered. This ultrasonic alkali washing operation was performed twice.

The thus prepared wet cake (b) was mixed with 100 parts of a 10% hydrochloric acid. The mixture was agitated for 10 minutes with a mixer TK HOMOMIER (trademark) at a revolution of 12000 rpm, followed by filtering. The thus prepared wet cake (c) was mixed with 300 parts of ion-exchange water and the mixture was agitated for 10 minutes with a mixer TK HOMOMIXER (trademark) at a revolution of 12,000 rpm, followed by filtering. This washing operation was performed twice. Thus, a wet cake (1) was prepared.

The wet cake (1) was dried for 48 hours at 45° C. using a circulating air drier, followed by sieving with a screen having openings of 75 μm.

Thus, polymerization toner particles (1) were prepared.

The toner particles (1) had an average circularity of 0.995, a volume average particle diameter Dv of 6.2 μm, a number average particle diameter Dn of 6.13 μm and a ratio Dv/Dn of 1.01.

Preparation of Toner Particles (2) and (3)

The procedure for preparation of toner particles (1) was repeated except that the manufacturing conditions were changed to prepare toner particles (2) and (3).

The toner particles (2) had an average circularity of 0.962, a volume average particle diameter Dv of 6.1 μm, a number average particle diameter Dn of 5.0 μm and a ratio Dv/Dn of 1.20.

The toner particles (3) had an average circularity of 0.950, a volume average particle diameter Dv of 6.0 μm, a number average particle diameter Dn of 4.8 μm and a ratio Dv/Dn of 1.25.

Preparation of Toners E1, E2 and E3

One hundred parts of each of the toner particles (1), (2) and (3) was mixed with 1.5 parts by weight of a hydrophobized silica having a specific surface area of 40 m²/g and a bulk density of 190 g/l) and 0.2 parts by weight of zinc stearate using a mixer HENSCHEL MIXER (trademark). Thus toners E1, E2 and E3 were prepared.

Preparation of Developer E1-E3

Five (5) parts by weight of each of the thus prepared toners was mixed with 95 parts by weight of a spherical carrier which had been coated with a silicone resin and which has an average particle diameter of 50 μm. Thus, developers E1, E2 and E3 were prepared.

Next, the cleaning device and image forming apparatus of the present invention will be explained.

### First Embodiment

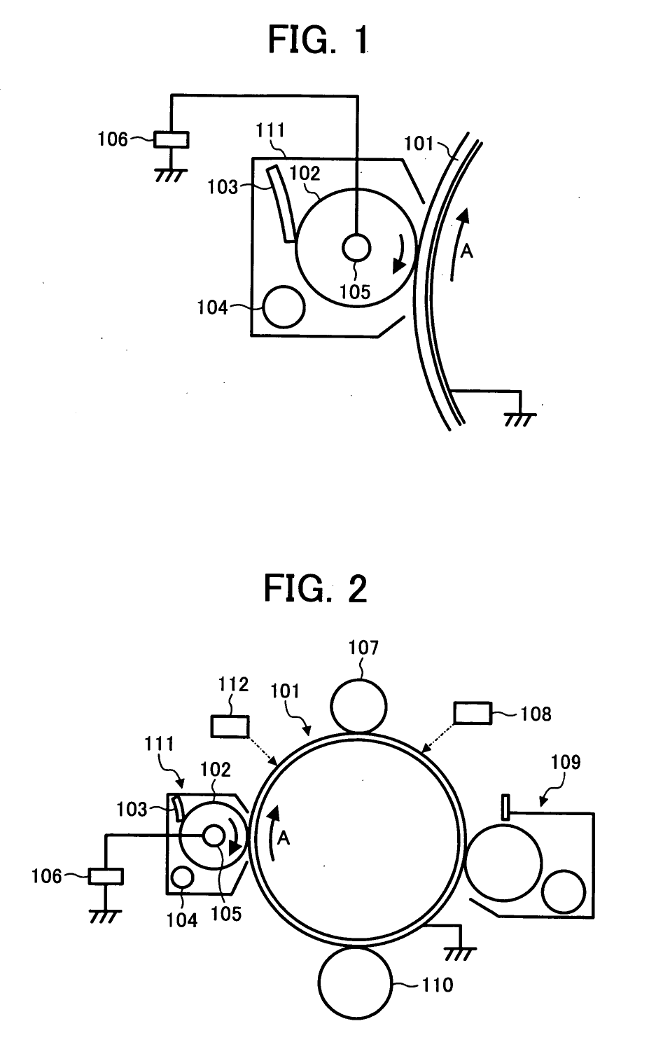

FIG. 1 is a schematic view illustrating a cleaning device for use in the image forming apparatus of the present invention.

The photoreceptor prepared above is used as an image bearing member 101. As illustrated in FIG. 1, a cleaning device 111 includes a cleaning member 102, a scraper blade 103 and a feeding coil 104. The cleaning member 102 includes a metal shaft 105, and an electroconductive elastic layer which is formed on the metal shaft 105 and which is made of, for example, a molded electroconductive rubber layer and has a rubber hardness of from 15 to 80° and a volume resistivity of from 10⁵ to 10¹⁵ Ω·cm. In addition, a tube or a layer which is made of an electroconductive fluorine-containing resin having a volume resistivity of from 10⁶ to 10¹⁶ Ω·cm can be overlaid on the elastic layer.

The cleaning member 102 is pressed toward the surface of the image bearing member 101 by a pressing member (not shown) at a pressure of from 300 to 700 gf. In addition, the cleaning member is set such that the surface of the cleaning member is contacted with the image bearing member while recessed at a length of from 0.1 to 1.0 mm (hereinafter this length is referred to as a bending distance). The surface of the cleaning member 102 has a ten point mean roughness (Rz) not greater than 5 μm.

In this embodiment, the cleaning member has a structure such that an electroconductive elastic layer having a rubber hardness of 70° and a volume resistivity of 10⁹ Ω·cm is formed on the metal shaft 105. The cleaning member 102 is pressed toward the surface of the image bearing member 101 at a pressure of 500 gf. The cleaning member is set so as to have a bending distance of 0.3 mm. The cleaning member 102 is rotated by driving means (not shown) at the same speed as that of the image bearing member 101. When the cleaning member 102 is rotated, toner particles remaining on the image bearing member 101 is transferred to the cleaning member 102. The toner particles thus transferred are removed from the surface of the cleaning member 102 by being scraped with the scraper blade 103 which is made of a polyurethane sheet and which is supported by a blade holder. The toner particles thus scraped off fall on the feeding coil 104 and are then discharged from the cleaning device by the feeding coil. Numeral 106 denotes a power source which applied a voltage to the metal shaft 105 of the cleaning member 102.

FIG. 2 is a schematic view illustrating an embodiment of the image forming apparatus of the present invention including the cleaning device illustrated in FIG. 1.

The image forming apparatus includes the image bearing member 101 rotating in a direction indicated by an arrow A, and a charging device 107, a light irradiating device 108, a developing device 109, a transferring device 110, the cleaning device 111 and a discharging device 112, which are arranged around the image bearing member 101. In addition, the image forming apparatus includes a fixing device (not shown) configured to fix a toner image, which has been transferred onto a receiving material from the image bearing member, to the receiving material.

The charging device 107 is arranged so as to be contacted with the image bearing member 101. The charging device applies a predetermined voltage to the image bearing member such that the image bearing member has a predetermined potential with a predetermined polarity.

In the image forming apparatus illustrated in FIG. 2, the image bearing member 101 is negatively charged with a charging roller. A scorotron charger in which a combination of a wire electrode and a grid electrode is set so as not to be contacted with the image bearing member can also be used as the charging device 107. The light irradiating device 108 includes a laser diode (LD) as a light source, and irradiates the charged image bearing member with imagewise light to form an electrostatic latent image. Other light emitting elements such as LEDs can be used as the light source of the light irradiating device 108.

The developing device 109 includes a developer bearing member which includes a fixed magnet roller therein and which is configured to feed the developer while bearing the developer thereon, and a feeding screw configured to feed the developer to the developer bearing member while agitating the developer. The developing device illustrated in FIG. 2 uses a two component developing method using a two component developer including a toner and a magnetic carrier. However, the developing method is not limited thereto and a one component developing method using a developer including a toner and no carrier can also be used.

A voltage is applied to the developer bearing member by a power source to adhere the charged toner to an electrostatic latent image in the developing region, resulting in formation of a toner image.

The transferring device 110 transfers the toner image on the image bearing member to a receiving material at a nip in which the transferring device 110 is pressure-contacted with the image bearing member 101 with the receiving material therebetween. In this case, a voltage is applied to the transferring device by a power source (not shown). In FIG. 2, a transfer roller is used as the transfer member, but other members such as corotrons and transfer belts can also be used.

The discharging device 112 is configured to discharge the charges remaining on the image bearing member 101, and a light emitting diode (LED) is used therefor in FIG. 2.

The image bearing member 101 of the image forming apparatus illustrated in FIG. 2 is rotated at a speed of 200 mm/sec.

In the image forming apparatus illustrated in FIG. 2, toner particle remaining on the image bearing member 101 even after the image transfer process is removed at a point in which the image bearing member faces the cleaning roller 102.

When a solid toner image is formed using the developer A (average circularity of 0.94) and then transferred onto a receiving material, the charge quantity per a unit weight (Q/M) of toner particles remaining on the image bearing member is measured while the transfer bias voltage is changed. Specifically, the procedure is as follows:
(1) an electrostatic solid image having a predetermined image proportion is formed on the image bearing member, followed by developing, transferring and cleaning;
(2) the switch of the image forming apparatus is forcibly turned off after completion of each of the above-mentioned processes and the toner particles remaining on the image bearing member are sucked using an air pump; and
(3) the charge quantity of the collected toner particles is measured with a coulomb meter (ELECTROMETER 611 (trademark) from Keithley Instruments Inc.) to determine the charge quantity (Q/M) of the toner per a unit weight (μC/g);

The results are shown in Table 3.

TABLE 3

| Charge quantity of toner | | |
|---|---|---|
| particles used for | | Charge quantity (Q/M) of |
| developing | Transfer bias | toner particles of residual |
| (μC/g) | voltage (V) | toner particles (μC/g) |
| −20.8 | 1600 | −15.4 |
| −20.8 | 1850 | −8.2 |
| −20.8 | 2100 | −6.8 |

It is clear from Table 3 that by changing the transfer bias voltage, the charge quantity (Q/M) of the residual toner particles is changed.

The transfer efficiency changes depending on the variables such as choice of receiving materials, environmental conditions under which the image forming apparatus is used, image forming modes, and time of use. Therefore, it is preferable to control the conditions of the transferring device to stably produce high quality images. In this regard, it is preferable to control the transfer bias voltage. In this case, the charge quantity of the residual toner particles changes as shown in Table 3.

When the residual toner particles have a negative charge as shown in Table 3, it is preferable to apply a positive DC voltage to the metal shaft 105 by the power source 106 to form a positive electric field between the cleaning member 102 and the image bearing member 101. In this case, the negatively charged residual toner particles on the image bearing member 101 are adhered to the cleaning member 102 and thereby the surface of the image bearing member is cleaned.

In this embodiment, the image bearing member 101 and the cleaning member 102 are rotated at the same speed and a voltage of 700 V is applied to the metal shaft 105 of the cleaning member 102. In this case, the density of the residual toner on the image bearing member, which is determined by transferring the residual toner to an adhesive tape and measuring the density of the tape with a densitometer, is 0.02. Namely, the surface of the image bearing member is well cleaned. As a result of the present inventors' study, it is found that the surface of the image bearing member is well cleaned when the applied voltage is in a range of from 400 to 800 V. However, the proper bias voltage changes depending on variables such as thickness and resistivity of the cleaning member used.

The present inventors made an experiment in which the residual toner density is measured while using the above-prepared three toners A, B and C having a circularity of 0.94, 0.96 and 0.98, respectively. The results are shown in Table 4 below.

The method for determining the density of residual toner particles on the image bearing member is as follows:
(1) the toner particles remaining on the image bearing member even after the cleaning process are transferred to a transparent adhesive tape (PRINTAC (trademark) from Nitto Denko Corp.); and

(2) the reflection densities of the adhesive tape with toner particles and the adhesive tape without toner particles are measured with a densitometer (X-RITE 938 (trademark) from X-Rite Corp.) to determined the difference between the densities, which is the density of the residual toner (hereinafter referred to as the residual toner density).

TABLE 4

| Voltage applied | Toner A | Toner B | Toner C |
|---|---|---|---|
| to cleaning | (circularity | (circularity | (circularity |
| roller (V) | of 0.94) | of 0.96) | of 0.98) |
| 350 | 0.132 | 0.022 | 0.005 |
| 500 | 0.074 | 0.007 | 0.004 |
| 600 | — | 0.004 | — |
| 700 | 0.054 | 0.002 | 0.001 |
| 800 | — | 0.004 | — |
| 900 | 0.114 | 0.006 | 0.001 |

It is clear from Table 4 that the toners B and C have better cleanability than the toner A.

In addition, the same experiment was performed (i.e., the residual toner density was maeasured) using the developers b1-b9 (i.e., by changing the average circularity and the ratio (Dv/Dp)). The results are shown in Table 5.

TABLE 5

| | | Average circularity of toner | | |
|---|---|---|---|---|
| | | 0.94 | 0.96 | 0.98 |
| Dv/Dp | 1.05 | 0.044 | 0.001 | 0.000 |
| | 1.20 | 0.074 | 0.007 | 0.004 |
| | 1.35 | 0.088 | 0.013 | 0.001 |

It is clear from Table 5 that the smaller ratio (Dv/Dp) a toner has, the better cleanability the toner has. In this experiment, the toner has a volume average particle diameter of 6 μm.

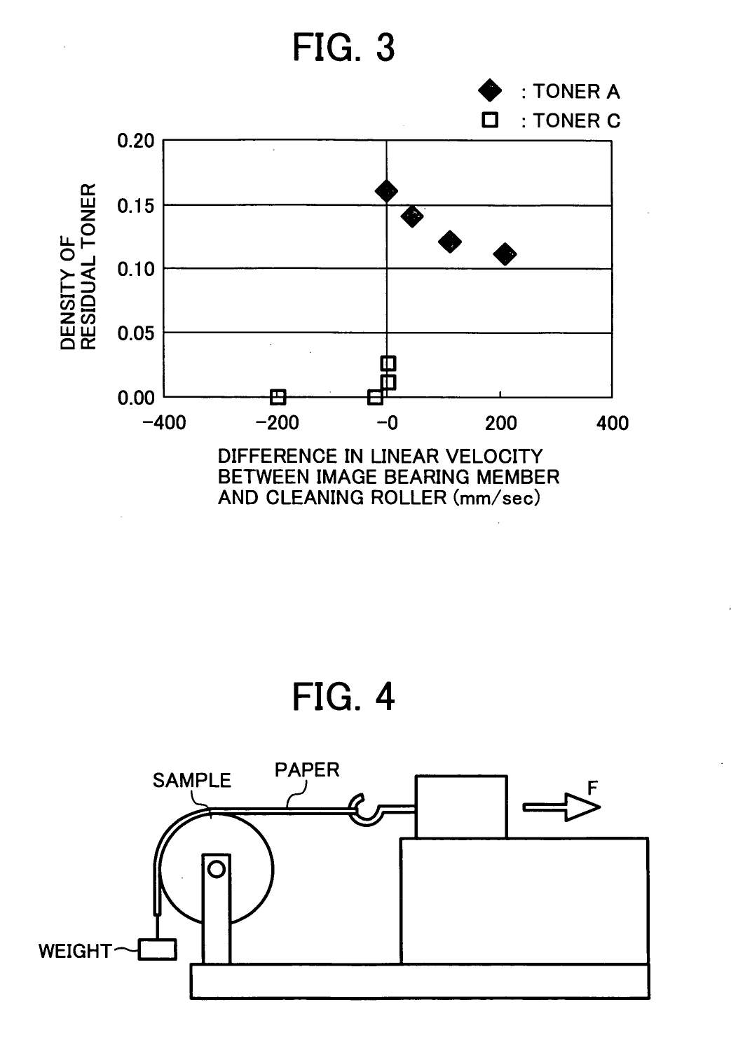

Then the present inventors made another experiment to check the dependence of the cleaning efficiency on the difference in rotation speed between the image bearing member 101 and the cleaning member 102. Specifically, the cleaning member 102 was rotated by a driving device at a speed different from the rotation speed of the image bearing member 101. The procedure for evaluation of the residual toner density mentioned above was repeated except that a voltage of +500 V was applied to the metal shaft 105 when the toner A was used, and a voltage of +600 V was applied to the metal shaft 105 when the toner C was used. The results are shown in FIG. 3. It is clear from FIG. 3 that as the difference in rotation speed increases, the residual toner density decreases.

When the cleaning member 102 is rotated so as to counter the image bearing member 101 (i.e., in the minus direction in the horizontal axis in FIG. 3), good cleaning effects can be produced. However, in this case the surface of the cleaning member 102 is greatly abraded particularly when the amount of residual toner particles is small because the cleaning member is softer than the image bearing member 101. Therefore, it is preferable that the difference in rotation speed is less than 10% of the rotation speed of the image bearing member 101 while the cleaning member 102 is rotated so as to trail along behind the image bearing member 101.

Then the present inventors made another experiment to check the dependence of the cleaning efficiency on the static friction coefficient (μ) of the surface of the cleaning member 102. Specifically, the cleaning efficiency was checked while the image bearing member 101 and the cleaning member 102 are rotated at different rotation speeds while the static friction coefficient (μ) of the cleaning member 102 was changed. The static friction coefficient (μOPC) of the surface of the image bearing member was changed by applying a stick of zinc stearate to the surface of the image bearing member 101. In addition, the static friction coefficient of the cleaning device 102 was changed by changing the material of the cleaning member. The static friction coefficients of the surfaces of the image bearing member and the cleaning member were measured with an instrument utilizing the Euler belt method, which is illustrated in FIG. 4.

In FIG. 4, two hooks are set at each end of a paper (TYPE 6200 PAPER from NBS Ricoh) and a weight (100 g) is set at one hook and a digital force gauge is set at the other hook. The paper is set in the measuring instrument so as to contact a sample which is fixed by a support as shown in FIG. 4. The paper contacts one fourth of the peripheral surface of the sample. The paper is pulled slowly with the digital force gauge. Provided when a force at which the paper starts to move is F, the coefficient of static friction of the sample is determined by the following equation:
[2ss=(π/2)ln(F/w)
wherein μs is the coefficient of static friction of the sample, F is the measured value of the force, and w is the weight (gram-force).

The experimental conditions were as follows:

Rotation speed of image bearing member: 94 mm/sec

Rotation speed of cleaning member: 113 mm/sec

(the cleaning member is rotated so as to counter the image bearing member)

Difference in rotation speed: −207 mm(i.e., 94-(−113))

Static friction coefficient (μOPC)

of image bearing member: 0.375

Bias applied to cleaning member: 0 V

As a result of the experiment, it is found that when the static friction coefficient (μR) of the cleaning member is greater than the static friction coefficient (μOPC) of the image bearing member, residual toner particles can be well removed. In this example, the cleaning bias is not applied. When a bias of from +400 to +800 V was applied, good cleaning effects can also be produced. By applying a proper bias to the cleaning member, the difference in rotation speed can be minimized. By using this technique, the abrasion of the cleaning member can be reduced.

If it is needed to increase the transfer voltage due to, for example, changes of environmental conditions and deterioration of image forming members with time, the residual toner becomes to have a positive charge as shown in Table 6 below. In this case, the residual toner cannot be well removed if a positive bias is applied to the cleaning member.

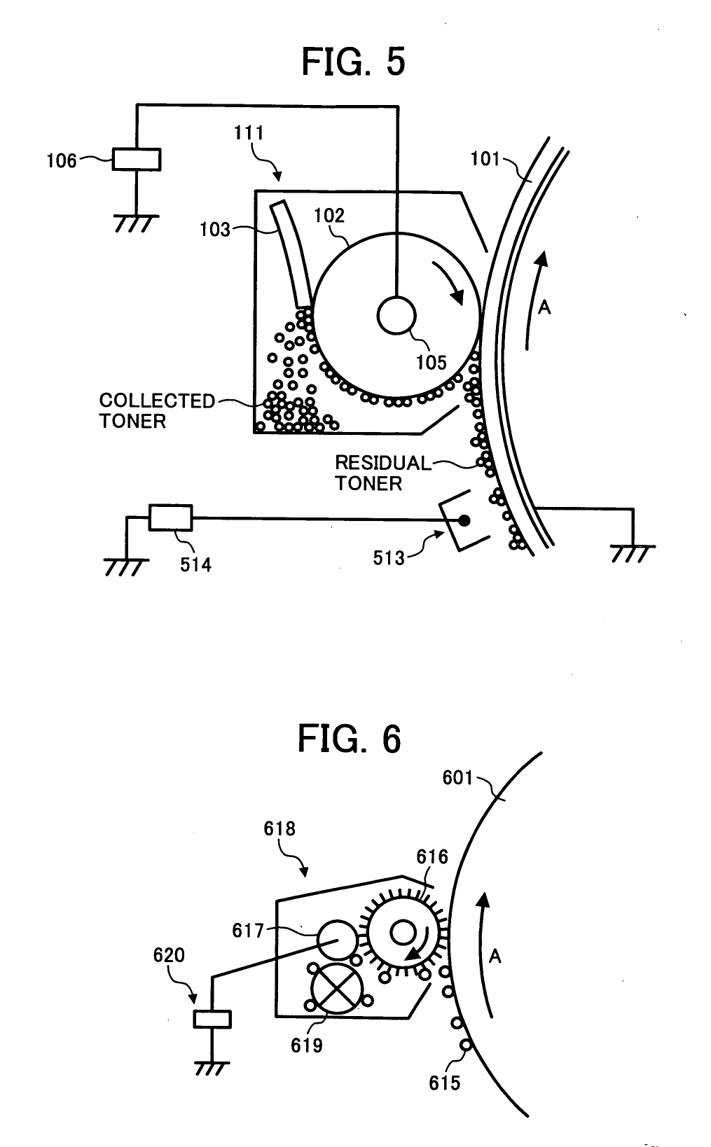

In order to well remove such a residual toner, a polarity controlling device 513 is preferably provided before the cleaning member 102 as illustrated in FIG. 5. In the cleaning device-illustrated in FIG. 5, a tungsten wire is used as the polarity controlling device 513. Specifically, an AC voltage (100 μA) and a DC voltage (−60 μA) are applied to the tungsten wire by a power source 514 to perform corona discharging, thereby applying a negative charge to the residual toner and the image bearing member 101. In this experiment, the charge of the residual toner after the corona discharging process is shown in Table 6.

TABLE 6

| | | Charge | Charge quantity of |
|---|---|---|---|
| Charge quantity of | | quantity of | residual toner |
| toner particles used | Transfer | residual toner | particles after |
| for developing | voltage | particles | corona discharging |
| (μC/g) | (V) | (μC/g) | (μC/g) |
| −24.8 | 1600 | −15.4 | −14.5 |
| −24.8 | 1850 | −8.2 | −13.5 |
| −24.8 | 2100 | −6.8 | −12.3 |
| −24.8 | 2350 | 1.8 | −11.0 |
| −24.8 | 2600 | 6.2 | −8.3 |

The thus negatively charged residual toner is then fed to a point in which the image bearing member 101 faces the cleaning member 102. Since a DC voltage is applied to the metal shaft 105 of the cleaning member 102 by the power source 106, the residual toner is adhered to the cleaning member 102 due do the electric field formed between the image bearing member and the cleaning member. Thus, the residual toner can be well removed.

### Second Embodiment

FIG. 6 is a schematic view illustrating another embodiment of the cleaning device for use in the image forming apparatus of the present invention. The photoreceptor (1) is used as the image bearing member 601.

Toner particles 615 remaining on an image bearing member 601 are clockwise fed and are removed from the surface of the image bearing member by a brush roller 616. Toner particles adhered to the brush roller and remaining thereon without being removed from the brush roller are knocked-off by a bias roller 617. In this case, the bias roller may be rotated or fixed. The toner particles released from the brush roller 616 or the bias roller 617 are collected by a collection roller 619 provided in a cleaning unit 618 to be fed to a developing tank and to be reused. Alternatively, in order to stabilize the image forming system, the collected toner particles may be fed to a waste toner bottle to be disposed of.

When the residual toner particles have a charge, a bias may be applied by a transfer bias source 620 to the bias roller 617. In this case, a voltage is applied to the tip of the brush of the brush roller and thereby an electrostatic force is applied to the brush as well as the mechanical force, and thereby the residual toner can be well removed.

In this embodiment, a bias is applied to the bias roller 617, but a bias may be directly applied to the metal shaft of the brush roller 616. In this case, the bias is a DC voltage, an AC voltage or a DC voltage overlapped with an AC voltage. By applying such a bias, the residual toner having an opposite charge is attracted by the brush. When an AC voltage is applied, the charge of the toner particles is discharged, and thereby the toner particles are removed from the image bearing member by a mechanical force of the brush.

The brush roller preferably has a structure in that bundles of hairs are arranged at regular intervals while the positions of the bundles are different from those of the adjacent lines of the bundles as illustrated in FIG. 12. In this case, residual toner particles can be securely removed from the surface of the image bearing member. The brush preferably satisfies the following relationship:
d≧P/n
wherein d represents the diameter of hairs of the brush; P represents the interval of bundle of hairs; and n represents the number of lines of the hairs in the rotation direction of the brush (i.e., the row direction illustrated in FIG. 12). In this case, occurrence of a problem in that some of residual toner particles pass through the bundles of hairs, resulting in defective cleaning can be prevented. In addition, each of the hairs of the brush preferably has a trunk and a branch connected with the trunk as illustrated in FIG. 15 to securely remove residual toner particles from the image bearing member.

### Third Embodiment

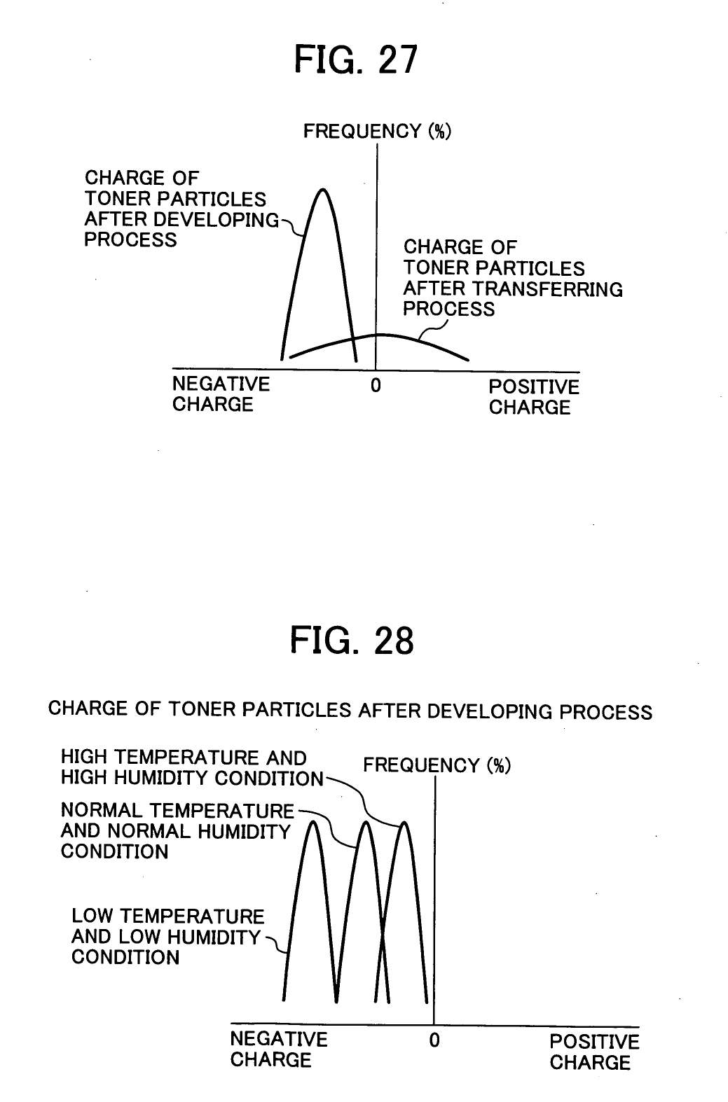

In the toner image transfer process, by applying a high voltage, a toner image on the image bearing member is electrostatically transferred to a receiving material or an intermediate transfer medium which is typically used for forming a full color image. In this case, a discharging phenomenon may be caused between the image bearing member and the electrode applying the transfer bias, thereby causing a problem in that the polarity of toner particles having a small amount of charge or toner particles having an abnormal charge is reversed. Therefore, a problem in that the residual toner includes toner particles with a negative charge and toner particles with a positive charge occurs. The toner particles in this state are illustrated in FIG. 27.

In order to avoid such a problem (i.e., in order to uniformize the polarity of the residual toner), charging is performed before the cleaning process. Since a high voltage is directly applied to the image bearing member in this charging process, ozone and NOx are produced. These gasses not only adversely affect environment and human being, but also deteriorate image qualities by being adhered to the surface of the image bearing member.

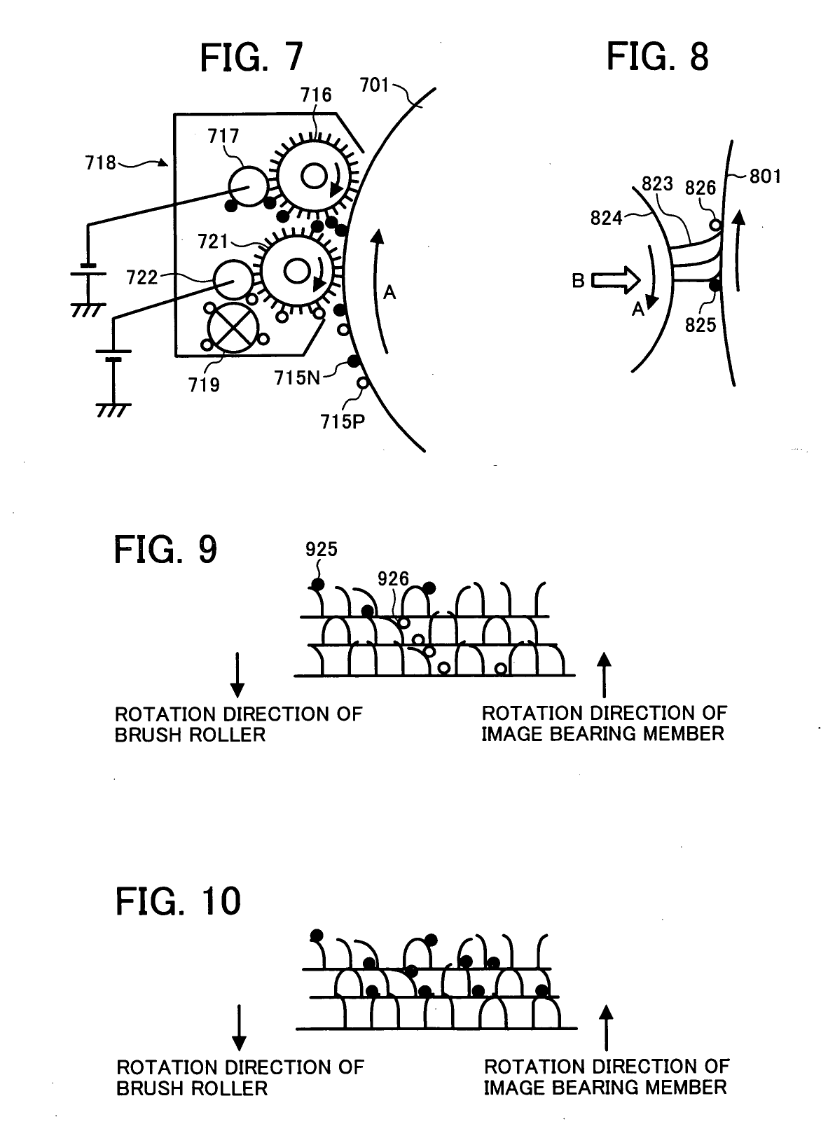

Therefore, it is preferable that a proper bias voltage is applied to the cleaning member instead of the discharging treatment. FIG. 7 is a schematic view illustrating another example of the cleaning device for use in the present invention. A cleaning device 718 includes a brush roller 721 to which a negative voltage is applied and another brush roller 716 which is provided on a downstream side from the brush roller 721 and to which a positive transfer bias is applied. By using such a cleaning device, a residual toner including both toner particles 715 N with a negative charge and toner particles 715 P with a positive charge can be well removed. In FIG. 7, each of numerals 717 and 722 denotes a bias roller. Numerals 719 denotes a toner collection roller.

FIG. 8 is a schematic side view illustrating how toner particles remaining on an image bearing member are removed therefrom.

The brush roller has a configuration such that a cloth on which hairs 823 are transplanted is spirally wound on a metal shaft 824. Suitable materials for use as the cloth include polyester cloths and nylon cloths. The hairs 823 are typically straight hairs or looped hairs, and are transplanted at a density of from 50,000 to 150,000 lines/inch². Bundles of hairs each including 30 to 50 hairs are transplanted and at an interval of form 0.7 to 0.9 mm. The hairs have a thickness of from 15 to 30 μm and are made of a carbon-containing acrylic fiber. The brush roller is set such that the tips of hairs are contacted with an image bearing member 801 while bent at a length of about 0.5 mm (i.e., the brush achieves a buckling state as illustrated in FIG. 8). Numerals 825 and 826 denote a toner particle removed by the hairs 823 and a toner particle which sneaks through the hairs 823 and is not removed by the hairs 823, respectively. FIG. 9 is a view illustrating the brush from a side B illustrated in FIG. 8.

Toner particles 925 to be cleaned are caught by the tip of the hairs of the brush roller. Some of the toner particles to be cleaned, a problem in that toner particles 926 sneak through bundles of hairs, resulting in defective cleaning occurs. In order to prevent occurrence of such a problem, a brush roller in which bundles of hairs are arranged at regular intervals while the positions of the bundles are different from those of the adjacent lines of the bundles as illustrated in FIG. 10 is preferably used. By using such a brush roller, toner particles to be cleaned can be well removed from the surface of the image bearing member.

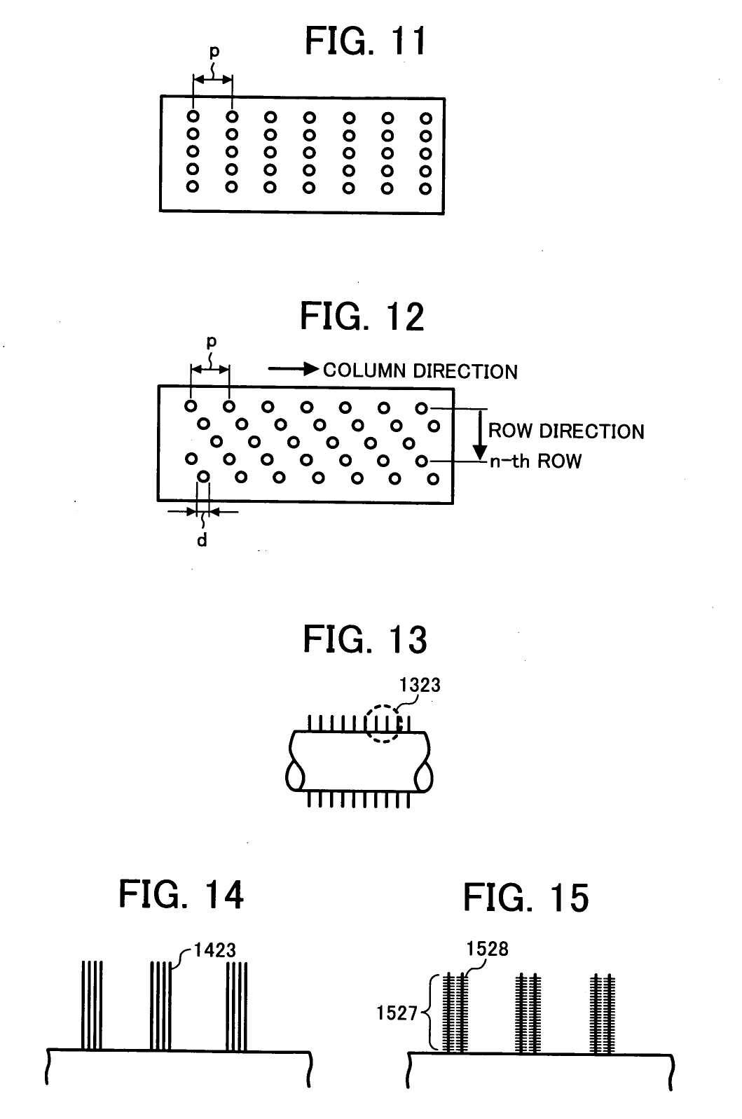

FIG. 11 is a schematic view illustrating a conventional brush roller in which bundles of hairs are arranged at a regular interval (p) while the positions of the bundles are the same as those of the adjacent lines of the bundles. Such a brush is prepared by winding a cloth, on which bundles of hairs are transplanted, around a shaft at an interval (pile width) of from 15 to 20 mm. Therefore there is a space between a bundle of hairs and adjacent bundles. FIG. 12 illustrates a brush roller for use in the image forming apparatus of the present invention. Referring to FIG. 12, a bundle of hairs, which has a diameter of (d) is arranged at an interval of (p) while the positions of the bundles are different from those of the adjacent lines of bundles in the row direction, and the n-th line of bundles of hairs has the same arrangement as that of the first line of bundles of hairs. It is preferable that the brush satisfies a relationship d≧P/n. By using such a brush roller, toner particles to be cleaned can be securely caught and scraped off by the brush roller and thereby occurrence of the defective cleaning problem can be prevented.

As illustrated in FIG. 13, the brush has bundles of hairs 1323 having a length of about 5 mm. If each of hairs 1423 has a straight form as illustrated in FIG. 14, a problem in that spherical toner particles sneak through the hairs even when the toner particles are contacted with the hairs occurs. In order to prevent occurrence of the problem, hairs each having a trunk 1527 and branches 1528 which preferably have a length of from 0.05 to 0.1 mm is preferably used. By using such a brush roller, the defective cleaning problem can be avoided, namely residual toner particles can be well removed.

### Fourth Embodiment

Then the fourth embodiment of the cleaning device for use in the image forming apparatus of the present invention will be explained.

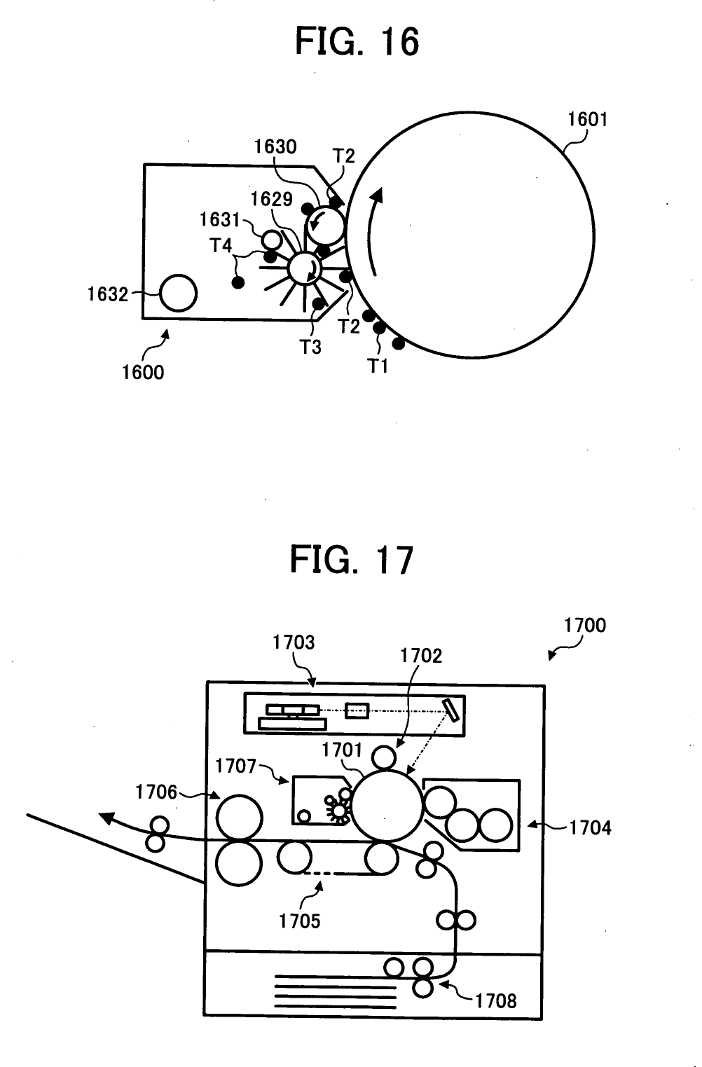

FIG. 16 is a schematic view illustrating the third embodiment of the cleaning device. In addition, FIG. 17 is a schematic view illustrating the image forming apparatus of the present invention using the cleaning device illustrated in FIG. 16. The photoreceptor (1) is used as an image bearing member 1601.

Referring to FIG. 16, a cleaning brush 1629 of a cleaning device 1600 is arranged so as to rub both the image bearing member 1601 and a cleaning roller 1630, and thereby residual toner particles on the image baring member 1601 are scraped by the cleaning brush before the residual toner particles reach the cleaning roller. Therefore, the amount of residual toner particles reaching the cleaning roller 1630 is dramatically reduced. In addition, the toner particles adhered to the cleaning roller can be scraped off without using a scraper or an exclusive cleaning brush for the cleaning roller. Therefore, a low-cost and small-sized cleaning device can be provided. In FIG. 16, numeral 1632 denotes an auger configured to feed the collected toner particles. In addition, characters T1-T4 denote residual toner particles; toner particles removed by the cleaning brush; toner particles fed by the cleaning brush while adhering to the cleaning brush; and toner particles falling from the brush by colliding against a flicker bar 1631.

If the cleaning roller 1630 is rotated so as to counter the image bearing member 1601, toner particles remaining on the surface of the cleaning roller 1630 without being scraped off by the cleaning brush 1629 are moved toward the nip between the image bearing member and the cleaning roller and stay in a wedgewise portion located before the nip. If such toner particles are re-transferred to the image bearing member, the toner particles are fed to the charging device. However, in the cleaning device illustrated in FIG. 16, the cleaning roller 1630 is rotated in a trailing direction (i.e., the cleaning roller 1630 and the image bearing member 1601 rotate in the same direction at the contact point), and thereby the toner particles remaining on the cleaning roller 1630 without being removed by the cleaning brush 1629 are moved to the upstream side of the cleaning roller, at which the toner particles can be subjected to a scraping treatment again by the cleaning brush 1629. Therefore, the cleaning device has good cleanability.

When the cleaning roller 1630 is rotated in such a direction as to counter the image bearing member 1601, the image bearing member 1601 receives a large mechanical force from the cleaning roller 1630 and thereby the effect of scraping residual toner particles can be enhanced. However, in this case the surface of the image bearing member is rubbed by a large mechanical force of the cleaning roller 1630 whose peripheral speed is largely different from that of the image bearing member, if the amount of residual toner particles present on the image bearing member is small. Therefore, the surface of the image bearing member is seriously abraded, resulting in shortening of the life of the image bearing member.

In contrast, in the cleaning device for use in the image forming apparatus of the present invention, the cleaning roller is rotated in a trailing direction, and thereby the difference in peripheral speed between the image bearing member and the cleaning roller is small. By decreasing the peripheral speed difference so as to be not greater than 10% of the peripheral speed of the image bearing member, the cleaning roller can produce a mechanical scraping effect while having a good combination of cleanability and durability. As a result of the present inventors' study, it is found that even when the peripheral speed difference is a few percent of the peripheral speed of the image bearing member, a good scraping effect can be imparted to the cleaning roller. Therefore, it is preferable to set the peripheral speed difference so as to be not greater than 10% of the peripheral speed of the image bearing member.

Since the cleaning brush 1629 is used for removing toner particles remaining on the image bearing member and the cleaning roller 1630, the flicker bar 1631 is provided to remove toner particles adhered to the hairs of the cleaning brush 1629. Therefore, the amount of toner particles adhered to the hairs of the brush roller is decreased after the hairs pass the flicker bar 1631, and thereby cleanability of the brush roller is revived. At first, the thus revived brush roller is used for scraping off a relatively small amount of residual toner particles present on the cleaning roller 1630, and is then used for scraping off a relatively large amount of residual toner particles present on the image bearing member 1601. Therefore, the cleaning device has good cleanability.

Referring to FIG. 16, the cleaning brush 1629 is rotated so as to counter the image bearing member 1601 and the cleaning roller 1630 is rotated so as to trail along behind the image bearing member (i.e., in a trailing direction). In this case, the cleaning brush 1629 is rotated so as to trail along behind the cleaning roller 1630. Therefore, the rotation speed of the cleaning brush is preferably differentiated from that of the cleaning roller so that toner particles on the cleaning roller can be effectively scraped off.

The hardness of surface of the image bearing member 1601 is much higher than that of the cleaning roller 1630 which is typically made of a rubber such as hydrin rubbers. Therefore, it is preferable for the cleaning brush 1629 to rub the surface of the image bearing member at a relatively high speed so that good cleaning effects can be produced. In addition, the cleaning brush 1629 rubs the surface of the cleaning roller 1630 at a relatively low speed so that the cleaning roller is not damaged. As mentioned above, the cleaning brush 1629 is rotated so as to trail along behind the cleaning roller 1630 in the cleaning device illustrated in FIG. 16. Therefore, even when the cleaning brush 1629 is used for removing both toner particles remaining on the image bearing member 1601 and toner particles remaining on the cleaning roller 1630, the durability of the cleaning roller 1630 is not deteriorated.

A voltage is applied to the cleaning roller 1630 by a bias applying device (not shown) such that an electric field is formed at a contact point of the cleaning roller with the image bearing member, and thereby residual toner particles on the image bearing member are electrostatically attracted by the cleaning roller. Since the strength of this electrostatic force is not changed even when the shape of the toner particles is changed, residual toner particles can be well removed even when the toner is a spherical toner.

It is difficult to well remove spherical toner particles from an image bearing member using a conventional blade. The cleaning device for use in the present invention can well remove residual spherical toner particles while having almost the same size and cost as those of conventional cleaning device using a blade. By using such a cleaning device, a compact and low-cost image forming apparatus which uses a spherical toner to produce high quality images can be provided.

Referring to FIG. 17, an image forming apparatus 1700 includes an image bearing member 1701; a charger 1702 configured to charge the image bearing member; a light irradiating device 1703 configured to irradiate the charged image bearing member with imagewise light to form an electrostatic latent image on the image bearing member; a developing device 1704 configured to develop the electrostatic latent image with a developer including a toner to form a toner image on the image bearing member; a transferring device 1705 configured to transfer the toner image onto a receiving material; a fixing device 1706 configured to fix the toner image on the receiving material; a cleaning device 1707 configured to clean the surface of the image bearing member, which is the cleaning device illustrated in FIG. 16; and a paper feeding device 1708 configured to feed the receiving material to a nip between the image bearing member and the transferring device.

### Fifth Embodiment

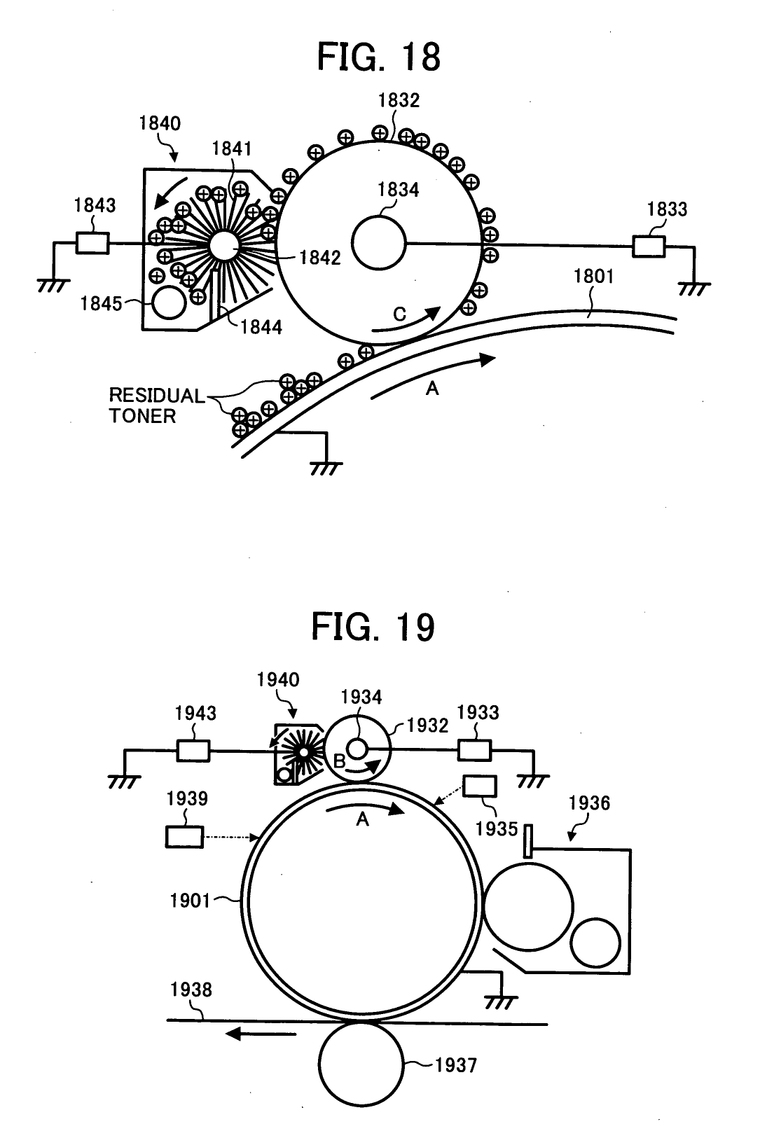

FIG. 18 is a schematic view illustrating another example of the cleaning device for use in the image forming apparatus of the present invention. In this embodiment the developer E1 is used.

The cleaning device uses a cleaning roller 1832 which is electroconductive and is made of an elastic material and which serves as a charging roller configured to charge an image bearing member 1801 (hereinafter the cleaning roller is sometimes referred to as the charging and cleaning roller 1832). The charging and cleaning roller 1832 is arranged so as to be contacted with the image bearing member 1801 and is rotated in a direction indicated by an arrow B. A voltage is applied to the charging and cleaning roller 1832 by a power source 1833, and thereby the image bearing member 1801 is charged so as to have a predetermined potential with a predetermined polarity. In this embodiment, the image bearing member is uniformly charged negatively.

When residual toner particles such as spherical toners or toners having a small particle diameter is removed with a blade, the toner particles are gathered at the contact point of the cleaning blade with the image bearing member by the cleaning blade so as to achieve a state near the closest packing state. Therefore, a second toner particle layer slips on a first toner particle layer which is contacted with the surface of the image bearing member while having a high adhesion against the image bearing member. Therefore, the first toner particle layer passes through the cleaning blade, namely the toner particle layer remains without being removed by the cleaning blade. Thus, a defective cleaning problem is caused, and the toner particles remain on the image bearing member.

When the contact pressure of the cleaning blade is increased to prevent such a defective cleaning problem, a large stress is applied to the residual toner particles, and thereby a wax included in a surface portion of the toner particles is exuded therefrom. The thus exuded wax is pressed by the cleaning blade to the surface of the image bearing member, resulting formation of a wax film on the surface of the image bearing member. This wax film deteriorates the image qualities.

The cleaning device for use in the present invention can well remove residual toner particles without causing the wax filming problem even when using a spherical toner having a small particle diameter and including a polyester binder resin having a relatively low melt viscosity (i.e., a relatively sharp melting property) compared to polyester resins used for conventional toners. Specifically, the cleaning device uses an elastic roller for the charging and cleaning roller 1832 and a voltage is applied to the roller. In addition, the charging and cleaning roller 1832 also charges the surface of the image bearing member 1801.

The charging and cleaning roller 1832 has a metal shaft 1834 and an electroconductive elastic layer which is formed on the metal shaft and which is made of an elastic material, such as polyurethane rubbers, silicone rubbers and butadiene rubbers, including a particulate electroconductive material such as carbon blacks, titanium oxides, aluminum oxides, ionic electroconductive materials.

In addition, a medium resistance layer having a medium electric resistance is formed thereon to prevent occurrence of a problem in that a large current flows through a pinhole of the image bearing member which is accidentally formed on the image bearing member. If desired, a protective layer can be formed as an outermost layer to prevent the surface of the charging and cleaning roller 1832 from being contaminated. In this embodiment, a protective layer is formed on the charging and cleaning roller 1832 such that the resultant roller has a volume resistivity of from 10⁶ to 10¹² Q·cm.

The power source 1833 is connected with the metal shaft 1834 to apply a voltage to the charging and cleaning roller 1832. Therefore, residual toner particles on the image bearing member 1801 are electrostatically attracted by the charging and cleaning roller 1832. Thus, the toner particles are transferred to the charging and cleaning roller 1832, and thereby the surface of the image bearing member can be cleaned. In FIG. 18, numeral 1840 denotes a cleaning device configured to clean the surface of the cleaning roller 1832. The cleaning device includes a cleaning brush 1841 having a metal shaft 1842 and a brush. A voltage is applied to the metal shaft 1842 by a power source 1843. Numerals 1844 and 1845 denote a plate by which the toner particles adhered to the brush are scraped off; and a feeding coil.

FIG. 19 is a schematic view for explaining the image forming processes. In this embodiment, an image bearing member 1901 is negatively charged. Then the charge image bearing member 1901 is exposed to imagewise light emitted by a light irradiating device 1935 to form an electrostatic latent image. Then a negatively charged toner is adhered to a lighted portion to develop the electrostatic latent image (i.e., the latent image is developed by a nega-posi developing method). Therefore, the toner on the image bearing member 1901 has a negative charge. Then a transferring device applies a positive voltage (or current) to the negatively charged toner image to transfer the toner image to a receiving material. Therefore, the toner particles remaining on the image bearing member without being transferred have a positive charge. Therefore, by applying a negative voltage to a cleaning roller 1932, the residual toner particles can be attracted to the cleaning roller 1932, and thereby the surface of the image bearing member can be well cleaned.

Specifically, by applying a voltage of −1300 V to a metal shaft 1934 of the cleaning roller 1932 (serving as a charging roller) by a power source 1933, the image bearing member is uniformly charged so as to have a potential of −700 V. The light irradiating device 1935 irradiates the charged image bearing member with imagewise light such that the lighted portion has a potential of −100 V. The thus prepared latent image is developed with a negatively charged toner while applying a voltage of −400 V to a developing roller of a developing device 1936. The toner image formed on the image bearing member 1901 is transferred to a receiving material by a transferring device 1937 to which a voltage of +1500 V is applied. Toner particles remaining on the image bearing member 1901 without being transferred have a positive charge.

The potential of the image bearing member 1901 is influenced by the transfer bias, but the charge remaining on the image bearing member after the transfer process is discharged by light emitted by a discharging device 1939 and thereby the image bearing member has a potential of about 0 V. In the cleaning process, the positively charged residual toner particles are electrostatically attracted to the cleaning roller 1932 to which a voltage of −1300 V is applied, and thereby the residual toner particles can be well removed. Thus, this image forming operation is repeated (i.e., the image bearing member 1901 is negatively charged again so as to have a potential of −700 V).

### Sixth Embodiment

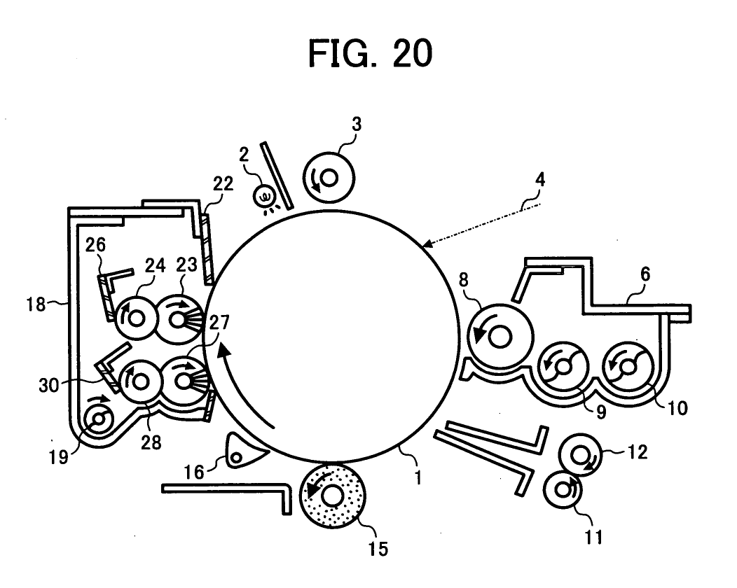

Then another cleaning device for use in the image forming apparatus of the present invention will be explained referring to FIG. 20. In this embodiment, the photoreceptor (1) is used an image bearing member 1, and the developer E2 is used as a developer. In addition, a reverse developing method is used. Further, a non-contact charging method is used.

In a cleaning device 18, two electrostatic assistant cleaning members 23 and 27 are arranged on an upstream side from a cleaning blade 22 to improve the cleanability of the cleaning device. In this embodiment, brush rollers are used as the assistant cleaning members and two metal rollers (i.e., toner collection rollers). 24 and 28 are provided to clean the surface of the cleaning brush rollers 23 and 27, respectively. Numerals 26 and 30 denote blades configured to scrape off the toner particles on the toner collection rollers 24 and 28, respectively.

When an image forming operation is started, a predetermined voltage is applied to each of a non-contact charging roller 3, a developing roller 8, a transfer roller 15, the toner collection rollers 24 and 28 and a discharge lamp 2. At the same time, the photoreceptor 1, the charging roller 3, the developing roller 8, the transfer roller 15, developer agitation screws 9 and 10, the cleaning brush rollers 23 and 27, the toner collection rollers 24 and 28, and a toner discharging screw 19 are rotated in the predetermined directions.

The photoreceptor 1 is uniformly charged with the non-contact charging roller 3 so as to have a potential of −900 V, and is then exposed to imagewise laser light 4 to form an electrostatic latent image thereon (the lighted portion has a potential of −150 V). The latent image is developed with a magnetic brush formed on the developing roller 8 of a developing device 6 while a developing bias of −600 V is applied to the developing roller. Thus, a toner image is formed on the photoreceptor 1.

The toner image is transferred to a receiving material by the transfer roller 15, which is fed by a paper feeding mechanism (not shown) and is then timely fed by a pair of registration rollers 11 and 12, while a transfer bias of +10 μA is applied to the transfer roller. The receiving material bearing the toner image thereon is separated from the photoreceptor 1 by a separation pick 16. The toner image is fixed on the receiving material by a fixing device (not shown), and then the receiving material (i.e., a copy) is discharged from the image forming apparatus.

Toner particles remaining on the photoreceptor 1 after the transfer process have a charge distribution illustrated in FIG. 27. Specifically, positively charged toner particles and negatively charged toner particles are mixed. The charge distribution of residual toner is changed as illustrated in FIGS. 28-30 when environmental conditions and/or transferring conditions are changed. The residual toner particles are transported to the lower cleaning brush roller 27. Since a voltage of +200 V is applied to the lower toner collection roller 28, a potential gradient (which changes depending on the resistance of the brush) is formed in the brush roller 27. Therefore, negatively charged toner particles are attracted by the cleaning brush roller 27. The positively charged toner particles are transported to the upper cleaning brush roller 23. Since a voltage of −200 V is applied to the upper toner collection roller 24, the positively charged toner particles are attracted by the cleaning brush roller 23.

Although the residual toner particles are electrostatically removed, a small amount of toner particles are present on the surface of the photoreceptor even after the cleaning brush roller 23. Such a small amount of toner particles prevent occurrence of a blade curling problem in that the tip of the cleaning blade is reversely curled by the rotated photoreceptor. The small amount of toner particles are removed from the photoreceptor 1 by the cleaning blade 22.

However, the cleaning effect of the above-mentioned electrostatic cleaning method is insufficient in the following cases:
(1) residual toner particles have no polarity;
(2) a charge is injected to the toner particles; and
(3) a large amount of residual toner particles are present on the surface of the photoreceptor, for example, in a case where a paper jamming problem occurs.

In these cases, the amount of toner particles reaching the cleaning blade 22 is changed.

When a charge is injected to toner particles by the voltage applied to the toner collection rollers 24 and 28, the charges of the toner particles are shifted to the side near the bias voltage applied to the collection rollers 24 and 28. Therefore, a problem in that the toner particles are not attracted by the brush rollers occurs. Specifically, a charge is injected to the toner particles on the cleaning brushes by the toner collection rollers 24 and 28, and thereby the toner particles remain on the cleaning brushes without being attracted by the toner collection rollers. The toner particles remaining on the cleaning brushes 23 and 26 are re-transferred to the photoreceptor 1.

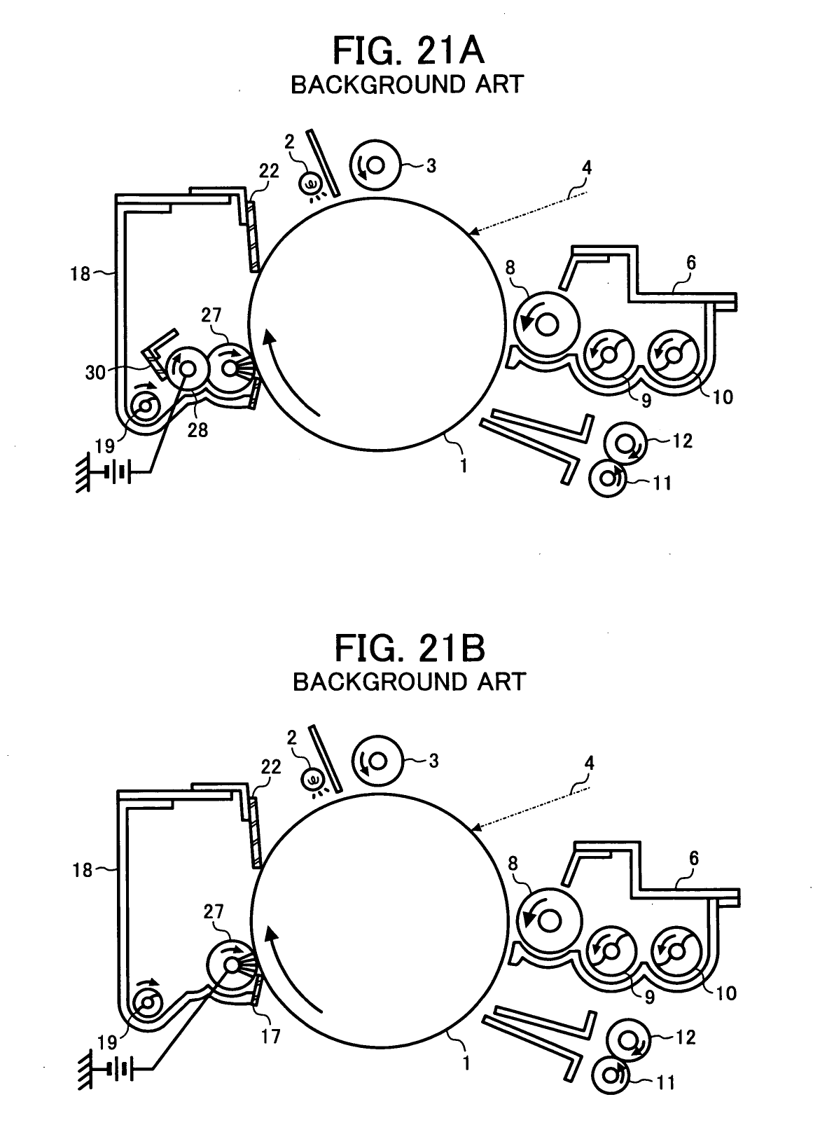

The present inventors analyze this phenomenon. The results are shown in Table 7. Specifically, the performance of a cleaning brush of a conventional cleaning device illustrated in FIG. 21A is studied. A cleaning device 18 illustrated in FIG. 21A has a cleaning blade 22 and a clening brush 27. In the image forming apparatus, a transferring device is removed therefrom for the experiment. Therefore, negatively charged toner particles are directly fed to the cleaning device.

The density of residual toner particles was measured at a point of the photoreceptor after the cleaning brush 27 while changing the voltage applied to the toner collection roller 28. The results are shown in Table 7.

TABLE 7

| Voltage | | | |
|---|---|---|---|
| applied to | Density | Voltage applied to | Density |
| toner collection | of residual | brush roller 27 | of residual |
| roller 28 (V) | toner particles | (V) | toner particles |
| 100 | 1.8 | 100 | 1.600 |
| 200 | 0.6 | 200 | 0.007 |
| 300 | 0.6 | 300 | 0.007 |
| 400 | 0.8 | 400 | 0.007 |
| 500 | 1.0 | 500 | 0.007 |

It is clear from Table 7 that when the voltage applied to the toner collection roller 28 is increased, the density of residual toner particles slightly decreases. However, when the voltage is greater than 300 V, the density increases. The charges of the residual toner particles are not changed when a voltage of 100 V is applied to the toner collection roller 28 (namely, a charge is not injected to the toner particles). The reason why the density increases when a voltage of not less than 300 V is applied to the collection roller 28 is that a charge is injected to the toner particles by the collection roller and the toner particles are retransferred to the photoreceptor. In this case, it is confirmed that almost all the toner particles are charged positively.

FIG. 21B illustrates another conventional cleaning device having a cleaning brush roller 27 to which a voltage is directly applied. The density of residual toner particles was measured at a point of the photoreceptor after the cleaning brush 27 while changing the voltage applied to the brush roller 27. The results are also shown on the right side of Table 7.

It is clear from the right columns in Table 7 that when a voltage not less than 200 V is applied to the brush roller 27, almost all the toner particles can be removed. Therefore, it is found that a charge is injected to toner particles at a location between the brush roller 27 and the collection roller 28.

However, a charge is injected to toner particles at a location between the brush roller 27 and the photoreceptor 1 if the resistivity of the brush rollers 23 and 27 decreases. In this regard, as the resistivity of the brush roller decreases, a greater amount of charge is injected to the toner particles. As a result of the present inventors' study, the resistivity of the brush roller is preferably from 10⁸ to 10⁹ Ω·cm to feed a proper amount of toner particles to the cleaning blade 22. When a spherical toner is used, an undesired streak or belt-shaped image is formed due to defective cleaning when the amount of toner particles fed to the cleaning blade increases. This is because spherical toner particles pass through the cleaning blade, more easily than toner particles having other shapes.

In the conventional image forming apparatus illustrated in FIG. 21A, the weight (M/A) of a toner image formed on the photoreceptor 1 is generally 0.5 mg/cm². Provided that the toner transferring rate is 90%, the amount of residual toner particles is 0.05 mg/cm². As illustrated in FIG. 27, the residual toner includes positively charged toner particles and negatively charged toner particles in a ratio of about 1:1. Therefore, the amount of each of the positively charged toner particles and negatively charged toner particles is 0.025 mg/cm². Therefore, the residual toner particles can be removed by the cleaning blade. However, when environmental conditions are changed or fresh toner particles are replenished, the charge distribution of the residual toner particles changes. In these cases, a cleaning problem may be caused.

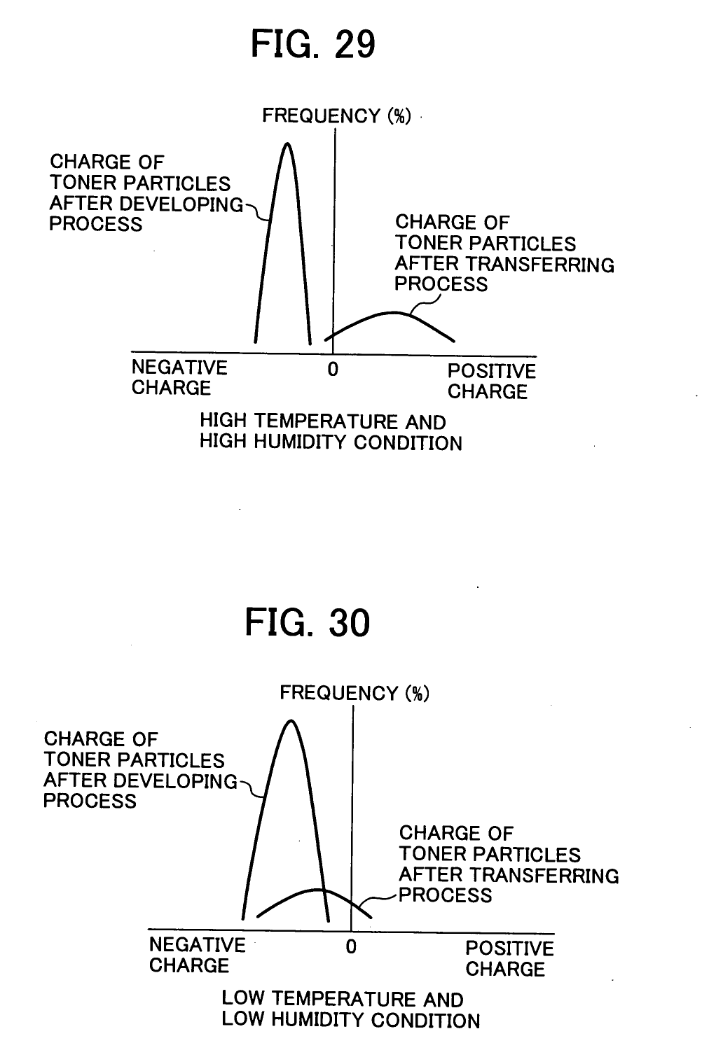

For example, in a high temperature and high humidity condition, the charge distribution of the toner particles after the developing process changes as illustrated in FIG. 29. Therefore, the amount of the toner particles reaching the cleaning blade changes. When fresh toner particles are replenished, the added toner particles typically have a low charge because the toner particles are not fully agitated by carrier particles. Therefore, the charge distribution of the toner particles reaching the cleaning blade changes. In these cases, a background fouling problem in that the background area of an image is soiled with toner particles occurs. Positively charged toner particles mainly cause the background fouling problem. As a result of the present inventors' study, when the amount of toner particles transported to the cleaning blade is greater than 0.05 mg/cm², a defective cleaning problem tends to occur.

When a paper jamming problem occurs, a large amount of toner particles are transported to the cleaning blade, resulting occurrence of a defective cleaning problem. In a conventional cleaning device which has one assistant cleaning member, a positive voltage is applied to the cleaning member (when a negative toner is used). However, the toner particles causing the background fouling problem have a positive charge, and therefore the toner particles cannot be removed by the conventional cleaning device.

In contrast, the cleaning device in this embodiment has two assistant cleaning members, one of which attracts positively charged toner particles and the other of which attracts negatively charge toner particles. When such a cleaning device is used, the amount of residual toner particles transported to the cleaning blade 22 is preferably controlled so as to be about 0.05 mg/cm², for example, by controlling the resistivity of the cleaning brushes. By using such a cleaning device, residual toner particles can be well removed without causing defective cleaning caused by curling of the cleaning blade even when a spherical toner is used.

With respect to the resistivity of the cleaning brushes 23 and 27, it is preferably that at least one of the brushes has a relatively high resistivity (of from 10⁸ to 10⁹ Ω·cm). Specifically, combinations of two brushes each having a resistivity of from 10⁸ to 10⁹ Ω·cm or combinations of a brush having a resistivity of from 108 to 10⁹ Ω·cm and another brush having a resistivity of from 10⁵ to 10⁶ Ω·cm can be preferably used. In the latter case, it is preferable that the brush having a lower resistivity is used for the brush roller 27 in FIG. 20. Namely it is preferable that the brush roller present on an upstream side has a lower resistivity.

In the present invention, it is also preferable that residual toner particles are charged with a brush so as to have either a positive or negative charge, and then the charged toner particles are attracted by a cleaning brush to remove the toner particles from the photoreceptor.

In the above-mentioned cleaning device having plural assistant cleaning members, the brush rollers can be replaced with elastic rubber rollers, rubber rollers having a hard surface layer, rollers having magnetic brushes of a magnetic material thereon, etc. In addition, the assistant cleaning members are not necessarily rotated, and fixed electroconductive brush rollers, sheets and elastic materials can be used as one of the assistant cleaning members. For example, a sheet 33 is used in a cleaning device illustrated in FIG. 23. However, it is preferable that at least the assistant cleaning member located on a downstream side rotates. In this case, a cleaning member configured to clean the surface of the assistant cleaning member is preferably provided.

Any known materials can be used for the cleaning blade 22. The shape and the using conditions are not particularly limited. Since plural assistant electrostatic cleaning members are provided on an upstream side from the cleaning blade 22, the amount of toner particles transported to the cleaning blade can be controlled, namely a problem in that a large amount of toner particles are fed to the cleaning blade is not caused even when a spherical toner having a relatively small particle diameter is used. In addition, the photoreceptor used in the present invention has a CCTL which has a good abrasion resistance but is properly abraded. Therefore, high quality images can be produced f 6 r a long period of time.

In this regard, the abrasion means that the surface of a photoreceptor is uniformly abraded. It is preferable that the surface of the photoreceptor is slightly abraded such that foreign materials (such as charging products, toner constituents (such as waxes), and dust of receiving papers) adhered to the surface of the photoreceptor are removed therefrom. By using the photoreceptor mentioned above, the abrasion of the surface thereof can be properly controlled.

For example, it is preferable to use a hard cleaning blade (more preferably a cleaning blade including an abrasive) to control the abrasion of the surface of the photoreceptor. In this case, the surface of the photoreceptor is always renewed.

Conventionally, techniques in that the surface of a photoreceptor is abraded by a member to remove foreign materials adhered to the surface have been proposed. However, when the photosensitive layer, which is typically made of a soft material, is abraded with a member, abrasion loss increases and a problem in that the surface is scratched occurs. Therefore, it is difficult for the techniques to properly abrade the surface of a photoreceptor. In addition, techniques in that a protective layer including a hard material therein is formed on a photoreceptor have been proposed. However, it is difficult for the techniques to properly abrade the surface of a photoreceptor.

### Seventh Embodiment

Then another cleaning device for use in the present invention will be explained. The photoreceptor (1) is used as the image bearing member and the developer E3 is used as the developer.

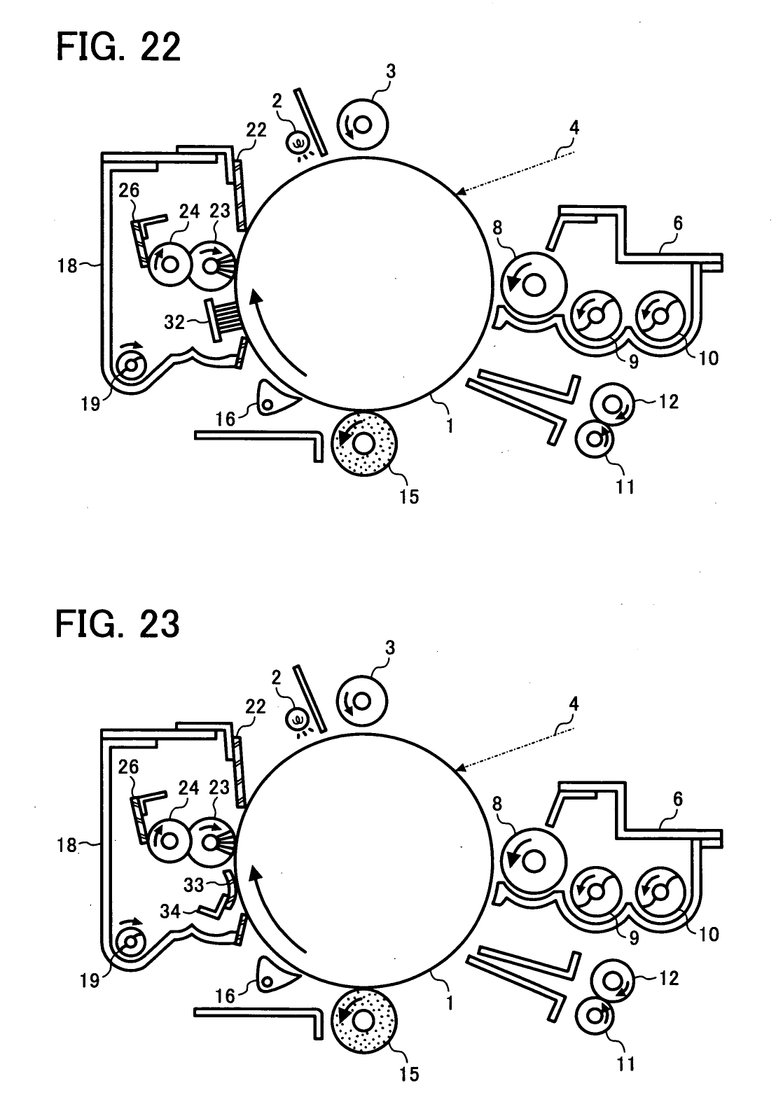

FIG. 22 is a schematic view illustrating the cleaning device. The cleaning device has an assistant cleaning member 32 which is a fixed brush having no cleaner therefor and which is arranged on an uppermost stream side from a cleaning blade 22 and a cleaning brush 23. The cleaning brush has a relatively low electric resistivity of from 10⁵ to 10⁶ Ω·cm. The cleaning brush 23 has a resistivity of from 10⁸ to 10⁹ Ω·cm. When a voltage of +200 V is applied to the cleaning brush 32, residual toner particles have the charge distribution as illustrated in FIG. 27. Namely, toner particles include positively charged toner particles and negatively charged toner particles. However, since the cleaning brush 32 has a low resistivity, a part of the residual toner is electrostatically attracted by the cleaning brush 32. In addition, a charge is injected to a part of the residual toner and thereby the residual toner is positively charged. The positively charged toner passes through the cleaning brush 32. In this regard, the amount of the toner particles passing through the cleaning brush 32 changes depending on the applied voltage. Specifically, as the applied voltage increases, the chance of charge injection also increases and thereby the amount of the toner particles passing through the cleaning brush 32 increases. Since the cleaning brush 32 has no cleaner, the amount of the toner particles caught by the cleaning brush 32 increases with time. Therefore, the cleaning brush 32 is contaminated with toner particles with time and thereby the charge injection ability of the cleaning brush 32 is deteriorated. In this case, a charge is gradually injected to the residual toner particles in the cleaning brush 32 and thereby the toner particles are gradually retransferred to the photoreceptor 1. Thus, after a certain number of copies are produced, the amount of toner particles caught by the cleaning brush becomes equal to that of toner particles retransferred to the photoreceptor 1, i.e., the amount of the toner particles borne by the cleaning brush becomes constant.

When image forming operations are performed under a high temperature and high humidity condition, the amount of residual toner particles increases and the toner particles have a charge distribution as illustrated in FIG. 29. When such residual toner particles are input into the cleaning brush 32, the charge injection ability of the cleaning brush 32 deteriorates. Therefore, it is preferable to retransfer the toner particles borne by the cleaning brush to the photoreceptor 1 while injecting a charge with a polarity such that the charge-injected toner particles can be attracted by the upper brush roller 23. In this case, it is preferable to perform a special charge injection operation in which a higher voltage is applied to the cleaning brush 32 after production of a predetermined number of copies to forcibly retransfer the toner particles in the cleaning brush 32 to the photoreceptor 1. This technique can be used for the cleaning devices mentioned below.

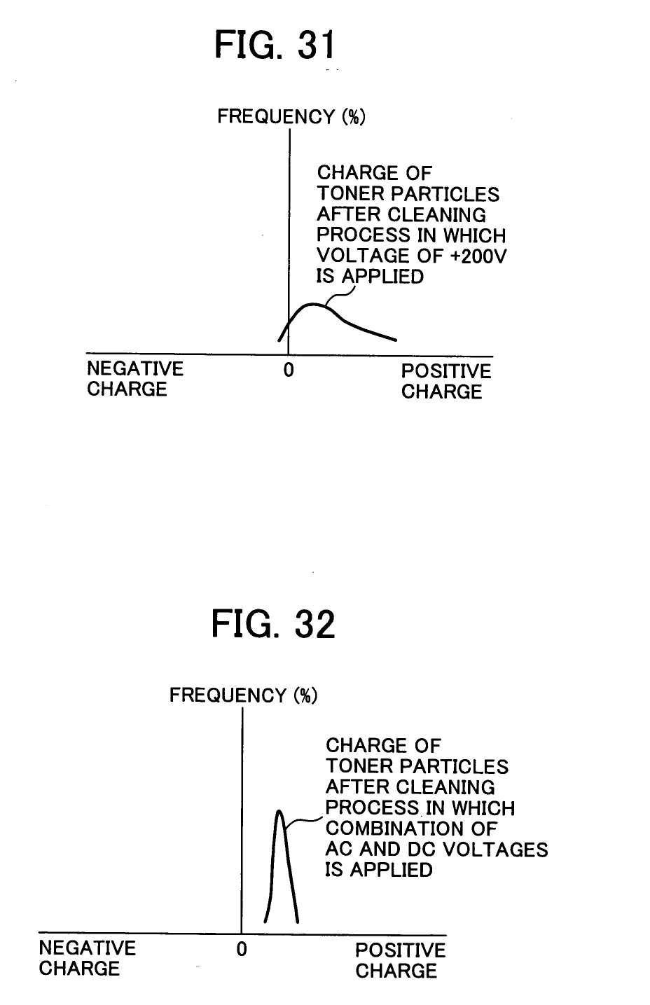

In the cleaning devices illustrated in FIGS. 20, 22, 23 and 24, a DC voltage overlapped with an AC voltage (hereinafter referred to as a DC/Ac voltage) can be preferably applied to the assistant cleaning member located on the uppermoststream portion. This operation will be explained referring to FIG. 20. When such a DC voltage is applied to the toner collection roller 28, the residual toner particles passing through the lower cleaning brush 27 have a charge distribution as illustrated in FIG. 31. Namely, the toner particles have a broad charge distribution while almost all the toner particles have positive charges. In this case, toner particles having a high change quantity cannot be easily caught by the upper cleaning brush roller 23 and in addition such toner particles cannot be easily removed with the cleaning blade 22. Such toner particles tend to form a toner film on the photoreceptor 1. When a DC/AC voltage is applied to the lower toner collection roller 28, the residual toner particles passing through the lower cleaning brush 27 have a sharp charge distribution while the charge quantities of the toner particles are relatively small. Therefore, the toner particles can be easily caught by the upper cleaning brush roller 23. Specifically, when a DC voltage of +100 V overlapped with an AC voltage having a sine wave having a frequency of 1.5 kHz and a peak-to-peak voltage (Vpp) of 200 V is applied, the residual toner particles passing through the lower cleaning brush 27 have the charge distribution as illustrated in FIG. 32. It is clear from FIG. 32 that the residual toner particles have a sharp charge distribution while the charge quantities of the toner particles are relatively small. Therefore, toner particles can be easily caught by the upper cleaning brush roller 23. The DC/AC voltage conditions are not limited to that mentioned above.

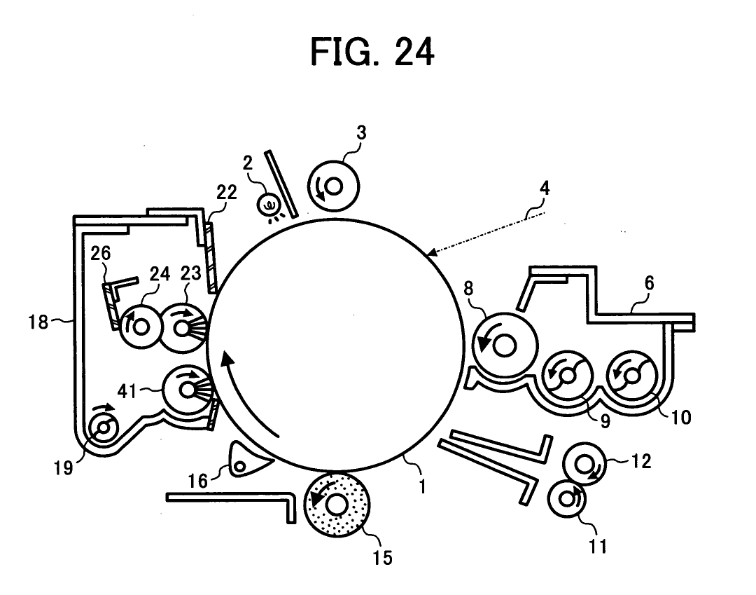

In FIG. 24, numeral 41 denotes a totating brush roller.

Application of the Roller Cleaning Device to Other Image Forming Apparatus

Then another embodiment in which the cleaning device, a spherical toner and a photoreceptor having the CCTL are applied to other image forming apparatus will be explained.

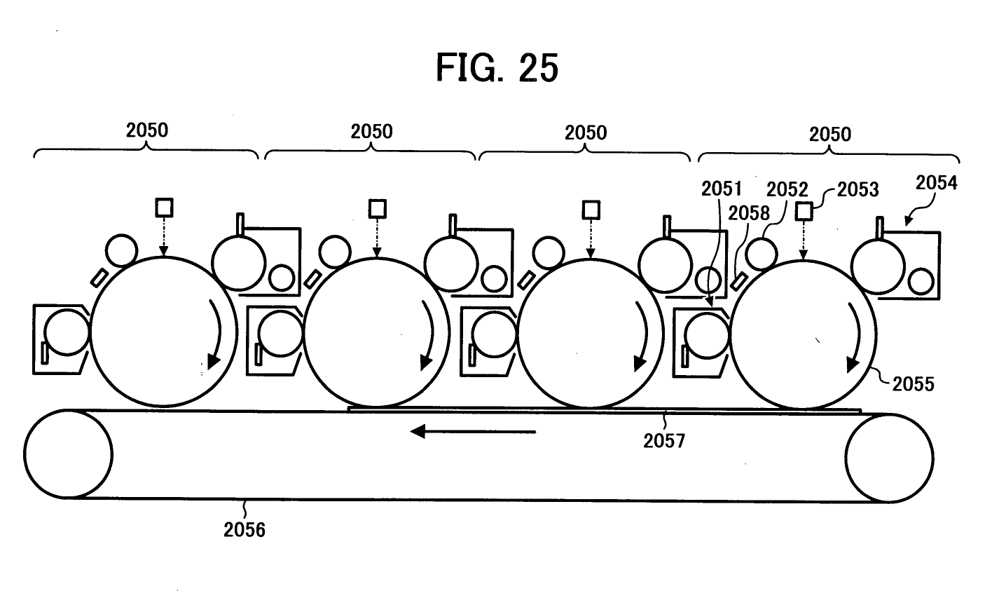

FIG. 25 is a schematic view illustrating a tandem type color image forming apparatus in which four image forming units, which are provided for producing yellow, magenta, cyan and black color images and each of which includes the cleaning device described in the first embodiment, are arranged side by side along a transfer belt 2056 which extends laterally. Although, the image forming apparatus uses a roller-type cleaning device, the cleaning device is not limited thereto and a cleaning device such as the cleaning devices mentioned above which have a combination of a cleaning blade and plural cleaning brushes can also be used.

Each of the image forming units 2050 includes an image bearing member 2055, a charging device 2052, a light irradiating device 2053, a developing device 2054, a roller cleaning device 2051 and a discharging device 2058. Yellow, magenta, cyan and black color toner images formed in the image forming units 2050 are transferred one by one onto a receiving material 2057 by the transfer belt 2056. The thus overlaid color toner images are fixed by a fixing device (not shown), resulting in formation of a full color image. The image formation order of yellow, magenta, cyan and black color images is not limited thereto, and the order may be changed.

Toner particles remaining on the surface of the image bearing member without being transferred are removed therefrom with the roller cleaning device 2051.

In conventional image forming apparatus using a cleaning blade, a wax film tends to be formed on an image bearing member and thereby the static friction coefficient is decreased as mentioned above. In this case, the adhesion of a toner to the surface of the image-bearing member decreases, and therefore a problem in that a toner image is scattered in the transferring process, resulting in formation of undesired scattered toner images occurs.

Since the roller cleaning device 2051 is used in the present embodiment, the wax film problem is not caused and therefore the toner scattering problem is not caused. Therefore, the roller cleaning device is preferably used for full color image forming apparatus in which four image transferring operations are performed in each image forming process, and good full color images can be produced.

In this embodiment, the roller cleaning device of the first embodiment is used. However, when the cleaning devices of the second to seventh embodiments are used for the image forming apparatus of the present invention, the same effects can also be produced. FIG. 21 is a schematic view illustrating another embodiment of the image forming apparatus of the present invention which includes the roller cleaning device mentioned above, four developing devices and an intermediate transfer medium.

The image forming apparatus includes a photoreceptor 2163 serving as an image bearing member, a charging device 2168 configured to charge the photoreceptor 2163, a light irradiating device 2169 configured to irradiate the charged photoreceptor with imagewise light to form an electrostatic latent image on the photoreceptor, four developing devices 2159-2162 configured to develop the electrostatic latent image with a yellow, magenta, cyan or black color toner, a cleaning device 2167 configured to remove residual toner particles remaining on the photoreceptor, a discharging device 2170 configured to discharge a residual charge remaining on the photoreceptor, an intermediate transfer medium 2164 configured to receive the color toner images from the photoreceptor, and a transferring device 2166 configured to transfer the toner images on the intermediate transfer medium 2164 to a receiving material 2165.

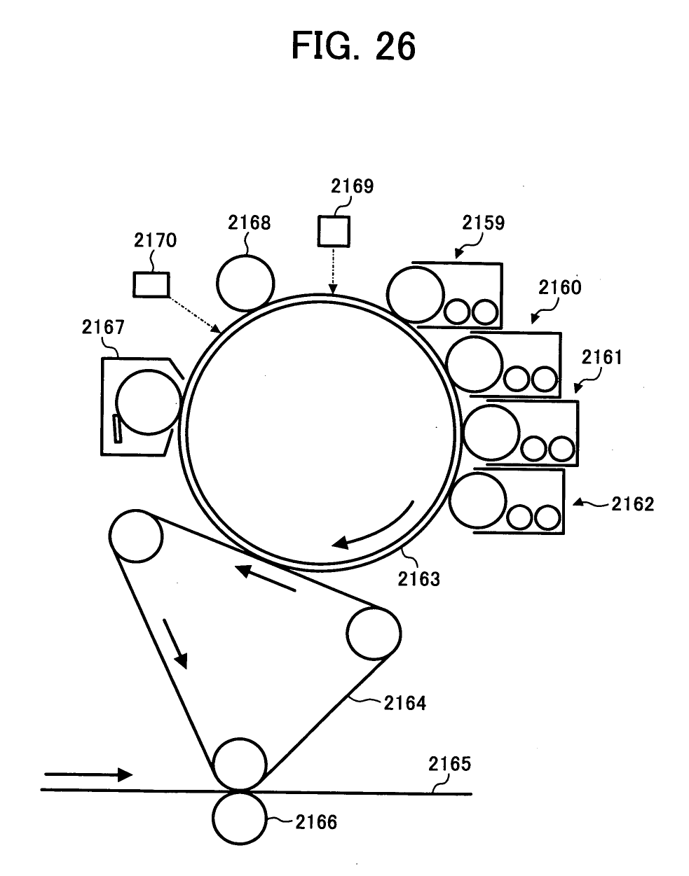

In the color image forming apparatus illustrated in FIG. 26, different color images (such as yellow, magenta, cyan and black color images) are formed by the four developing devices 2159-2162 and the color images are overlaid on the intermediate transfer medium 2164. The thus overlaid color images are transferred to the receiving material 2165 at the same time by a transferring device 2166. The thus transferred color images are fixed with a fixing device (not shown), resulting in formation of a full color image. The image forming order is particularly not limited. Although, the image forming apparatus uses a roller-type cleaning device, the cleaning device is not limited thereto and a cleaning device such as the cleaning devices mentioned above which have a combination of a cleaning blade and plural cleaning brushes can also be used.

Toner particles remaining on the surface of the photoreceptor without being transferred are removed therefrom with the roller cleaning device 2167 which is the cleaning device described above in the first embodiment.

In conventional image forming apparatus using a cleaning blade, a wax film tends to be formed on a photoreceptor and the wax is transferred to the intermediate transfer medium. Thereby the static friction coefficients of the surfaces of the photoreceptor and the intermediate transfer medium are decreased. In this case, the adhesion of a toner to the surfaces of the photoreceptor and the intermediate transfer medium decreases, and therefore a problem in that a toner image is scattered in the primary transferring process (image transfer from the photoreceptor to the intermediate transfer medium) and the secondary transferring process (image transfer from the intermediate transfer medium to the receiving material), resulting in formation of undesired scattered toner images occurs.

Since the roller cleaning device mentioned above is used in the present embodiment, the wax film problem is not caused and therefore the toner scattering problem is not caused. Therefore, the roller cleaning device is preferably used for such a full color image forming apparatus in which five image transferring operations (four primary image transferring operations plus one secondary image transferring operation) are performed in each image forming process, and good full color images without toner scattering can be produced.

Then the cleaning device of the present invention was evaluated while changing the photoreceptor and toner as shown in Tables 8 to 10. The evaluation method is as follows.

Evaluation Apparatus

A digital color printer (IPSIO 8200 (trademark) manufactured by Ricoh Co., Ltd.) which has a configuration as illustrated in FIG. 25 and which is modified such that each of the cleaning devices as illustrated in FIGS. 5, 6, 7, 16, 18, 20 and 22 is incorporated was used as the evaluation apparatus. In Comparative Example 1, a cleaning device including only a cleaning blade was used instead of the roller cleaning device. In this case, the cleaning device illustrated in FIG. 21A was used while the brush roller 27 is removed therefrom.

The conditions of the cleaning blade 22 used in Examples and Comparative Examples were as follows.

Material of cleaning blade 22: urethane rubber

Length of deformed tip portion of blade: 1.05 mm

Young's modulus: 0.45

Length of non-supported tip portion of blade: 8 mm

Angle formed by blade and photoreceptor: 79°

Pressure of blade: 80 g/cm

Direction of blade: counter direction (in a direction so as to counter the rotating photoreceptor)

In addition, a modified version of the cleaning device illustrated in FIG. 20, which was modified such that the cleaning blade 22 is replaced with a polishing blade having the same shape was also used as an evaluation apparatus. The polishing blade has a configuration such that a urethane layer and a polishing layer including a particulate alumina in an amount of 30% are overlaid while the layers are supported by a metal plate. The portion of the blade contacted with the photoreceptor has a curved surface such that the blade can be smoothly contacted with the photoreceptor. The contact pressure is 20 gf/cm. In addition, the cleaning device is modified to include an oscillating mechanism and an attach/detach mechanism configured to attach and detach the polishing blade. The surface of the photoreceptor is subjected to a polishing treatment using the polishing blade after every 5000 copies. In the polishing treatment, the photoreceptor is rotated by 30 revolutions to be subjected to the polishing treatment. The results are shown in Table 10. In this case, the cleaning device of sixth embodiment and the developer E1 were used. The photoreceptors Nos. (7) to (20) were used as the image bearing member. The evaluation methods for Examples 13 to 23 and Comparative Examples 5 to 7 are the same as those for Examples 1-12.

The evaluation items and methods are as follows.

Durability

One hundred thousand (100,000) copies of a character image having an image area proportion of 7% were intermittently produced one by one under an environmental conditions of 35° C. and 80% RH. In this running test, a 12 hour pause was made after every ten thousand copies.

Image Quality

Just after every 10,000 copy running test and just before every 10,000 copy running test, a half tone image, a solid white image and a solid black were produced to determine the image density of the black solid image, and to determine whether or not background fouling and image tailing are caused. In addition, with respect to evaluation of cleanability, the images were observed to determine whether defective images (such as streak images, white spots and black spots, which have a diameter (or thickness) not less than 0.3 mm) are formed. Further, the density of residual toner particles was also measured by the above-mentioned method.

The image density was measured with a densitometer X-RITE 938 (trademark) from X-Rite. The image density of a black solid image was determined by measuring the image densities of 5 points of the image and averaging the image densities. In order to evaluate the background fouling, the densities of ten different points of the white solid image were measured with the densitometer and averaging the densities to determine the difference between the average density of the white solid image and the density of the white paper which is not used for image formation.

Abrasion Loss

In order to evaluate the durability of the photoreceptors, the average thickness of each photoreceptor was determined before and after the 100,000 copy running test to determined the abrasion loss (i.e., the difference between the thickness before the running test and the thickness after the running test) of the photoreceptor. The average thickness was determined by measuring the thickness of ten different points in the longitudinal direction of the photoreceptor and averaging the thickness data.

Damage of Photoreceptor

The surface of the photoreceptors was visually observed to determine whether the photoreceptors have a scratch, a peeled portion, a crack and the like defects.

The results are shown in Tables 8-10.

TABLE 8

| | | | Photoreceptor | | Developer | | | |
|---|---|---|---|---|---|---|---|---|
| | Cleaning | | | Thickness | | Dv | | |
| | device | BL* | No. | of CCTL (μm) | No. | (μm) | CIR*² | Dv/Dp |
| Ex. 1 | Single | No | No. 1 | 5 | A | 6.4 | 0.940 | 1.35 |
| | rubber | | | | | | | |
| | roller | | | | | | | |
| | (FIG. 5) | | | | | | | |
| Ex. 2 | Single | No | No. 1 | 5 | B | 5.4 | 0.968 | 1.20 |
| | brush | | | | | | | |
| | roller (FIG. | | | | | | | |
| | 6) | | | | | | | |
| Ex. 3 | Double | No | No. 1 | 5 | C | 3.3 | 0.988 | 1.05 |
| | brush | | | | | | | |
| | rollers | | | | | | | |
| | (FIG. 7) | | | | | | | |
| Ex. 4 | Roller/ | No | No. 1 | 5 | D | 8.8 | 0.980 | 1.10 |
| | brush | | | | | | | |
| | (FIG. | | | | | | | |
| | 16) | | | | | | | |
| Ex. 5 | Single | No | No. 1 | 5 | E1 | 6.2 | 0.995 | 1.01 |
| | roller (i.e., | | | | | | | |
| | charger) | | | | | | | |
| | (FIG. 18) | | | | | | | |
| Ex. 6 | Double | No | No. 1 | 5 | E2 | 6.1 | 0.962 | 1.20 |
| | brushes/ | | | | | | | |
| | blade | | | | | | | |
| | (FIG. 20) | | | | | | | |
| Ex. 7 | Double | No | No. 1 | 5 | E3 | 6.0 | 0.950 | 1.25 |
| | brushes | | | | | | | |
| | (one fixed | | | | | | | |
| | brush)/ | | | | | | | |
| | blade | | | | | | | |
| | (FIG. 22) | | | | | | | |
| Ex. 8 | Double | No | No. 2 | 1 | E2 | 6.1 | 0.962 | 1.20 |
| | brushes/ | | | | | | | |
| | blade | | | | | | | |
| | (FIG. 20) | | | | | | | |
| Ex. 9 | Double | No | No. 3 | 3 | E3 | 6.0 | 0.950 | 1.25 |
| | brushes/ | | | | | | | |
| | blade | | | | | | | |
| | (FIG. 20) | | | | | | | |
| Ex. 10 | Double | No | No. 4 | 8 | E1 | 6.2 | 0.995 | 1.01 |
| | brushes/ | | | | | | | |
| | blade | | | | | | | |
| | (FIG. 20) | | | | | | | |
| Ex. 11 | Double | No | No. 5 | 10 | E2 | 6.1 | 0.962 | 1.20 |
| | brushes/ | | | | | | | |
| | blade | | | | | | | |
| | (FIG. 20) | | | | | | | |
| Ex. 12 | Double | Yes | No. 6 | 20 | E3 | 6.0 | 0.950 | 1.25 |
| | brushes/ | | | | | | | |
| | polishing | | | | | | | |
| | blade | | | | | | | |
| | (FIG. 20) | | | | | | | |
| Comp. | Blade | No | No. 1 | 5 | E1 | 6.2 | 0.995 | 1.01 |
| Ex. 1 | (FIG. 21A, | | | | | | | |
| | brush | | | | | | | |
| | roller is | | | | | | | |
| | removed) | | | | | | | |
| Comp. | Double | No | No. | 5 | E1 | 6.2 | 0.995 | 1.01 |
| Ex. 2 | brushes/ | | 19 | | | | | |
| | blade | | | | | | | |
| | (FIG. 20) | | | | | | | |
| Comp. | Double | No | No. | 1.5 | E2 | 6.1 | 0.962 | 1.20 |
| Ex. 3 | brushes/ | | 18 | | | | | |
| | blade | | | | | | | |
| | (FIG. 20) | | | | | | | |
| Comp. | Double | No | No. | 0 | E3 | 6.0 | 0.950 | 1.25 |
| Ex. 4 | brushes/ | | 20 | (none) | | | | |
| | blade | | | | | | | |
| | (FIG. 20) | | | | | | | |

BL*: Whether or not a polishing blade is used.

TABLE 9

| | Image density | | | Background fouling | | |
|---|---|---|---|---|---|---|
| | | After | After | | After | After |
| | 1-10 | 50,000 | 100,000 | 1-10 | 50,000 | 100,000 |
| | copies | copies | copies | copies | copies | copies |
| Ex. 1 | 1.37 | 1.36 | 1.35 | 0.01 | 0.02 | 0.04 |
| Ex. 2 | 1.38 | 1.38 | 1.35 | 0.01 | 0.03 | 0.05 |
| Ex. 3 | 1.39 | 1.37 | 1.35 | 0.01 | 0.01 | 0.03 |
| Ex. 4 | 1.40 | 1.38 | 1.35 | 0.01 | 0.01 | 0.03 |
| Ex. 5 | 1.41 | 1.36 | 1.33 | 0.01 | 0.01 | 0.02 |
| Ex. 6 | 1.39 | 1.35 | 1.32 | 0.01 | 0.01 | 0.02 |
| Ex. 7 | 1.40 | 1.41 | 1.41 | 0.01 | 0.01 | 0.01 |
| Ex. 8 | 1.40 | 1.39 | 1.38 | 0.01 | 0.02 | 0.03 |
| Ex. 9 | 1.39 | 1.38 | 1.38 | 0.01 | 0.02 | 0.02 |
| Ex. 10 | 1.41 | 1.40 | 1.40 | 0.01 | 0.01 | 0.03 |
| Ex. 11 | 1.40 | 1.40 | 1.40 | 0.01 | 0.03 | 0.03 |
| Ex. 12 | 1.40 | 1.35 | 1.31 | 0.03 | 0.03 | 0.05 |
| Comp. | 1.41 | 1.38 | 1.36 | 0.01 | 0.31 | 0.32 |
| Ex. 1 | | | | | | |
| Comp. | 1.38 | 1.36 | — | 0.01 | 0.03 | — |
| Ex. 2 | | | (note 1) | | | (note 1) |
| Comp. | 1.41 | 1.40 | 1.40 | 0.03 | 0.03 | 0.04 |
| Ex. 3 | | | | | | |
| Comp. | 1.38 | 1.10 | — | 0.10 | 0.20 | — |
| Ex. 4 | | | (note 1) | | | (note 1) |

(note 1):
Since the surface of the photoreceptor was seriously abraded and damaged, the running test was stopped at 50,000^{th} image.

TABLE 10

| | Density of residual toner | | | Undesired | | | | |
|---|---|---|---|---|---|---|---|---|
| | | After | | images* | | Peel, | Abrasion | |
| | 1-10 | 50,000 | After 10⁵ | (1-10⁵ | Tailed | crack, | loss | |
| | copies | copies | copies | images) | image*² | scratch | (μm) | Overall |
| Ex. 1 | 0.00 | 0.01 | 0.02 | No | ◯ | ◯ | 0.35 | ◯ |
| Ex. 2 | 0.03 | 0.04 | 0.04 | No | ◯ | ◯ | 0.42 | ◯ |
| Ex. 3 | 0.07 | 0.08 | 0.10 | No | ◯ | ◯ | 0.41 | ◯ |
| Ex. 4 | 0.03 | 0.03 | 0.04 | No | ◯ | ◯ | 0.71 | ◯ |
| Ex. 5 | 0.00 | 0.00 | 0.01 | No | ◯ | ◯ | 0.82 | ◯ |
| Ex. 6 | 0.00 | 0.02 | 0.02 | No | ◯ | ◯ | 0.78 | ◯ |
| Ex. 7 | 0.00 | 0.00 | 0.01 | No | ◯ | ◯ | 0.53 | ◯ |
| Ex. 8 | 0.01 | 0.02 | 0.02 | No | ◯ | Δ | 0.72 | Δ |
| Ex. 9 | 0.01 | 0.01 | 0.03 | No | ◯ | ◯ | 0.45 | ◯ |
| Ex. 10 | 0.01 | 0.03 | 0.03 | No | ◯ | ◯ | 0.40 | ◯ |
| Ex. 11 | 0.01 | 0.03 | 0.03 | No | ◯ | ◯ | 0.44 | ◯ |
| Ex. 12 | 0.01 | 0.03 | 0.03 | No | ◯ | ◯ | 0.50 | ◯ |
| Comp. | 0.01 | 0.28 | 0.31 | Yes | X | ◯ | 0.43 | X |
| Ex. 1 | | | | | | | | |
| Comp. | 0.02 | Defective | — | No | ◯ | Δ | Note 1 | X |
| Ex. 2 | | cleaning | (note 1) | | | | | |
| Comp. | 0.03 | 0.03 | 0.03 | Yes | X | ◯ | 0.10 | X |
| Ex. 3 | | | | | | | | |
| Comp. | 0.01 | Defective | — | Yes | Δ | ◯ | Note 1 | X |
| Ex. 4 | | cleaning | (note 1) | | | | | |

Undesired images*: “Yes” means that wax filming and scattered toner image problem occurred.
Tailed image*²: “No” includes a case where even if a tailed image is formed, the image quality is recovered before 50 images are produced after the tailed image.
◯: No tailed image is formed from 1 to 100000 copies.
Δ: Tailing occurred at a copy from 50000 to 100000 copies.
X: Tailing occurred after 50000 copies.
Note 1:
the surface of the photoreceptor was seriously abraded and damaged, and therefore the running test was stopped at 50000^{th} image.
Overall evaluation is performed as follows.
◯: Good
Δ: Acceptable
X: Bad (i.e., not acceptable)

Undesired images*: “Yes” means that wax filming and scattered toner image problem occurred.
Tailed image*²: “No” includes a case where even if a tailed image is formed, the image quality is recovered before 50 images are produced after the tailed image.
◯: No tailed image is formed from 1 to 100000 copies.
Δ: Tailing occurred at a copy from 50000 to 100000 copies.
×: Tailing occurred after 50000 copies.
Note 1: the surface of the photoreceptor was seriously abraded and damaged, and therefore the running test was stopped at 50000^{th} image.

Overall evaluation is performed as follows.
◯: Good
Δ: Acceptable
×: Bad (i.e., not acceptable)

It is clear from Tables 8-10 that by using a combination of the cleaning device, photoreceptor and toner mentioned above, high quality images having high density can be produced with hardly causing background fouling, tailing and toner scattering even under high temperature and high humidity conditions. This is because the cleaning device mentioned above can well remove a spherical toner.

TABLE 11

Photoreceptor

| | | | Thickness of |
|---|---|---|---|
| | Cleaning device | No. | CCTL (μm) |
| Ex. 13 | Double brushes/ | (7) | 5 |
| | polishing blade | | |
| Ex. 14 | Double brushes/ | (8) | 5 |
| | polishing blade | | |
| Ex. 15 | Double brushes/ | (9) | 5 |
| | polishing blade | | |
| Ex. 16 | Double brushes/ | (10) | 5 |
| | polishing blade | | |
| Ex. 17 | Double brushes/ | (11) | 5 |
| | polishing blade | | |
| Ex. 18 | Double brushes/ | (12) | 5 |
| | polishing blade | | |
| Ex. 19 | Double brushes/ | (13) | 5 |
| | polishing blade | | |
| Ex. 20 | Double brushes/ | (14) | 5 |
| | polishing blade | | |
| Ex. 21 | Double brushes/ | (15) | 5 |
| | polishing blade | | |
| Ex. 22 | Double brushes/ | (16) | 5 |
| | polishing blade | | |
| Ex. 23 | Double brushes/ | (17) | 5 |
| | polishing blade | | |
| Comp. | Double brushes/ | (18) | 5 |
| Ex. 5 | polishing blade | | |
| Comp. | Double brushes/ | (19) | 1.5 |
| Ex. 6 | polishing blade | | |
| Comp. | Double brushes/ | (20) | 0 |
| Ex. 7 | polishing blade | | (no CCTL) |

TABLE 12

| | Density of residual toner | | | Undesired | | | | |
|---|---|---|---|---|---|---|---|---|
| | | After | After | images* | | Peel, | Abrasion | |
| | 1-10 | 50,000 | 10⁵ | (1-10⁵ | Tailed | crack, | loss | |
| | copies | copies | copies | images) | image*² | scratch | (μm) | Overall |
| Ex. 13 | 0.01 | 0.01 | 0.01 | No | ◯ | ◯ | 0.46 | ◯ |
| Ex. 14 | 0.01 | 0.01 | 0.02 | No | ◯ | ◯ | 0.51 | ◯ |
| Ex. 15 | 0.01 | 0.01 | 0.01 | No | ◯ | ◯ | 0.67 | ◯ |
| Ex. 16 | 0.02 | 0.03 | 0.02 | No | ◯ | ◯ | 0.81 | ◯ |
| Ex. 17 | 0.01 | 0.01 | 0.01 | No | ◯ | ◯ | 0.90 | ◯ |
| Ex. 18 | 0.01 | 0.01 | 0.02 | No | ◯ | ◯ | 0.89 | ◯ |
| Ex. 19 | 0.00 | 0.00 | 0.01 | No | ◯ | Δ | 0.53 | Δ |
| Ex. 20 | 0.01 | 0.02 | 0.02 | No | ◯ | Δ | 0.72 | Δ |
| Ex. 21 | 0.01 | 0.01 | 0.03 | No | ◯ | Δ | 0.45 | Δ |
| Ex. 22 | 0.01 | 0.03 | 0.03 | No | ◯ | ◯ | 0.40 | ◯ |
| Ex. 23 | 0.01 | 0.03 | 0.03 | No | ◯ | ◯ | 0.44 | ◯ |
| Comp. | 0.01 | 0.03 | Note 1 | No | ◯ | Δ | Note 1 | X |
| Ex. 5 | | | | | | | | |
| Comp. | 0.03 | 0.03 | Note 2 | No | Δ | X | 0.56 | X |
| Ex. 6 | | | | | | | | |
| Comp. | 0.02 | Note 1 | Note 1 | No | ◯ | ◯ | Note 1 | X |
| Ex. 7 | | | | | | | | |

Note 1:
the surface of the photoreceptor was seriously abraded and damaged, and therefore the running test was stopped at or before 50000^{th} image.
Note 2:
A defective cleaning problem occurred.

The details of the photoreceptors (1)-(18) are as follows.

| | | CCTL | | | |
|---|---|---|---|---|---|
| | | | Radical | | |
| | | | polymerizable | Radical polymerizable | |
| | Photo- | | monomer having a | monomer (or oligomer) | |
| | Receptor | ThickNess | charge transport | having no charge transport | |
| | No. | (μm) | structure | structure | |
| Mfg. Ex. 1 | No. 1 | 1 | No. 54 | TMPTA | DPCA 120 |
| | | | (n = 1) | (n = 3) | (n = 6) |
| | | | | (v = 105) | (v = 1700) |
| Mfg. Ex. 2 | No. 2 | 3 | No. 54 | TMPTA | DPCA 120 |
| | | | (n = 1) | | |
| Mfg. Ex. 3 | No. 3 | 5 | No. 54 | TMPTA | DPCA 120 |
| | | | (n = 1) | | |
| Mfg. Ex. 4 | No. 4 | 8 | No. 54 | TMPTA | DPCA 120 |
| | | | (n = 1) | | |
| Mfg. Ex. 5 | No. 5 | 10 | No. 54 | TMPTA | DPCA 120 |
| | | | (n = 1) | | |
| Mfg. Ex. 6 | No. 6 | 20 | No. 54 | TMPTA | DPCA 120 |
| | | | (n = 1) | | |
| Mfg. Ex. 7 | No. 7 | 5 | No. 54 | TMPTA | U-15HA |
| | | | (n = 1) | | (n = 9) |
| | | | | | (v = 45000) |
| Mfg. Ex. 8 | No. 8 | 5 | No. 54 | SR-494 | U-15HA |
| | | | (n = 1) | (n = 4) | |
| | | | | (v = 150) | |
| Mfg. Ex. 9 | No. 9 | 5 | Compound having | TMPTA | DPCA 120 |
| | | | formula (I) (n = 2) | | |
| Mfg. Ex. | No. 10 | 5 | Compound having | RP-1040 | U-15HA |
| 10 | | | formula (I) (n = 2) | (n = 4) | |
| | | | | (v = 150) | |
| Mfg. Ex. | No. 11 | 5 | No. 217 | TMPTA | DPCA 60 |
| 11 | | | (n = 3) | | (n = 6) |
| | | | | | (v = 900) |
| Mfg. Ex. | No. 12 | 5 | No. 217 | RP-1040 | U-15HA |
| 12 | | | (n = 3) | | |
| Mfg. Ex. | No. 13 | 5 | No. 54 | TMPTA | — |
| 13 | | | (n = 1) | | |
| Mfg. Ex. | No. 14 | 5 | Compound having | DPHA | — |
| 14 | | | formula (I) (n = 2) | (n = 6) | |
| | | | | (v = 6000) | |
| Mfg. Ex. | No. 15 | 5 | No. 217 | U-15HA | — |
| 15 | | | (n = 3) | | |
| Mfg. Ex. | No. 16 | 5 | No. 54 | KS-HDDA | U-15HA |
| 16 | | | (n = 1) | (n = 2) | |
| | | | | (v = 7) | |
| Mfg. Ex. | No. 17 | 5 | Compound having | SR-256 | DPCA 120 |
| 17 | | | formula (I) (n = 2) | (n = 1) | |
| | | | | (v = 6) | |
| Mfg. Ex. | No. 18 | 5 | No. 217 | SR-256 | KS-HDDA |
| 18 | | | (n = 3) | | |

The character “n” represents the number of functional groups.
The character “v” represents the viscosity.

The character “n” represents the number of functional groups.
The character “v” represents the viscosity.

It is clear from Tables 11 and 12 that when a polishing blade is used for the cleaning device, the photoreceptor can be well polished without causing problems such that the photosensitive layer is peeled or cracked.

This document claims priority and contains subject matter related to Japanese Patent Application No. 2004-318342, filed on Nov. 1, 2004, incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. An image forming method comprising:
forming a toner image on a surface of an image bearing member;
transferring the toner image onto a receiving material optionally via an intermediate transfer medium; and
then cleaning the surface of the image bearing member with a cleaning member while applying a voltage to the cleaning member such that an electric field is formed between the image bearing member and the cleaning member, and the cleaning member attracts toner particles remaining on the surface of the image bearing member,
wherein the image bearing member has, as an outermost layer, a crosslinked charge transport layer comprising a crosslinked resin comprising at least one unit obtained from at least one radical polymerizable polyfunctional monomer having three or more radical polymerizable functional groups and no charge transport structure, and a unit obtained from a radical polymerizable functional monomer having one or more radical polymerizable functional groups and a charge transport structure.

2. The image forming method according to claim 1, wherein the at least one radical polymerizable polyfunctional monomer having three or more radical polymerizable functional groups and no charge transport structure comprises two or more radical polymerizable polyfunctional monomers.

3. The image forming method according to claim 1, wherein the crosslinked resin further comprises a unit obtained from at least one radical polymerizable functional monomer selected from the group consisting of radical polymerizable monofunctional monomers having no charge transport structure and radical polymerizable difunctional monomers having no charge transport structure.

4. The image forming method according to claim 1, wherein the radical polymerizable functional monomer having one or more radical polymerizable functional groups and a charge transport structure comprises a radical polymerizable monofunctional monomer having a charge transport structure.

5. The image forming method according to claim 1, wherein the crosslinked charge transport layer has a thickness of from 1 to 20 μm.

6. The image forming method according to claim 1, wherein the at least one radical polymerizable polyfunctional monomer comprises at least one radical polymerizable functional group selected from the group consisting of an acryloyloxy group and a methacryloyloxy group.

7. The image forming method according to claim 6, wherein the at least one radical polymerizable polyfunctional monomer comprises the following formula (A): 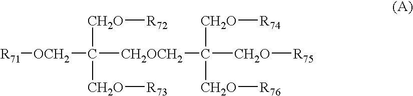
wherein each of R₇₁, R₇₂, R₇₃, R₇₄, R₇₅ and R₇₆ represents a hydrogen atom or a group having the following formula (B): 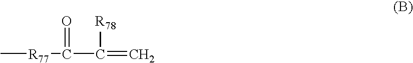
wherein R₇₇ represents a single bond, an alkylene group, an alkeleneether group or an alkyleneoxycarbonyl group, and R₇₈ represents a hydrogen atom or a methyl group.

8. The image forming method according to claim 6, wherein at least five groups of the six groups R₇₁, R₇₂, R₇₃, R₇₄, R₇₅ and R₇₆ have formula (B) and the other of the six groups is a hydrogen atom.

9. The image forming method according to claim 1, wherein the radical polymerizable functional monomer having one or more functional groups comprises one radical polymerizable functional group selected from the group consisting of an acryloyloxy group and a methacryloyloxy group.

10. The image forming method according to claim 1, further comprising:
charging the toner particles remaining on the image bearing member before or during the cleaning step.

11. The image forming method according to claim 10, wherein the charging is performed while applying a DC voltage having a polarity opposite to a polarity of charge of the toner, an AC voltage or a combination of a DC voltage and an AC voltage.

12. The image forming method according to claim 1, wherein the toner has a volume average particle diameter (Dv) of from 3 to 9 μm, a ratio (Dv/Dn) of the volume average particle diameter (Dv) to the number average particle diameter (Dn) of from 1.01 to 1.25, and an average circularity of not less than 0.950 and less than 1.00.

13. The image forming method according to claim 1, wherein the toner comprises a modified polyester resin and a wax, and wherein the wax is dispersed in the modified polyester resin.

14. The image forming method according to claim 13, wherein the modified polyester resin is a urea-modified polyester resin.

15. An image forming apparatus comprising:
an image bearing member configured to bear an electrostatic latent image on a surface thereof;
a developing device configured to develop the electrostatic latent image with a developer including a toner to form a toner image on the surface of the image bearing member;
a transferring device configured to transfer the toner image onto a receiving material optionally via an intermediate transfer medium; and
a cleaning device configured to clean the surface of the image bearing member with a cleaning member while applying a voltage to the cleaning member such that an electric field is formed between the image bearing member and the cleaning member and the cleaning member attracts toner particles remaining on the surface of the image bearing member,
wherein the image bearing member has, as an outermost layer, a crosslinked charge transport layer comprising a crosslinked resin comprising at least one unit obtained from at least one radical polymerizable polyfunctional monomer having three or more radical polymerizable functional groups and no charge transport structure, and a unit obtained from a radical polymerizable functional monomer having one or more radical polymerizable functional groups and a charge transport structure.

16. The image forming apparatus according to claim 15, wherein the at least one radical polymerizable polyfunctional monomer having three or more radical polymerizable functional groups and no charge transport structure comprises two or more radical polymerizable polyfunctional monomers.

17. The image forming apparatus according to claim 15, wherein the crosslinked resin further comprises a unit obtained from at least one radical polymerizable functional monomer selected from the group consisting of radical polymerizable monofunctional monomers having no charge transport structure and radical polymerizable difunctional monomers having no charge transport structure.

18. The image forming apparatus according to claim 15, wherein the radical polymerizable functional monomer having one or more radical polymerizable functional groups and a charge transport structure comprises a radical polymerizable monofunctional monomer having a charge transport structure.

19. The image forming apparatus according to claim 15, wherein the crosslinked charge transport layer has a thickness of from 1 to 20 μm.

20. The image forming apparatus according to claim 15, wherein the at least one radical polymerizable polyfunctional monomer comprises at least one radical polymerizable functional group selected from the group consisting of an acryloyloxy group and a methacryloyloxy group.

21. The image forming apparatus according to claim 20, wherein the at least one radical polymerizable polyfunctional monomer comprises the following formula (A): 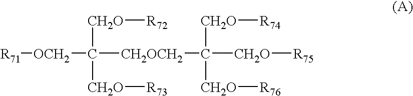
wherein each of R₇₁, R₇₂, R₇₃, R₇₄, R₇₅ and R₇₆ represents a hydrogen atom or a group having the following formula (B): 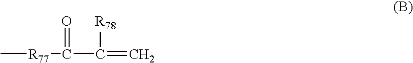
wherein R₇₇ represents a single bond, an alkylene group, an alkeleneether group or an alkyleneoxycarbonyl group, and R₇₈ represents a hydrogen atom or a methyl group.

22. The image forming apparatus according to claim 20, wherein at least five groups of the six groups R₇₁, R₇₂, R₇₃, R₇₄, R₇₅ and R₇₆ have formula (B) and the other of the six groups is a hydrogen atom.

23. The image forming apparatus according to claim 15, wherein the radical polymerizable functional monomer having one or more functional groups comprises one radical polymerizable functional group selected from the group consisting of an acryloyloxy group and a methacryloyloxy group.

24. The image forming apparatus according to claim 15, wherein the cleaning device further comprises a toner polarity controlling member configured to control a polarity of charge of the toner particles remaining on the surface of the image bearing member before the toner particles are attracted by the cleaning device.

25. The image forming apparatus according to claim 15, wherein the cleaning member comprises an elastic roller which is contacted with the surface of the image bearing member to catch the toner particles remaining on the surface of the image bearing member.

26. The image forming apparatus according to claim 15, wherein the cleaning member comprises at least one brush roller which is contacted with the surface of the image bearing member and to which a DC voltage having a polarity opposite to a polarity of charge of the toner, an AC voltage or a combination of a DC voltage and an AC voltage is applied to the at least one brush roller.

27. The image forming apparatus according to claim 26, wherein the cleaning member comprises two brush rollers, one of which is located on an upstream side from the other of the two brush rollers relative to a rotation direction of the image bearing member, and wherein voltages having different polarities are applied to the two brush rollers.

28. The image forming apparatus according to claim 26, wherein the cleaning member comprises a cleaning blade and at least two assistant cleaning members each of which is located on an upstream side from the cleaning blade relative to a rotation direction of the image bearing member and is contacted with the surface of the image bearing member.

29. The image forming apparatus according to claim 28, wherein each of the at least two assistant cleaning members is a rotatable brush roller having a cleaner configured to clean the brush roller.

30. The image forming apparatus according to claim 28, wherein the at least two assistant cleaning members have substantially a same resistivity.

31. The image forming apparatus according to claim 28, wherein the at least two assistant cleaning members comprise a rotatable brush roller and a fixed brush.

32. The image forming apparatus according to claim 28, wherein the at least two assistant cleaning members comprise a rotatable brush roller and an elastic sheet.

33. The image forming apparatus according to claim 28, wherein the at least two assistant cleaning members have different resistivities, and wherein the assistant cleaning member located on an uppermoststream side has a lower reisistivity than any other assistant cleaning members.

34. The image forming apparatus according to claim 28, wherein DC voltages having different polarities are applied to the at least two assistant cleaning members.

35. The image forming apparatus according to claim 28, wherein a combination of a DC voltage and an AC voltage is applied to an assistant cleaning member located on an uppermoststream side and a DC voltage is applied to any other assistant cleaning members.

36. The image forming apparatus according to claim 28, wherein an amount of toner particles reaching the cleaning blade is not greater than 0.05 mg/cm².

37. The image forming apparatus according to claim 28, wherein the cleaning blade is a polishing blade.

38. The image forming apparatus according to claim 15, wherein the toner has a volume average particle diameter (Dv) of from 3 to 9 μm, a ratio (Dv/Dn) of the volume average particle diameter (Dv) to the number average particle diameter (Dn) of from 1.01 to 1.25, and an average circularity of from 0.950 to 0.995.

39. The image forming apparatus according to claim 15, wherein the toner comprises a modified polyester resin and a wax, and wherein the wax is dispersed in the modified polyester resin.

40. The image forming apparatus according to claim 39, wherein the modified polyester resin is a urea-modified polyester resin.

41. The image forming apparatus according to claim 15, wherein the cleaning member comprises at least one brush roller configured to clean the surface of the image bearing member while rotating and contacting the surface of the image bearing member, and wherein the at least one brush roller has a plurality of lines of bundles of hairs and satisfies the following relationship:
d≧P/n
wherein d represents a diameter of each of the bundles of hairs of the at least one brush roller; P represents an interval of the bundles of hairs; and n represents a number of lines of the bundles of hairs in a rotation direction of the at least one brush roller, wherein an n-th line of the bundles of hairs has a same arrangement as that of a first line of bundles of hairs.

42. The image forming apparatus according to claim 41, wherein the hairs of the at least one brush roller have a trunk and a branch.

43. The image forming apparatus according to claim 41, wherein the cleaning device further comprises a flicker bar which is set so as to contact brush of the at least one brush roller to scrape off toner particles adhered to the at least one brush roller.

44. The image forming apparatus according to claim 15, further comprising:
a charger configured to charge the surface of the image bearing member; and
a light irradiator configured to irradiate the charged image bearing member with imagewise light to form the electrostatic latent image,
wherein the cleaning member comprises a cleaning roller, and wherein the cleaning roller serves as the charger.

45. A process cartridge comprising:
an image bearing member configured to bear an electrostatic latent image on a surface thereof; and
a cleaning device configured to clean the surface of the image bearing member with a cleaning member while applying a voltage to the cleaning member such that an electric field is formed between the image bearing member and the cleaning member and the cleaning member attracts toner particles remaining on the surface of the image bearing member,
wherein the image bearing member has, as an outermost layer, a crosslinked charge transport layer comprising a crosslinked resin comprising at least one unit obtained from at least one radical polymerizable polyfunctional monomer having three or more radical polymerizable functional groups and no charge transport structure, and a unit obtained from a radical polymerizable functional monomer having one or more radical polymerizable functional groups and a charge transport structure.
